(19) United States
(12) Patent Application Publication
(10) Pub. No.: US 2018/0356964 A1
(43) Pub. Date: Dec. 13, 2018

(54) METHODS, SYSTEMS, AND COMPUTER PROGRAM PRODUCTS FOR INTERGRATING CONFIGURATION, MONITORING, AND OPERATIONS

(71) Applicant: SITTING MAN, LLC, Raleigh, NC (US)

(72) Inventor: Robert Paul Morris, Raleigh, NC (US)

(21) Appl. No.: 16/003,021

(22) Filed: Jun. 7, 2018

Related U.S. Application Data
(60) Provisional application No. 62/516,276, filed on Jun. 7, 2017.

(51) Int. Cl. G06F 3/0484

(52) U.S. Cl. CPC G06F 3/04845

(57) ABSTRACT

Methods and systems are described for detecting, in an output space having at least one dimension, a first location of a subspace, wherein a first user interface element of a first operating instance of an operable entity is presented, based on the first location, in the subspace location and a user interface element of a second operating instance of an operable entity is presented, based on the first location, in the subspace. The method further includes receiving an indication to change the subspace and changing the subspace to have a second location in the output space, wherein the first user interface element and the second user interface element are each presented, based on the second location, in the changed subspace.

### RELATED APPLICATIONS

The present application claims priority to U.S. Provisional Patent Application No. 62/516,276, titled “METHODS, SYSTEMS, AND COMPUTER PROGRAM PRODUCTS FOR INTERGRATING CONFIGURATION, MONITORING, AND OPERATIONS,” filed Jun. 7, 2017, the contents of which are incorporated herein by reference in their entirety for all purposes.

### BACKGROUND

There is an ever-present need for easing the ability of users to interact with applications, devices, and operating environments; for easing the configuration and management of applications, devices, and operating environments; and for easing the enablement of interoperation between and among applications, devices, and operating environments. The present disclosure addresses the foregoing needs as well as other related needs.

### SUMMARY

Methods and systems are described for detecting, in an output space having at least one dimension, a first location of a subspace, wherein a first user interface element of a first operating instance of an operable entity is presented, based on the first location, in the subspace location and a user interface element of a second operating instance of an operable entity is presented, based on the first location, in the subspace. The method further includes receiving an indication to change the subspace and changing the subspace to have a second location in the output space, wherein the first user interface element and the second user interface element are each presented, based on the second location, in the changed subspace.

### BRIEF DESCRIPTION OF THE DRAWINGS

Objects and advantages of the subject matter of the present disclosure will become apparent to those skilled in the art upon reading this description in conjunction with the accompanying drawings, and in which for the subject matter described herein:

FIG. 1 illustrates a flow chart in accordance with an embodiment the subject matter described herein;

FIG. 2 illustrates user interface elements in accordance with an embodiment of the subject matter described herein;

FIG. 3 illustrates an arrangement of components of a system in accordance with an embodiment of the subject matter described herein;

FIG. 4 illustrates an arrangement of locations in a memory for accessing data in accordance with an embodiment of the subject matter described herein;

FIG. 5 illustrates an arrangement of locations in a memory for accessing data in accordance with an embodiment of the subject matter described herein;

FIG. 6 illustrates an arrangement of locations in a memory for accessing data in accordance with an embodiment of the subject matter described herein;

FIG. 7 illustrates an arrangement of locations in a memory for accessing data in accordance with an embodiment of the subject matter described herein;

FIG. 8 illustrates an arrangement of components of a system in accordance with an embodiment of the subject matter described herein;

FIG. 9 illustrates user interface elements in accordance with an embodiment of the subject matter described herein;

FIG. 10 illustrates user interface elements in accordance with an embodiment of the subject matter described herein;

FIG. 11 illustrates user interface elements in accordance with an embodiment of the subject matter described herein;

FIG. 12 illustrates a flow chart in accordance with an embodiment the subject matter described herein;

FIG. 13 illustrates user interface elements in accordance with an embodiment of the subject matter described herein;

FIG. 14 illustrates user interface elements in accordance with an embodiment of the subject matter described herein;

FIG. 15 illustrates a flow chart in accordance with an embodiment the subject matter described herein;

FIG. 16 illustrates an arrangement of components of a system in accordance with an embodiment of the subject matter described herein;

FIG. 17 illustrates an arrangement of components of a system in accordance with an embodiment of the subject matter described herein;

FIG. 18 illustrates an arrangement of components of a system in accordance with an embodiment of the subject matter described herein;

FIG. 19 illustrates a flow chart in accordance with an embodiment the subject matter described herein;

FIG. 20 illustrates a flow chart in accordance with an embodiment the subject matter described herein;

FIG. 21 illustrates a flow chart in accordance with an embodiment the subject matter described herein;

FIG. 22 illustrates an arrangement of components of a system in accordance with an embodiment of the subject matter described herein;

FIG. 23 illustrates a flow chart in accordance with an embodiment the subject matter described herein;

FIG. 24 illustrates an arrangement of components of a system in accordance with an embodiment of the subject matter described herein;

FIG. 25 illustrates an arrangement of components of a system in accordance with an embodiment of the subject matter described herein;

FIG. 26 illustrates a flow chart in accordance with an embodiment the subject matter described herein;

FIG. 27 illustrates a flow chart in accordance with an embodiment the subject matter described herein;

FIG. 28 illustrates an arrangement of components of a system in accordance with an embodiment of the subject matter described herein;

FIG. 29 illustrates a flow chart in accordance with an embodiment the subject matter described herein;

FIG. 30 illustrates a flow chart in accordance with an embodiment the subject matter described herein;

FIG. 31 illustrates an arrangement of components of a system in accordance with an embodiment of the subject matter described herein;

FIG. 32 illustrates an arrangement of components of a system in accordance with an embodiment of the subject matter described herein;

FIG. 33 illustrates a flow chart in accordance with an embodiment the subject matter described herein;

FIG. 34 illustrates an arrangement of components of a system in accordance with an embodiment of the subject matter described herein;

FIG. 35 illustrates user interface elements in accordance with an embodiment of the subject matter described herein;

FIG. 36 illustrates a flow chart in accordance with an embodiment the subject matter described herein;

FIG. 37 illustrates an arrangement of components of a system in accordance with an embodiment of the subject matter described herein;

FIG. 38 illustrates an arrangement of components of a system in accordance with an embodiment of the subject matter described herein;

FIG. 39 illustrates a flow chart in accordance with an embodiment the subject matter described herein;

FIG. 40 illustrates a flow chart in accordance with an embodiment the subject matter described herein;

FIG. 41 illustrates user interface elements in accordance with an embodiment of the subject matter described herein;

FIG. 42 illustrates a flow chart in accordance with an embodiment the subject matter described herein;

FIG. 43 illustrates a flow chart in accordance with an embodiment the subject matter described herein;

FIG. 44 illustrates a flow chart in accordance with an embodiment the subject matter described herein;

FIG. 45 illustrates user interface elements in accordance with an embodiment of the subject matter described herein;

FIG. 46 illustrates a flow chart in accordance with an embodiment the subject matter described herein;

FIG. 47 illustrates user interface elements in accordance with an embodiment of the subject matter described herein;

FIG. 48 illustrates user interface elements in accordance with an embodiment of the subject matter described herein;

FIG. 49 illustrates user interface elements in accordance with an embodiment of the subject matter described herein;

FIG. 50 illustrates a flow chart in accordance with an embodiment the subject matter described herein;

FIG. 51 illustrates a flow chart in accordance with an embodiment the subject matter described herein;

FIG. 52 illustrates a flow chart in accordance with an embodiment the subject matter described herein;

FIG. 53 illustrates user interface elements in accordance with an embodiment of the subject matter described herein;

FIG. 54 illustrates user interface elements in accordance with an embodiment of the subject matter described herein;

FIG. 55 illustrates a flow chart in accordance with an embodiment the subject matter described herein;

FIG. 56 illustrates a flow chart in accordance with an embodiment the subject matter described herein;

FIG. 57 illustrates user interface elements in accordance with an embodiment of the subject matter described herein;

FIG. 58 illustrates a flow chart in accordance with an embodiment the subject matter described herein;

FIG. 59 illustrates user interface elements in accordance with an embodiment of the subject matter described herein;

FIG. 60 illustrates a flow chart in accordance with an embodiment the subject matter described herein;

FIG. 61 illustrates a flow chart in accordance with an embodiment the subject matter described herein;

FIG. 62 illustrates user interface elements in accordance with an embodiment of the subject matter described herein;

FIG. 63 illustrates a flow chart in accordance with an embodiment the subject matter described herein;

FIG. 64 illustrates user interface elements in accordance with an embodiment of the subject matter described herein;

FIG. 65 illustrates user interface elements in accordance with an embodiment of the subject matter described herein;

FIG. 66 illustrates user interface elements in accordance with an embodiment of the subject matter described herein;

FIG. 67 illustrates user interface elements in accordance with an embodiment of the subject matter described herein;

FIG. 68 illustrates a flow chart in accordance with an embodiment the subject matter described herein;

FIG. 69 illustrates user interface elements in accordance with an embodiment of the subject matter described herein;

FIG. 70 illustrates a flow chart in accordance with an embodiment the subject matter described herein;

FIG. 71 illustrates a flow chart in accordance with an embodiment the subject matter described herein;

FIG. 72 illustrates user interface elements in accordance with an embodiment of the subject matter described herein;

FIG. 73 illustrates a flow chart in accordance with an embodiment the subject matter described herein;

FIG. 74 illustrates a flow chart in accordance with an embodiment the subject matter described herein;

FIG. 75 illustrates a flow chart in accordance with an embodiment the subject matter described herein;

FIG. 76 illustrates an arrangement of components of a system in accordance with an embodiment of the subject matter described herein;

FIG. 77 illustrates a flow chart in accordance with an embodiment the subject matter described herein;

FIG. 78 illustrates an arrangement of components of a system in accordance with an embodiment of the subject matter described herein;

FIG. 79 illustrates a flow chart in accordance with an embodiment the subject matter described herein;

FIG. 80 illustrates a flow chart in accordance with an embodiment the subject matter described herein;

FIG. 81 illustrates user interface elements in accordance with an embodiment of the subject matter described herein;

FIG. 82 illustrates user interface elements in accordance with an embodiment of the subject matter described herein;

FIG. 83 illustrates user interface elements in accordance with an embodiment of the subject matter described herein;

FIG. 84 illustrates user interface elements in accordance with an embodiment of the subject matter described herein;

FIG. 85 illustrates user interface elements in accordance with an embodiment of the subject matter described herein;

FIG. 86 illustrates an exemplary operating environment in which one or more aspects of the subject matter may be embodied; and

FIG. 87 illustrates an exemplary system in which one of more aspects of the subject matter may be embodied.

Some addressable entities or other types of parts, illustrated in the drawings are identified by numbers with an alphanumeric suffix. An addressable entity or part may be referred to generically in the singular or in the plural by dropping a suffix of the addressable entity's or part's identifier or a portion thereof.

### DETAILED DESCRIPTION

All publications, patent applications, patents, and other references mentioned herein are incorporated by reference in their entirety, unless explicitly stated otherwise. In case of conflict, the present disclosure, including definitions, will control.

One or more aspects of the disclosure are described with reference to the drawings, wherein the various structures are not necessarily drawn to scale. In addition, the materials, Figures, and examples are illustrative only and not intended to be limiting. As an option, each of the flow charts, data flow diagrams, system diagrams, hardware diagrams, network diagrams, user interface diagrams, or Figures that depict other types of diagrams may be implemented in the context and details of any of the other diagrams in the foregoing figures unless clearly indicated by the diagrams themselves or in the description below. For purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form to facilitate describing one or more aspects of the disclosure. It is to be understood that other embodiments or aspects may be utilized and structural and functional modifications may be made without departing from the scope of the subject matter disclosed herein.

Although flow charts, pseudo-code, hardware, devices, or systems similar or equivalent to those described herein can be used in the practice or testing of the subject matter described herein, suitable flow charts, pseudo-code, hardware, devices, or systems are described below. Each embodiment, option, or aspect of the subject matter disclosed herein (including any applications incorporated by reference) may or may not incorporate any desired feature from any other embodiment, option, or aspect described herein (including any applications incorporated by reference).

Of course, the various embodiments set forth herein may be implemented utilizing hardware, software, or any desired combination thereof. For that matter, any type of hardware or circuitry may be utilized which is usable for implementing the various functionality set forth herein. It should be noted that, one or more aspects of the various embodiments of the subject matter of the present disclosure may be included in an article of manufacture (e.g. one or more computer program products) having, for instance, computer usable media. The media has embodied therein, for instance, computer readable program code for providing and facilitating the capabilities of the various embodiments. The article of manufacture can be included as a part of a computer system or sold separately.

References in this specification or references in specifications incorporated by reference to an “embodiment”; may mean that aspects, architectures, functions, features, structures, characteristics, etc. of an embodiment that may be described in connection with the embodiment may be included in at least one implementation. Thus, references to an “embodiment” may not necessarily refer to the same embodiment. The aspects etc. may be included in forms other than the embodiment described or illustrated and all such forms may be encompassed within the scope and claims of the present application.

References, in this specification or references in specifications incorporated by reference to “for example”, may mean that aspects, architectures, functions, features, structures, characteristics, etc. described in connection with the embodiment or example may be included in at least one implementation. Thus, references to an “example” may not necessarily refer to the same embodiment, example, etc. The aspects etc. may be included in forms other than the embodiment or example described or illustrated and all such forms may be encompassed within the scope and claims of the present application.

The various embodiments, examples, and portions thereof provided herein relating to improvements to apparatuses and processes (e.g. as shown in the contexts of the figures included in this specification, for example) may be used in various systems, methods, arrangements, applications, contexts, environments, etc. that may not be limited to those described herein. For example, one or more embodiments, examples, and portions thereof described or illustrated in the context of, for example, one or more figures of the present disclosure may be combined with or may be used in combination with one or more other embodiments, examples, and portions thereof described or illustrated in the context of one or more other figures of the present disclosure. Further, one or more embodiments, examples, and portions thereof described or illustrated in the context of, for example, one or more figures of the present disclosure may be combined with one or more embodiments, examples, and portions thereof described or illustrated in the present disclosure or may be combined with one or more embodiments, examples, and portions thereof described or illustrated in any specifications incorporated by reference.

Still yet, the diagrams depicted herein are just examples. There may be many variations to these diagrams or the steps (or operations) described therein without departing from the spirit of the various embodiments of the subject matter. For instance, the steps may be performed in a differing order, or steps may be added, deleted or modified. These variations are considered a part of the claimed subject matter.

While various embodiments are described below, they have been presented by way of example only, and not limitation. Thus, the breadth and scope of a subject matter of the present disclosure should not be limited by any of the above-described exemplary embodiments, but should be defined only in accordance with the following claims and their equivalents.

Unless otherwise defined herein or alternatively in a definition included by reference, all technical and scientific terms used herein have the same meaning as commonly understood by one of ordinary skill in the art to which the present disclosure belongs.

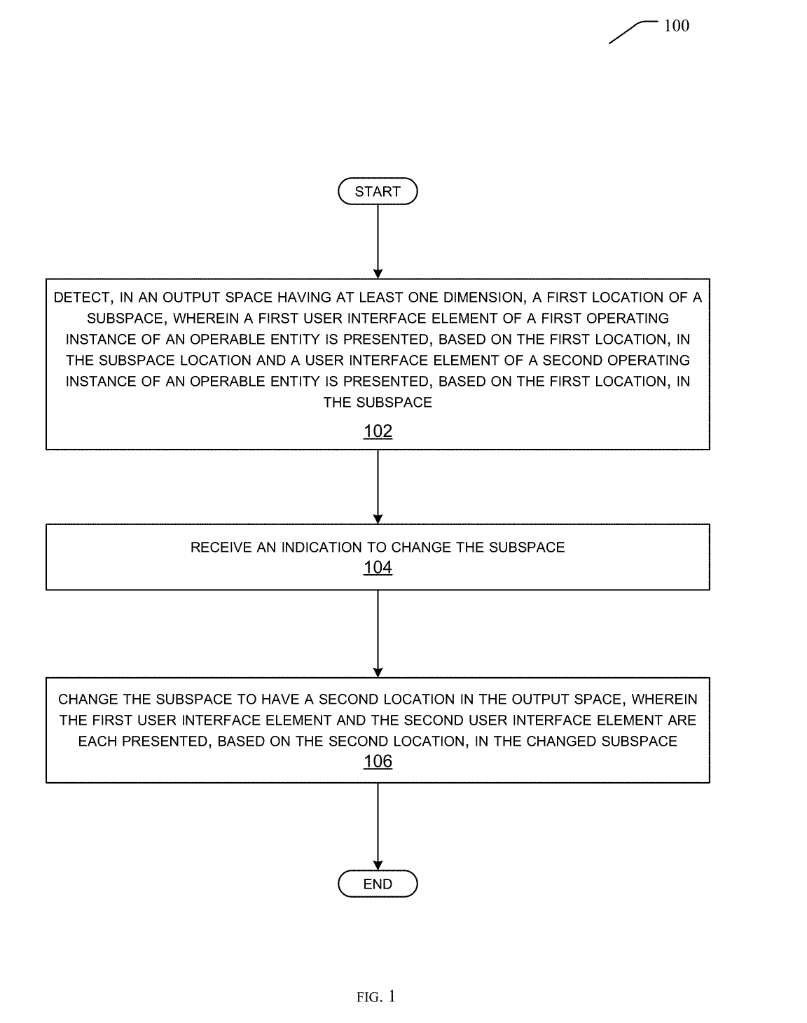

FIG. 1 shows a flow chart 100 in accordance with an embodiment of a method of the present disclosure. Circuitry may be included in an embodiment or a method may include providing circuitry that is operable for use with a system included in performing a method of flow chart 100. Such a system may include an output device, a data transfer medium, and a visible output space for interacting with a user via the output device. An output space may include memory provided by a memory device or memory provided by another medium allocated or otherwise provided to store or otherwise represent output information presented or for presenting via an output device. Output information may include audio, visual, tactile, or other sensory data for presentation via an output device. Output information in a visible output space, such as a screen of a display device, may be visibly detected by a user. At block 102, the circuitry may operate in detecting a subspace having a first location in the output space. The subspace may be an output space or a part of an output space that is part of or is included in another output space. The output space may have one or more dimensions such as a horizontal dimension, a vertical dimension, or a depth dimension. A first user interface element (UI element) allowing a user to interact with a first operating instance of an operable entity may be presented, based on the first location, in the subspace and a second user interface element allowing a user to interact with a second operating instance of an operable entity may also be presented, based on the first location, in the subspace. A user interface element (UI element) may be a user-detectable output of an output device. Examples include menu bars, menu items, windows, panes, tabs, buttons, checkboxes, textboxes, and the like. The terms user interface element and visual output are used interchangeably in the present disclosure. An operating instance may be an operating or executing of an operable entity. Examples of an operating instance includes an operating of an application, a computing process, a thread, an operating environment (OE), an operating of a device, an operating of a network service, a virtual machine, or an operating system container such as a LINUX container. An operating instance may be created from or may operate based on an operable entity such as operable hardware, electrical circuitry, or code and data for processing as operating virtual circuitry by or for an application, computing process, thread, virtual machine, network service, and so on. At block 104, the circuitry may operate in receiving, identifying, or otherwise detecting an indication to change the subspace. The change may identify or include moving the subspace, changing a shape of the subspace, or changing a size of the subspace—to name some examples. At block 106, the circuitry may operate in changing the subspace to have a second location in the output space. The first user interface element and the second user interface element may each be presented, based on the second location, in the changed subspace. A user interacts with an object (e.g. a system, a user interface element, etc.) in an interaction which may include any activity including a user and the object. The object may be a source of sensory data detected by the user or the user may be a source of input for the object.

Instructions may be executed in a computing context referred to as a “computing process” or simply a “process” A process may include one or more “threads”. A “thread” includes one or more instructions executed by a processor in a computing sub-context of a process. The terms “thread” and “process” may be used interchangeably herein when a process includes only one thread.

In an embodiment, the changed subspace may include both the first location and second location. In an embodiment, the changed subspace may include the second location and not include the first location.

Changing a subspace may include moving a user interface element representing or identifying some or all of the subspace, changing a size of the interface element representing or identifying some or all of the subspace, or changing the shape of the user interface element representing or identifying some or all of the subspace. A boundary of a subspace may not be visible to a user prior to receiving an indication to change the subspace. Changing a subspace may include presenting a user interface element that identifies some or all of the boundary. A boundary may identify a location in a subspace. Moving a subspace may be performed automatically in response to a detecting a change indication. Moving a subspace may include an interaction between a user and a user interface element that represents the subspace. For example, a user may identify a location via a touch or other pointing input device. A subspace may be changed be based on the identified location. A change may include a change in a location, a size, or a shape of a subspace in one or more of dimensions of the subspace or of an output space that includes some or all of the subspace. Any user interface elements in a subspace may be modified so they remain in the subspace as a part of a changing of the subspace or in response to a change to the subspace.

A user interface element may be presented in a two-dimensional output space where a location may be defined via a two-dimensional coordinate space of a coordinate system, such as a Euclidean coordinate system. For example, a coordinate system may be specified where one dimension is specified as a vertical dimension and the other a horizontal dimension. A location in a first dimension, such as a horizontal dimension, may be referenced according to an X-axis and a location in a second dimension (e.g. a vertical dimension) may be referenced according to a Y-axis of a coordinate space. In another aspect, a user interface element may be presented in a three-dimensional output space where a location may be defined utilizing a coordinate space of a coordinate system having a third dimension (e.g. a depth dimension) in addition to a first dimension (e.g. a vertical dimension) and a second dimension (e.g. a horizontal dimension). A location in a depth dimension may be identified according to a Z-axis. A visual output in a two-dimensional presentation may be presented as if a depth dimension existed allowing the visual output to overlie or underlie some or all of another visual output.

A subspace may allow a creation of, removal of, modification of, or interaction via a first user interface element in the subspace where the first user interface element is in a user interface of or otherwise represents a first operating instance. A change to the first user interface element may affect a second user interface element in the subspace where the second user interface element is in a user interface of or otherwise represents a second operating instance. A change to one user interface element in a subspace may affect another user interface element via a rule or policy of the subspace. For example, circuitry may detect a rotation in one or more dimension of a user interface element in a subspace. Circuitry may operate, in response to detecting the rotation, to rotate another user interface element in the subspace where each of the user interface elements represents a different operating instance.

In various embodiments, some or all of a subspace, when included in a visible output space, may be visible to a user at sometimes, at all times that a subspace is in the visible output space, or a subspace may invisible at all times.

A user interface element, of an operating instance, in a subspace may be presented in a visually detectable portion of an output space. The portion may visually represent of some or all of the subspace. The portion is, itself, an output space. The output space that includes the portion may be another subspace that may be visible in a portion of yet another output space.

In an embodiment, a user interface element in a subspace may be in a user interface of an operating instance or may represent the operating instance without being in the user interface of the operating instance. In either case, the user interface element may allow an interaction between a user and the operating instance. Additionally, a subspace may be a resource accessed by or for an operating instance that has a UI element in the subspace. Further, circuitry may be included in a system for subspace that may enable, modify, or prevent access to a resource that is accessed by or for an operating instance having a user interface element in the subspace. A creation, deletion, or modification of a resource, accessed by or for an operating instance having a user interface element in a subspace, may activate circuitry of the subspace or of the operating instance that operates in changing the user interface element. Alternatively or additionally, a creation, deletion, or modification of a resource, accessed by or for an operating instance having a user interface element in a subspace, may activate circuitry of the subspace or of the operating instance that changes the subspace or that changes another operating instance having a user interface element in the subspace. Circuitry of a subspace may create, monitor, modify, delete, or otherwise control an access to the subspace or an attribute of the subspace by or for an operating instance having a user interface element in the subspace.

A subspace may have a size when presented in an output space. The size be smaller than an output space allowing the entire subspace to be included in a portion of the output space. A size of a subspace may be larger in one or more dimensions than an output space allowing only a portion of the subspace to be included in the output space. User interface elements, of operating instances, that are in a subspace may be associated with the subspace via circuitry or via data stored in a memory that directly or indirectly identifies one or more of the user interface elements and that directly or indirectly identifies the subspace.

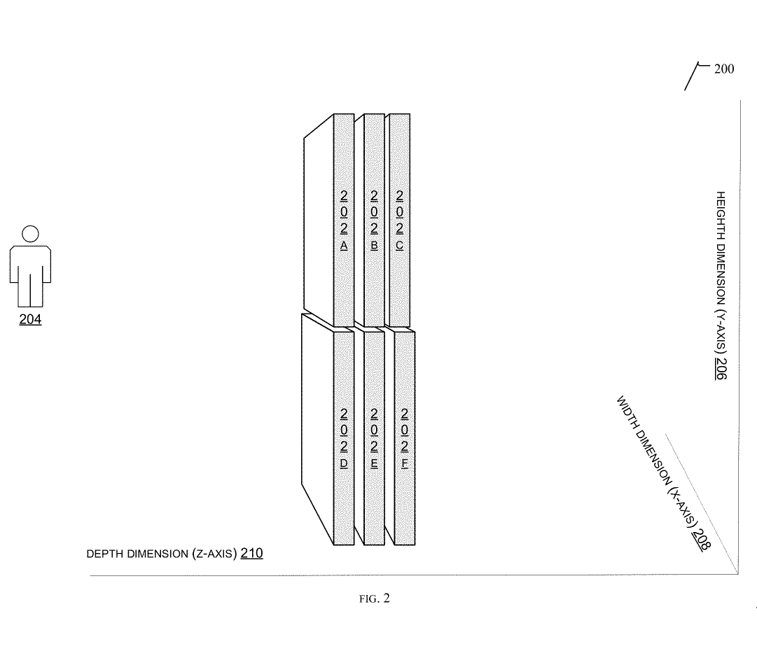

FIG. 2, illustrates an output space 200. The output space 200 may be included in an output device such as a screen included in a display device. In another embodiment, output space 200 may be external to an output device. An output space, such as output space 200 may include physical space in which output of a device may be presented. One or more output devices may present a user interface element in a space not included in the one or more output devices. Such an output space is referred to herein as an external output space or e-space. A hologram or other projection of one or more user interface elements are examples user interface elements that may be presented in an e-space. A projected user interface element may be projected onto a surface or into a region of an e-space. In an embodiment, an e-space may include no visible physical objects along with one or more user interface elements presented in the e-space via one or more output devices. In an embodiment, an e-space may include one or more user interface elements presented via one or more output devices and may also include one or more visible physical objects. Such an output space is referred to herein as an “augmented reality” output space (ar-space). A user interface element presented in an output space may be a representation of a physical object that exists in the real world or not. Alternatively or additionally, an output space may include a simulation of a physical object that may or may not exist in the real world.

FIG. 2 illustrates six subspaces 202a-f in output space 200. FIG. 2 depicts a user 204. A location of the user 204 relative to the output space 200 identifies a user perspective of the subspaces 202. The output space 200, as illustrated, has three dimensions; a height dimension 206, a width dimension 208, and a depth dimension 210. An output space may be referenced via any suitable coordinate system. For example, output space 200 may be referenced as a Euclidean space having a y-axis corresponding to the height dimension, an x-axis corresponding to the width dimension, and a z-axis corresponding to the depth dimension 210. FIG. 2 illustrates that a subspace 202 may have a height, a width, and a depth in output space 200. FIG. 2, illustrates that, in an embodiment, subspace 202 may have same size. A change in size to subspace 202a may activate circuitry that changes the respective sizes of the other subspaces 202b-f. FIG. 2 illustrates that the subspaces 202 may occupy different respective portions of the subspace 200. That is, subspaces may not intersect according to an embodiment. Alternatively or additionally, subspaces in an output space may not be allowed to overlap in one or more specified dimensions or in one or more specified locations, in some embodiments. FIG. 2 illustrates that subspaces 202 may be arranged in a grid of distinct regions of the output space 200. Subspaces 202 are shown stacked in the depth dimension and in the height dimension. Subspaces may also be stacked in the width dimension or not stacked according to an embodiment. Thus, subspaces may have a regular order in one or more dimensions in at least part of an output space. Alternatively or additionally, subspace may have an irregular order in one or more dimensions in at least part of an output space, in an embodiment.

While FIG. 2 illustrates a single user perspective, an output space may have more than one user perspective. For example, the perspective of user 204 in FIG. 2 may provide user 204 a front view of the subspaces 202. The view of subspaces 202 visible to a viewer of FIG. 2 illustrates another user perspective that provides a side view of the subspaces 202. Two users with different perspectives may share a coordinate space via a shared device or via respective devices that interoperate. In an embodiment, each user may interact with a same output space via a device or devices utilizing different coordinate spaces. For example, the depth dimension 210 with respect to user 204 may be a width dimension to another user. Alternatively or additionally, a user may view an output space or a subspace in the output space from more than one perspective and may interact with an output space or a subspace in the output space via more than one coordinate space of one or more coordinate systems.

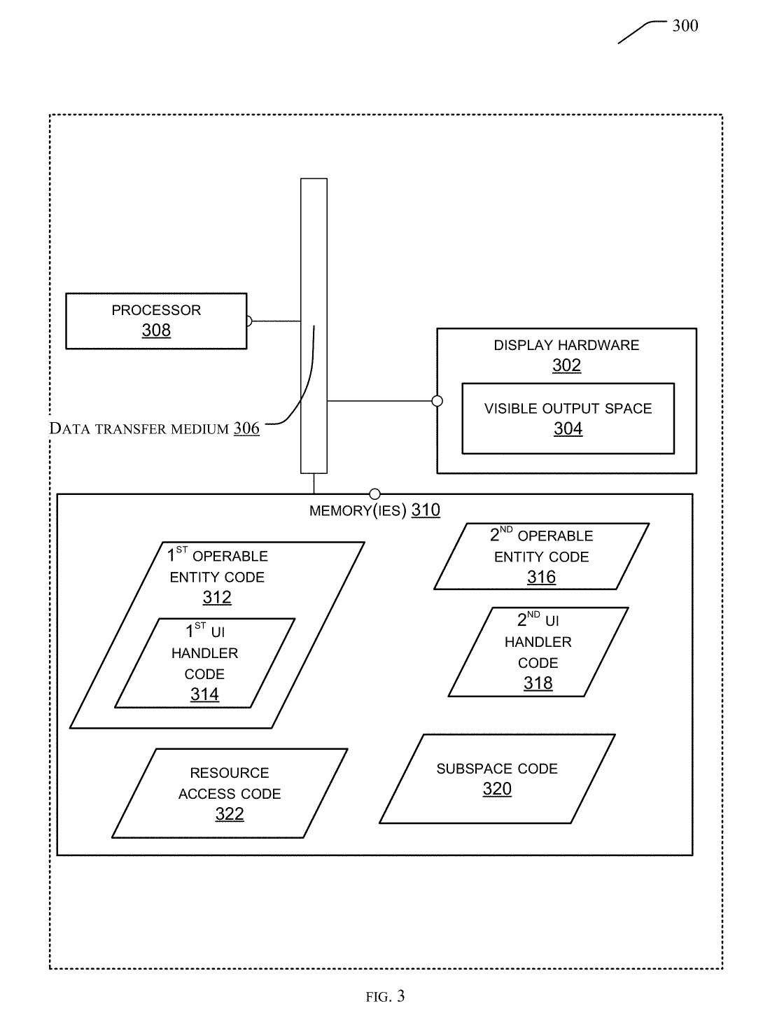

FIG. 3 shows a system 300 configured to perform one or more methods of the subject matter of the present disclosure, such as a method of flow chart 100. FIG. 3 shows that the system 300 includes display hardware 302 included in an output device (not shown). System 300 includes an output space 304 of the display device that may be viewed by a user. Also illustrated is a data transfer medium 306 allowing components of the system 300 to exchange information. A processor 308 may be included in system 300 for accessing code to execute to operate virtual circuitry specified via code translated from source code written in a programming language. A system may include one or more a memory device 310. A memory device may include data accessible to processor 308 via one or more processor memories (not shown) each defined by an address space of the processor 308. Code for a first operable entity 312 is illustrated. Code 312 may include instructions of data for an application, a link library, device driver, a portion of an operating system, a client or server portion of an application or service, a network protocol, and so forth. Also shown is code for a first user interface handler 314 that may be accessed by processor 308 to operate virtual circuitry that may be included presenting a first user interface element of an operating instance of the first operable entity code 312 or that may be included in interacting with a user via the first user interface element. Code for a second operable entity 316 is also illustrated in memory 310. Also shown, stored in memory 310, is code 318 of a second user interface handler accessible to processor 308 via data transfer medium 306 to operating virtual circuitry that may be included in presenting a second user interface element of an operating instance of the second operable entity code 316 or that may be included in interacting with a user via the second user interface element. Memory 310 may also include code 320 accessible to processor 308 for operating virtual circuitry for creating and managing one or more subspaces via structured data stored in memory 310 that associates user interface elements with one or more subspaces. Still further, the system 300 may include code accessible to processor 308 for operating virtual circuitry for monitoring or accessing 322 one or more resources accessed by or for an operating instance. Processor 308 may operate virtual circuitry by accessing code, via data transfer medium 306, stored in memory 310.

A user interface handler (UI handler) may include circuitry (virtual or physical) that operates in sending information to present an output (e.g. a user interface element) via an output device (e.g. a display). A user interface handler, additionally or alternatively, may include circuitry to process input information that corresponds to a user interface element.

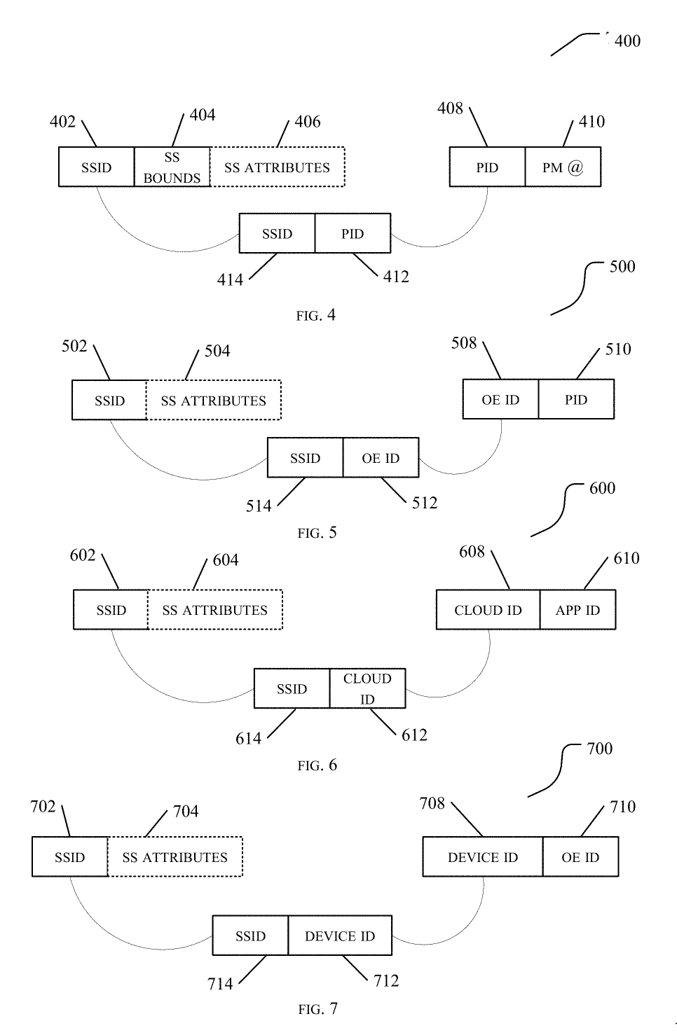

FIGS. 4, 5, 6, and 7 illustrate data structures that may be represented in a memory of a system or operating environment in various embodiments. An arrangement of data structures 400, shown in FIG. 4, includes a subspace identifier (SSID) 402 storage location for a subspace that may be associated with one or more operating instances that each include a respective computing process. The data structures 400 include an SSID bounds 404 storage location that may identify a current extent in an output space of a subspace identified by the SSID 402. The data structures 400, may also include a additional fields, records, or locations in a memory for storing data of or about one or more other attributes of the subspace identified by the SSID 408. An SS attributes 406 storage location illustrates an embodiment of such additional fields, records, or locations. FIG. 4 illustrates a data structure that may identify an operating instance by identifying a process of the operating instance. A process identifier (PID) 408 stored location may include data that identifies a process as an operating instance. The data structure may include along with the PID 408 location a field, record, or memory location for data of or about one or more resources 410 of the process identified by the PID 408 location. A process may be or may include an operating instance associated with a subspace by another record or memory location that, as shown, includes the PID location 412 and an SSID location 414. A value in the PID location 412 may match or reference a value in a structure have a PID location 408. An SSID location 414 may include a value to match or reference a subspace identified by a SSID location 402 to bind, relate, otherwise associated a subspace with a process. A user interface element of a process identified in a PID field 412 may be presented in the subspace identified by the SSID field 414 when the subspace is in a visible portion of an output space.

An arrangement of data structures 500, shown in FIG. 5, includes a subspace identifier (SSID) 502 location for a subspace that may be associated with one or more operating environments that may be or that may include an operating instance. An SS attributes location 504 may store resource data of the subspace or of operating instances with user interface elements in the subspace. For example, resource data may identify a location in an output space of the subspace identified in the SSID location 502. An extent of the subspace in an output space may be stored in location 504, may be stored in a related memory location, or may be determined by circuitry that presents, manipulates, or otherwise accesses the output space in presenting a visual representation of the subspace or that presents a user interface element, of an operating instance, in the subspace. FIG. 5 illustrates a separate data structure that includes an operating environment identifier (OEID) 508 location along with a PID 510 location of a process of the operating environment that together ma identify an operating instance. An application, thread, task, or device of an operating environment may be identified in the structure or in other structures in various embodiments, rather than or in addition to the structure illustrated that includes a PID 510 location. An operating environment or a portion of an operating environment, such as a process, may be associated with a subspace by still another record, as shown in FIG. 5, that includes the OEID of the operating environment in a location 512 (and may also identify the process in the same location or an additional location). The structure may also include a SSID location 514 for storing a value to match or reference a value in a SSID location 502 to create an association between a subspace and an operating instance of an operating environment. A user interface element may be included in the subspace where the user interface element is in a user interface of the operating environment or of an operating instance, of an operable entity, hosted by or included in the operating environment.

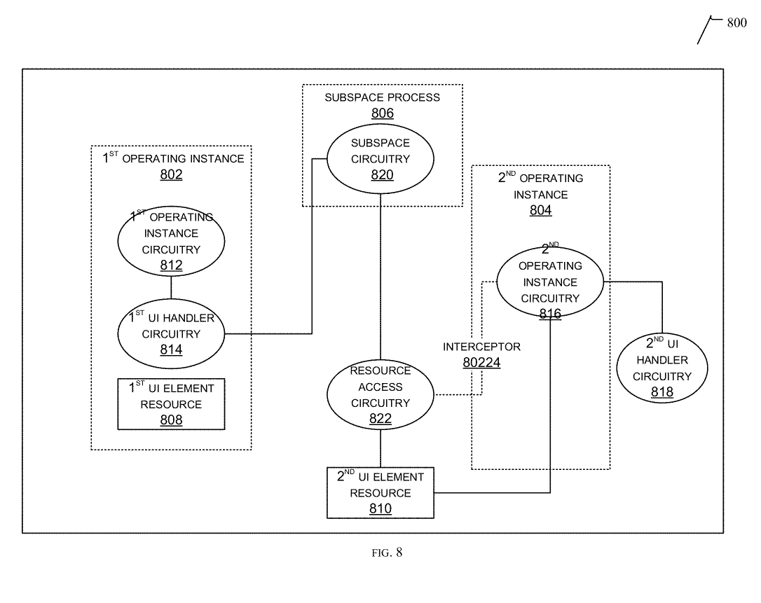

An arrangement of data structures 600, shown in FIG. 6, includes a subspace identifier (SSID) location 602 for data that identifies a subspace that may be associated with an operating instance of a cloud operating environment or an operating instance, of an operable entity, hosted by or included in the cloud operating environment. Exemplary operating instances of a cloud operating environment include task circuitry operating to perform a specified task, a computing process, a thread, a device (real or virtual) that hosts or is simulated by the cloud operating environment, or an application operating at least partially in the cloud operating environment. A location(s) for storing one or more other attributes 604 of the subspace or of operating instances with user interface elements in the subspace. FIG. 6 illustrates a separate data structure that includes a cloud operating environment identifier (CLOUD ID) location 608 for storing data that identifies a cloud computing environment (CCE) along with a location 610 for storing an ID of an application (APP ID) 610 operating at least partially in the cloud operating environment A cloud operating environment is a type of operating environment, so the description with respect to operating environments in the previous paragraph applies. An application of a cloud operating environment may be associated with a subspace by still another record, as shown in FIG. 6, that includes a CLOUD ID location 612 for storing a value to match or reference a CLOUD ID location 608 (and may also include an identifier of the application in the same location or an additional location). The structure may also include a SSID location 614 for storing a value to match or reference a SSID location 602 of a subspace to bind or associate an operating instance of a cloud operating environment, an operating instance included in a cloud operating environment, or an operating instance hosted by cloud operating environments to a subspace. A user interface element of such an operating instance may be included in the subspace when presented.

An arrangement of data structures 700, shown in FIG. 7, includes a location 702 for storing a subspace identifier (SSID) for a subspace that may be associated with one or more operating instances. A structure that includes a SSID location 702 may also include an SS attributes location 704 for storing data about one or more attributes of the subspace or operating instances with user interface elements in the subspace or one or more resources accessed by or for one or more of the operating instances that may be a device or may be operating instances of a device. FIG. 7 illustrates a separate data structure than includes a device identifier (DEVICE ID) location 708 for storing data that identifies a device along with an operating environment identifier (OE ID) location 710 for storing data that that identifies an operating environment of the identified device. A device may be associated with a subspace by still another record, as shown in FIG. 7, that includes a DEVICE ID location 712 for storing data to match or reference a DEVICE ID location 708 of a device (and may also identify an identifier of an operating instance hosted at least partially by the device in the same location or in an additional location). The structure may also have a SSID location 714 for storing data to match or reference SSID location 702 of a subspace to associate the device or operating environment of the device with a subspace. A user interface element of in a user interface of the device or in a user interface of an operating instance (e.g. an operating environment) or the device or at least partially hosted by the device may be included in the associated subspace when presented.

The arrangements of structures described above and elsewhere in the present disclosure are not exhaustive. The structures may be stored in a processor memory via a machine code translation of source code written in a programming language. Data locations or fields in a structure may be stored in contiguous locations in a memory or may be linked via pointers or other types of references including one or executable machine code instructions. The data of the exemplary structures, their analogs, or their equivalents may be stored in a database, such as a SQL database, may be stored as binary data, may be stored as text such as in an XML document, or may be stored as addressable entities (e.g. variables or constants) in a translation of source code that specifies or defines data locations or metadata about the location or data in the locations—to name a few examples.

FIG. 8 shows a system 800 that may operate in performing one or more methods of the subject matter of the present disclosure, such as a method of flow chart 100. FIG. 8 shows that system 800 includes a first operating instance 802 of an operable entity associated with a subspace. The first operating instance 802 may operate via virtual circuitry, partially illustrated by first operating instance circuitry 812. First operating instance virtual circuitry may be realized by a processor, such as processor 308, executing code, such first operable entity code 312, as described with respect to FIG. 3. Similarly, system 800 includes a second operating instance 804 of the same subspace. The second operating instance 804 may be realized via an operation of circuitry illustrated in part by second operating instance circuitry 816. Second operating instance circuitry 816 may be realized, at least in part, by processor 308 executing code such as second operating entity code 316 illustrated in FIG. 3. In an embodiment, two or more operating instances of a same operable entity may each have user interface elements in a same subspace or in different subspaces. A subspace process 806 is illustrated that may operate as virtual circuitry 820 realized by processor executing subspace code 320. FIG. 8 also illustrates a resource 808 of the first operating instance 802 accessed in presenting or during interaction with a first user interface element of the first operating instance 802. For example, resource 808 may be data that identifies a font, a structure stored in a processor memory identifying a location of the first user interface element in an output space or in a subspace, content to include in the first user interface element, and so forth. Similarly, a resource 810 is illustrates as not included in the second operating instance 804. The resource 810 may be accessed via the system 800 in presenting or during an interaction with a second user interface element of the second operating instance 804. For example, resource 810 may include hardware or virtual circuitry such as a codec accessed in processing a media stream included in the second user interface element. First operating instance circuitry 812 may include first user interface handler circuitry 814 that operates to present the first user interface element or to interact with a user via the first user interface element. First user interface element circuitry 814 may be realized as virtual circuitry, at least in part, based on execution of corresponding code by a processor, as illustrated by first user interface handler code 314 and processor 308 in FIG. 3. First user interface handler circuitry 814 may be included in first operating instance circuitry 812 as FIG. 8 illustrates. Second operating instance circuitry 816 may interoperate with second user interface handler circuitry 818 that operates to present the second user interface element or to interact with a user via the second user interface element. Second user interface element circuitry 818 may be realized as virtual circuitry, at least in part, based on execution of code, such as second user interface handler code 318, by a processor, such as processor 308. Second user interface handler circuitry 818 may be external to second operating instance circuitry 816 as FIG. 8 illustrates. Second user interface handle circuitry 818 may be included in the second operating instance 816 by a processor, such as processor 308, accessing corresponding code, such as second user interface handler code 318 from a code library stored in a processor memory. Second user interface element circuitry 818 may operate at least partly in another process or as electrical circuitry in separate hardware such as a graphics adapter which may include a graphic processing unit (GPU).

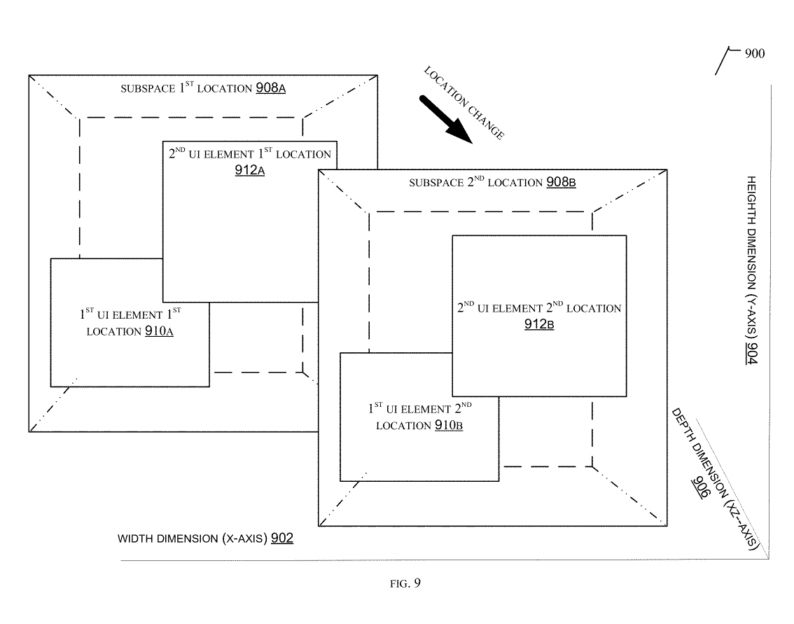

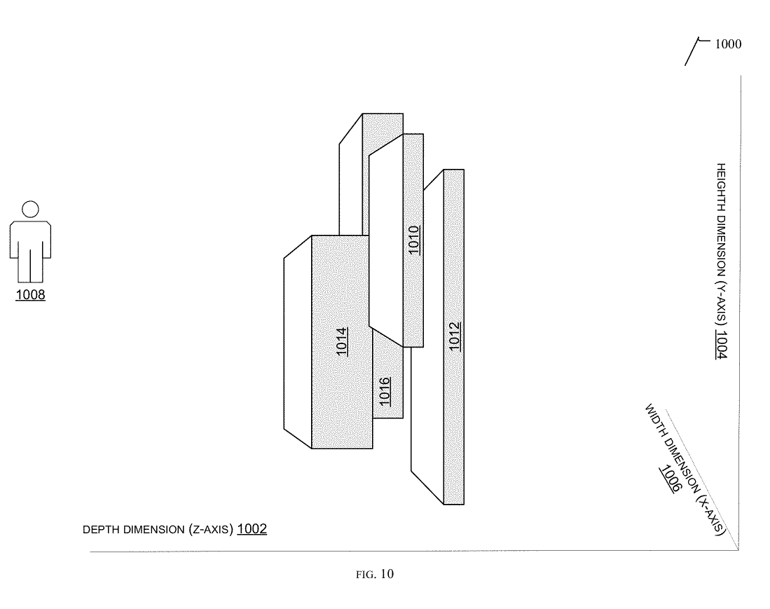

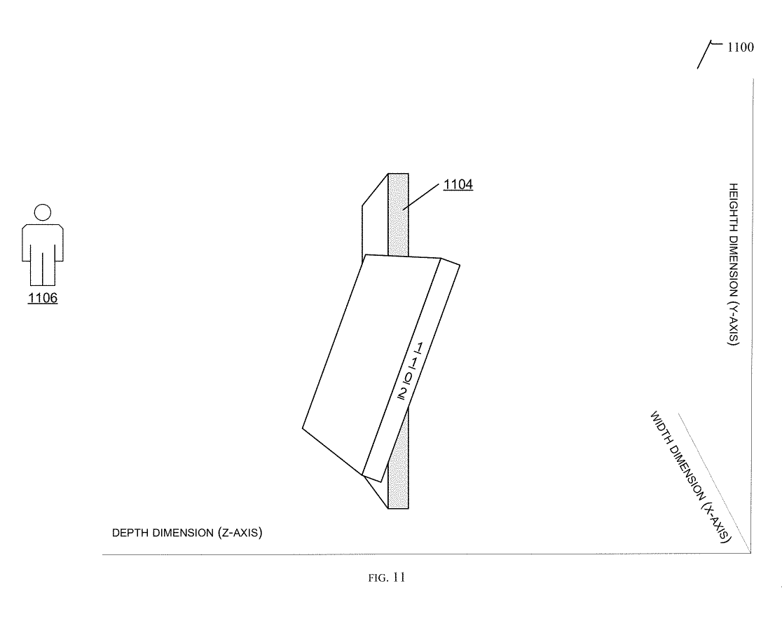

FIG. 9, illustrates an output space 900 having a width dimension 902, a height dimension 904, and a depth dimension 906 detectable to a user. A subspace may be included in output space 900. A subspace is illustrated by a bounding box at a subspace first location 908a in output space 900. The bounding box, in an embodiment, may not be displayed at all or under specified conditions. The bounding box, in an embodiment, may be displayed, at least partially, at all times, or at times when a specified condition is met. At the subspace first location 908a, a first user interface element may be presented at a first-first location 910a in the subspace. The first user interface element may be in a user interface of a first operating instance. Also at the subspace first location 908a, a second user interface element of a second operating instance may be presented, as shown, at a first-second location 912a. FIG. 9 also shows the same subspace, after a location change, by a bounding box at a subspace second location 908b in the output space 900. At the subspace second location 908b, the subspace includes the first user interface element at a second-first location 910b as a result of the subspace location change. While at the subspace second location 908b, the second user interface element may be presented at a second-second location 912b.

FIG. 10 illustrates an output space 1000 according to an embodiment of the subject matter. FIG. 10 illustrates the output space has a width dimension 1002, a height dimension 1004, and a depth dimension 1006 detectable to a user 1008. FIG. 10 illustrates that an embodiment may present or otherwise locate subspaces irregularly in an output space. In output space 1000, from a perspective of a user 1008, subspaces may at least partially overlap in one or more dimensions. In FIG. 10, subspace 1010 partially overlays subspace 1012 from the user's 1008 perspective. Subspace 1012 lies at least partially behind subspace 1010. Subspace 1014 and subspace 1016 also illustrate partial overlapping in one or more of a height, depth, or width dimension.

While subspaces in FIG. 9 and FIG. 10 have rectangular or box shapes, a subspace may have any shape. A subspace shape, size, or location may be prespecified or may be determined based the user interface elements that are in the subspace. A count of user interface elements, user interface element sizes, user interface element shapes, user interface element locations, or other user interface element attributes or metadata may be included in determining an attribute of a subspace. Exemplary subspace attributes include a subspace size, a shape, a location, a rotation, allowable direction(s) of movement, or allowable distance(s) of movement. A subspace shape may be curved or may include a curved portion. A subspace may have an irregular shape. A subspace shape may include portions of different shapes. Part of a subspace may be located in front of another subspace in a dimension. At the same time, another part of the subspace may be located behind the other subspace in the dimension or may be located in a same location in the dimension. Such relationships may occur in more than one dimension at a same time. FIG. 11 represents an output space 1100 that includes a first subspace 1102 and a second subspace 1104 in which part of subspace 1104 is in front of subspace 1102 with respect to a user 1106. As shown, part of subspace 1104 is behind part of subspace 1102 with respect to the user 1106. Further, a portion of subspace 1102 intersects with a portion of subspace 1104.

Regular geometric shapes other than rectangular shapes may be supported by an embodiment. Exemplary shapes include subspaces that are at least partially circular or cylindrical, triangular, trapezoidal, and so forth. Subspaces may be visible or only partially visible. For example, a subspace may have a menu bar or tool bar that is visible when a specified criterion is met but may be invisible otherwise.

In an embodiment, locations in an output space may be identified via a coordinate space of a coordinate system. The output space and a subspace presented in a portion of the output space may share the same coordinate space or may each have different coordinate spaces of the same or different coordinate system. For example, an output space and a subspace may be addressed by a same coordinate system. An output space and subspace may both, for example, use a coordinate space of a Euclidean coordinate system where the output space has an origin coordinate defined and the subspace has its own origin coordinate allowing the output space and the subspace to use separate coordinate spaces. In an embodiment, an output space and a subspace may share a coordinate space. A choice of coordinate systems or coordinates spaces may allow a developer to make choices that ease a programming task. Further, allowing different coordinate systems or coordinate spaces may ease integration and testing of various applications, processes, tasks, and so forth. To give an example, an operable entity may include code for executing in an operating instance that presents a user interface element in an output space. The code may not include instructions for rotating the user interface element in one or more dimensions, positioning the user interface element with respect to a user interface element of another operating instance, or resizing a user interface element based on an attribute of the output space of the user interface element. Missing features may be added for an operating instance by including a user interface element of the operating instance in a subspace that supports one or more of the unsupported functions. A user interface element in a subspace that includes circuitry for rotating the subspace may automatically rotate the user interface element with the subspace, for example. In addition to providing additional functionality a subspace may constrain a user interface element by constraining one or more resources accessed in presenting or otherwise operating on the user interface element. For example, rather than presenting text using a default font of an operating system desktop output space, a subspace may over-ride the default by providing access to a different font rather allowing access to the system default font.

A coordinate space in a subspace may be oriented in a same direction as a coordinate space of output space that includes some or all of the subspace. Alternatively or additionally, the subspace may be rotated in the output space without affecting a coordinate space of the subspace. For example, a depth dimension in the output space may be a width dimension in the subspace. Such a relationship may be fixed or may be the result of a rotation of the subspace or of the output space that includes the subspace. The output space may be a subspace of yet another output space.

In an embodiment, moving a subspace or a user interface element in an output space may including rotating the subspace or user interface element in one or more dimensions of the output space. Moving a user interface element that is in a subspace may include rotating the user interface element in one or more dimensions of the subspace or rotating the user interface element in one or more dimensions of an output space that includes the subspace. A rotation of a subspace or a rotation of a user interface element in a subspace or in an output space that includes the subspace may be detectable to a user or may not be detectable to a user. A user interface element may be rotated in a subspace without an associated rotation of the subspace. A subspace may be rotated in an output space while a user interface element in the subspace is not rotated. An output space that includes a subspace may be rotated. A subspace in the output space may be rotated in response to a rotating of the output space or the subspace may not be rotated. A user interface element in the subspace may be rotated in response to a rotating of the output space or of the subspace, or the user interface element may not be rotated in response to the rotating of the output space or the rotating of the subspace. A rotation of a subspace in response to a rotation of an output space may differ from the rotation of the output space in a measure of rotation in one or more dimensions of the output space. A rotation of a user interface element in response to a rotation of a subspace that includes the user interface element may differ for the rotation of the subspace in a measure of rotation. A rotation of a user interface element in a subspace in response to a rotation of an output space that includes the subspace may differ from the rotation of the output space in a measure of rotation. A size of a subspace or a size or a user interface element in the subspace may be changed in response to a rotation of an output space that includes the subspace. A size of a user interface element in a subspace may be changed in response to a rotation of the subspace in an output space that includes the subspace.

An indication to move a subspace may be detected via an input directed to or otherwise included in identifying a location where the subspace is to be located via the move. A touch at or near a destination location may be detected. Detecting the indication may include detecting the indication while the subspace has input focus for the input device included in receiving the indication. In an embodiment, an indication to move a subspace may be received in response to a change in an output space that includes some or all of the subspace. For example, a new user interface element or new may be presented, a user interface element or another subspace may be removed, or some other change to a user interface element or another subspace may be or may result in an indication to move a subspace.

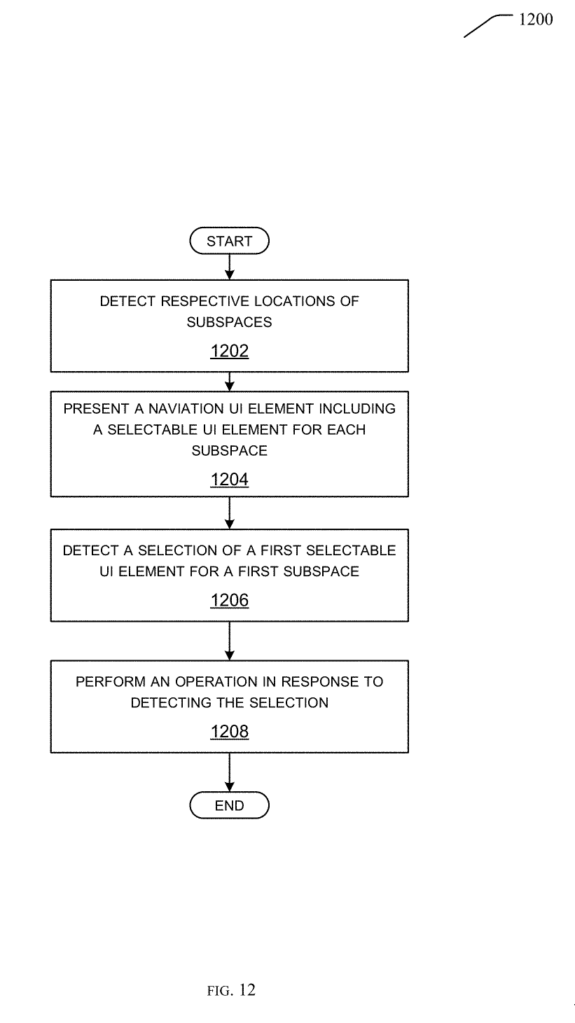

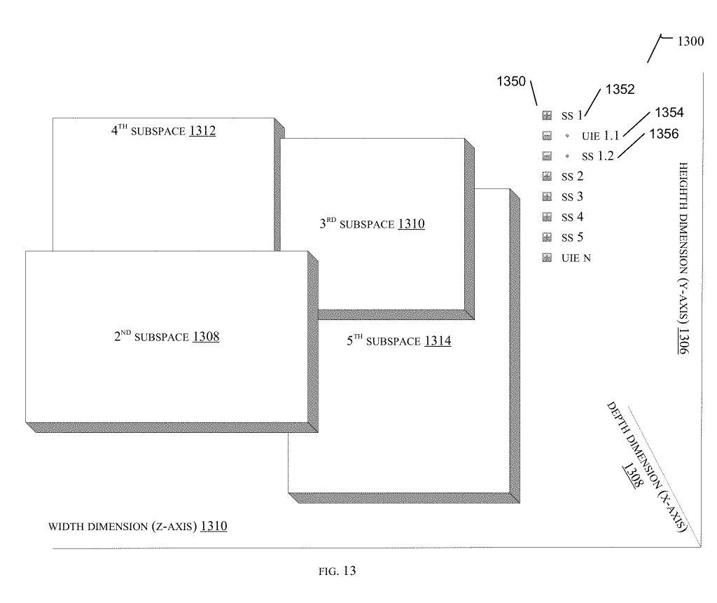

In an embodiment, a navigation user interface may be provided to allow a user to select a subspace in a plurality of subspaces for some other purpose, such as to move one or more selected subspaces. FIG. 12 includes a flow chart 1200 for an embodiment that moves a subspace via a navigation user interface. Circuitry may be included in or operable with a system for performing flow chart 1200, At block 1202, the circuitry may be included in or provided that operates with a device or a system in detecting locations of respective subspaces in a plurality of subspaces in an output space. The detecting may include detecting a first-first location of a first subspace in the output space and in detecting a first-second location in the output space of a second subspace. At block 1204, the circuitry may be included in presenting a navigation user interface element. In an embodiment, circuitry may send presentation information that represents a navigation user interface element to a windows subsystem, a graphics subsystem, a display adapter, or a display to display the navigation user interface element via an output space of an display. The first subspace may be in the first-first location in the output space when the selection of the first subspace is detected. In a scenario, the first subspace may be behind the second subspace in whole or in part in the depth dimension of the output space. The circuitry may also be included in presenting a first selectable user interface element in the navigation user interface element that corresponds to the first subspace and in presenting a second selectable user interface element corresponding to the second subspace. At block 1206, the circuitry may be included in receiving input information, in response to a user input detected via an input device. The input information may identify the first selectable user interface element as selected. At block 1208, the circuitry may be included in moving or performing some other operation to the first subspace, such as moving the first subspace to a second-first location from the first-first location in response to receiving the input information. Alternatively or additionally, an operation may be performed that utilizes some or all of a selected subspace as an input. In an embodiment, a subspace may be visually represented during a moving of the subspace. In an embodiment, the first subspace may be presented in the first-second location rather than the first-first location with no visible representation of the first subspace in a location between the first-first location and the first-second location during the moving.

Figures such as FIG. 2, FIG. 10, and FIG. 11 illustrate that multiple subspaces may be in an output space where each subspace has a location in the output space. Further in an embodiment, each subspace may have may have a height dimension, a width dimension, or a depth dimension. A first subspace may have a first location in depth dimension of the output space and a second subspace may have a second location in the depth dimension. The second subspace may be in front, with respect to user, of the first subspace. The user may not be able to see or interact with some or all of the first subspace or with some or all of the user interface elements in the first subspace. For example, the first subspace may include a first-first user interface element presented by a first-first application process and a first-second user interface element presented by a first-second application process. A navigation user interface element may be presented that includes a first selectable user interface element corresponding to the first subspace and a second selectable user interface element corresponding to the second subspace. In response to a user input detected by an input device, input information may be received that identifies the first selectable user interface element as user selected. The first subspace or the second subspace may be moved in one or more dimensions of the output space so that one or more user interface elements in the first subspace are fully visible or at least more visible than prior to the move. For example, the first subspace may be moved from the first location to a new first location in the depth dimension in front of the second subspace from the user's perspective. The first-first user interface element and the first-second user interface element may be moved such that they are, in the first subspace, at the new first location. Alternatively or additionally, the second subspace may be moved from the second location to a new second location in the depth dimension. If a second-first user interface element is in the second subspace at the second location, the second-first user interface element is moved such that the second-first user interface element is in the second subspace at the new second location.

A subspace or a user interface element in a subspace may be identifiable in a navigation user interface element to a user based on an identifier, a task, a role, an operating instance, a resource, a device, an operating environment, a network service, a user, a group, or other attribute of the subspace, a user interface element in the subspace, or an operating instance represented by the user interface element. Each user interface element may be selectable by a selector. An identifier of a subspace, a user interface element in a subspace, or an operating instance represented by a user interface element in a subspace may be included in an identifier space. For example, the identifier may be alphabetic or numeric. An ordering of identifiers may correspond to an ordering of subspaces or user interface elements in one or more dimensions of one or more coordinate spaces. In an embodiment, a selectable user interface element in a navigation user interface element may represent a location in a z-ordering. When the selectable user interface element is selected, user interface elements of operating instances presented in a subspace at the location in the z-ordering identified by the selected user interface element may be identified for moving or for some other operation, such as a close operation identified via an interaction with the user. In an embodiment, when a location in a z-ordering is selected via a selectable user interface element, a sub-navigation user interface element (e.g. a submenu) may be presented if more than one subspace or user interface element is at the selected location. The sub-navigation user interface element may include a selectable user interface element for a subspace or a user interface element at the selected location.

In an embodiment, a first subspace may intersect a second subspace. In an embodiment, a portion of the first subspace may overlay a portion of the second subspace from a user's perspective and a portion of the second subspace may overlay a portion of the first subspace from a user's perspective. See FIG. 11 and the corresponding description above. In a navigation user interface element, a selectable user interface element may be presented for the first subspace or for one or more portions of the first subspace such as the portion overlaying part of the second subspace, the portion intersecting part of the second subspace, or the portion overlaid by part of the second subspace. One or more selectable user interface elements may be presented in the navigation control analogously for the second subspace or for one or more portions of the second subspace. One or more inputs detected in interacting with a user may select the first subspace or may select one or more respective portions of the first subspace for performing an operation. In an embodiment, an operation may including rotating one or both of first subspace and the second subspace, based on the inputs, to remove the intersection. In an embodiment, an operations may including moving with or without rotating one or both of first subspace and the second subspace, based on the inputs, to remove the intersection. In an embodiment, an operation may including moving one or more portions of the first subspace or the second subspace, based on the inputs, to change a shape of the first subspace or the second subspace. An intersection may be unchanged as result of a performing an operation or the intersection may be changed for another performing of the same operation or for a performing of another operation.

User interface elements in a subspace or in a different subspace may be slanted or laid across another user interface element, which may create one or more intersections of user interface elements. Selectable user interface elements may be presented for the user interface elements or portions thereof in a manner analogous to that described in the preceding paragraph for performing analogous operations on subspaces.

In an embodiment, circuitry may operate in moving a subspace from a first location in an output space to a second location. An attribute of the moved subspace or an attribute of the other subspace in the output space may be changed in response to the moving. Similarly, an attribute of a user interface element in the subspace or a user interface element in the other subspace may be changed in response to the move. Exemplary attributes a visibility setting, a font setting, an input focus setting, an output focus setting, a color setting, or an operating state setting—to name some examples. Each of the setting may be stored in or accessed from a corresponding location in a memory. An attribute is a type of resource.

An attribute of a subspace, a user interface element in the subspace, or of an operating instance with a user interface element in the subspace may be changed by an operation performed in response to selecting a subspace, a user interface element in a subspace, or an operating instance. An operation may change an input focus setting, an output focus setting, a visibility attribute, a size attribute, a transparency attribute, or other attribute of a subspace, a user interface element, or an operating instance.

In an embodiment, zero, one, or more operating instances may each have a user interface element in one or more subspaces. One or more of operating instances may each be represented via a selectable user interface element in a navigation user interface element. Alternatively or additionally, one or more user interface elements in a subspace or otherwise in an output space that includes some or all of the subspace may be represented by a selectable user interface element accessed via a navigation user interface element. In an embodiment, a subspace navigation user interface element may enable or ease navigation between or among UIs elements of operating instances of a subspace or between or among subspaces. This may be useful for an output space with many user interfaces elements or subspace. Virtually reality output spaces and e-spaces, for example, may include many user interface elements or many subspaces of associated user interface elements. An augmented reality space may include many physical objects from the real world. Some or all may be associated with one or more user interface elements in or not in a subspace presented via an output device. Due to their association, one or more attributes of a user interface element may change in response to a change in an attribute of one of a physical object, a change in another user interface elements in the output space, or a change in a subspace of the output space. A subspace may be used to locate user interface elements with respect to a location of a physical object. For example, virtual books may move or change as a bookcase, a desk, or table changes. Virtual décor may change as lighting in a room changes. The room may include an e-space where user interface elements included in the virtual décor are presented. Associated user interface elements may be monitored and modified via being in a subspace. Items of virtual décor may be presented via a user interface element in a respective subspace. Décor items that are related such as a vase and a picture that are to be place together may be associated via a subspace.

FIG. 13 illustrates a three-dimensional output space 1300 which may be a subspace of another output space, such as a display of a device or an e-space. The output space 1300 illustrate has a width dimension 1302, a height dimension 1304, and a depth dimension 1306 according a coordinate space for the output space. The output space 1300 may include a number of subspaces some of which may be visible to a user from a given perspective, such as the perspective shown to a user viewing FIG. 13. The output space 1300 may include one or more user interface elements, of operating instances, that are presented in subspaces. The subspaces may be visible (see second subspace 1308), partially visible (see third subspace 1310, fourth subspace 1312, and fifth subspace 1314), or not visible (a first subspace not shown) from the given perspective. To aid a user in navigation, a number of methods of interacting with a user may be realized. An embodiment, may include hardware and may also include circuitry to rotate an output space to provide a different perspective to a user. A subspace or other user interface element that was hidden or partially hidden may be more visible. A subspace or user interface element which may be behind another subspace or other user interface element from one perspective may be alongside or in front of the other subspace or other user interface element in another perspective. Similarly, a subspace or user interface element may be hidden or made less visible from a given perspective as a result of a rotation. Alternatively or additionally, a navigation user interface element may be provided including selectable representations that identify or otherwise correspond to subspaces or other user interface elements that are in the subspaces or that are otherwise in the output space 1300. FIG. 13 illustrates a hierarchical or tree structured navigation user interface element 1350. Subspaces and user interface elements at the top level are in the output space 1300. That is, output space 1300 may be the parent output space of top-level entities. A user interface element or subspace that is not a top-level entity may be identified by a user interface element that is nested below a user interface element that represents the parent entity of the user interface element or subspace. For example, a first subspace, which is not visible in the perspective shown in FIG. 13, may include a user interface element and may include another subspace. The first subspace may be selected via an interaction between a user and a selectable user interface element 1352 via an input device. In response to the interaction, one or more changes may be performed in output space 1300 to make the first subspace visible or more visible. The first subspace may be moved horizontally, vertically, or in the depth dimension. A subspace or other user interface element that overlays some or all of the first subspace may be moved, resized, or a transparency attribute of an overlaying subspace or user interface element may be changed. As mentioned, the output space 1300 may, alternatively or additionally, be rotated in one or more dimensions. Similarly, a user interface element in the first subspace or a subspace in first subspace may be selected via, respectively, selectable user interface element 1354 or selectable user interface element 1356. The output space 1300 or a user interface element or subspace in output space 1300 may be changed so that the selected subspace or selected user interface element in the first subspace is at least partially visible. Alternatively, one or more user interface elements in the first subspace may be changed to decrease visibility or accessibility of the selected subspace or user interface elements included in the subspace.

Navigation in an output space or subspace may be based on identifiers that correspond to respective subspaces or other user interface elements. Navigation, alternatively or additionally, may be via or otherwise based on a device of a user interface element or device of a subspace in an output space or in another subspace. Alternatively or additionally, navigation maybe via or otherwise based on a task, a role of a user of one or more user interface elements in an output space or subspace, a remote service such as a web site or a cloud computing environment, a resource accessed by or for circuitry that presents a user interface element of an operating instance. Navigation may be via or based on textual, audio, numeric, or image based identifiers. A navigation control or a specified interaction, such as a swipe or other gesture, may be included in identifying a location in one or more dimensions of an output space or a subspace. A location may identify a subspace or a user interface element at the location or within a specified distance of the location.

In an embodiment, a control user interface element similar or functionally analogous to navigation user interface element 1350 in FIG. 13 may include user interface elements that represent z-levels in a z-ordering of user interface elements or subspaces in a subspace or output space. In response to an interaction with a user interface element that represents a z-level, user interface elements of a subspace, subspaces, or other user interface elements at least partially located at the identified z-level may be modified for a purpose specified by the embodiment, such as making them visible or more visible to a user, changing a focus assignment, changing a size, changing a font, changing a presentation state (e.g. minimized, restored, etc.), changing an operational state (e.g. paused, open, closed, etc.), changing an amount of power provided for or otherwise accessible to an operating instance of a user interface element at least partially included in the z-level, changing a security state, and so forth. A navigation user interface element or specified interaction may represent any coordinate in any dimension of a coordinate space of a subspace or of an output space of the subspace. Various types of selectors or identifiers may be combined to narrow selection. Nodes in navigation control 1350 in FIG. 13 may include different types of selectable user interface elements that may correspond to different types of identifiers that may be combined via a selected path from a root in the navigation tree to a descendent node. A leaf node may identify zero, one, or more subspaces or user interface elements.

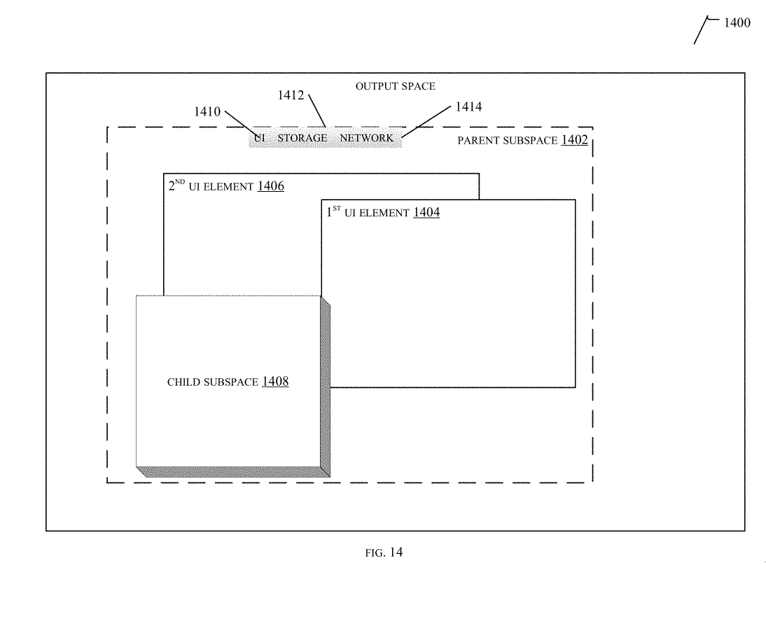

As also described elsewhere in the present disclosure, a subspace may be visible to a user or may be invisible. FIG. 14 illustrates an output space 1400 including a subspace 1402. The subspace 1402 may be invisible as indicated by the dotted line depicting a boundary of the subspace 1402. The subspace 1402 is illustrated including a first user interface element 1404, a second user interface element 1406, and a child subspace 1408. FIG. 14 illustrates that a subspace may have the same or fewer dimensions than a child subspace it includes or than an output space that includes the subspace. In an embodiment, a subspace may have more dimensions than one or more of a user interface elements or a child subspace in the subspace. Subspace 1402 is illustrated in a 2-dimensional output space 1400, includes 2-dimensional user interface elements (see first user interface element 1404 and second user interface element 1406), and includes a 3-dimensional child subspace 1408. One or more user interface elements in a subspace may be visible while the subspace is invisible. FIG. 14 also illustrates that while a boundary of subspace 1402 may be invisible, a UI element of the subspace may be visible or may be made visible in response to an interaction or some other event or condition. FIG. 14 illustrates a UI menu 1410 for managing user interface attributes of user interface elements in the subspace 1402 or for managing visual attributes of the subspace, such as size data or circuitry, location data or circuitry, transparency data or circuitry, input focus data or circuitry, output focus data or circuitry, and the like. A storage menu 1412 is shown that via interaction with a user may allow management of one or more storage resources of the subspace 1402. or of operating instances that have a user interface element in the subspace 1402, such as file permissions data or circuitry, default folders data or circuitry, naming resources data or circuitry, processor memory models data or circuitry, processor memory size data or circuitry, memory swapping criteria data or circuitry, and so forth. A network menu 1414 is shown that via interaction with a user may allow management of one or more network resources of the subspace 1402. or of operating instances that have a user interface element in the subspace 1402, such as access data or circuitry for or in a network interface (physical or virtual), data or circuitry for available network protocols and their attributes, data or circuitry for accessible network services such as cloud providers, data or circuitry for firewall settings, data or circuitry for encryption policies, data or circuitry for authentication and authorization credentials, and data or circuitry for quality of service settings—to name a few examples.

A subspace may be made visible or invisible in some embodiments. For example, resizing a subspace may be enabled by presenting a boundary of the subspace and interacting with the user via the presented boundary to receive input for a resizing operation. One or more user interface elements may be presented for interacting with the subspace. A subspace may include a navigation user interface analogous to navigation user interface elements described with respect to FIG. 13 to allow interaction with a user in navigating to, between, or among user interface elements that are in the subspace A user interface element may be presented to allow interaction with a user to change an attribute of one or more user interface elements in the subspace. A change to the resource may initiate an operation that changes one or more of the members of the subspace.

As those skilled in the art will understand based on the present disclosure, a subspace may define part of an operating environment for operating instances with user interface elements in the subspace. Operating instances when interoperating with their user interface elements in the subspace access one or more resources of the subspace. A resource of the subspace may be accessible via an operating environment that includes one or more of the operating instances. When in the subspace, an access to the resource may be altered or another resource may be substituted by the subspace for the resource of the operating environment. Alternatively or additionally, access to a resource may be constrained according to data or circuitry of a subspace when accessed by or for circuitry of an operating instance. A subspace constrains presentation of user interface elements of operating instances to a portion of an output space that includes the subspace. The subspace may replace the output space accessible in the operating environment when an operating instance operates unconstrained by the subspace.

An operating instance in an operating environment may access resources directly or indirectly during operation. The operating environment may provide access to some or all of the resources. As illustrated by the description of subspaces above, a subspace may include data or circuitry that may modify access to one or more of their resources accessed by an operating instance represented by a user interface element in the subspace. A subspace may provide a substitute resource, may provide a resource not accessible to the operating instance from the operating environment when not operating in the context of the subspace, or may modify access to the resource for the operating instance when operating in the context of the subspace as compared to access to the resource when operating in the operating environment and not in the context of the subspace. More generally, access to one or more resources accessed by or for one or more operating instance may be modified for the one or more resources when the set of operating instances operates in a specified context referred to herein as an “access context”. Access to a resource may be modified by emulating an interface, by specify a pointcut to identify one or more joinpoints where circuitry of associated advice may operate before, during, or after an access. The terms “pointcut”, “jointpoint”, and “advice” are defined as those skilled in the art of aspect orient programming define these terms. For a description of aspect-oriented object code and machine codes see, by the present inventor, U.S. patent application Ser. No. 12/055,550, titled “Method and Systems for Invoking an Advice Operation Associated with a Joinpoint”, filed on Mar. 26, 2008. In an embodiment, an access context may modify machine code of an operating instance (e.g. via linker or loader rewriting) to invoke access modifying instructions. For example, an interrupt instruction may be inserted in machine code of an operating instance before, during, or after code included in access a resource. Interrupt circuitry may include one or more instructions that may replace accessed data, change a behavior of an accessed set of instructions, and the like. For an access via a network, a proxy may be included in access to a network resource to modify an access. The foregoing are merely exemplary.

A subspace may be an embodiment of an access context or may represent or identify an access context. As described above with respect to subspaces, an embodiment of an access context may include structured data that identifies the access context, that associates one or more resources with the access context or is configured to allow one or more resources to be associated with the access context, and that associates one or more operating instances with the access context or is configured to allow one or more operating instances to be associated with the access context. Alternatively or additionally, an embodiment of an access context may include operating of circuitry (physical or virtual) that operates in enabling, modifying, or preventing access to a resource, in a context set of access context, by or for an operating instance. The one or more resources are referred to herein as a context set of the access context. The operating instance is referred to herein as a member of the access context. A resource in a context set of an access context is referred to herein as a context resource of the access context and may also be referred to as a context resource accessed by or for a member when the resource is accessed by or for the member.

An access context creates, modifies, or prevents a relationship between a resource in a context set of the access context and an operating instance that is a member of the access context. The relationship differs from a corresponding relationship between the same or an alternative resource and the operating instance when accessed via the operating environment when not a member. A set of members of an access context may include zero or more operating instances of zero of more operable entities at some time. In an embodiment, a set of members of an access context may change over time. One or more members of an access context may be pre-specified and may also be static (i.e. unchangeable). In an embodiment, a member of an access context may be specified based on one or more operable entities. For example, an operable entity may be associated with an access context so that an operating instance of the associated operable entity operates as a member of the access context. An access context may have one or more operating instances of a same operable entity. An additional criterion may be specified for an access context so that only operating instances of a specified operable entity that meet the additional criterion operate as members of the access context. An operating instance may be a member of more than one access context. An operable entity may have an operating instance that is a member of a first access context and a second operating instance that is a member of a second access context.

A first resource and a second resource may be accessed by or for an operating instance of an operable entity. In an embodiment, a first operating instance, of the operable entity, may be a member of a first access context in an operating environment. The first access context may include the first resource or a substitute for the first resource in a first context set of the first access context. The first context set, in an embodiment, does not include the second resource or a substitute for the second resource. The second resource may be accessed by or for the first operating instance via the operating environment as it would be if the first operating instance was not a member of the first access context. The first resource or the substitute for the first resource is accessed by or for the first operating instance via or based on the first access context. The access of the first resource or the substitute is different than if the first operating instance was not a member of the first access context. The first context may be said to provide a modified operating environment, an overlay environment or layer on top of the operating environment, a partial operating environment, an augmented environment, or a plugin environment. In an embodiment, the first resource may not be accessible via the operating environment by an operating instance not included in the first context. An access context may provide access to one or more resources that are not accessible by an operating environment that includes or is combined with the access context.

In an embodiment, a second operating instance, of the operable entity, may not be a member of a first access context in the operating environment. The first resource and the second resource may be accessed by or for the second operating instance via the operating environment unconstrained or not modified by or based on the first context. Alternatively or additionally, an access context may prevent access to a resource by or for a member operating instance that would be accessible to the operating instance when not a member. Still further, an access context may constrain or change access to a resource accessible without the change or with a different constraint when accessed in the operating environment. An access context may alter an accessed resource, substitute another resource, or may alter access to a resource by or for a member of the access context. A access may be modified by a change in a security attribute, a change in memory location for accessing a resource or a substitute, transforming an input or an output of an access, changing a format or schema of a stored or access resource, changing an address via which a resource is accessed, changing or otherwise constraining a time of access, a duration of an access, a user included in an access, a provider of a resource, a network resource included in accessing a resource via a network or other data exchange medium, a speed of access (e.g. accessing via slower hardware), a rate of a repeated access, or a count of other operating instances that may access a resource at a same time or sequentially—to name a few examples.

In an embodiment, an access context may alter no resource not in the context set nor alter access to a resource not included in the context set of the access context. An access context may change some or all of an operating environment for an operating instance member depending on the resources in the context set. When an access context modifies a portion of resources or modifies access to a portion of resources accessible otherwise in an operating environment for an operating instance member, a “partial operating environment” for the member is realized via the access context.

A subspace may be an “access context”. Operating instances with user interface elements in a portion of an output space specified by the subspace may be members and resources of the subspaces or accessed via or based on the subspace may define a context set. Alternatively or additionally, an access context may have a context set that includes a subspace as a resource accessible by or for a member of the access context. A context set of an access context may include more than one subspace.

An access context may modify a resource, substitute a resource, or modify access to a resource by replacing a default setting of an operating environment for a member operating instance; by replacing a default setting of an operable entity for an operating instance that is a member of the access context; by altering or replacing an addressable entity accessed by, accessed for, or included in a member operating instance; by specifying a security constraint for a resource access by or for a member; by specifying a resource to access by or for a member when an operating environment provides multiple suitable resource (e.g. an access context may include a subset of processors in its context set accessible to a member of a set of processors otherwise accessible by or for an operating instance not in the access context); by changing a constant setting accessible via an operating environment to a variable setting settable via one or more mechanisms by or for a member; by constraining a number of times a resource may be accessed by or for a member or a set of members of an access context; by constraining a time or duration of access to a resource by or for a member; by modifying a source of resource such a default file system or an environment path accessed by or for a member; by specifying minimum number of accesses or resources accessed by or for a member or a set of members; by changing a default application for accessing a resource for a member; or by changing or constraining access to one or more network nodes or other network resources by or a member. Other types of changes, substitutions, and constraints are described elsewhere in the present disclosure. In an embodiment, an operating instance of an operable entity may have access to resource or type of resource only when the operating instance is a member an access context having a context set that includes the resource or type of resource. Some operable entities may have operating instances that perform an operation only in the context of one or more access contexts or types of access contexts. Note that one or more of a device, a process, an operating environment, another access context, or a thread may be resource in a context set of an access context. Access contexts may be configured to specify and manage access to resources in cloud computing systems and other types of distributed or network based systems such as client-server systems.

As used herein, the term “addressable entity” may refer to any entity specified in source code written in a programming language. Examples of addressable entities include variables, constants, structures, functions, methods, methods of an object, and scoped code blocks—to name a few examples.

An access context may affect access by or for a member to a resource accessed in exchanging data via a network, accessed in storing or retrieving data from a memory device, accessed in executing an instruction, accessed in interacting with a user, and the like. Examples of resources accessed in exchanging data via a network include a network interface, a network, a protocol endpoint, or other network entity whether physical or virtual.

A context set may be an identifier of an access context or may identify a type of access context. An access context may be assigned an identifier such as a name, a number, an image, a character string, or an identifier from any identifier space selected for an embodiment by a developer, user, administrator, or other authority. Identifiers are resources in and of themselves and may be included in a context set for an access context. Other resources that may be included in a context set of an access context include hard drives, file systems, files, operating environments, security roles, processors, or metadata for any or all of the foregoing.

FIGS. 4, 5, 6, and 7 identify data structures for various embodiments of access contexts that are subspace based. Similar or analogous data structures and corresponding code may support access contexts and associated context sets. Note that the data structures in FIGS. 4, 5, 6, and 7 each include a link table that links context resources to various types of members. Link tables are bidirectional allowing a context resource to be identified based on a member as well as allowing a member to be identified based on a context set or based on a context resource. An embodiment may include an arrangement of data fields or data structures that allow a context resource to be identified based on a member but not vice versa. Similarly, an embodiment may include an arrangement of data fields or data structures that allow a member to be identified based on a context resource but not vice versa. Arrangements of records may be centrally stored or stored in a distributed manner. Data may be accessible via an access context circuitry or may be exchanged between or among members or circuitry of or for a context resource.

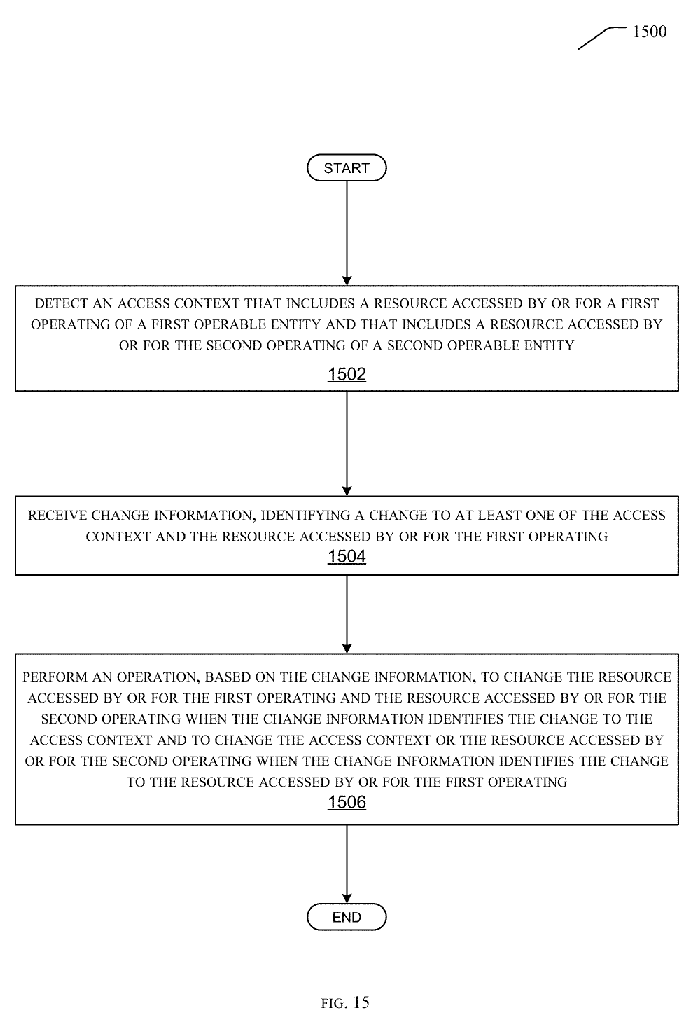

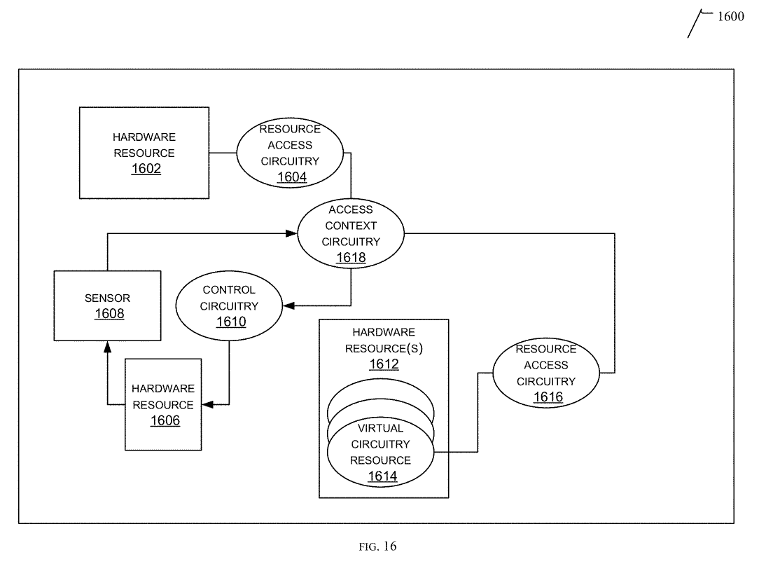

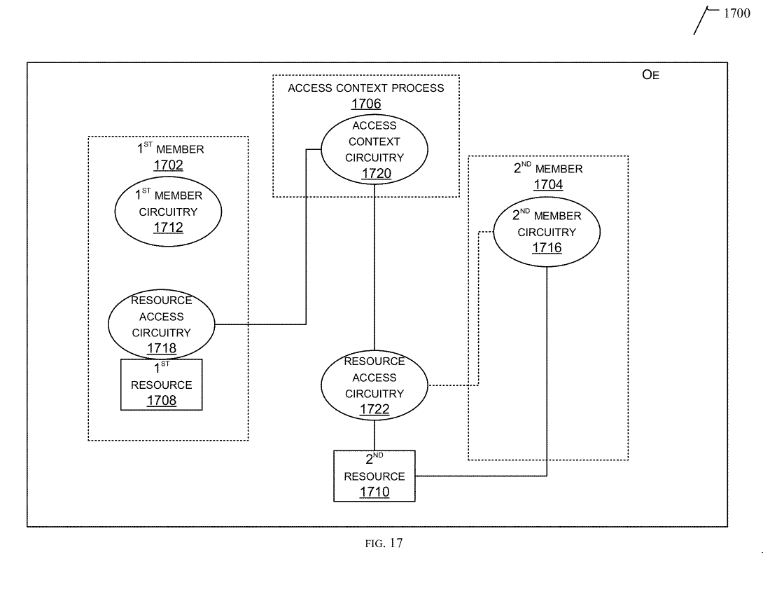

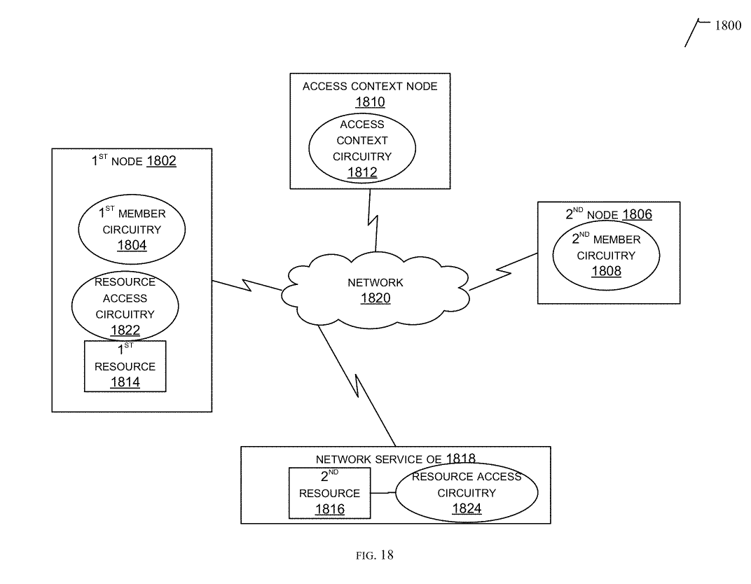

FIG. 15 shows a flow chart 1500 in accordance with an embodiment of a method of the present disclosure. Circuitry may be included in an embodiment or the method may include providing circuitry that is operable for use with a system included in performing a method of flow chart 1500. Such a system may include a first operable entity. The system may also include a second operable entity. At block 1502, the circuitry may operate in detecting an access context having a context set. The context set may include a resource accessed by or for a first operating of the first operable entity and may include a resource accessed by or for a second operating of the second operable entity. The first operating and the second operating may be members of the access context (i.e. each operating is a member operating instance). Membership may be respectively based on a specified association between the first operable entity and the access context and on a specified association between the second operable entity and the access context. At block 1504, the circuitry may operate in receiving change information, identifying a change to one or more of the access context and the resource accessed by or for the first operating. At block 1506, the circuitry may operate in performing an operation, based on the change information, to change the resource accessed by or for the first operating and the resource accessed by or for the second operating when the change information identifies the change to the access context and to change the access context or the resource accessed by or for the second operating when the change information identifies the change to the resource accessed by or for the first operating.

In an embodiment, a change to a context resource may include one or both of a change to an access context that has a context set that includes the context resource and a change to a context resource accessed by or for a member. Further, a member may change a context resource, thus changing the access context. The changed context resource may change a subsequent member's operating as a result. With respect to an access context that has a context set that includes a subspace. A change to a user interface element, in the subspace, of a member may change the subspace as described elsewhere in the present disclosure.

FIG. 16 shows a system 1600 that may operate in performing one or more methods of the subject matter of the present disclosure, such as a method of flow chart 1500. FIG. 16 shows system 1600 including a hardware resource 1602 that may be in a context set of an access context. The hardware resource 1602 may be accessed by or for a member of the access context. Resource access monitor circuitry 1604 may operate to detect a change to the hardware resource 1602, may operate to change the hardware resource 1602, or may operate to detect an access to the hardware resource 1602 by or for the member. Hardware resource 1602 may include a processor, a network adapter, a storage device, a volatile memory device, an interface for exchanging data with a peripheral device, a graphics adapter, a steering mechanism, an axle, a heat generating device, a cooling device, a compressor, a speedometer, a security device, a media recording device, a media playing device, or a data transfer medium—to name just a few examples. Also illustrated is a hardware resource 1606 that may be monitored via a sensor 1608, such as a heat sensor, a power sensor, a counter, and so forth. In various embodiments, hardware resource 1606 may be an energy storage devices such as a battery, an energy transformation device such as a transformer, an energy generating device such as a sterling engine, or any other type of device such as those identified in this paragraph or elsewhere in the present disclosure. The identified devices are not intended to be a complete list. Control circuitry 1610 which may be separate from the sensor 1608 may be included to interoperate with the hardware resource 1606 to change the hardware resource 1606. One or both of sensor 1608 and control circuitry 1610 may operate in access accessing resource 1606 or in response to an access to resource 1606 for the member. FIG. 16 also illustrates that one or more hardware resources 1612 may provide access to, include, or host one or more virtual resources such as virtual circuitry 1614 as shown. For example, a hardware resource 1612 may include some or all of a processor and physical memory accessible to the processor (e.g. a system of a chip (SOC)). A hardware resource 1612 may include or alternatively may be included in an automotive device, an appliance, a smart phone, a notebook computer, a thermostat, a television, a lighting device, a heating device, or any of numerous internet of things (IOT) devices—to name some examples. Resource access/monitor circuitry 1616 is illustrated which may be included to monitor the virtual circuitry resource(s) 1614 for a change, to apply a change to one or more virtual resources 1614, or to operate in or in response to an access to one or more virtual resources 1614 by or for a member. In an embodiment, resource access monitor circuitry 1616 may include scheduling circuitry, interrupt circuitry, data exchange circuitry, or circuitry realized based on instructions in a link library accessed in response to operating of one or more instances of virtual circuitry 1614. FIG. 16 also includes access context circuitry 1618 for interoperating with access monitor circuitry 1604 to detect a change to, to change, or to access hardware resource 1602 for a member of an access context. Access context circuitry 1618 may, alternatively or additionally, interoperate with sensor 1608 or control circuitry 1610 to detect a change in, to change, or to access hardware resource 1606 by or for a member of an access context. Still further, access context circuitry 1618 may, alternatively or additionally, interoperate with access monitor circuitry 1616 for detecting a change to, for changing, or for accessing one or more virtual circuitry resources 1614 by or for a member of an access context. Access context circuitry 1618 may also operate to detect a change to or for changing an access context. One or more of hardware resource 1602, hardware resource 1606, hardware resource(s) 1612, virtual circuitry resource(s) 1614, or a resource in or accessible via any of the foregoing may be in a context set of an access context. Note that an access context may be specified that includes a member that may be included in interacting with a user. The user may be included in the interaction when assigned a suitable role. A suitable role may be specified by a context resource of the access context. In an embodiment, a user may be accessed by or for a member of an access context via a resource (e.g. an input device or an output device) in a context set of the access context. A system may include one or more operating access contexts operating based on one or more embodiments of access context circuitry. An analogous statement is true for resource access circuitry, control circuitry, virtual circuitry resources, and operating instances that operate based on any of the foregoing.

FIG. 17 shows a system 1700 that may operate in performing one or more methods of the subject matter of the present disclosure, such as a method of flow chart 1500. FIG. 17 shows that system 1700 includes a first member 1702 of an access context. The first member may operate via virtual circuitry 1712 realized by a processor, such as processor 308 in FIG. 3, executing code, such as first operable entity code 312, as described above. Similarly, system 1700 includes a second member 1704 that may be realized via an operation of second member circuitry 1716. Second member circuitry 1716 may be realized, at least in part, by processor 308 executing second operable entity code 316. An access context process 1706 is illustrated that may operate based on operation of virtual circuitry 1720 realized by processor 308 executing access context code (not shown). FIG. 17 also illustrates a first resource 1708 of the first member 1702 accessed by or for the first member 1702. For example, resource 1708 may be a network interface, an interprocess communications mechanism, data stored in a memory, a memory or a portion of a memory, a database, a machine code library referenced by the first member 1702, a user interface element of the first member 1702, a semaphore, a queue, a data stream, an address of a network service, or a user—to name a few examples in addition to others exemplary context resources identified elsewhere in the present disclosure. The first resource 178 may be included in the context set of the access context process 1706. Similarly, a second resource 1710, which in FIG. 17 is not included in the second member 1704, may be accessed via the system 1700 by or for the second member 1704. The second resource 1710 may be a member of the same context set as the first resource 1708 during an operation of an embodiment. Second member circuitry 1716 may be realized by execution of the second operable entity code 316 by a processor 308 as described with respect to FIG. 3. Resource access circuitry 1718 may be realized as virtual circuitry, at least in part, based on execution of code generated from or written in a programming language to detect a change, to operate in changing, or to operate in an access of the first resource 1708 by or for the first member 1702. Resource access circuitry 1718 may be included in the first member 1702. Resource access circuitry 1708 may be included in first member circuitry 1712 in an embodiment. Resource access circuitry 1722 may be realized as virtual circuitry, at least in part, based on execution of code generated from or written in a programming language to detect a change, operate in changing, or to operate in accessing second resource 1710 by or for the second member 1704. Resource access circuitry 1722 may operate in an operating instance other than the second member 1704. Resource access circuitry 1722 may exchange information with the second member 1704 via an interprocess communication mechanism, via a network, or via a reference such as a processor memory address or a symbolic reference. Note the first member 1702 and the second member 1704 may operate in a same device or the same operating environment in an embodiment. The first member 1702 and the second member 1704 may operate in different devices or different operating environments in an embodiment.

FIG. 18 shows a system 1800 that may operate in performing one or more methods of the subject matter of the present disclosure, such as a method of flow chart 1500. FIG. 18 shows that system 1800 includes a first node 1802 which may be or may otherwise include a first member of an access context. The first member may operate via first member circuitry 1804. Similarly, system 1800 includes a second node 1806 that may be or may include a second member realized via second member circuitry 1808. A node 1810 is illustrated that may include or may be included in an access context which may operate, at least in part, based on access context circuitry 1812. FIG. 18 also illustrates a first resource 1814 of the first node 1802 accessed by or for the first member. For example, first resource 1814 may be a network interface, an interprocess communications mechanism, data stored in a memory, a memory or a portion of a memory, a database, a machine code library referenced by the first member, a user interface element of the first member, a semaphore, a queue, a data stream, an address of a network service, or a user to name a few examples in addition to other exemplary resources identified elsewhere in the present disclosure. The first resource 1814 may be included in the context set of the access context. Similarly, a second resource 1816, which as illustrated, may be accessible by or for the second member from a network service operating environment 1818 via a network 1820. The second resource 1816 may include an image, circuitry of a remote procedure call, a web page, or a media stream—to name a few examples. The second resource 1816, may be accessed via the system 1800 by or for the second member. The second resource 1816 may be a member of the same context set as the first resource 1814. Resource access circuitry 1822 may be realized as virtual circuitry, at least in part, based on execution of code generated from or written in a programming language to detect a change, to operate in changing, or to operate in an access of the first resource 1808 by or for the first member 1802. Resource access circuitry 1822 may be included in the first node 1802 or in an operating environment of the first node 1802. Resource access circuitry 1822 may be included in first member circuitry 1804 in an embodiment. Resource access circuitry 1824 may operate to detect a change to, operate in changing, or to operate in accessing the second resource 1816 by or for the second member circuitry 1808 of the second node 1806. Resource access circuitry 1824 may be included in the one or more nodes of network service operating environment 1818, which in an embodiment may include or may be included in a cloud computing environment.

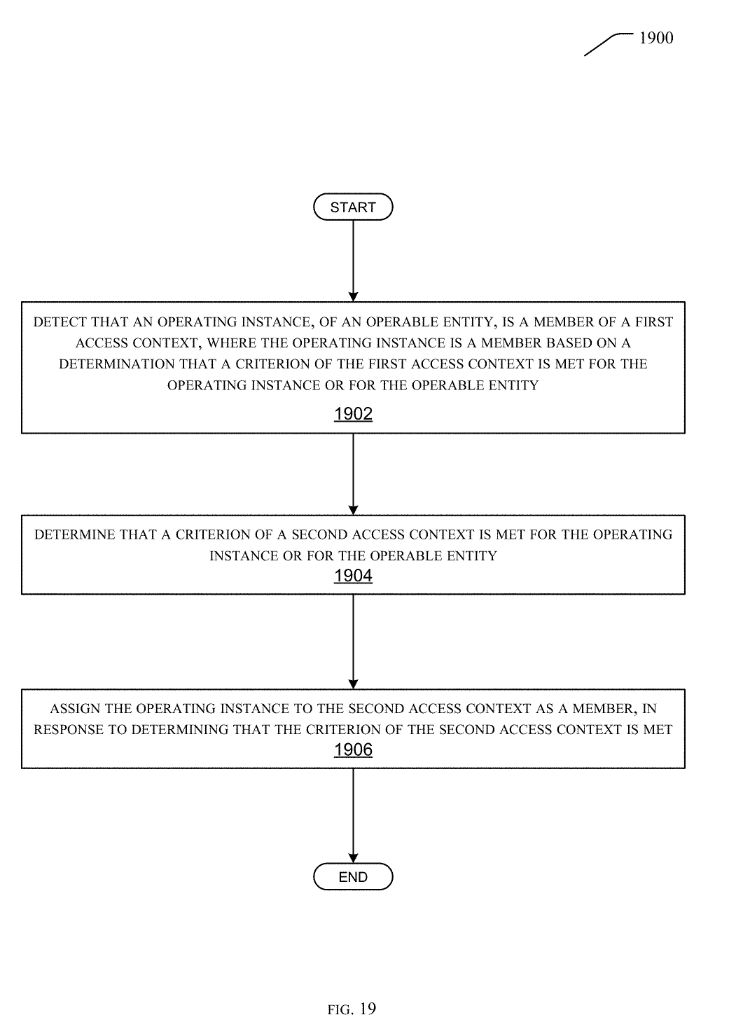

FIG. 19 shows a flow chart 1900 in accordance with an embodiment of a method of the present disclosure. In various embodiments, circuitry may be included in a system or circuitry may be provided that is operable for use with a system included in performing a method of flow chart 1900. At block 1902, the circuitry may operate in detecting that an operating instance, of an operable entity, is a member of a first access context. The operating instance may be a member of the first access context in response to a determination that a specified criterion of the first access context is met for the operating instance or for the operable entity. At block 1904, the circuitry may operate in determining that a specified criterion of a second access context is met for the operating instance or for the operable entity. At block 1906, the circuitry may operate in assigning the operating instance to the second access context as a member, in response to determining that the criterion of the second access context is met.

In an embodiment, an operable entity may be member of one or more access contexts at a time. An embodiment may restrict an operable entity from being a member of more than one access context. An operating instance may be removed as a member of a first access context in response to determining that the operating instance is to be or has been added as a member of a second access context. An operating instance, of an operable entity, may be added as a member of a first access context in response to determining that the operating instance, of the operable entity, is to be or has been removed as member of a second access context. An adding or removing operation may be performed automatically in an embodiment. An adding or removing may include interaction with a user in an embodiment.

In an embodiment, an operating instance, of an operable entity, may be a member of an access context during a portion of the operating of the operating instance. Prior to the portion, the operating instance may not be member and may be added to as a member of the access context for the portion. Subsequent to the portion, the operating instance may be removed from the access context. The operable entity, in an embodiment, may be associated with the access context to identify some or all operating instances of the operable entity as members in response to associating the operable entity with the access context. In an embodiment, an operating instance may be a member of an access context during an access by or for the operating instance to a resource in a context set of the access context. Membership of an operating instance in one or more access contexts may change based on detecting a resource to be accessed, a resource being accessed, or based on a prior access to a resource. A membership change may be based on detecting that a resource is in a context set of an identifiable access context or detecting that a resource is not in a context set of an identifiable access context or otherwise is not configured for access in any access context. Prior to an access to a resource, an operating instance may not be member and may be added to as a member of an access context during or prior to an accessing of the resource by or for the operating instance. Subsequent to the accessing, the operating instance may be removed as a member from the access context.

A criterion, for adding or removing an operating instance respectively to or from an access context, may be based on the operating instance, another operating instance, an operable entity, a resource accessed by or for an operating instance, an access context, or a user interaction with the operating instance or with another operating instance—to name some examples. For example, a maximum number of members that meet a specified criterion may be defined for an access context. When the maximum has not been met, an operating instance that meets the specified criterion may be added as a member to the access context. When the maximum has been met, an operating instance that meets the specified criterion may not be added as a member of the access context. For example, an access context may be specified for an operating instance that executes circuitry that embodies a communications agent, such as an instant messaging client. In response to adding the communications agent operating instance to the access context, an adding of an operating instance of an address book may be allowed and an adding of an operating instance of an image capture device may be added as a member (e.g. to capture and attach a digital image to a text message). The member set of the access context may be specified to allow multiple operating instances of address book application(s) while allowing a maximum of one image capture device at any time to the member set. The operating instances in the member set may exchange information via one or more context resources (e.g. a virtual network) of the access context. That is, data exchange between or among the operating instances may be enabled in response to or based on being members of an access context. An operating instance when not in the access context may be unable to exchange information or may exchange data differently.

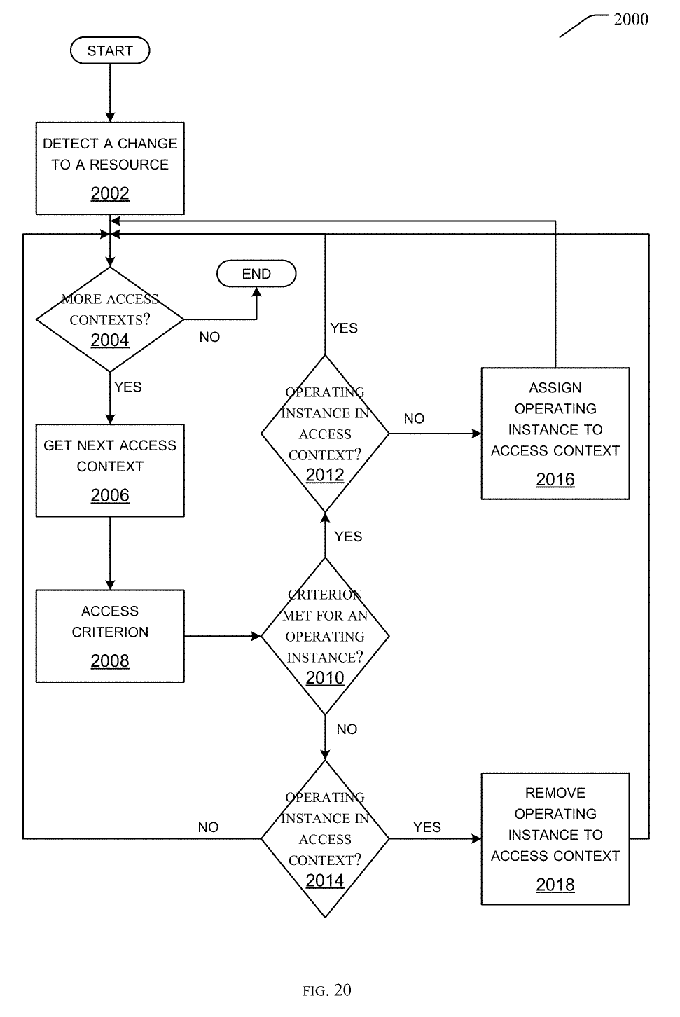

FIG. 20 shows a flow chart 2000 that, in an embodiment, may perform a method of flow chart 1900. Circuitry may be included in an embodiment or a method may include providing circuitry that is operable for use with a system included in performing the flow chart 2000. At block 2002, the circuitry may operate in detecting a change to a resource. At block 2004, the circuitry may operate in iterating through access contexts, if any. When there are no access contexts or no more access contexts to process, the operating may end. At block 2006, the circuitry may operate in getting a next access context, if more exist. At block 2008, the circuitry may operate in accessing a criterion for the access context accessed in block 2006. At block 2010, the circuitry may operate in determining whether the accessed criterion is met based on the changed resource for an operating instance or for an operable entity. A determination may be made for one or more operating instances or operable entities individually or in groups (not shown). If the criterion is met, then operation may continue at block 2012. Otherwise operation may continue at block 2014. At block 2012, the circuitry may operate in determining whether the operating instance is in the access context. If the operating instance is not in the access context then operation may continue at block 2016. Otherwise, operation may return to check for more access contexts leaving the operating instance as a member of the access context. At block 2016, the circuitry may operate in assigning or adding the operating instance as a member of the access context then return to check for more access contexts. At block 2014, the circuitry may operate in determining whether the operating instance is in the access context. If the operating instance is in the access context then operation may continue at block 2018. Otherwise, operation returns to check for more access contexts leaving the operating instance assigned to the access context. At block 2018, the circuitry may operate in removing the operating instance from the access context, then return to check for more access contexts.

As described, access contexts may be used to change operating environments, of an operating instance or a group of operating instances, dynamically in response to network resource utilization, storage resource utilization, processor utilization, memory utilization, or based on change in attributes of operating instances or groups of operating instances such as a count of operating instances that access a resource, a source of a group of operating such as a high priority client or an untrusted source, performance or other quality of service requirements of an operating instance or a group of operating instance—to name some examples.

In the embodiment of FIG. 20, when an operating instance is added to an access context in response to a determination that a criterion of the access context is met, the operating instance may remain in the access context until a determination is made that the criterion is not met. In another embodiment, an access context may have a criterion for adding an operating instance to the access context and a separate criterion for removing the operating instance from the access context. For example, an application may be added to an access context when a measure or processor utilization falls below a specified threshold and the application is at a position in a queue indicating the application is ready for adding.

In an embodiment, a resource may be included in one or more context sets of one or more respective access contexts at a time. Each access context may modify the resource or access to the resource differently. An embodiment may restrict a resource from being included in more than one context set. A resource may be removed from a first context set in response to determining that the resource is to be or has been included in a second context set. A resource may be included in first context set in response to determining that the resource is to be or has been added to second context set. An adding or removing operation may be performed automatically in an embodiment. An adding or removing may include interaction with a user in an embodiment.

An access context may be prespecified and not changeable by a user. An operating instance, of an operable entity, may be identified as a member prior to its existence by associating the operable entity and the access context. Adding or removing of members may be automatic or may include user interaction. An access context may be modifiable by a user. An access context may be created by or in response to a user interaction. A context set may include multiple resources which may be of a same type or may be different types of resources. A context set may include a single resource. For example, an access context may be defined with a context set that includes a specified data base, a specified data base connection, a specified role via which the database is accessible to a member of the access context, or a specified geospatial location of a member of the access context from which the database may be accessed by or for an the member.

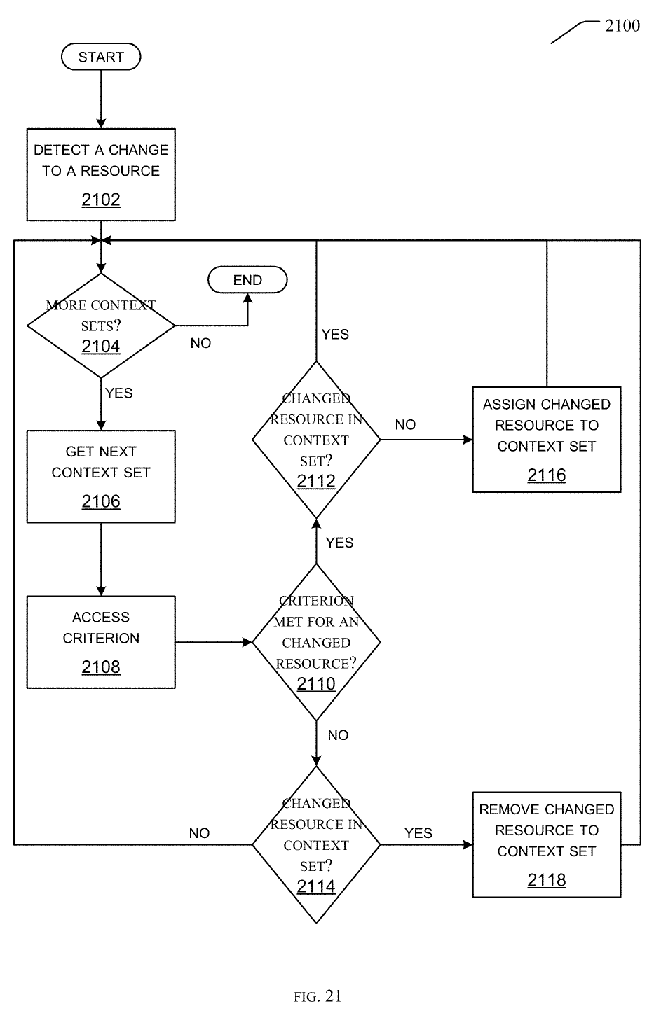

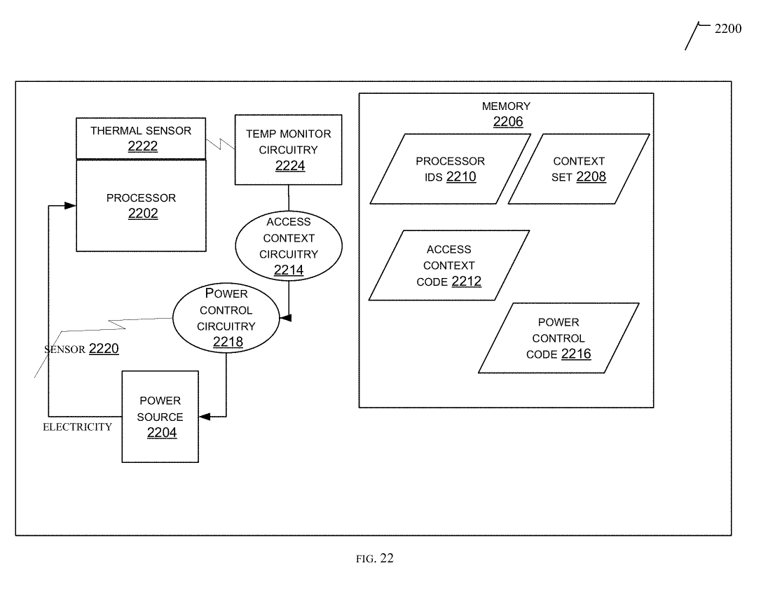

FIG. 21 shows a flow chart 2100, in an embodiment, that may perform a method of the present disclosure. Circuitry may be included in an embodiment or a method may include providing circuitry that is operable for use with a system included in performing the flow chart 2100. At block 2102, the circuitry may operate in detecting a change to a resource. At block 2104, the circuitry may operate in iterating through context sets, if any. When there are no context sets or no more context sets to process, the operating may end. At block 2106, the circuitry may operate in getting the next context set, if more exist. At block 2108, the circuitry may operate in accessing a criterion for the context set accessed in block 2106. At block 2110, the circuitry may operate in determining whether the accessed criterion is met based on the changed resource. A determination may be made for one or more resources individually or in groups (not shown). If the criterion is met, then go to block 2112. Otherwise go to block 2114. At block 2112, the circuitry may operate in determining whether the resource is in the context set. If the resource is not in the context set then go to block 2116. Otherwise, return to check for more context sets leaving the resource in the context set. At block 2116, the circuitry may operate in assigning the resource to the context set, then return to check for more context sets. At block 2114, the circuitry may operate in determining whether the resource is in the context set. If the resource is in the context set then go to block 2118. Otherwise, return to check for more context sets leaving the resource in the context set. At block 2118, the circuitry may operate in removing the resource from the context set, then return to check for more context sets.

In an embodiment of FIG. 21, when a resource is added to a context set in response to a determination that a criterion of the context set is met, the resource may remain in the context set until a determination is made that the criterion is not met. In another embodiment, a context set may have a criterion for adding a resource to the context set and a separate criterion for removing the resource from the context set. For example, a network interface may be added to a context set based on a quality of service (QOS) measure that is determined to be within a specified range. Alternatively or additionally, a measure of heat in or heat output from a processor may exceed a first temperature (i.e. a first criterion). An access context may include a context set criterion based on processor temperature. For example, the processor may be included in a context set of a first access context, when a processor temperature exceeds a first temperature. The access context may constrain access to power providing relatively low power or having lower priority for access to the processor for its members with respect to a second context set. The processor may be included in a context set of the second access context when processor temperature is below a second temperature. The second access context may allow access to relatively more power or have relatively higher priority for access to the processor than the first access context. The processor may be included in the context sets of each of the first access context and the second access context when the processor temperature is between the first temperature and the second temperature, if the second temperature is less than the first temperature. The processor may be included in neither context set of the first access context nor the second access context when the processor temperature is between the first temperature and the second temperature, if the second temperature is higher than the first temperature. Note that in addition to managing environments in which operating instances of operable entities operate, resources may be managed. The example, just given illustrates a method or mechanism for managing processor utilization and temperature. In doing so, power received by processor(s), access to processor(s), or processor utilization may be managed via one or more access contexts providing a greater degree of flexibility not only for a single processor but also for multi-processor environments such as cloud computing environments. Note that access contexts that include processors as context resources may be utilized or assigning, for prioritizing, tasks performing operating instances to processors based on any of various processor attributes in addition to or instead of processor temperature.

Resources others than processors may be managed via an access contexts as well. Members of an access context may be managed to manage access to any resource in the context set of the access context according to the data and circuitry of an access context which implement one or more rules, constraints or policies. For example, a processor in a context set of an access context may be accessed only by members of the access context. Control of the member set may be utilized to control any number of processor resources such as time of use, temperature, power utilization, and so on. An access context may also include rules for sharing a resource between or among the members of the access context. Those skilled in the art will see, based on the present disclosures, that access contexts may be utilized to monitor, manage, or configure resources. Alternatively or additionally, those skilled in the art will see, based on the present disclosure, that access contexts may be utilized to monitor, manage, or configure operating instances of operable entities by controlling membership in one or more access contexts. Further still, those skilled in the art will see, based on the present disclosure, that access contexts may be utilized to monitor, manage, or configure a system which may include one or processes, applications, devices, operating environments which may be or may include one or more virtual operating environments, networks, or systems distributed across a network. Access contexts allow an operating environment to provide multiple overlapping customized operating environments for operating instances operating in the same operating environment. Further, an access context may provide a mechanism for combining some or all of multiple operating environment into a single environment or partial environment by including resources of different operating environments in a same context set of an access context.

FIG. 22 shows a system 2200 that may operate in performing one or more methods of the subject matter of the present disclosure. FIG. 22 shows that system 2200 includes a processor 2202 and a power source 2204 that may provide energy, such as electrical energy, to the processor 2202. System 2200 also includes a memory 2206 from which processor 2202 may access code and data to process to operate virtual circuitry specified by the code. Memory 2206 is shown storing context set data 2208 that may identify or reference a memory location that identifies one or more context resources such as the address of processor id data 2210. Context set data 2208 may also identify criterion data (not shown) for determining whether to modify a resource or to otherwise modify access to a resource in the context set, add a resource to the context set, remove a resource from context set, or exclude a resource from the context set. Context set data may include or identify other data about or associated with the context set. Access context code 2212 is shown stored in memory 2206. Access context circuitry 2214 may operate via processor 2202 operating to access and execute one or more instructions and data values in access context code 2212 or a translation of access context code (e.g. access code may be stored in a scripting language, object code, byte code, machine code, etc.). A translation may be performed by a compiler, loader, linker, interpreter, or the like. Power control code 2216 is also shown stored in memory 2206. Power control circuitry 2218 may be operated via processor 2202 accessing and executing power control code 2212. FIG. 22 also illustrates a sensor 2220 that may send a signal to power control circuitry 2218 indicating a measure of energy transferred from power source 2204 to processor 2202. Power control circuitry 2218 may interoperate with power source 2204 to control the measure of electrical energy accessed by or for a member of an access context based on an access context constraint specified in or otherwise accessible to the access context circuitry 2214 (e.g. identified a context set of the access context). FIG. 22 also illustrates a thermal sensor 2222 and thermal energy monitoring circuitry 2224 that may be included in system 2200 to determine a measure of heat in processor 2202 or a measure of heat emitted by processor 2202. The measure(s) may be provided to access context circuitry 2214 to process in controlling access to processor 2202 by a member of the access context. Access to electrical energy for the processor 2202 by or for a member may also be managed.

A resource may be added or removed from a context set automatically in an embodiment. In some embodiments, a user interaction may be included in determining whether to add a resource to a context set or whether to remove a resource from a context set. For example, a resource of an application or a resource provided by an application may be added to a context set of an access context by moving a user interface element of the application to a location in an output space that is included in a subspace that represents the access context. Circuitry of the access context may be generated from source code written in a programming language to detect and add files of a specified type, stored in a specified location, and so forth to the context set of an access context. An operating instance of an application may or may not be added to an access context as a member depending an a membership criterion of the access context. In an embodiment, a file may be added as a resource to a context set of an access context. Once the file is added to the context set, the access context may monitor the file for one or more specified events or conditions, may control access to the file, may control a location of the file in a data store, may control data stored in or read from the file, or may control any number of other resources of the file or operations performed on or with the file.

An access context may be included in exchanging data between or among operating instances. An exchange may be via a network, via physical link, via an interprocess communication mechanism, via a shared resource, via direct access such as via a function call of one operating instance by another. An exemplary system may include a first node, a second node, and a network. The circuitry may operate in detecting a performing of an operation included in exchanging data via a data transfer medium, such as the network of the exemplary system. The circuitry may operate in determining that a member of an access context is included in the exchanging. The circuitry may operate in identifying a constraint of the access context specified for the exchanging. The circuitry may operate in executing an instruction included in constraining the exchanging based on the constraint of the access context. A context set may include a shared data space, a pipe, a bus, a software interface, or other mechanism that allows (e.g. defines a constraint for) a member of the access context to exchange information with another member of the access context or which may be in another node or to exchange information with an operating instance that is not a member of the access context. A member of an access context may exchange data, per the access context, with an operating instance that is not a member of the access context, in an embodiment.

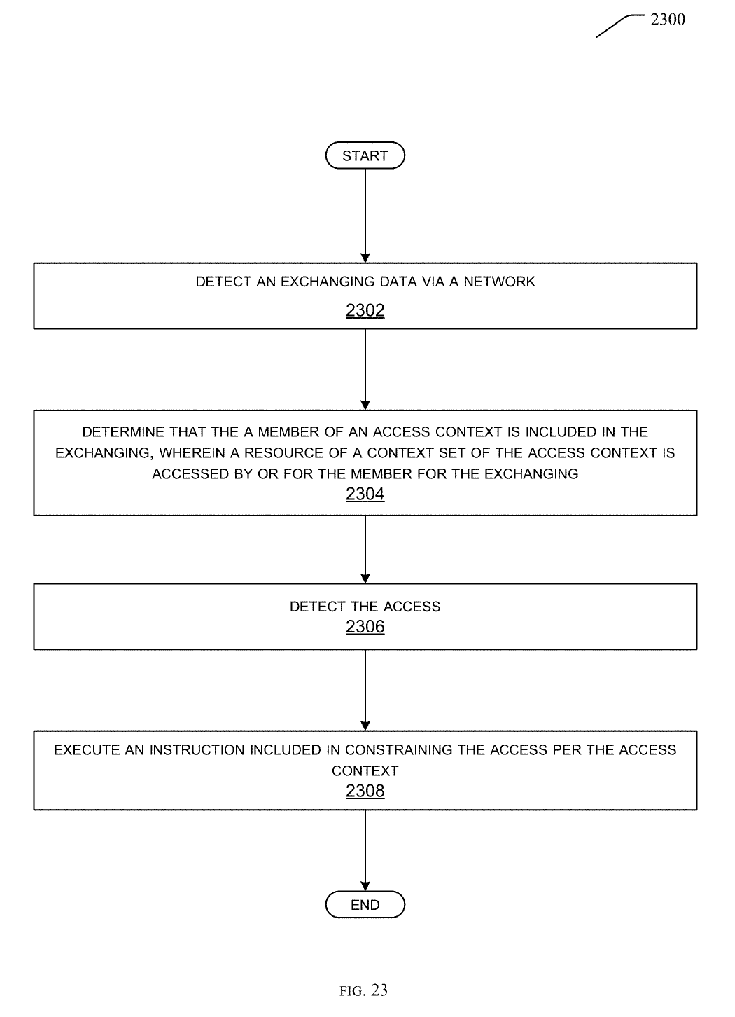

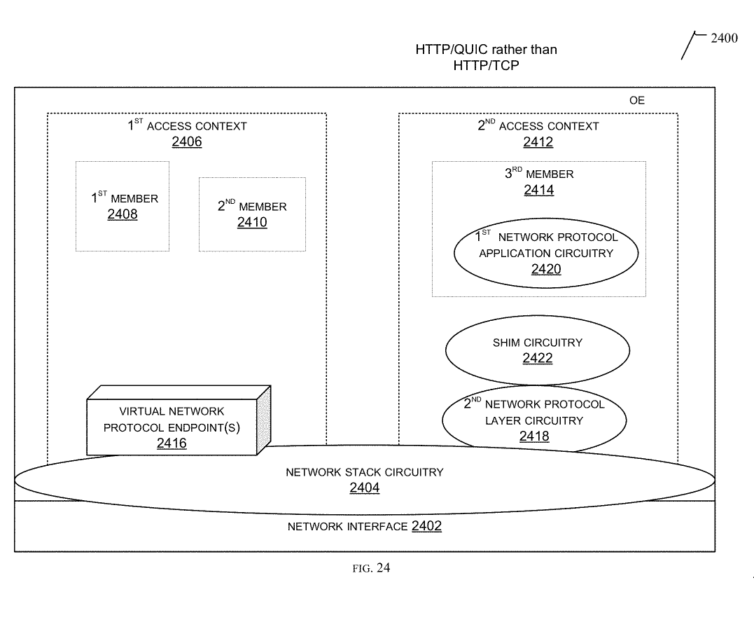

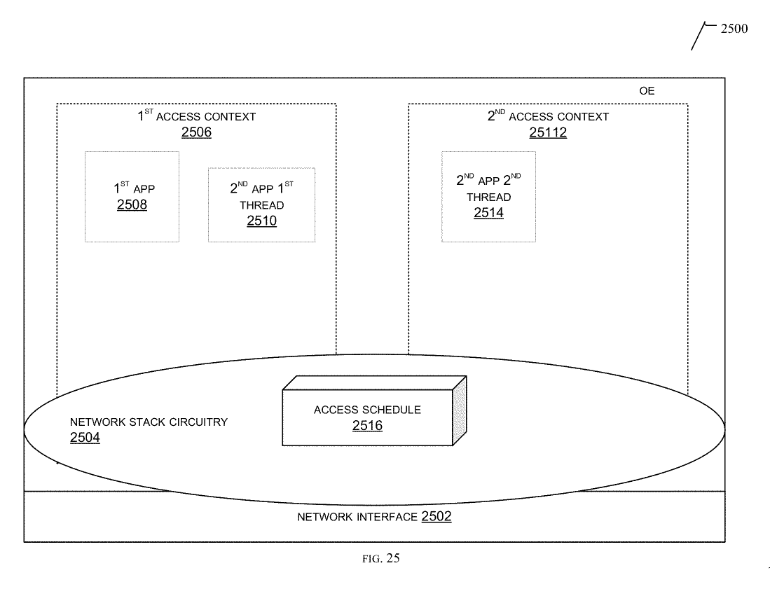

FIG. 23 shows a flow chart 2300 in accordance with an embodiment of a method of the present disclosure where an access context is included in a data exchange. In various embodiments, circuitry may be included in a system or circuitry may be provided that is operable for use with a system included in performing a method of flow chart 2300. An exemplary system may include a first node, data exchange hardware (e.g. an Ethernet adapter, a wireless adapter, a bus, a Bluetooth adapter, etc.), and circuitry for exchanging change via the data exchange medium according a specified protocol. At block 2302, the circuitry may operate in detecting an exchanging of data via network. An exchanging of data may be detected prior to or during the exchanging. At block 2304, the circuitry may operate in determining that a member of an access context is included in the exchanging. A member may be a sender or data; a receiver of data; may relay data; may include an application; may be hosted by a server; may be hosted by a client; may include a communications agent; may include a user agent; may include a web server; may include a network service provider; may be included in a network stack; may be included in a network adapter; may be included in a relay node or proxy node; or may be included in compressing, encrypting, or otherwise transforming data included in an exchanging—to name some examples. At block 2306, the circuitry may operate in detecting the access by or for the member. At block 2308, the circuitry may operate in executing an instruction included in constraining the access per the access context.

In an embodiment, circuitry in system or interoperating with a system may operate in identifying an access context. The access context may have a constraint that is specified for constraining a member where the member is included in an exchanging of data between a first operating instance and a second operating instance. In an embodiment, the member includes the first operating instance operating in the first node and the second operating instance operates in a second node communicatively coupled to the same network as the first node. In another embodiment, the member may not include the first operating instance or the second operating instance. The circuitry may, also, operate in executing, in response to the detection, an instruction included in constraining the exchanging by constraining the operating per the specified constraint. In an embodiment, the exchanging may be constrained to a network protocol, a network path, a network interface, or the like based on one or more resources in the context set of the access context or based on circuitry included in the embodiment of the access context which may include circuitry included in the embodiment of the context set.

FIG. 24 shows a system as an operating environment 2400 that may operate in performing one or more methods of the subject matter of the present disclosure, such as a method of flow chart 2300. FIG. 24 shows that operating environment 2400 includes a network interface 2402 such as an Ethernet adapter, a wireless transceiver, a serial link adapter, and the like. System 2400 may include one or more layers of network stack circuitry 2404 for communicating via a data transmission medium (not shown) communicatively coupled to operating environment 2400 via the network interface 2402. A first access context 2406 is defined that includes a first member 2408 such as a first operating instance of an application and includes a second member 2410 such as a second operating instance of a same or different application. A second access context 2412 is also specified. A third member 2414 such as a third operating instance of the same application as the first member or the second member or of a different application than either the application of the first member or the application of the second member. The third member is included in the second access context 2412. The first access context 2406 may have a constraint that allows network exchanges a first virtual networks identified in a first context set of the first access context by first virtual network protocol endpoint(s) 2416 that are accessible to a member of the first access context 2406 when operating to exchange information via the network. The second access context 2412 may have a constraint that limits network exchanges to exchanges via a specified network protocol (see second network protocol layer circuitry 2418), which may be substituted for a network protocol that a member attempts to access if different (see first network protocol application circuitry 2420) than the specified transport protocol (see second network protocol layer circuitry 2418) of the second access context. The third member 2414 may include application circuitry (see first network protocol application circuitry 2418) for sending and receiving data via network via a first network protocol. The resource context of the second access context 2412 may include a circuitry of a shim layer (see shim circuitry 2422) that emulates or interoperates with the first network protocol application circuitry as would network layer circuitry of the first protocol (not shown and which may not be included in the operating environment 2400 in an embodiment). The shim circuitry 2422 may translate or transform data exchanged between the first network protocol application layer 2420 and the shim circuitry 2422 according to the first network protocol to data exchanged between the shim circuitry 2422 and the second network protocol layer circuitry 2418 according to the second network layer protocol. Such data exchanges may be outgoing with respect to OE 2400 or incoming. For example, the 3rd member may be an app or a browser than exchanges data with a first service provider via sending or receiving data via the hypertext transfer protocol (HTTP) over the transmission control protocol (TCP). The first network protocol layer protocol shim circuitry 2422 may transform or substitute data received via the first network protocol application circuitry 2420 to send the transformed or substituted data via a second network protocol (see substitute network protocol circuitry 2418). The first network protocol layer protocol shim circuitry 2422 may further transform data received via the second network protocol (the substitute network protocol circuitry 2418) to a format suitable for receiving by the third member 2414 via the first network protocol application circuitry 2420. Continuing with the HTTP example, the substitute network protocol circuitry 2422 may be QUIC layer network protocol circuitry for transmitting HTTP via QUIC over an IP protocol layer (not shown) in the network stack circuitry 2404, in an embodiment. The network protocol layer shim circuitry 2422 may transform data received via the first network protocol application circuitry 2420 to send HTTP data via QUIC rather than TCP. The network protocol layer shim circuitry 2422 may transform HTTP data received via the QUIC protocol to relay to the first network protocol application circuitry 2420 as if received via TCP. In an embodiment, the third member 2414 may exchange information with a service provider that is capable of exchanging data via HTTP/TCP or HTTP/QUIC. In an embodiment, the context set of the second access context 2412 may constrain data exchanges with remote operating instances communicatively coupled to a node of the operating environment 2400 via HTTP/QUIC. In an embodiment, the context set of the second access context 2412 may constrain data exchanged between a node of the operating environment 2400 and a node that supports HTTP/QUIC but not HTTP/TCP.

FIG. 25 shows a system including an operating environment 2500 that may operate in performing one or more methods of the subject matter of the present disclosure, such as a method of flow chart 2300. FIG. 25 shows that operating environment 2500 includes a network interface 2502 such as described above with respect to FIG. 24. System 2500 may include one or more layers of network stack circuitry 2504 for communicating via a data transmission medium (not shown) communicatively coupled to operating environment 2500 via the network interface 2502. A first access context 2506 may be defined that includes an operating first application 2508 as a member and includes a first thread of a second application 2510 as a member. The operating first application 2508 may include a computing process, that may include one or more threads of execution. Any thread in the operating first application 2508 that operates in exchanging data via the network may be subject to a constraint specified for the first access context 2506. A second access context 2512 is illustrated that includes a second thread 2514 of the second application. The first thread 2510 when included in exchanging data via the network may be subject to a specified constraint of the first access context 2506. The second thread 2514 when included in exchanging data via the network may be subject to a specified constraint of the second access context 2512. FIG. 25 illustrates an access schedule 2516 that may define, via configuration data or via executable circuitry, a constraint for the first access context for accessing a resource of the network stack circuitry 2504. The access schedule 2516 may also define a constraint for the second access context 2512 for accessing a resource of the network stack circuitry 2504. The constraint for the first access context 2506 or the constraint for the second access context 2512 may allow or prevent access to the network, to network nodes, to protocols, to services or service levels based on a date, a time of day, a duration of access, or any other time-based criterion.

Other examples of resources that may be included in a context set of an access context include one or more of a network interface, a network protocol endpoint, circuitry included in an embodiment of a network protocol layer in a network stack, a network address space of a network protocol, a network address that may identify a network protocol endpoint, a memory buffer for storing data to transmit or receive via the network, a network path, a hop, a link included in a hop, or a network relay—to name some examples.

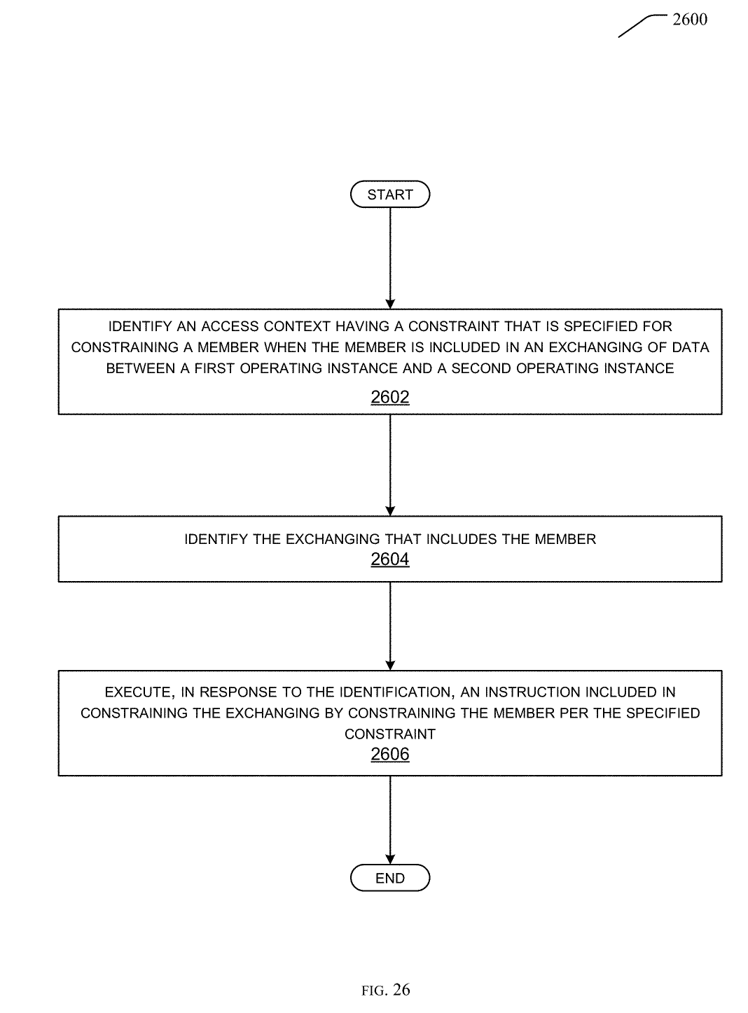

FIG. 26 shows a flow chart 2600 in accordance with an embodiment of a method of the present disclosure. In various embodiments, circuitry may be included in a system or circuitry may be provided that is operable for use with a system included in performing a method of flow chart 2600. At block 2602 in flow chart 2600, the circuitry may operate in identifying an access context having a constraint that is specified for constraining a member when the member is included in an exchanging of data between a first operating instance and a second operating instance. At block 2604, the circuitry may operate in detecting the exchanging that includes the member. At block 2606, the circuitry may operate in executing, in response to the detection, an instruction included in constraining the exchanging by constraining the member per the specified constraint.

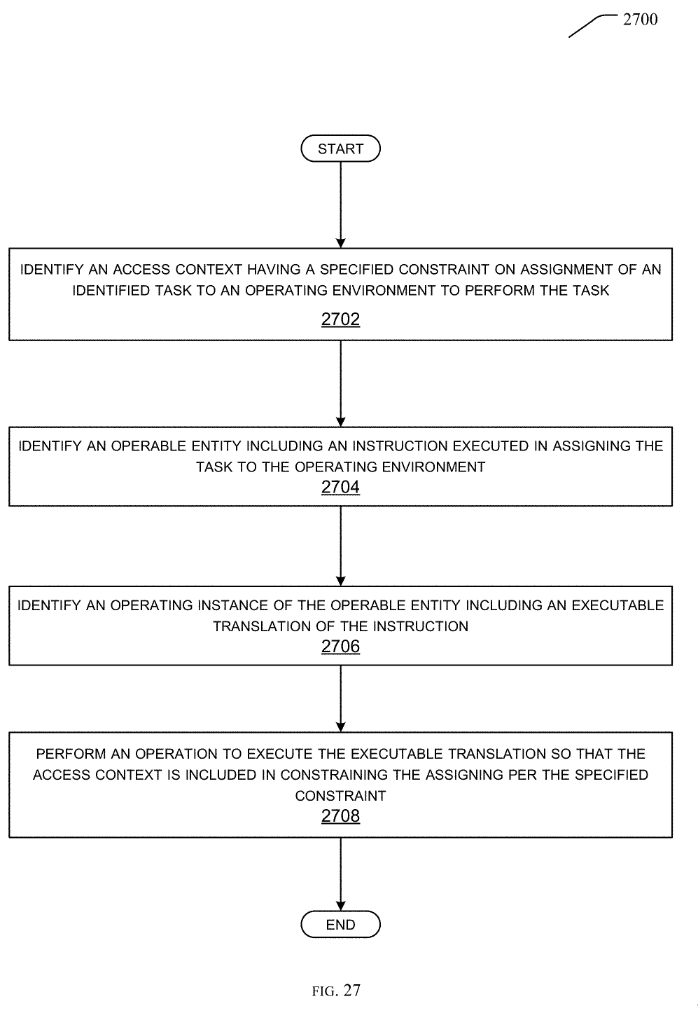

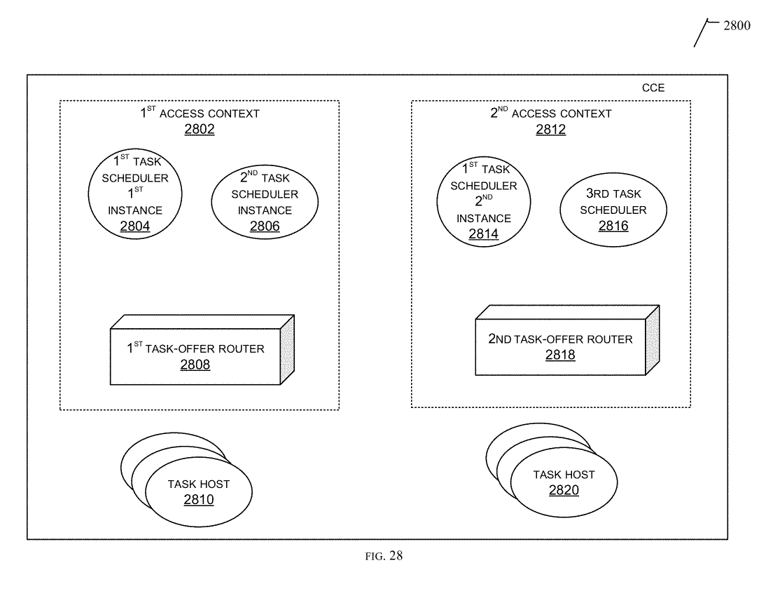

FIG. 27 shows a flow chart 2700 in accordance with an embodiment of a method of the present disclosure. In various embodiments, circuitry may be included in a system or circuitry may be provided that is operable for use with a system included in performing a method of flow chart 2700. At block 2702, the circuitry may operate in identifying an access context having a specified constraint on assignment of an identified task to an operating environment to perform the task. At block 2704, the circuitry may operate in detecting an operable entity. The operable entity includes an instruction that is executed in assigning the task to the operating environment. At block 2706, the circuitry may operate in identifying or detecting an operating instance of the operable entity including an executable translation of the instruction. At block 2708, the circuitry may operate in performing an operation to execute the executable translation so that the assigning is constrained per the specified constraint of the access context.

In an embodiment in a cloud operating environment, a scheduler may receive task information identifying a first task. The first task may be included in processing a request from a user or client of a network service. The network service may be provided in whole or in part via an cloud operating environment. The client may be associated with a one or more quality of service parameters based on one or more attributes of the client, such as client account size or based on a contractual obligation. A scheduler for the task may be a member an access context having a context set that includes resources suitable for meeting the requirements of the client. A resource may be included, excluded, added as needed, removed, or modified based on one or more criteria such as a measure of utilization, a measure of performance, a measure of security, or a measure of reliability. A second task for a different client may be sent to a scheduler operating as a member of different access context or not operating as a member of any access context. A task may be provided to a scheduler operating as a member of an access context or operating. Alternatively or additionally, a scheduler with a task to assign may be added to an access context or may be removed from an access context. A scheduler for a task may be selected, a scheduler may be added as a member of an access context, a scheduler may be removed as a member of an access context, or an access context of a scheduler may be modified based on an indicator of trust (e.g. of a requesting client) associated with a task, based on a type of task (e.g. a search, a data exchange via a network, a payment, and so forth), based on an measure of data processed in performing a task, based on a cost or other financial measure associated with a task, based on an attribute of physical object identified in a task (e.g. a dimension or a weight), a geospatial location of an object associated with the task, or based on a stage of workflow in which a task may be included or shipping weight) of a transaction, access context based on stage in a transaction or other workflow (e.g. browsing, adding to an online cart, paying, shipping, return, etc.). The foregoing list is not intended to be exhaustive.

FIG. 28 shows a system including a cloud computing environment (CCE) 2800 that may operate in performing one or more methods of the subject matter of the present disclosure, such as a method of flow chart 2700. FIG. 28 shows that system 2800 includes a first access context 2802. A first instance of virtual circuitry 2804, for a first task scheduler operable entity (not shown), that operates to assign or schedule one or more tasks to perform, is shown as a member of the first access context 2802. A second instance of circuitry 2806, for a second task scheduler operable entity (not shown), that operates to assign or schedule one or more tasks to perform is also shown as a member of the first access context 2802. Code or circuitry, in an embodiment for the second task scheduler operable entity may support multiple instances operating in a cloud computing environment. An embodiment, may not allow multiple instances of a same operable entity. A first task-offer router operating instance 2808 may be included in a context set (not shown) of the first access context 2802. Members of the first access context 2802 may be constrained to requesting task assignment via the first task-offer router 2808 which may constrain task hosts 2810 that may be accessed for performing a task assigned by a scheduler in the first access context 2802. In an embodiment, task hosts 2810 may be associated with the first task-offer router 2808 via a third access context (not shown) which includes the first task-offer router 2808 as a member and includes the task host(s) 2810 in the third access context's context set. The one or more task hosts 2810 may provide task host environments for executing code to perform a task assigned by the first task-offer router 2808. FIG. 28 shows that system 2800 includes a second access context 2812. A second operating instance 2814 of virtual circuitry of the first task scheduler operable entity may be a member of the second access context 2812 as FIG. 28 illustrates. A third operating instance 2816 of a third task scheduler operable entity may also be a member of the second access context 2812. A second task-offer router operating instance 2818 may be included in a context set of the second access context 2812 as FIG. 28 illustrates. Members of the second access context 2812 may be constrained to assigning tasks to task host(s) 2820 by the second task-offer router operating instance 2818 accessible to the members of the second access context 2812 per the context set of the second access context 2812. The second task-offer router operating instance 2818, like the first task-offer router operating instance 2808, may further constrain task assignment based on task hosts 2820 accessible to the second task-offer router operating instance 2818. The one or more task hosts 2820 may provide task host environments for an operating instance that executes an instruction to perform a task assigned by the second instance 2814 of the first task scheduler operable entity, in an embodiment. With respect to the first instance 2804 of the first task scheduler operable entity and the second instance 2814 of the first task scheduler operable entity, each instance may be realized as virtual circuitry via a processor executing first task scheduler code. Each instance may operate in a different process, a different device, or a different operating environment hosted by cloud operating environment 2800. Each instance may operate via a same or different processor(s) in a same or different device in a same or different operating environment. For additional details about “offer-based”computing environments, which are within the scope of the present disclosure see, by the present inventor, U.S. Provisional Patent Application No. 62/964,868, titled “Offer-based Computing Environments”, filed on Jun. 6, 2016.

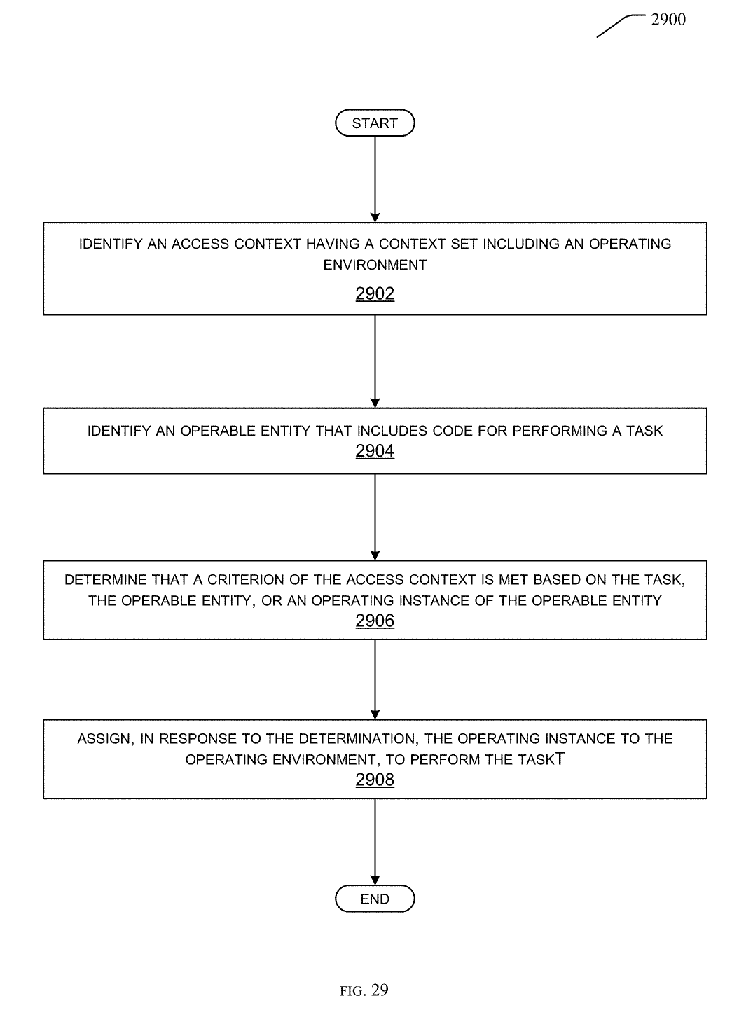

FIG. 29 shows a flow chart 2900 in accordance with an embodiment of a method of the present disclosure. In various embodiments, circuitry may be included in a system or circuitry may be provided that is operable for use with a system included in performing a method of flow chart 2900. At block 2902, the circuitry may operate in identifying an access context having a context set including or otherwise identifies an operating environment. At block 2904, the circuitry may operate in identifying an operable entity that includes code for performing a task. At block 2906, the circuitry may operate in determining that a criterion of the access context is met based on the task, the operable entity, or an operating instance of the operable entity. At block 2908, the circuitry may, in response to determining that the criterion is met, operate in assigning, the operating instance to the operating environment, to perform the task.

An operating instance may be a member of an access context based on a task that the operating is included in performing. The operating instance may be assigned before the operating instance. The operating instance, per the context set of the access context, may be assigned to an operating environment in which the operating instance may be created to perform the task. In an embodiment, a first portion of an operating instance may be in an access context in a first operating environment. A second portion of the operating instance may be in a second operating environment identified via context set of the access context. The task may be assigned to the second operating environment per the context set, at least a portion of the task is performed by the second portion. The first portion may be constrained by the access context to invoking the second portion in the second operating environment. In an embodiment, an access context for a task may be created so the task may be assigned to the access context to be performed per a constraint of the access context. Alternatively or additionally, an access context may be modified as part of assigning a task or other operating instance to the access context. Alternatively or additionally, an access context may be modified in response to adding a task or other operating instance as a member of the access context. For example, a task assigned may be assigned to an operating environment that may be modified (e.g. by another access context) to may be performed based on a user or client that requested the task. In another example, an access context that matches one or more security criteria configured by or for the client may exist, may be created, an existing access context may be modified per the needs of particular data that is processed in a performing of the task.

An access context in a cloud computing environment may be utilized in allocating cloud, in sharing resources, in prioritizing access to a resource, in managing resource utilization, in managing energy utilization or production, in managing security, in geographic distribution of task performance, or in assembling operating instances and other resources for a specified purpose or type of task. Access contexts may be utilized to customize task assignment based on cloud operating environment customers, client devices, or task types—to name some examples.

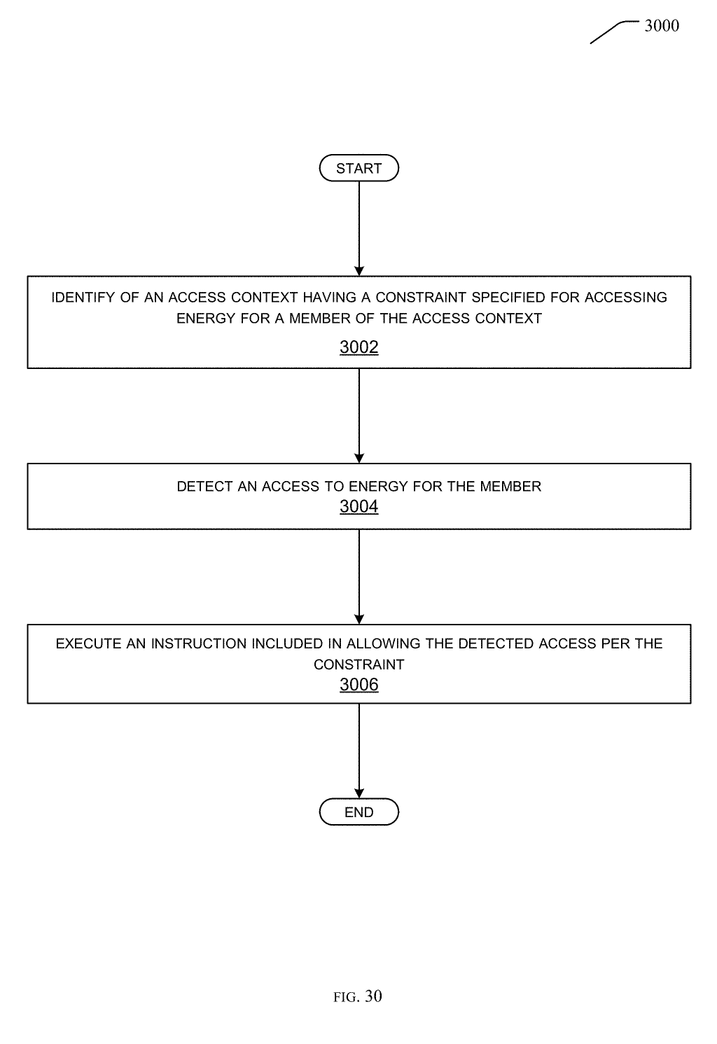

FIG. 30 shows a flow chart 3000 in accordance with an embodiment of a method of the present disclosure. In various embodiments, circuitry may be included in a system or circuitry may be provided that is operable for use with a system included in performing a method of flow chart 3000. Such a system may include a source of energy, an operable entity, and a memory. At block 3002, the circuitry may operate in identifying an access context. The access context may be specified by data stored in one or more locations in the memory. The data may associate a member set and a context set with the identified access context. One or more resources of the context set may be included in a constraint or may be processed in enforcing the constraint. The constraint may specify a constraint on energy accessible by or for a member in the member set. At block 3004, the circuitry may operate in detecting an access to energy by or for the member. At block 3006, the circuitry may operate in executing an instruction to constrain the access according to the specified constraint.

A context set of an access context may identify an energy source, an energy generator, an energy converter, an energy transformer, and the like to control an amount, a rate, a quality measure, a type, or a source of energy to operate in or to affect an access to energy by a member of the access context. Further, a context set may include a time, a duration, or other criterion for determining when any of the forgoing resources may be accessed for or by a member of the access context. In an embodiment, an operating instance may be allowed to access power only from an electricity grid external to a system of the operating instance, an operating instance may be allowed to access power from a battery in a system of the operating instance when a duration of available power accessible from the battery exceeds a specified threshold, an operating instance may be allowed to access power from a battery in a system of the operating instance when a temperature of a battery is behold a specified temperature, an operating instance may be allowed to access power from a specified source when an amount of power accessible via an electricity transmission medium meets a criterion based on one or more attributes of electrical energy such as amps, volts, etc.; an operating instance may be allowed to access power or a specified amount of power when a measure of waste heat is emitted below a specified rate where the waste heat is emitted by hardware in the operating instance or that is accessed by or for the operating instance. In another embodiment, an access context may allow power to be accessed by or for a first operating instance while power is accessed by or for a second operating instance or in response to an accessing of power by or for the second operating instance.

For example, a media streaming device (i.e. a first operating instance) and a media presentation device (i.e. a second operating instance) may be placed in an access context so that when one receives power the other receives power.

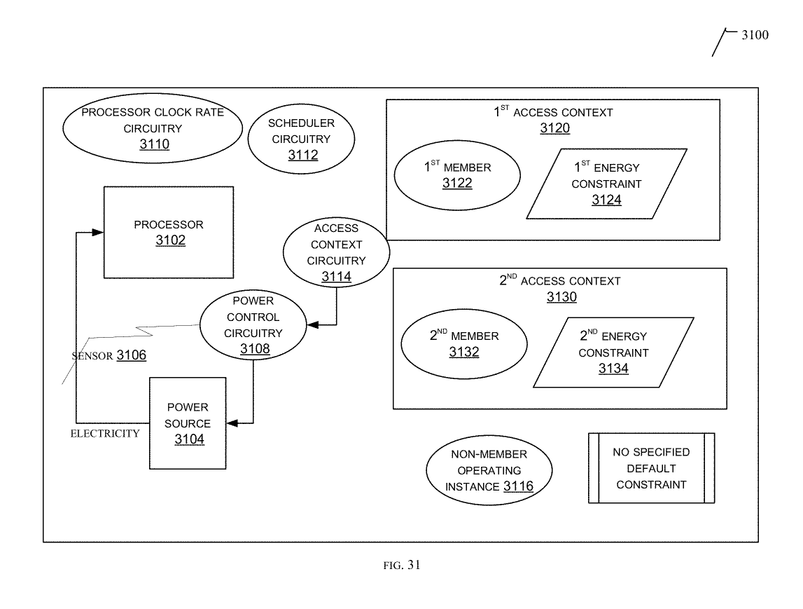

FIG. 31 shows a system 3100 that may operate in performing one or more methods of the subject matter of the present disclosure, such as a method of flow chart 3000. FIG. 31 shows that system 3100 includes a processor 3102. The processor 3102 may operate utilizing electrical energy received from a power source 3104. The power source 3104 may include an external source (e.g. accessible via an electrically conductive cord) or an internal source (e.g. a battery or generator). The power source 3104 may store energy to provide electrical energy or the power source 3104 may generate electrical energy by converting motion, heat, or some other form of energy received by the power source 3104 to electrical energy. A sensor 3106 is illustrated that may operate in determining one or more measures of electrical energy transferred from the power source 3104 to the processor 3102. Power control circuitry 3108 may receive one or more signals from the sensor 3106 to receive a measure or to determine a measure based on data communicated via the one or more signals. Power control circuitry 3108 may also interoperate with power source 3104 to modify or control power utilized by the processor 3102. Scheduler circuitry 3112 may be included to control utilization of the processor 3102 in operatings of various operable entities, such as processes or threads. Access context circuitry 3114 may be generated from instructions written in a programming language to access data or code of an access context during an operating, of an operable entity, that is a member of the access context. FIG. 31 illustrates a first access context 3120 that may be defined by data or code stored in a memory (not shown) accessible to the system 3100. The first access context 3120 may be specified to identify a first member 3122 and a first energy constraint 3124. The first energy constraint 3124 may be, may include, or may be realized via a context resource in a context set of the first access context 3120. Alternatively or additionally, the context set of the first access context 3120 may specify a type of energy as a resource included in the context set, a time for allowing access, a time for providing energy for a member, and so on. FIG. 31 illustrates a second access context 3130 that may be defined by data or code stored in a memory (not shown) accessible to the system 3100. The second access context 3130 may be specified to identify a second member 3132 and a second energy constraint 3134. The constraint may be realized as a location in a memory that identifies a user. The location of the data may be in the context set of the second access context 3130. The second access context 3130 may allow or provide energy for the second member 3132 when a user identified via the constraint matches a user interacting with the system 3100. Still further, FIG. 31 illustrates an operating instance 3116 that is not a member of an access context that has no constraint specified for controlling access to energy. The non-member operating instance 3116 may include circuitry of an operable entity including code translated from source code written in a programming language or may include operating hardware such a network adapter, a memory device, and so on.

In an embodiment, when scheduler circuitry 3112 determines that a duration of operation of the processor 3102 is to be assigned to an identified operating instance, access context circuitry 3114 may receive data, based on the determination, that identifies the operating instance. Access context circuitry may determine whether the operating instance is a member of one or more access contexts or not. If an operating instance is a member of an access context, one or more constraints of the access context may be applied. In FIG. 31, access context circuitry 3114 may interoperate with power control circuitry 3108 to apply a constraint specified in a context set of an access context.

FIG. 31 illustrates at least two exemplary mechanisms for applying an energy constraint for energy accessed by a processor 3102 by or for an operating instance. In an embodiment, power control circuitry 3108, may detect a current measure of power provided to or accessed by the processor 3102 from the power source 3104 based on data received from sensor 3106. Operation of the power source 3104 may be modified by a signal sent from power control circuitry 3108 based on the current measure and the specified constraint. Energy provided from power source 3104, sent to the processor 3102, or received by the processor 3102 may be modified per the constraint based on the current measure or measures detected, determined, or identified. In an embodiment, a change in electrical energy may result in a signal from the processor 3102 to circuitry that controls one or more resources of the processor 3102. Processor clock rate circuitry 3110 is shown, illustrating an example processor resource. Processor clock rate circuitry 3110 may monitor or modify the clock rate of the processor 3102 in response to a change in electrical energy received. Alternatively or additionally, power control circuitry 3108, may detect one or more resources of the processor, such as a processor clock rate, via an interoperation with processor clock rate circuitry 3110. A current measure of power may be determined directly or indirectly based on one or more current processor resources. Electrical energy received or utilized by the processor 3102 may be modified or not based on the current processor resource data and the specified constraint.

Electrical energy received or utilized by the processor 3102 may be modified by changing a processor resource. In an embodiment, an amount of power received or utilized by a processor 3102 may be increased or decreased by the power control circuitry 3108 interoperating with the processor clock rate circuitry 3110 to, respectively, increase or decrease the clock rate of the processor 3102. In an embodiment, a power mode resource of the processor may be modified. In an embodiment, a resource or operation of the power source or of an electricity conducting medium may be modified by changing one or more processor resources. Slowing the clock rate of the processor 3102 may change an amount of power accessed by the processor 3102. In response, the power source 3104 may change a rate at which the power source 3104 receives non-electrical energy to be converted to electrical energy. Alternatively or additionally, a power source that generates excess electrical energy as a result of a constraint on a processor resource may transfer electrical energy to be stored for later use. A battery in the system or external to the system may store the energy in various embodiments.

A system may include specified default data, default circuitry, or default hardware that is accessible to an operating instance in the system. An access context may modify access to the default, substitute a different resource than the default, or prevent access to the default for any compatible resource with respect to the operating instance.

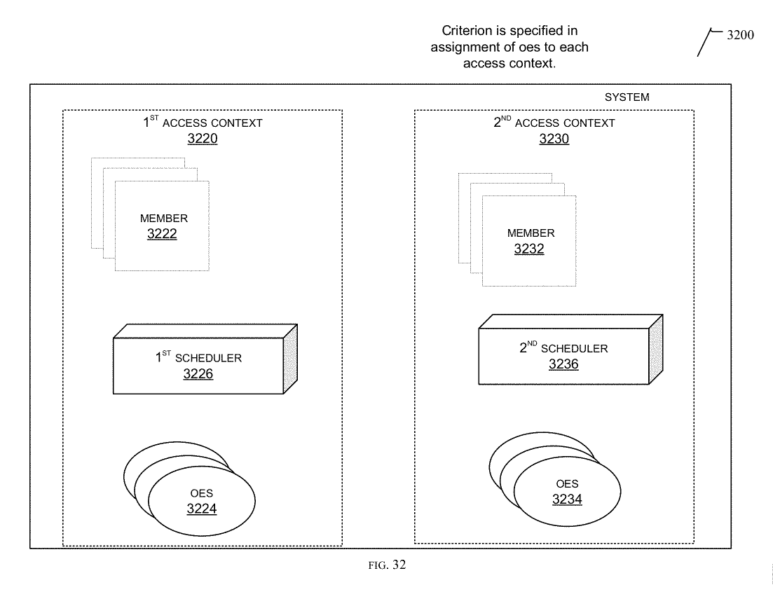

FIG. 32 shows a system 3200 that may operate in performing one or more methods of the subject matter of the present disclosure, such as a method of flow chart 3000. FIG. 32 shows that system 3200 includes a first access context 3220 with data that identifies one or members 3222 of the first access context 3220. A context set of the first access context 3220 may, as shown, include one or more operating environments 3224 for a member 3222. A member may access one or more resources of an operating environment 3224 to which the member is assigned. In an embodiment, an operation environment in the operating environments 3224 in the context set may constrain access to one or more resources differently that another operating environment in the operating environments 3224. In an embodiment, a resource may be shared by members 3222 of the first access context 3220. Power, is an example, of a resource that may be shared. Each member 3222 may be constrained by an amount of power available via an operating environment 3224 of the first access context 3220. A member 3222 may be further constrained by operation of a first scheduler 3226 that may operate to assign a member 3222 to an operating environment in the operating environments 3224. Alternatively or additionally, a first scheduler 3226 may allocate a duration that a member may operate in an operating environment of the operating environments 3224. System 3200 also illustrates a second access context 3230 that may also include one or more operating environments 3234 in the context set of the second access context 3230, as shown. The second access context 3230 may include a second scheduler 3236 to assign, monitor, or control assignment of members 3232 of the second access context to the various operating environments 3234. In an embodiment, power may be shared between members of both the first access context 3220 and the second access context 3230. The power may be shared indirectly via an operation of the operating environments 3224 and the operating environments 3234. Power may, alternatively or additionally, be shared directly via hardware and software that controls flows of electrical energy to or among hardware of the operating environments 3224 and the operating environments 3234. In an embodiment, the first access context 3220 may be assigned a measure of power and the second access context 3230 may be assigned a measure of power. The respective measures may serve as constraints on the members 3222 of the first access context 3220 and the members 3232 of the second access context 3230. A third access context (not illustrated) may be specified that includes an instance of the first access context 3220 and an instance of the second access context 3230 as members. The measures of power may be specified constraints of the third access context. All or a specified portion of the power available to the system 3200 may be specified in the context set of the third access context as accessible to members (the member access context) of the third access context.

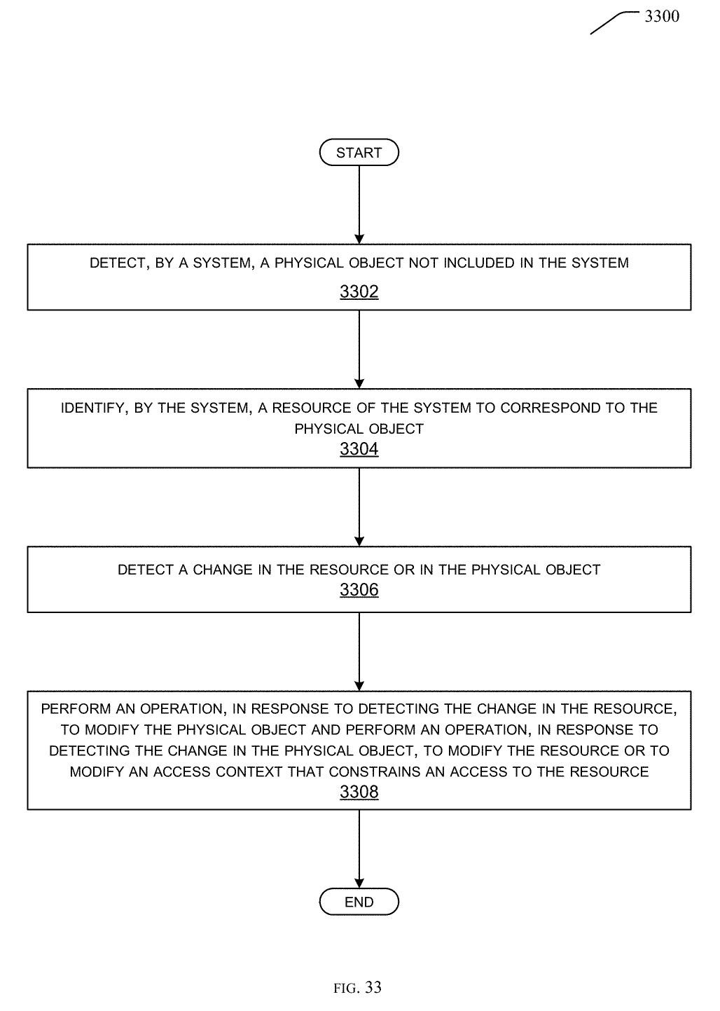

Augmented reality output spaces are described above. A physical object external to a system may be accessible as a resource of the system (such as a device or an arrangement of devices). Alternatively or additionally, a system may interoperate with a physical object not included in the system. FIG. 33 shows a flow chart 3300 in accordance with an embodiment of a method of the present disclosure. Circuitry may be included in an embodiment or a method may include providing circuitry that is operable for use with a system included in performing a method of flow chart 3300. Such a system may include at least one device of at least one operating environment. At block 3302, the circuitry may operate in detecting a physical object. The physical object may not be included in or may not be a part of a system that performs a method of flow chart 3300. The physical object may be user detectable via an interaction between the user and the system via an input device of the system, an output device of the system, or a network device of the system. At block 3304, the circuitry may operate in identifying a resource, of the at least one operating environment, to represent or to otherwise correspond to the physical object. In an embodiment, the resource may include one or more of a user interface element, a device, a network protocol endpoint included in a communicative coupling with the physical object, an input device interacting or interoperating with the physical object, an output device interacting or interoperating with the physical object, data stored in a memory of the system such as metadata for the physical object, or any other suitable resource. At block 3306, the circuitry may operate in detecting a change in one or more of the resource or the physical object. At block 3308, the circuitry may operate in modifying, based on the change, the other one of the one or more of the resource and the physical object.

For example, a measure of light emitted or received by some or all of a physical object may change. In response, a visible attribute of a user interface element representing the physical object may be changed. Alternatively or additionally, a location of a resource in a system that corresponds to the physical object may be changed. (e.g. the resource may be moved from a first memory location to a second memory location). In response, a signal may be sent by the system to the physical object to move the physical object or may be sent to a device or a uses that operates to move the physical object. Alternatively or additionally, a surface of a physical object may change so that it is accessible to a system for presenting a user interface element. In response, the system may present the user interface element on or via the surface. A surface may an opaque surface, a mirror, a lens, or may be at least partially transparent such as a window.

In an embodiment, a physical object may represent itself in an e-space of a system. The physical object may represent itself in addition to or instead of being represented by a resource of the system.

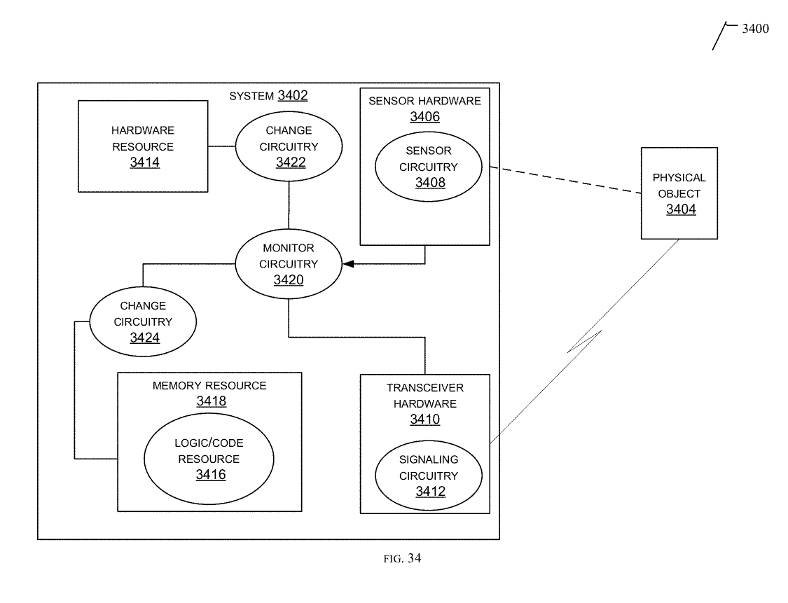

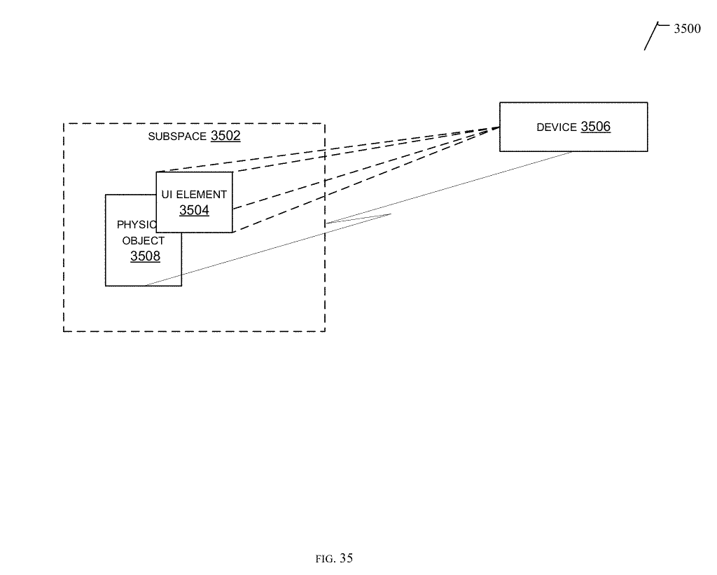

FIG. 34 shows an arrangement 3400 that includes a system 3402 that may operate in performing one or more methods of the subject matter of the present disclosure, such as a method of flow chart 3300. FIG. 34 shows that the arrangement 3400 includes a physical object 3404. The system 3402, as illustrated, may include sensor hardware 3406, sensor circuitry 3408, transceiver hardware 3410, signaling circuitry 3412, a hardware resource 3414, a code resource 3416, a memory resource 3418, monitor circuitry 3420, change circuitry 3422, or change circuitry 3424.

A physical object 3404 may be detected via various mechanisms. System 3400 illustrates several such mechanisms. Sensor hardware 3406 may include an optical sensor such as a visible light camera. Alternatively or additionally, sensor hardware 3406 may include an infrared camera. Each camera may be capable of detecting a form of energy in the electromagnetic spectrum. Alternatively or additionally, sensor hardware 3406 may detect x-rays, microwaves, or other types of electromagnetic energy. Sensor hardware 3406, in an embodiment, may be included to detect thermal energy other than infrared energy. For example, sensor hardware 3406 may include a thermometer. Sensor hardware 3406 may include thermal conducting material to transfer heat to a heat sensor. Still further, sensor hardware 3406 may include a motion detecting device. A motion detecting device may detect velocity or acceleration as part of detecting motion. Those skilled in the art will understand that many other types of sensors, passive or active, exist and will be created that will be suitable for including in a system to detect a physical object. Sensor hardware 3406 may include sensor circuitry 3408 as shown. Note that transceiver hardware 3410 may operate as a sensor for detecting a physical object in an embodiment. Alternatively or additionally, a system 3402 may include circuitry that receives sensor data to transform to a form, such as a digital signal or an analog signal, suitable for providing to one or more other components of the system 3402 as input. FIG. 34 illustrates sensor circuitry 3408 that may covert data detected from or about physical object 3404, by sensor hardware 3406 to send data about the physical object 3404 to monitor circuitry 3420. When operating as a sensor, signaling circuitry 3412 may convert a signal received by a network to input data for monitor circuitry 3420. In an embodiment, monitor circuitry 3420 may be realized as virtual circuitry by a processor (not shown) in the system 3402 executing machine code translated from source code including instructions for identifying and detecting changes to one or more physical objects based on input data received via one or more sensors interoperating with one or more physical objects. In an embodiment, a physical object may provide data that is predefined for identifying the object. The physical object 3404 may transmit the data or the data may be accessed from the physical object 3404. For example, data may be in, on, or near a physical object. That data may be readable or otherwise detectable via a sensors and suitable sensor circuitry such as optical character recognition (OCR) circuitry, bar code circuitry, and the like. Examples of detectable physical objects, include a person or part of a person such as a face, an article of furniture, an automotive vehicle, a home appliance, a wall, a floor, a light, a computing device, a network device, or a data storage device. Sensor circuitry 3408 may identify a physical object, part of a physical object, an arrangement of physical objects (that may or may not interoperate or which otherwise may be associated or grouped). Alternatively or additionally, monitor circuitry 3420, may identify a physical object, part of a physical object, an arrangement of physical objects based on input data received from one or more sensors.

Monitor circuitry 3420 may further identify a resource of the system or a resource accessible, directly or indirectly, to the system and that is or may be associated with the physical object 3404. In an embodiment, the resource may identify, represent, or correspond with the physical object 3404 or a part of the physical object 3404. In FIG. 34, monitor circuitry 3420 may create or may identify a correspondence between the physical object 3404 and a hardware resource 3414. For example, a physical object may have a surface suitable for presenting an output projected by projection hardware. A physical object may have a size, a shape, a color, or other attribute that may each or as a group correspond to a stored value such as in a structure stored in a memory resource 3418. The location in the memory resource 3418 may correspond to at least an attribute of the physical object 3404. Monitor circuitry 3420 may, based on a detected attribute of a physical object, identify code 3416 stored in a memory (see 3418). The code may be accessed by a processor and executed to create an operating instance of virtual circuitry that operates in response to detecting some or all of the physical object 3404, that operates in response to identifying a change in the physical object 3404 or a change in another resource that corresponds to the physical object 3404, that operates to associate or bind the physical object 3404 to another object that may be physical or virtual, or that operates to interoperate with the physical object 3404, or that allows a user to interact with the physical object 3404—to name some examples.

In system 3402, a change to the physical object 3404 may be detected via a sensor (see sensor hardware 3406 and sensor circuitry 3408), via an exchange of data between the physical object 3404 and the system 3402 (e.g. via transceiver hardware 3410 and signaling circuitry 3412, via sensor hardware 3406 and sensor circuitry 3408, or via a user interacting with the system 3402 and the physical object 3404). A change to a resource that corresponds to the physical object 3404 may be detected via change circuitry that accesses the corresponding resource, directly or indirectly. Change circuitry may be realized in numerous forms. In an embodiment, change circuitry 3422 may include a data exchange medium such as a bus, a network cable, a wireless medium, and so forth. A change to hardware resource 3414 may, in an embodiment, result in a signal sent from the hardware resource 3414 to monitor circuitry 3420. In an embodiment, change circuitry 3422, may include virtual circuitry of a subscriber to an event source. Hardware resource 3414 may include circuitry that publishes events in response to a change in some or all of hardware resource 3414. In an embodiment, change circuitry 3422, may include virtual circuitry that requests data from hardware resource 3414 to detect a change. In an embodiment, change circuitry 3422, may be included in or may interoperate with a sensor that detects a physical attribute of a hardware resource to detect a change to the hardware resource. In an embodiment, change circuitry 3422 may include one or more circuits that operate in changing the hardware resource 3414 in response to a detected change in or to the physical object 3404 or a part of the physical object 3404. Still further, in an embodiment, change circuitry 3422 may include one or more circuits that operate interoperate with monitor circuitry 3420 to send a signal to the physical object 3404, a user, or another device to change an attribute of the physical object 3404 in response to detecting a change in a resource 3414 that represents or otherwise corresponds to the physical object 3404 or a part of the physical object 3404. Monitor circuitry 3420 may send a signal via interoperating with a sensor (see sensor hardware 3406 and sensor circuitry 3408). Alternatively or additionally, monitor circuitry 3420 may send a signal via interoperating with transceiver hardware 3410 or signaling circuitry 3412. In an embodiment, change circuitry 3424, may be included in or may interoperate with a sensor, such as sensor hardware 3406 or transceiver hardware 3410 via monitor circuitry 3420, that may detect a change to physical object 3404 or a change to data about a physical object 3404. Change circuitry 3424 may also interoperate with memory resource 3418 to detect a change in a resource 3416 that represents or that otherwise corresponds to a physical object 3404. In an embodiment, change circuitry 3424 may include one or more circuits that operate in changing a resource 3416 in response to a detected change in or to a corresponding physical object 3404 or a part of the physical object 3404. Still further, in an embodiment, change circuitry 3424 may include one or more circuits that interoperate with monitor circuitry 3420 to send a signal to a physical object 3404, a user, or another device to change an attribute of the physical object 3404 in response to detecting a change in a resource 3416 that represents or otherwise corresponds to the physical object 3404 or a part of the physical object 3404.

In system 3402, the physical object 3404 may be modified via a sensor (see sensor hardware 3406 and sensor circuitry 3408), via an exchange of data between the physical object 3404 and the system 3402 (e.g. via transceiver hardware 3410 and signaling circuitry 3412, or via a user interacting with system 3402 and the physical object 3404). A resource that corresponds to the physical object 3404 may be modified via change circuitry that accesses the corresponding resource, directly or indirectly. Change circuitry may be realized in numerous forms. In an embodiment, change circuitry 3422 may include a data exchange medium such as a bus, a network cable, a wireless medium, and so forth. A modification to hardware resource 3414 may, in an embodiment, be made via a signal sent from the monitor circuitry 3420 to the hardware resource 3414 via change circuitry 3422. In an embodiment, change circuitry 3422, may include virtual circuitry of a notifier or publisher of data sent to hardware resource 3414 or a part of hardware resource 3414 that when processed, changes hardware resource 3414. Monitor circuitry 3420 or change circuitry 3422 may include circuitry that publishes events in response to a change in some or all of the physical resource 3404 or in another resource that corresponds to the physical resource 3404. In an embodiment, change circuitry 3422, may include virtual circuitry that receives request data from monitor circuitry 3420 or from sensor circuitry 3408. The request data may identify a change to make to the hardware resource 3414. Alternatively or additionally, request data provide to send a signal to change the physical resource 3404. The signal may be sent to the physical resource 3404, to a user to modify the physical resource, or to some other device capable of interoperating with physical resource to modify the physical resource.

TBD—describe some working examples. In an embodiment, the resource may include one or more of a user interface element, a device, a network protocol endpoint included in a communicative coupling with the physical object, an input device interacting or interoperating with the physical device, an output device interacting or interoperating with the physical device, data stored in a memory of the system such as metadata for the physical object, or any other suitable resource.

FIG. 35, illustrates an e-space 3500 including a subspace 3502. The subspace, as shown includes a user interface element 3504 presented via device 3506. The subspace 3502 may include a physical object 3508 not included in the device 3506. A device 3506 may include an output device that projects user interface element 3504 into subspace 3502. A or a, device 3506 may include an output device that overlays user interface element 3504 in a view of subspace. For example, UI element 3504 may be presented or projected onto a surface (e.g. a lens in user eyewear or headgear) through which a user may see physical object 3508. device 3506 may include an output device that includes, overlays, or underlays user interface element 3504 into image data (e.g. a video stream) of physical object 3508 in the e-space 3500. Further, instead of or in addition to any of the foregoing output devices in this paragraph, a device 3506 may include an input device, such an image capture device for capturing image data, such as just described in this paragraph. An input device, which may include a user input device or sensor for detecting physical object 3508 or information about physical object 3508, may include one or more of a thermal sensor, an audio sensor such as a sonar device (both an input and an output device), or TBD. ?????Physical object 3508 may include a surface for presenting user interface element. Physical object 3508 may include or be associated with machine readable data, such as data output physical object 3508. Exemplary data about physical object 3508 may include physical attribute data (e.g. a size, a weight, mass, speed, velocity, thermal data, a material, etc.), owner data, tax data, historical data, location data, error data, manufacturing data, task data, reservation or other usage data, price data, environmental data, medical data, packaging data, safety data, operating data, storage data, replacement data, inventory data, insurance data, or repair data—to name some examples.

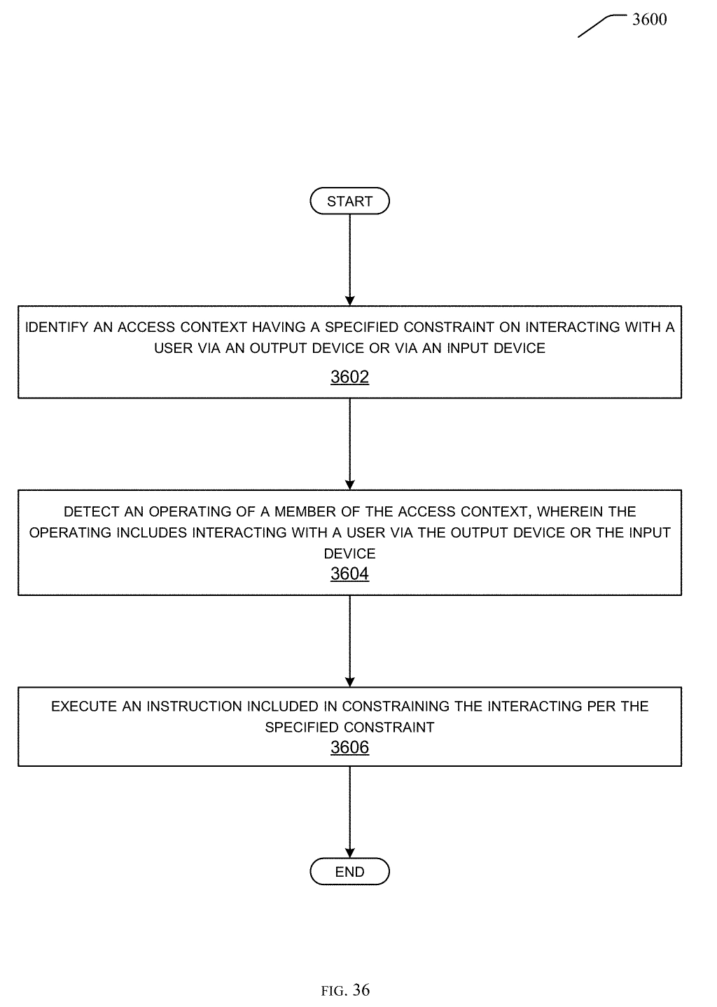

FIG. 36 shows a flow chart 3600 in accordance with an embodiment of a method of the present disclosure. In various embodiments, circuitry may be included in a system or circuitry may be provided that is operable for use with a system included in performing a method of flow chart 3600. Such a system may include an input device, an output device, and an output space. At block 3602, the circuitry may operate in identifying an access context having a specified constraint on interacting with a user via the output device or via the input device. At block 3604, the circuitry may operate in detecting a member of the access context. The operating includes interacting with a user via the output device or the input device. At block 3606, the circuitry may operate in executing an instruction included in constraining the interacting based on the specified constraint.

In an embodiment, an operating instance of an application may be included in an access context that constrains interacting with a user. The constraint may be based on one or more resources in a context set of the access context. For constraining the interacting, the context set may include or identify an input device, an output device, an input device driver, an output device driver, a time, a duration, an output space, a subspace, an attribute of a user interface element, another operating instance having a user interface, a user interface model, input data allowed, input data prohibited, conditions for allowing or prohibiting input data, output data allowed, output data prohibited, conditions for allowing or prohibiting output data, a rate of receiving input data, a rate of providing output data, a rate of responding to output in response to input, or a rate of input such as a maximum character input rate—to name some examples.

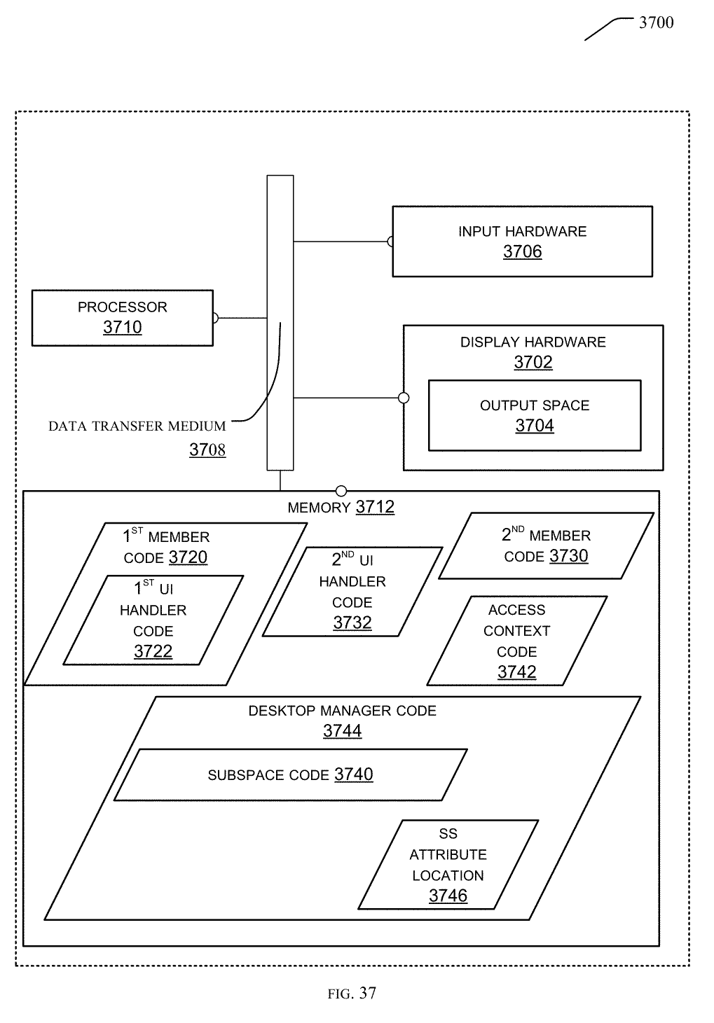

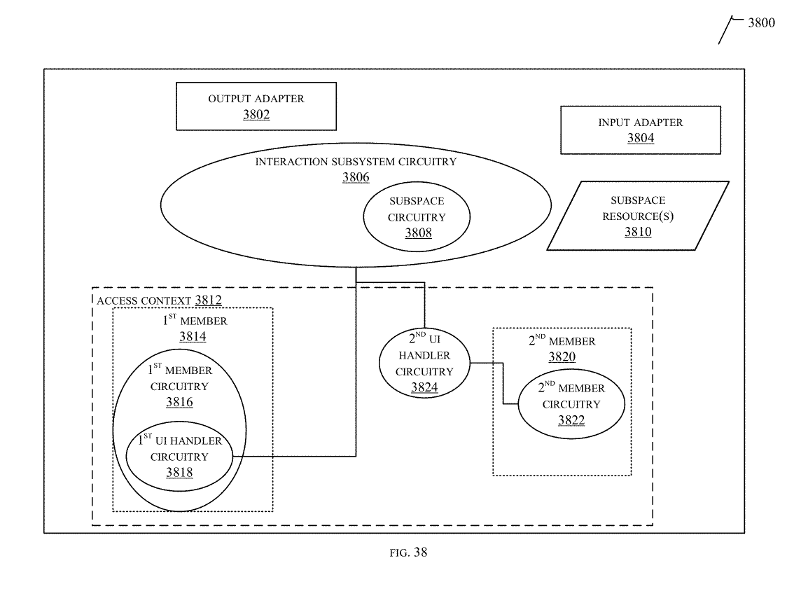

FIG. 37 shows a system 3700 configured to perform one or more methods of the subject matter of the present disclosure, such as a method of flow chart 3600. FIG. 37 shows that system 3700 includes display hardware 3702 included in an output device (not shown). Also, illustrated, is an output space 3704 of the display device that may be made visible to a user. System 3700 also illustrates an embodiment may include input hardware 3706 for interacting with a user in detecting user input. A data transfer medium 3708 allowing components of the system 3700 to exchange information is shown. System 3700, includes a processor 3710 for accessing code to execute to operate virtual circuitry translated from and specified via a programming language. The processor 3710 may access code from a memory 3712 via the data transfer medium 3708. Code for an operating instance specified as first member code 3720 may be stored in memory 3712 and accessed by processor 3710 via data transfer medium 3708 to operate virtual circuitry specified by the code 3720. Code of a first user interface handler 3722 may be included in or stored with the code for the first member code 3720. Code of the first user interface handler 3722 may be accessed and executed by processor 3710 to interact with a user by presenting a first user interface element of an operating instance of code 3720. Code 3730 for a second member of the access context may also be stored in a memory, which may have the same or a different address space than the memory of the first member code 3720. Code 3732 of a second user interface handler for interacting with a user by presenting a second user interface element of an operating instance of the second member code 3730 may also be stored in a memory. A memory of the system 3700 may also include code 3740 for creating and managing one or more subspaces. Access context code 3742 may be stored that when executed as virtual circuitry may associate user interface elements of members of an access context with a subspace in a context set of the access context. Subspace code 3740 may be stored with or referenced by code 3744 realized as virtual circuitry. In an embodiment, the virtual circuitry may manage a desktop presented in an output space 3704. Still further, the context set of the access context may include data 3746 stored in a memory for storing attributes of the subspace, such a location of the subspace in the output space 3704. The system 3700 may include code (not shown) for monitoring or accessing one or more other resources accessed by or for an operating instance having a user interface element in the subspace.

FIG. 38 shows a system 3800 that may operate in performing one or more methods of the subject matter of the present disclosure, such as a method of flow chart 3600. FIG. 38 shows that system 3800 may include an output adapter 3802 for presenting output via an output device (not shown). System 3800 also is shown including an input adapter 3804 for receiving data in an interaction with a user. Interaction subsystem circuitry 3806 is shown that coordinates input and output interaction with a user. Examples of current subsystems that include interaction circuitry include WINDOWS PRESENTATION MANGER, UNIX X-WINDOWS, and LINUX GNOME DESKTOP. Circuitry 3808, that operates in interacting with a subspace located in a portion of an output space, may be included in, accessible to, or interoperable with interaction subsystem circuitry 3806. Subspace circuitry 3808 may access one or more subspace resources 3810 from a memory location (not shown) accessible in or by the system 3800. An access context 3812 may be realized by data and circuitry (not shown) that operates in the system 3800. A subspace may be in a context set of the access context 3812 with subspace circuitry 3808 operating in an interaction between a user and the subspace when located in a visible portion of an output space. FIG. 38 illustrates a first member 3814 in the access context 3812. The first member may include operating of virtual circuitry 3816 based on code for the first member. First user interface handler circuitry 3818 may operate to exchange information with interaction subsystem circuitry 3808. The interaction may be constrained via a value of one or more resources 3810 of the subspace in the context set of the access context for a user interface element of the first member 3814. FIG. 38 illustrates a second member 3820 in the access context 3812. The second member 3820 may operate via rformed via virtual circuitry 3822 for the second member. Second user interface handler circuitry 3824 may operate to exchange information with interaction subsystem circuitry 3808 in an interaction between a user and a user interface element of the second member 3820. In an embodiment, the interaction may be constrained via a value of one or more resources 3810 of the subspace in the context set of the access context 3812 for a user interface element of the second member 3820.

A user interface element or a user interface handler may be included in a context set of an access context. The user interface element or user interface handler may be accessed by or for a member of the access context. The user interface element or the user interface handler may be included in an interaction between a user and the member. The user interface element may include content provided by the member. The user interface element may be presented via an output device based on presentation information provided by or for the member. The user interface element may be included in a user interface of the member.

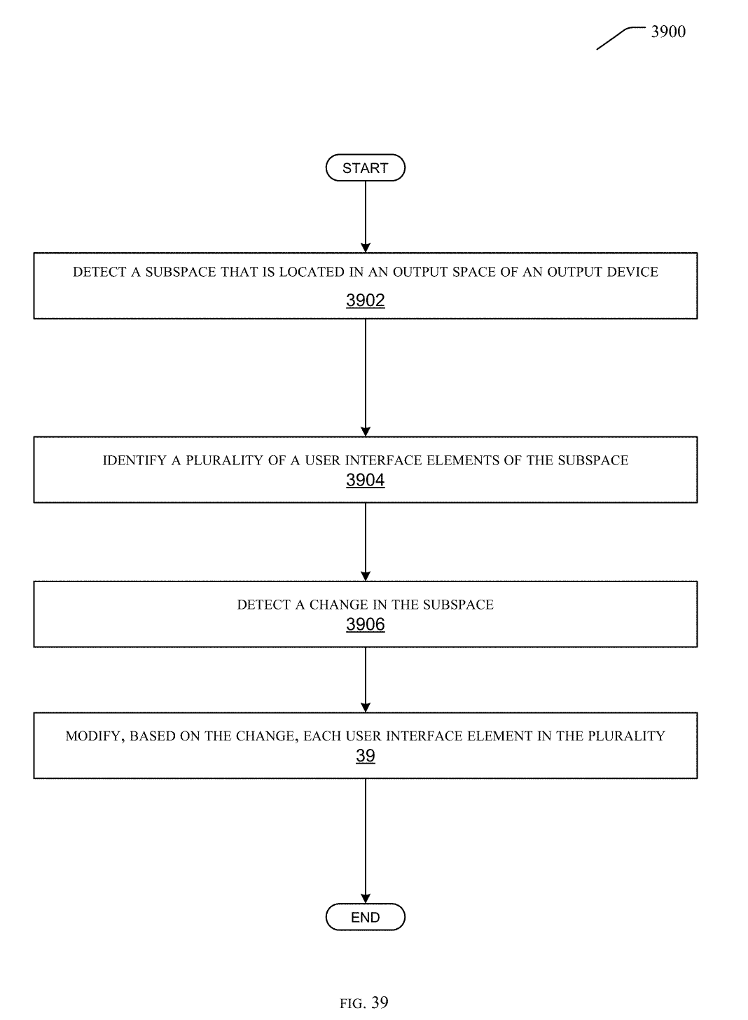

FIG. 39 shows a flow chart 3900 in accordance with an embodiment of a method of the present disclosure. Circuitry may be included in an embodiment or a method may include providing circuitry that is operable for use with a system included in performing a method of flow chart 3900. Such a system may include one or more devices of one or more operating environments. At block 3902, the circuitry may operate in detecting a subspace. Some or all of the subspace may be located in an output space of an output device of the one or devices or the one or more operating environments. At block 3904, the circuitry may operate in identifying one or more user interface elements of one or more operating instances. In an embodiment, the one or more operating instances may be members of the access context and the subspace may be in a context set of the access context. The subspace may represent the access context, in an embodiment. The user interface elements may represent respective members. At block 3906, the circuitry may operate in detecting a change in the subspace. With respect to the access context, the circuitry may operate in detecting a change in some other resource in a context set of the access context. The subspace may be a context resource. At block 3908, the circuitry may operate in modifying, based on the change, each operating instance. Subsequently, future operating instance(s) having a user interface element in the subspace may be modified, based on the change, in an embodiment. The modifying may include a user detectable change to each user interface element in the subspace. In an embodiment, a user interface element may represent a member of an access context or may include a representation of a resource accessed by or for a member such as a file accessed by a member.

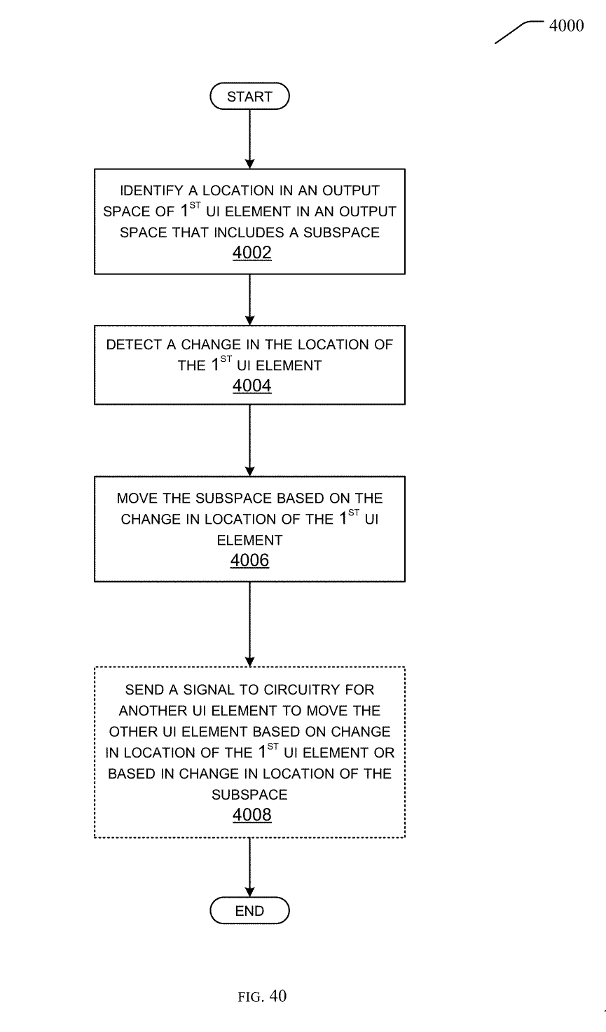

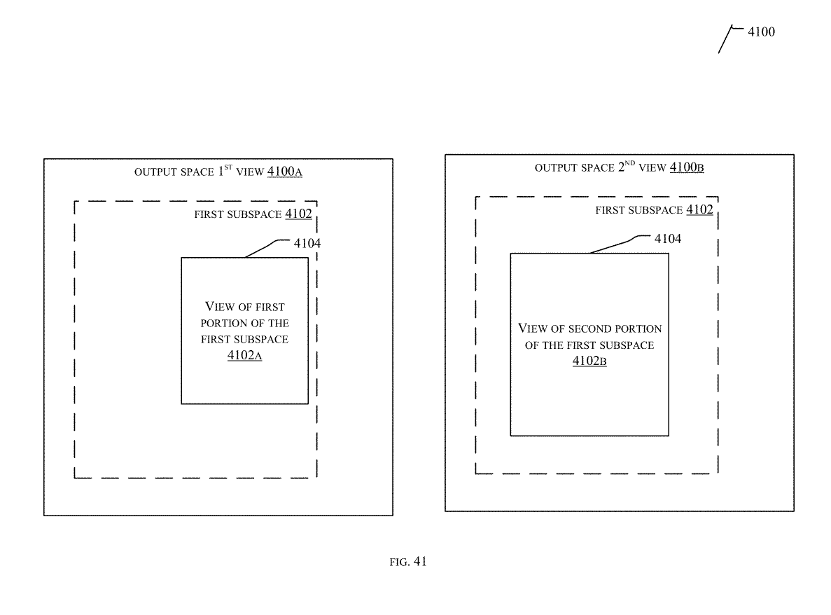

FIG. 40 shows a flow chart 4000 for processing a change in location of a user interface element in a subspace in accordance with an embodiment of the present disclosure. Data identifying a location of the subspace or a location of the user interface element may be a resource in a context set of an access context represented by the subspace. Alternatively or additionally, the subspace may be a resource in the context set. Circuitry may be included in an embodiment or may be provided that is operable for use with a system included in performing the flow chart 4000. Such a system may include one or more devices and one or more operating environments. At block 4002, the circuitry may operate in identifying a location in an output space of a first user interface element. The first user interface element may be in a subspace of the output space. Alternatively, the user interface element may not be in the subspace. At block 4004, the circuitry may operate in detecting a change in the location of the first user interface element in the output space. At block 4006, the circuitry may operate in moving the subspace in the output space, in response to the changed in location of the first user interface element. At block 4008, the circuitry may operate in sending a signal to move another user interface element in the output space based on the change in location of the first user interface element or based on the change in location of the subspace. The other user interface element may be in the subspace. Alternatively, the other user interface element may not be in the subspace.

Referring to system 3800 illustrated in FIG. 38 and to FIG. 9 described above, interaction subsystem circuitry 3806 or subspace circuitry 3808 may identify a subspace first location 908a in an output space 900 and may also identify a first user interface element first location 910a. Alternatively or additionally, subspace circuitry 3808 may detect the first user interface element first location 910a. In an embodiment, first user interface handler circuitry 3818 may detect the first user interface element first location 910a, or may identify a location of the subspace first location 908a. The second user interface element first location 912a may be located similarly by one or more of interaction subsystem circuitry 3806, subspace circuitry 3808, or second user interface handler circuitry 3822. In various embodiments, one or more of user interaction subsystem circuitry 3806, subspace circuitry 3808, or the first user interface handler circuitry 3818 may detect a change in the first user interface element location from the first user interface element first location 910a to a first user interface element second location 910b. In various embodiments, one or more of user interaction subsystem circuitry 3806 or subspace circuitry 3808 may operate in moving the subspace from the subspace first location 908a to a subspace second location 908b. In various embodiments, one or more of user interaction subsystem circuitry 3806, subspace circuitry 3808, or the second user interface handler circuitry 3822 may operate in moving the second user interface element from the second user interface element first location 912a to a second user interface element second location 912b. The second user interface handler circuitry 3822 may invoke (i.e. send a signal) one or more interfaces (e.g. APIs) of interaction subsystem to operate in the moving.

The moving may be performed automatically or may include interacting with a user. Moving a subspace may include presenting the subspace in motion. The motion may be in one or more directions or dimensions. A motion in one direction or dimension may be performed simultaneously with a motion in another direction or dimension. A motion in one direction or dimension may be performed prior to or after a motion in another direction or dimension.

In an embodiment, moving a subspace from a first location to a second location may include presenting the subspace in the second location as a result of the moving without presenting the subspace in an intermediate location subsequent to presenting the subspace in the first location prior and prior to presenting the subspace in the second location.

In an embodiment, input information may be received, in response to a user input detected via an input device. The input information may identify or otherwise associate a subspace or a location in a subspace with a user interface element. A record, structure, or other data may be accessed to store data that identifies the subspace and that identifies an operating instance of the user interface element. The stored data may identify an access context and may identify a member of the access context, directly or indirectly. In an embodiment, the stored data may identify the subspace or a location in the subspace and may identify the user interface element. In an embodiment, a context set of the access context may include one or more memory locations for storing data that identifies one or more attributes of the subspace such as a size, location in one or more dimensions, a transparency setting, a font, or one or more resources that may identify circuitry that performs one or more operations on the subspace, the context set, or the member set. In an embodiment, circuitry for one or more of the operations may detect a change to a resource. In response to detecting the change, one or more instructions may be executed in changing some or all of the members of the access context or in changing some or all of the user interface elements of the members in the subspace. For example, in response to detecting a change in size of the subspace, circuitry of the access context may invoke circuitry, such as an API of an interaction subsystem illustrated in FIG. 38 or an analog, to resize, relocate, or change some other attribute of one or more of the user interface elements in the subspace of members of the access context.

Adding an operating instance to an access context, in an embodiment, may include operating circuitry the interacts with a user to detect a user interface element in a user interface of an operating instance. For example, an interaction may include dragging and dropping a user interface element of an operating instance into a subspace that represents an access context. The operating instance may be added as a member to the access context, in response. A member may be removed from an access context via user interaction, such an interaction that includes ragging a user interface element of a member from a location in a subspace representing the access context to a location outside the subspace. Alternatively or additionally, a user interface element, that represents a boundary of a subspace representing an access context, may be moved so that a user interface element of an operating instance is in the subspace. In response, circuitry of the access context may store data to identify the operating instance as a member of the access context. A member may be removed from a subspace by moving a boundary so that a user interface element or user interface of the member is no longer in the subspace. Circuitry of the access context may delete data that identifies the operating instance as a member or may store data the indicates the operating instance is not presently a member.

Note that subspaces may intersect or overlap, which in an embodiment may allow an interaction similar those described in the previous paragraph to add an operating instance as a member to one or more access contexts or to remove an operating instance that is a member of more than one access context from one or more of the more than one access context.

As described, a subspace may have a boundary in an output space. Some or all of the boundary may be detectable to a user. For example, some or all of a boundary may be visible. Some or all of a boundary may be detectable via a change to a pointer, a user interface element of a member, or other output to indicate a location, which may be exact or approximate, of the boundary. Part or all of a boundary may be hidden at a first time and may be visible or otherwise detectable at a second time. Such times may be scheduled or may occur in response to detecting a specified event such as described in this paragraph. In an embodiment, input data may be specified to initiate presenting a visible indication of some or all of a boundary. Similarly, input data may be specified for making a visible indication of a boundary invisible (e.g. a boundary may be deleted, made fully transparent, or overlaid by one or more other user interface elements).

In an embodiment, a user input may interact via an input device to identify a first location in an output space. A measure of distance determined based on the first location and a second location of a subspace at least partially included in the output space may be determined or received. A boundary may be presented based on such a distance. Alternatively or additionally, an already visible boundary may be hidden based on such a distance. For example, a user may drag a user interface element in a subspace in a first direction. As the user interface element approaches a boundary of the subspace, a transparency attribute of the approached boundary may be lowered, so that the boundary becomes less transparent based on a distance between the user interface element and the boundary.

In an embodiment, the some or all of a boundary of an output space may be detectable to a user via an audio output device and or a haptic output device. For example, a user may resize a user interface element that is not in a subspace. As the size increases and the user interface element approaches, overlays, or intersects with the subspace; an audio device may output one or more sounds which may change in volume, pitch, rate, and so on. In an embodiment, a specified audio output may indicate that a user interface element is in a location for adding the user interface element to a subspace. In an embodiment, adding a user interface element of an operating instance to a subspace, may add the operating instance as a member to an access context that includes or is represented by the subspace. Code may be translated from source code written in a programming language. The source code may include instructions to detect a user input via an input device, to present an output via an audio device or a haptic device to indicate to a user a location of a part or all of a boundary of a subspace. The code may be executed by a processor to operate virtual circuitry to perform the instructions per the source code.

In an embodiment, some or all, of a boundary may be made visible to a user by visually identifying a location adjacent to or within a specified distance from some or all of the boundary so that the location is visually different from one or more locations adjacent to or within a specified distance of the boundary and outside the subspace. For example, a location in a subspace may have a different color than a location outside the subspace. Text in a subspace may be presented in a different font than text outside the subspace. Many other possibilities will be identifiable to those skilled in the art based on the present disclosures.

Some or all of a boundary may be detectable to a user during an operation performed on the boundary such as a moving of the boundary, a reshaping of the subspace, and the like. Some or all of a boundary may not be detectable to a user during an operation performed on the boundary. In an embodiment, some or all of a boundary of a subspace may be detectable when a visibility condition, based on a distance between some or all of a user interface element and some or all of the subspace, may be met. Some or all of a boundary of a subspace may be detectable in response to an interaction between a user and a user interface element in the subspace. Some or all of a boundary of a subspace may be detectable in response to a change in a user interface element in the subspace. For example, content in the user interface element may be modified, the user interface element may be minimized, or the user interface element may be moved. Some or all of a boundary of a subspace may be detectable when some or all of a user interface element in the subspace becomes detectable in an output space to a user.

In response to a moving, a changing of size, or a changing of shape of a subspace in an output space; a user interface element may be moved so that the user interface element remains in the subspace. The user interface element may be moved to a location relative to a boundary of the subspace or relative to another user interface element in the subspace. A specified criterion met prior to initiating of the moving, the changing of the size, or the changing of the shape may be met in response to the moving, the changing of the size, or the changing of the shape. For example, relative distances between user interface elements in a subspace may be maintained during or as a result of a resizing of the subspace.

A subspace may be moved in one or more of a height dimension, a width dimension, or a depth dimension. The user interface element may be included in a plurality of user interface elements that are each in the subspace. In response to moving the subspace, each user interface element in the plurality may be moved. Each user interface element may be moved so that each moved user interface element is in the moved subspace. Each user interface element may be resized, reordered, or reorganized in the subspace. One or more resources in a context set of an access context of the subspace may be modified in response to the moving of the subspace or in response to moving of one or more of the user interface elements in the subspace.

User interface elements in a subspace may be ordered or organized in a depth dimension of the subspace or of an output space that includes some or all of the subspace. Respective locations of the user interface elements in the order or organization may be identified based on a z-ordering or by a coordinate in a coordinate space. In an embodiment, an ordering may be maintained during or subsequent to a change in the subspace or a change in a user interface element in the subspace. An ordering may be changed during or subsequent to a different change in a subspace or a different change in a user interface element in a subspace. An ordering in another subspace may be changed during or subsequent to a same type of change in the other subspace or a same type of change in a user interface element in the other subspace.

In an embodiment, a second subspace may be included in a portion of an output space and, subsequent to a change (e.g. a moving) to a first subspace, the second subspace may be changed (e.g. moved or resized). The second subspace may be changed automatically based on a rule that a specified criterion must be met, such as a visibility condition of the second subspace, a relative ordering in one or more dimensions of the output space, a distance that may be relative or absolute with respect to the first subspace, a directional vector identifying a position of the second subspace relative to the first subspace, and the like.

In an embodiment, a subspace in or representing an access context may or may not be allowed to overlap or intersect with another subspace. In an embodiment, a subspace may be prevented from overlapping or intersecting with another subspace. A subspace may include another subspace referred to herein a child subspace. In an embodiment, a child subspace may define a scope for access to resources in the context set of the access context it is in or that it represents. The constraints of the child access context may override or be combined with those of the parent access context or vice versa. In a child subspace or in an intersection that includes portions of two subspaces, respective constraints may be additive for members of the respective access contexts, or one constraint may have priority over another in an embodiment. A constraint applied if more than one access context identifies a constraint may be from a one of the subspaces selected to have precedence. Constraints from more than one access context may be applied in a specified order in an embodiment.

In an embodiment, a first subspace and a second subspace may be constrained to specified regions or portions of an output space. Two or more subspaces may be allowed to share a boundary or their boundaries may be allowed to overlap. In an embodiment, when a first subspace is visible in an output space, a second subspace may not be allowed to be visible. In an embodiment, when a first subspace is visible in an output space, a second subspace may automatically be presented in the output space.

As described elsewhere, a change in an attribute of a subspace may be detected. The attribute may be changed in response to an interaction between a user and a user interface element representing some or all of the subspace. The interaction may occur via an input device or an output device. In response to detecting the change in the subspace one or more user interface elements in the subspace may be changed. Changing an attribute of a subspace or changing an attribute of a user interface element in a subspace may include one or more of resizing, minimizing, maximizing, changing a transparency level, assigning an input focus for an input device, removing an input focus for an input device, assigning an output focus for an output device, removing an output focus for an output device, changing a font size, changing a color, or changing a style. Alternatively or additionally, in response to detecting a change in a subspace, a user interface element of a member of the subspace or the member may be one or more of suspended, closed, terminated, hibernated, the member may operate as a daemon without a user interface, or some other attribute may be changed.

In an embodiment, when a subspace is in a first location in an output space, a resource in a context set of the subspace may have a first setting. When the subspace is in a second location in the output space, the resource may have a second setting. For example, a user interface element in a subspace may be assigned output focus when the subspace is moved towards a user in one or more dimensions of an output space. A subspace moved away from a user with respect to another subspace may lose an input focus assignment while one or more user interface elements in the other subspace may be assigned input focus for an input device. A change in location may result in a change in size, in a rotation, in an operational state, in a resource in a context set of an access context that includes or is represented by the subspace, in a member or an access context represented by or including the subspace, in a user interface model, in accessible energy for an operating instance having a user interface element in the subspace, or in a type of interaction allowed or prohibited—to name some examples.

In an embodiment, when a subspace is rotated, a resource in a context set of an access context that includes or is represented by the subspace may be changed. A change may be based on a specified direction that at least part of the subspace faces from a prespecified perspective. A change may be based on direction relative to a position of the subspace prior to a rotation, relative to a position a user interface element not in the subspace, relative to a position of another subspace, relative to a position of an output space that includes some or all of the subspace, or relative to a position of a user interface element in the subspace. A change may be based on a measure of a rotation in one or more dimensions, a count of rotations in one or more dimensions, a duration of a rotation, a speed or acceleration of a rotation, a direction of a rotation in one or more dimensions, a sequence of rotations, and the like. In an embodiment, when a user interface element in a subspace is rotated, a resource in a context set of an access context that includes or is represented by the subspace may be changed. A change may be based on a specified direction that at least part of the user interface element faces from a prespecified perspective. A change may be based on direction relative to a position of the user interface element prior to a rotation, relative to a position of another user interface element, or relative to a position of the subspace. A change may be based on a measure of a rotation in one or more dimensions, a count of rotations in one or more dimensions, a duration of a rotation, a speed or acceleration of a rotation, a direction of rotation in one or more dimensions, a sequence of rotations, and the like.

In an embodiment, an operational state of an operating instance may be changed in response to a rotation of a user interface element of the operating instance or other change to the user interface element. In an embodiment, membership in an access context may not be required. Member ship in an access context may be required for some operating instances in some operating environments.

In an embodiment, a communications agent having user interface element face a user may be allowed to receive messages (e.g. incoming calls, texts, emails, etc.) In response to as rotating, the communications agent may not be allowed to receive messages. Membership in an access context may or may not be required depending on an embodiment of an operating environment of the communications agent or depending on an embodiment of the communications agent. By including an operating instance of an operable entity of the communications agent as a member to an access context, the foregoing behavior may be changed. For example, other operational states of the may be changed in response to the same rotation criterion or in response to another change to a user interface element of the communications agent, such as change in location, a different rotation, a change in size, a change in shape, and the like. For example, the member operating instance may be restricted to encrypted communication in response to a change in location of a user interface element to a specified region of a output device. In embodiments of various operating environment, communications agents, or access contexts; a communications agent having user interface element r may be allowed to receive and send audio or video data to another communications agent, present outputs alerting a user to new messages or incoming calls, communication with a first specified address book, send attachments of specified type or size. In response a change in the user interface element, the communications agent may not be allowed to receive or to send audio or video (e.g. an active audio communications session may be muted or a video stream to another communicant may be paused), alerts notifying a user of new messages may be turned off made less noticeable for the communicant represented by the communications agent, may be allowed to communicate with communicants identified in a second address book in addition to or instead of the first address book, sending or receiving attachment may be disable or a size or type of allowable attachments may be modified. In an embodiment, a change to a user interface element (e.g. a rotation) of first communications agent may activate circuitry to send a signal to a second communications agent to change an operational capability or a user detectable attribute of a second communications agent. In embodiments of various operating environment, communications agents, or access contexts; an operational state or other attribute of a communications agent may changed in response to detecting that a criterion, based on a change to a user interface element of the communications agent, is met. The criterion may be specified by differently by different access contexts. An access context may change a criterion of an operating environment. In various operating environments, access contexts, an operating instances, a criterion may be based on an amount of a rotation, a speed or rate of rotation, a direction of rotation, or a pattern of rotation (e.g. a first rotation, followed by a reverse rotation with respect to the first rotation, followed by a rotation in the same direction as the first rotation—a “double twist”). In addition to or instead of a rotation, an operational state of a communications agent may be changed in response to change in location of a user interface element of the communications agent, a change in color, a change in size, a change in shape, A criterion may be met based on an interaction with a user (e.g. a communicant) that occurs prior to, during, or after the rotation such as specified exchange of data via the interaction, may be based on an attribute of a communicant (e.g. identity, role, etc.), may be based on another movement of a user interface element of the communications agent such as a

As described, whether an access context is required or not to change operational state or other attribute of an operating instance in response to a change in a user interface element of the operating instance, the change to the operating instance or the change to the user interface element that triggers the change to operating instance may be disabled, augmented, or otherwise modified by an access context when the operating instance is a member of the access context.

An operational state or other attribute of any type of operating instances may be changed in response to a change in a user interface element of the operating instance. Change to an operating instance and triggering changes to user interface elements of the operating instances may be based on and managed by adding or removing an operating instance as member from one or more access contexts configured to change an operating instance in response to a change in a user interface element of the operating instance. Operating instances of various operable entities may be hibernated, activated, or paused in response to changes in respective user interface elements of the operating instances that meet criterion in a context set of an access context of otherwise specified by an operating environment of an operating instance or specified in circuitry or data of an operating instance.

In an embodiment, an application may have a multi-side user interface element (e.g. a two-sided, three-sided, etc.) such as cube. Each side of the user interface element may include a user interface for exchanging data with another application (remote or local). A rotation of the cube may activate or allow communications with an application corresponding to a side of the multi-sided user interface element facing a user. User interface presented in other sides may be paused, disable, ended, muted, etc. as appropriate per the type of application or desires of a user. For example, a user may interact with various web sites or remote service provides via respective sides of a multi-sided user interface element. In an embodiment, an operating instance may send data via a network to a web site or remote service to identify change in an operational state or other attribute of a user interface for interacting with the web site or remote service presented in a side of a multi-sided user interface element. In an embodiment, a user may switch between communications sessions via user interaction included in manipulating a multi-sided user interface element that presents different communications or different communication sessions in different sides of the multi-side user interface element.

In an embodiment, a multi-side user interface elements may be position so that more than one side is visible to a user. A user interface in a side may be assigned input focus or output focus based on measure or indicator of visibility to a user.

A multi-sided user interface element may be foldable. An operational state or other attribute of a user interface presented in a foldable surface or side or an operational state or other attribute of an operating instance having a user interface element in a foldable surface or side may change based in response to a folding or unfolding of one or more panels or sides of the multi-sided user interface element.

A side of a multi-side user interface element may include a subspace, which may be in a context set of an access context or which may represent an access context. A multi-side user interface element may be a subspace, with user interface elements in the subspace presented in sides of the subspace.

In an embodiment, a first subspace may have an instance of a resource with a first setting in a context set of a first access context that includes or is represented by the first subspace. A second subspace may an instance of the resource with a second setting in a context set of a second access context that includes or is represented by the second subspace. An operable entity when operating as member of the first access context operates based on the first setting. The operating instance may be moved to the second subspace in or representing the second access context so that the operating instance is a member of the second access context. The operating instance, when operating as a member of the second subspace, operates based on the second setting. For example, to access a first network by or for an operating instance of an operable entity, the operating instance may be included as member of a first subspace of a first access context that has a first network interface as a resource in a context set of the first access context. The first network interface may be communicatively coupled the first network. To access a second network by or for an operating instance of the operable entity, the operating instance may be included as member of a second subspace in or representing the second access context that has a second network interface as a resource in a context set of the second access context. The second network interface may be communicatively coupled to the second network. Assigning an operating instance as a member of an access context in plurality of access contexts may provide access to different users, security policies, allowable operational states, user interface models, input devices, output devices, processors, data storage devices, file systems, databases, or portions of any of the foregoing—to identify just a few examples.

FIG. 41, illustrates two views 4100 of an output space including a first subspace 4102. Subspace 4102 is illustrated as partially hidden (as represented by the dotted lines) in a first view 4100a of the output space and partially hidden in a second view 4100b of the output space. In the first view 4100b of the output space a view of a first portion 4102a of the first subspace 4102 is visible via a first user interface element in a first location 4104a in the first view 4100a of the output space. Note that the output space may be a subspace in another output space as described elsewhere in the present disclosure. The first user interface element may be in a user interface of a first operating instance of an application or other operable entity. In the second view 4100b of the output space a view of a second portion 4102b of the first subspace 4102 is visible via a moved and resized first user interface element at a second location 4104b in the second view 4100b of the output space.

In an embodiment, an operating instance may have more than one user interface element each providing a view of a respective portion of a same subspace. Further, multiple operating instances of the same or different operable entity may each have a user interface element that provides a view of a portion of a same or of different subspaces. In an embodiment, an output space may be presented via a virtual reality or an augmented reality device. A subspace viewable in one or more portions may be an e-space. The output space may be an overlay of real space. Changing a user interface element may change the view of the subspace presented as content of the changed user interface element. Changing or moving an output device presenting the output space may change a view of a subspace in the output space. For example, glasses or other augmented reality headgear when moved may provide a different view of a portion of an e-space that is a subspace in an output space of the glasses or headgear. Multiple operable entities may be associated with a member set of an access context where an operating instance of each of the multiple operable entities is a member of the access context. An output space or subspace may be in a context set of the access context. The output space or subspace may be accessed by or for operating instance. In an embodiment, an output space in a context set may be an e-space. Members of the access context of the context set may provide different perspectives, different types of representations of some or all of the e-space, or different information about the e-space. Different members of the access context may interoperate with different physical or virtual objects in the e-space. Different members of the access context may interact with different users or provide different mechanisms for interaction between a user and some or all of the e-space. For example, TBD.

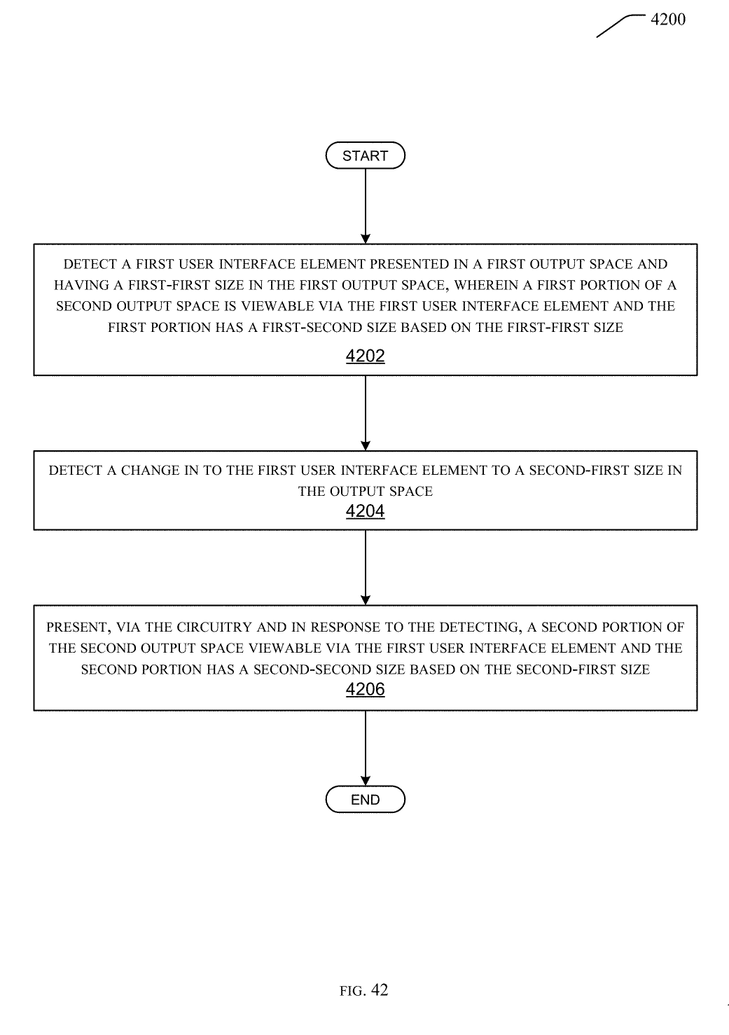

FIG. 42 shows a flow chart 4200 in accordance with an embodiment of a method of the present disclosure. Circuitry may be included in an embodiment or a method may include providing circuitry that is operable for use with a system included in performing a method of flow chart 4200. Such a system may include one or more devices of one or more operating environments. At block 4202, the circuitry may operate in detecting a first user interface element presented in a first output space and having a first-first size in the first output space, wherein a first portion of a second output space is viewable via the first user interface element and the first portion has a first-second size based on the first-first size. At block 4204, the circuitry may operate in detecting a change in the first user interface element to a second-first size in the output space. At block 4206, the circuitry may operate in presenting, in response to the detecting, a second portion of the second output space viewable via the first user interface element and the second portion has a second-second size based on the second-first size. The presenting may be performed automatically in an embodiment. Alternatively, the presenting may include receiving a user input or may be performed in response to receiving an input from a user.

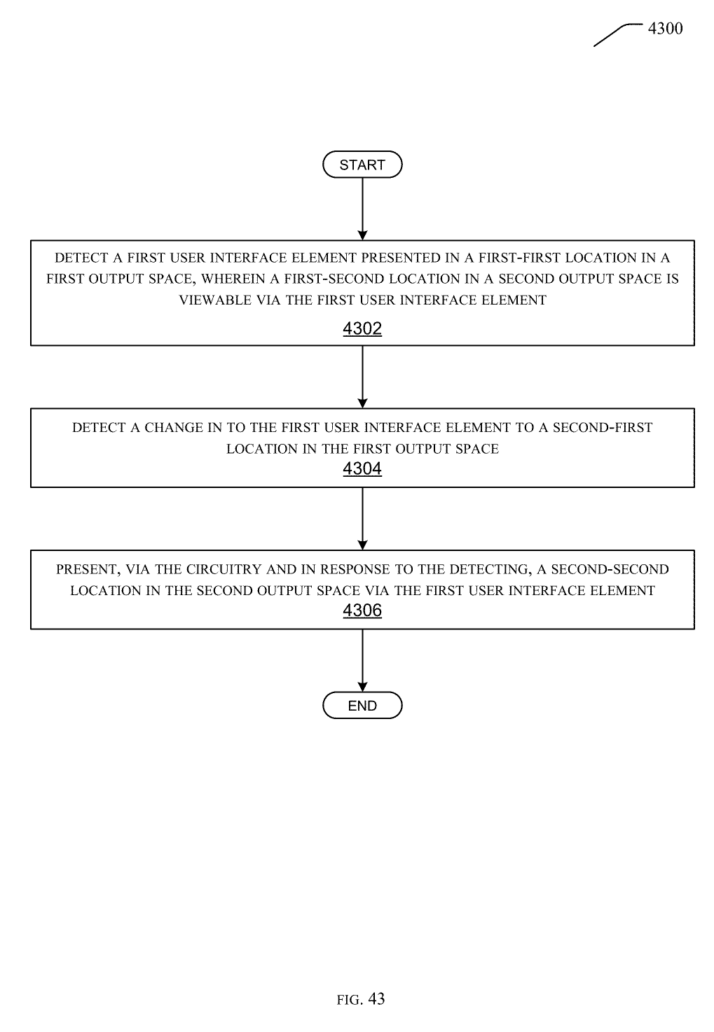

FIG. 43 shows a flow chart 4300 in accordance with an embodiment of a method of the present disclosure. Circuitry may be included in an embodiment or a method may include providing circuitry that is operable for use with a system included in performing a method of flow chart 4300. Such a system may include one or more devices of one or more operating environments. At block 4302, the circuitry may operate in detecting a first user interface element presented in a first-first location in a first output space, wherein a first-second location in a second output space is viewable via the first user interface element. At block 4304, the circuitry may operate in detecting a change in to the first user interface element to a second-first location in the first output space. At block 4306, the circuitry may operate in presenting, via the circuitry and in response to the detecting, a second-second location in the second output space via the first user interface element. The presenting may be performed automatically in an embodiment. Alternatively, the presenting may include receiving or may be performed in response receiving an input from a user.

A change may absolute or may be relative (e.g. proportional) in a subspace or output space. For example, user interface elements in a set may be presented stacked in a subspace. When the subspace gets smaller the stack shrinks and when the subspace is enlarged the stack of user interface elements may be spread (e.g. unstacked).

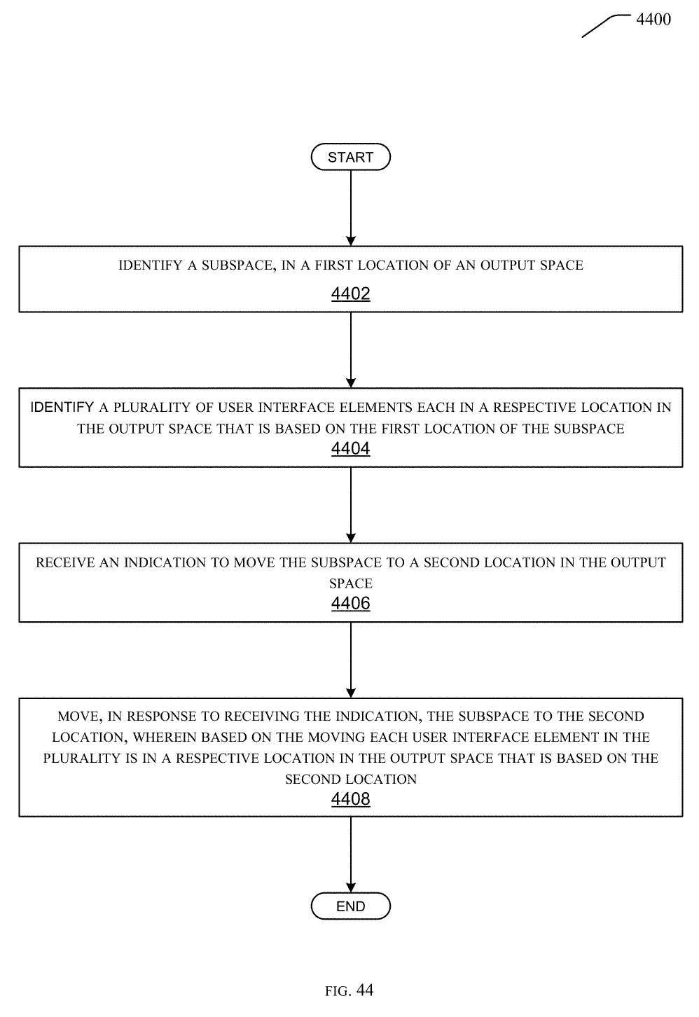

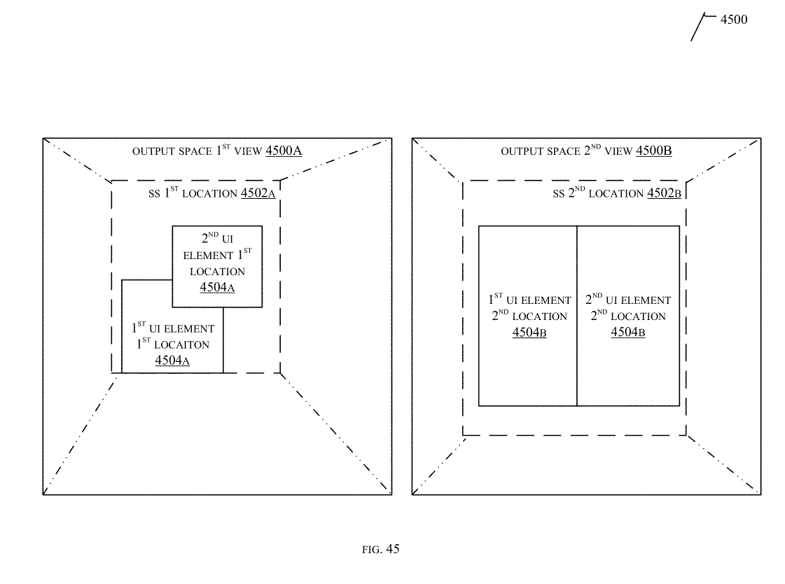

FIG. 44 shows a flow chart 4400 in accordance with an embodiment of a method of the present disclosure. Circuitry may be included in an embodiment or a method may include providing circuitry that is operable for use with a system included in performing a method of flow chart 4400. Such a system may include one or more devices of one or more operating environments and an output device of the one or more operating environments. At block 4402, the circuitry may operate in identifying a subspace, having a first attribute, such as a first location of an output space. At block 4404, the circuitry may operate in identify plurality of user interface elements each in a respective attribute, such as their respective locations in the output space, that is based on the first attribute. At block 4406, the circuitry may operate in receiving an indication to change the first attribute. For example, an indication to move the subspace to a second location in of the output space may be received. At block 4408, the circuitry may operate in changing the first attribute. Continuing with the location example, the changing may include moving, in response to receiving the indication, the subspace to the second location. In response to the changing of the first attribute, each respective attribute of each user interface element in the plurality be changed. The changes may be based on the changed first attribute. With respect to the location example, a location of each user interface element in the plurality may be changed. Based on the moving, each user interface element in the plurality may have a respective location in the output space that is determined based on the second location. Each user interface element may be moved or not so that each user interface element is in the subspace when the subspace is at the second location.

Examples of other subspace attributes include a color, a size, a transparency, a font, an output focus assignment, an input focus assignment, an authorized user, an interaction capability, a communication capability, an update capability, or a data access capability. User interface elements may be changed based on changes to one or more subspace attributes. Similarly, an access context may have one or more attributes. Members may be changed based on a change to one or more resources in the context set of the access context.

In an embodiment, a first subspace in a first portion of an output space of a first output device may be identified. Whether the first subspace has a first input focus for a first input device or does not have the first input focus may be detected. A first user interface element may be identified to be presented in the output space in one of a first location and a second location relative to the first subspace. When the first user interface element is in the first location, the first user interface element may be assigned the first input focus when the first subspace has the first input focus. The first user interface element may not have the first input focus when the first subspace does not have the first input focus when the first user interface element is in the first location. When the first user interface element is in the second location, the first user interface element may have the first input focus when the first subspace has the first input focus, and the first user interface element not have the first input focus when the first subspace does not have the first input focus. A change in relative location of the first user interface element may be detected with respect to the first subspace. The relative location may be from the first location to the second location or from the second location to the first location. The input focus may be changed accordingly. Other attributes of user interface elements or corresponding operating instances may be assigned or set based on the relative location of the user interface elements with respect to a subspace. Accordingly, a user may control one or more attributes user interfaces of a number of operating instances which may be otherwise unrelated. Additionally, via an access contexts, a number of operating instances may be monitored, managed, or control. One or more of the operating instances may otherwise be unrelated.

In an embodiment, subspace circuitry for a subspace may operate in the moving of one or more user interface elements to respective locations determined based on a location of the subspace. Some or all of the user interface elements may be in the subspace or not. The moving may be automatic. For example, with reference to FIG. 38 described above, interaction subsystem circuitry 3806 may operate in moving the one or more user interface elements based on moving the subspace. In an embodiment, access context circuitry or subspace circuitry 3808 may interoperate with circuitry of one or more user interface handlers that may operate in the moving of the one or more user interface elements. Alternatively or additionally, moving the one or more user interface elements may include exchanging data via a network with another device or network accessible service that is included in moving one or more of the user interface elements based a change to a subspace. For example, a user interface element may be presented in a subspace via a user agent communicatively coupled to a web site or other network service. Data may be exchanged to report the move of a user interface element, to determine a location of the user interface element based on a change to a subspace, or to access presentation information to present the user interface element in a moved location. A moved user interface element may differ from the user interface element prior to the move. For example, a size of the user interface element may change in response to moving or in response to changing a subspace in a depth dimension from the perspective of a user. In an embodiment, a subspace may be at a first location in a z-ordering in an output space and may be moved to a second location in the z-ordering. User interface elements in the subspace may maintain their z-ordering with the subspace. User interface elements in the subspace may be moved to be in the subspace at the second location.

FIG. 45, illustrates two views 4500 of an output space that includes a subspace. The subspace, in FIG. 45, includes a first user interface element and a second user interface element. In a first view 4500a of the output space, the subspace is in a first location 4502a of the output space. In a second view 4500b of the output space, the subspace is in a second location 4502b of the output. At the first location 4502a of the subspace, the first user interface element is presented at a first user interface element first location 4504a and the second user interface element is presented at a second user interface element first location 4506a. FIG. 45 illustrates the first user interface element and the second user interface element overlapping when the subspace is at the first location 4502a where the first user interface element is at the first user interface element first location 4504a and the second user interface element is at the second user interface element first location 4506a. At the subspace second location 4502b, the first user interface element is presented at a first user interface element second location 4504b and the second user interface element is presented at a second user interface element second location 4506a. FIG. 45 illustrates that first user interface element and the second user interface element with no overlapping portions when the subspace is at the second location 4502b where the first user interface element is at the first user interface element second location 4504b and the second user interface element is at the second user interface element second location 4506b. The first user interface element and the second user interface elements the subspace appear relatively larger at the subspace second location 4502b which allows more area to present the user interface elements. Note that, in an embodiment, the relative positions and sizes of user interface elements in a subspace may be changed in response to a change in location or size of subspace as FIG. 45 illustrates.

One or more attributes of a user interface element in subspace may be changed in response to a move or other change in a subspace. A resource may be changed during a moving operation. The resource may be the same prior to an after the moving. The resource may be different during the moving and after the moving. The resource may be the same during the moving, After the moving of the resource may be different. A resource may be different during a moving than after a moving. Changed resources may include one or more of a color, size, a transparency, a font, a user interface control type, an output focus assignment, an input focus assignment, an authorized user, or an interaction capability. An attribute of a user interface element may represent a resource or attribute of an operating instance that has a user interface that includes the user interface element. The resource may be in a context set of an access context of the subspace. The operating instance may be a member of the access context. A change in an attribute of a user interface element of a member may be in response to or may initiate a change in a context resource accessible by or for the member.

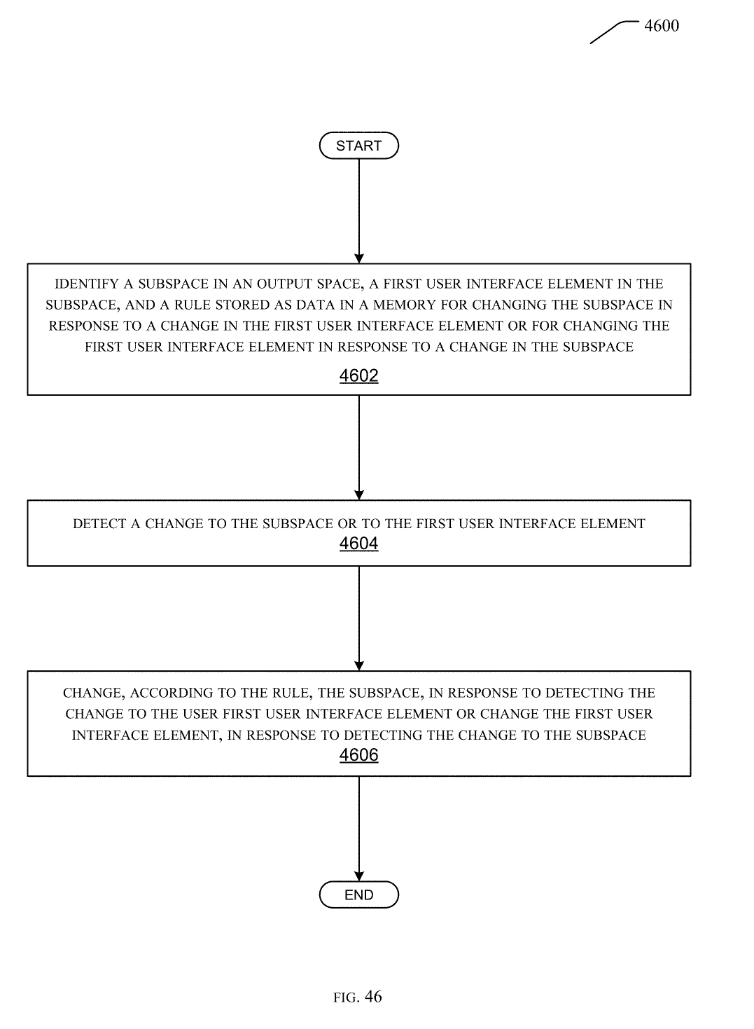

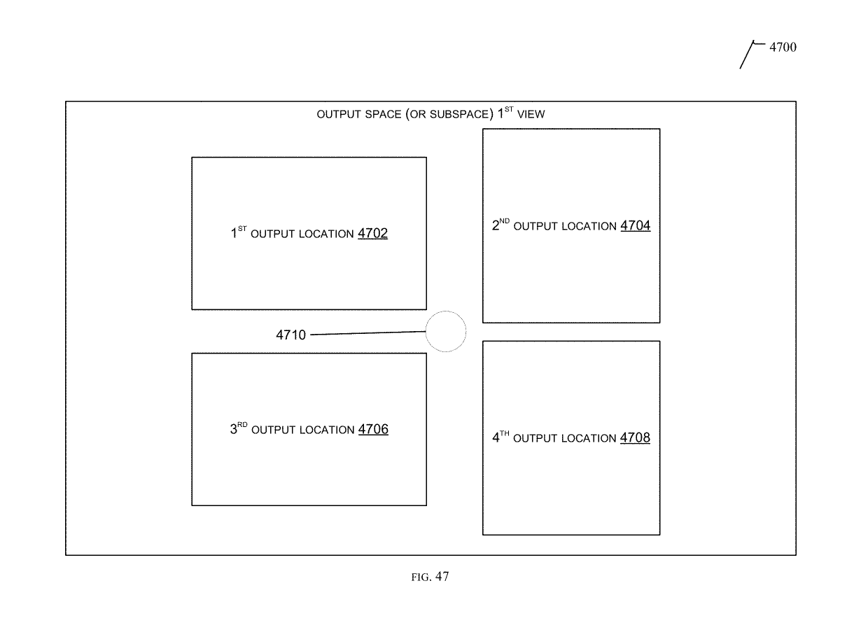

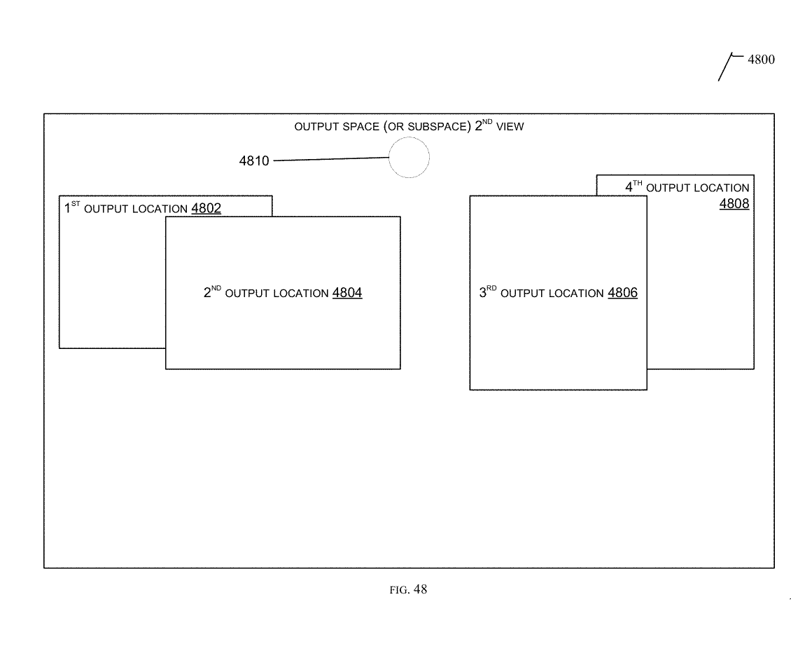

FIG. 46 shows a flow chart 4600 in accordance with an embodiment of a method of the present disclosure. Circuitry may be included in an embodiment or a method may include providing circuitry that is operable for use with a system included in performing a method of flow chart 4600. Such a system may include one or more devices, one or more of operating environments, and an output device. At block 4602, the circuitry may operate in identifying a subspace, a first user interface element, and a rule. Each may be identified based on data stored in a memory. The data may include code for operating virtual circuitry or may include data accessed and processed in operands of one or more instructions. The rule may be specified to change the subspace in response to a change in the first user interface element or to changing the first user interface element in response to a change in the subspace. At block 4604, the circuitry may operate in detecting a change to the subspace or in detecting a change to the first user interface element. At block 4608, the circuitry may operate in changing, according to the rule, the subspace in response to detecting the change to the first user interface element or may operate in changing the first user interface element in response to detecting the change to the subspace. In an embodiment of the method, a change to the first user interface element or to the subspace may be detectable to a user via an output presented via an output device.

In an embodiment, a move user interface element may be presented for moving a subspace or for moving user interface elements in an output space which may be a subspace, or for moving multiple user interface elements of respective operating instances in a coordinated manner. The move user interface element may be a user interface element in the user interface elements to be moved. An interaction may be detected between a user and the move user interface element. The interaction may identify a direction, a distance, or a location to move multiple user interface elements of respective operating instances, where the multiple user interface elements are associated with the move user interface element. In response, multiple user interface elements may be moved while maintaining their relative positions or their relative sizes, may be relocated with respect to one another, or their relative sizes may be changed. Alternatively or additionally, in a moving of multiple user interface elements a shape of one or more user interface elements may be changed. Other attributes of one or more of the user interface elements may be changed in response to a moving of multiple user interface elements in response to an interaction with a move user interface element. In an embodiment, an interaction with a move user interface element may be replaced by, may include, or may be augmented with a gesture, a touch, an interaction with a location in an output space that includes or doesn't include the move user interface element, an interaction with a location associated with a subspace that includes or doesn't include the move user interface element, or an interaction with a location associated with a user interface element moved, to be moved, or moving user interface elements.

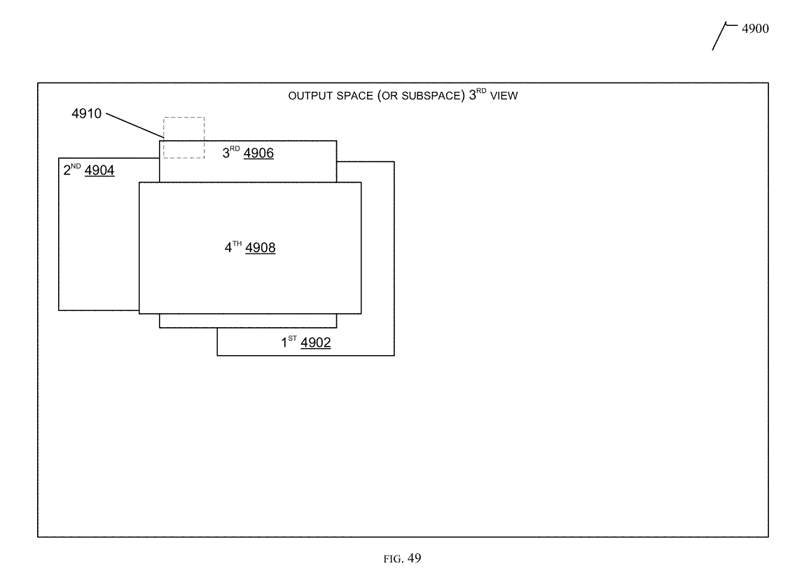

Referring to FIG. 47, a first view 4700 of an output space is shown. The first view 4700 includes a set of output locations in the output space. Each output location may include one or more user interface elements or subspaces in a first arrangement illustrated in the first view 4700. The output locations illustrated includes a first-first output location 4702, a first-second output location 4704, a first-third output location 4706, and a first-fourth output location 4708. The user interface elements or subspaces in the different output locations may be presented by a same or by two or more different operating instances of a same or different operable entities. A first arrangement location 4710 is illustrated by a circle, but may have any shape suitable for interaction with a user. An interaction that includes the first arrangement location 4710 may be associated with the illustrated arrangement of output locations in the first view 4700 An arrangement location for arranging output locations or for selecting a predefined arrangement of output locations may be included in an interaction with a user to receive data that identifies the arrangement location, a direction, a start location for an interaction, an end location for the interaction, a path or pattern of inputs included in an interaction, a rate of inputs or outputs in an interaction, a speed of interaction movement, an acceleration of interaction inputs or outputs, a pause in an interaction, a duration between interaction events in an interaction, and the like. In an embodiment, a start location and an end location in an interaction may be the same location or one may include at least part of the other. Data exchanged in an interaction identifying a direction, a distance, and so on may include an indication of pressure, movement, time, or location. In an embodiment, an arrangement location, such as the first arrangement location 4710, may include a user interface element, may have an attribute such as a color that identifies it to a user, or may not be visibly distinct to a user. A user may interact with an arrangement location, such as the arrangement location 4710, to create an arrangement of output locations, to identify a predefined arrangement of output location, to identify a predefined pattern for creating an arrangement of output locations, or to identify a currently visible arrangement of output locations. An arrangement location may be identified by a user interface element, via an interaction with a user, by an arrangement or type of arrangement of output locations, via a location relative to another visible output. An interaction including the arrangement location 4710 may include movement from a start location to a destination location. The arrangement location 4710 may include the start location or the destination location. An interaction may begin at the arrangement location 4710 shown and may end at another location. Alternatively or additionally, an interaction may begin at another location and end at the arrangement location 4710. An interaction may be between a user and only the arrangement location 4710. For example, the arrangement location 4710 may be identified as associated with output locations arranged in a regular pattern relative to the arrangement location 4710. A pattern may be based on a user choice, a count or size of user interface elements, a count or size of subspaces, a count or size of members in an access contexts, one or more users, or one or more operating instances—to identify some examples. An interaction that includes an arrangement location, such as the arrangement location 4710, may identify a direction, a distance, or a location that may be included in determining a type of arrangement, an arrangement, a location for an arrangement, a size of an arrangement, and the like. In an embodiment, an output space may be included in a touch sensitive device. A user touch may be detected in a first location along with a second touch at a second location that identifies a direction, a distance, and may identify an end location with respect to a start location. Based on the interaction via the user touch, the arrangement location 4710 may be identified as shown in FIG. 47. A dragging motion may be detected via the touch device in the interaction or two or more distinguishable touches each separated in time may be detected.

In an embodiment, an arrangement location for an arrangement of output locations or for arranging output locations may be identified in a specified portion or specified location an output space (or subspace). A set of user interface elements or subspaces may be moved or otherwise presented in an arrangement based on the arrangement location. The first view 4700 illustrates the arrangement location 4710 at the center or within a specified area that includes the center. The user interface elements or subspaces may be arranged based on the arrangement location 4710 as illustrated by the exemplary arrangement of the first-first output location 4702, the first-second output location 4704, the first-third output location 4706, and the first-fourth output location 4708 as illustrated.

FIG. 48, illustrates a second view 4800 of an output space, which may be the same output space as shown in FIG. 47 or may be a different output space. The second view 4800 includes a set of output locations that each may include one or more user interface elements or subspaces in a second arrangement. The output locations illustrated include a second-first output location 4802, a second-second output location 4804, a second-third output location 4806, and a second-fourth output location 4808b. A second arrangement location 4810 is illustrated. In an embodiment, the first arrangement location 4710 in the first view 4700 may be a start location for an interaction with a user. The interaction may identify the second arrangement location 4810 illustrated in the second view 4800 as a destination location. In response, the user interface elements or subspaces arranged in output location in the first view 4700 may be arranged or rearranged in output locations as shown in the second view 4800 which includes the second-first output location 4802, the second-second output location 4804, the second-third output location 4806, and the second-fourth output location 4808 based on the second arrangement location 4810 or based on other data received in interacting with the user to change the arrangement location from the first arrangement location 4710 to the second arrangement location 4810. In an embodiment, the one or user interface elements or output spaces in the first-first output location 4802 may be moved to the second-first output location 4802. The user interface element(s) or output space(s) in the first-first output location 4702 may have similar or a different arrangement in the second-first output location 4802. Similarly, in an embodiment, the user interface elements or subspaces in the first-second output location 4704, the first-third output location 4706, and the first-fourth output location 4708 may be respectively moved to the second-second output location 4804, the second-third output location 4806, and the second-fourth output location 4808. In an embodiment, a first user interface element and a second user interface element presented in the first-first output location 4702 may be presented in separate output locations in the second view 4800. Still further, when a first arrangement of output locations is rearranged or moved to present a second arrangement of output locations, the number of output locations in the first arrangement may be more or less than the number of output locations in the second arrangement. The user interface elements and subspace presented in output spaces of the first arrangement may have a one-to-one correspondence with the user interface elements or subspace in the second arrangement. In an embodiment, one or more user interface elements or subspace in the first arrangement may not be presented in the second arrangement or one or more user interface elements in the second arrangement may not be included in the first arrangement. An arrangement may correspond to a change in one user interfaces, to a change in operating instances of the one or more user interfaces, to a change in a subspace that includes at least some of the one or more user interfaces, or to a change in an access contexts that includes at least some of the operating instances as members.

The second view 4800 illustrates the second arrangement location 4810 at or within a specified portion of the output space near the top. User interface elements or subspaces may be arranged in the second-first output location 4802, the second-second output location 4804, the second-third output location 4806, and the second-fourth output location 4808.

FIG. 49, illustrates a third view 4900 of an output space, which may be the same output space as shown in FIG. 47 or as shown in FIG. 48 or may be a different output space than in FIG. 47 or FIG. 48. The third view 4900 includes a set of output locations that each include one or more user interface elements or subspaces in a third arrangement. The output locations illustrated include a third-first output location 4902, a third-second output location 4904, a third-third output location 4906, and a third-fourth output location 4908. A third arrangement location 4910 is illustrated. In an embodiment, the first arrangement location 4710 in the first view 4700 or the second arrangement location 4810 in the second view 4800b may be a start location for an interaction with a user. The interaction may identify the third arrangement location 4910 illustrated in the third view 4900. As an option, a user may interact with the third arrangement location 4910 regardless of where any other arrangement locations. In response, user interface elements or subspaces arranged in the output locations as shown in the first view 4700 or arranged in the output locations in the second view 4800 may be arranged or rearranged in the third-first output location 4902, the third-second output location 4904, the third-third output location 4906, and the third-fourth output location 4908 based on the third arrangement location 4910 or based on other data received in interacting with a user to change the arrangement location from the first arrangement location 4710 or the second arrangement location 4810 to the third arrangement location 4910.

The third view 4900 illustrates the third arrangement location 4910 at or within a specified portion of the output space 4900 near the top-left. The user interface elements or subspaces may be arranged in the third-first output location 4902, the third-second output location 4904, the third-third output location 4906, and the third-fourth output location 4908 as illustrated.

An arrangement location such as any of the first arrangement location 4710, the second arrangement location 4810, or the third arrangement location 4910 may be established, as an arrangement location, prior to establishing another arrangement location such as any one or more of the other of the first arrangement location 4710, the second arrangement location 4810, or the third arrangement location 4910 as a subsequent arrangement location. The locations may change as illustrated or may change based on an order of establishing the arrangement locations shown or other locations as arrangement location in time.

In an embodiment, an output space may include multiple arrangements of output locations that are each associated with a respective arrangement location. Two or more arrangements of output locations such the first arrangement 4700, the second arrangement 4800, or the third arrangement 4900, may be visible at a same time. In an embodiment, the output locations in the first view 4700 may include user interface elements of a first subspace or a first access context while the output locations of the second view 4800 include user interface elements of a second subspace. The first view and the second view may be presented as a same time in a same or in different output spaces of a same or different device or system.

An arrangement of output locations for user interface elements or subspaces based on an arrangement location may be based on a circle, an oval, an arc, a triangle, a square, or some other regular polygon. Output locations for one or more user interface elements or subspaces, in an embodiment, may be located, sized, or oriented based on an arrangement location utilizing a random or irregular pattern. In some embodiments, a start location in an interaction may be any location other than a corresponding end location. That is, a user may move a pointer, for example, from any location (as a start location) in an output space to an end location to identify the end location as an arrangement location. The organization of output locations associated with the interaction may be based on the end location irrespective of the start location. Still further in an embodiment, the start location may be an arrangement location for a first arrangement of output locations and the end location may identify a new arrangement for second arrangement of output locations to replace the first arrangement. An interaction and one or more locations identified in an interaction may include an exchange of data between a system and a user that identifies or is included in determining an arrangement location, a size, an orientation, or other attribute of user interface elements, subspace, or output locations in an arrangement. In still another aspect, a number of inputs in an interaction, a pattern of the inputs (e.g. a shape identified by the number inputs), a rate in time of receiving inputs, one or more measures of pressure, velocity, acceleration, and the like may be included in determining an arrangement location, a pattern for arranging user interface elements or subspaces, a pattern for arranging output locations, a size for a user interface element or a subspace, a size for an output location, an orientation of a user interface element or a subspace, an orientation for an output location, any other attribute of user interface elements or subspaces presented in an arrangement, or any other attributes of output locations in an arrangement.

An output location may be or may include a subspace. An output location may represent an access context. An output location may be a resource in a context set of an access context. An arrangement location or a user interface element in an arrangement location may overlay, underlie, intersect, be included in, or be presented apart from one or more user interface elements, subspaces, or output locations in an arrangement identified, created, or modified via an interaction that includes the arrangement location. For example, arrangement location 4910 may be invisible as FIG. 49 attempts to represent.

Moving, changing a size, or changing some other resource of an arrangement of user interface elements, subspaces, or output locations may change an input focus assignment, an output focus assignment, a z-ordering, a transparency level, or any other user detectable attribute of one or more of the user interface elements, subspaces, or output locations. For example, when user interface elements of a subspace are arranged in or around or near a center point of the subspace, each user interface element in the subspace maybe assigned output focus for an output device. the user interface elements in the subspace may not have output focus in another arrangement. Alternatively or additionally, when user interface elements or subspaces in an arrangement are arranged in or around or near a specified location of an output space or subspace, operating instances of the user interface elements or subspace in the arrangement may exchange information via a resource of the arrangement such as a shared location in a memory, a pipe, a socket, a virtual network, a physical data exchange medium, or some other data exchange mechanism. The user interface elements or subspaces, when not in the arrangement, may not be allowed to exchange information or may exchange information via a different mechanism than when arranged based on the specified location. In an embodiment, the user interface elements or subspaces may not be allowed to exchange information when arranged in or around a different specified location. Alternatively or additionally, when user interface elements of subspaces are arranged in or around or near a specified location of an output space or subspace, operating instances of the user interface elements or subspaces in the arrangement access a shared resource such as a source of energy, a source of content to present to a user, a same network, a same service accessible via a network (e.g. a website, a cloud service provider, etc.). Alternatively or additionally, when user interface elements or subspaces are arranged in or around or near a specified location of an output space or subspace, operating instances of the user interface elements or subspace(s) in the arrangement may access different resources in a corresponding set of resources or may access different respective portions of a shared resource. For example, different operating instances may access different portions of a transaction in performing respective portions of the transaction, such as a buy-sell transaction. The examples provided are not intended to be exhaustive.

User interface elements, subspace, or output locations of an arrangement may be tiled, stacked, resized, reshaped, reordered in one or more dimensions, rotated in one or more dimensions, position in an irregular pattern, or position based on a random or pseudo-random output generator.

In an embodiment, a user detectable attribute of a subspace of an access context may include one or more of a location of the subspace in an output space, a size of the subspace (absolute or relative to the output space or to another subspace), a measure of visibility, a level of transparency, a location in a z-ordering (x-ordering or y-ordering), a color, a visible pattern, a shape defined by an outside boundary, a shape defined by an inside boundary, a visible association with another subspace, a user interface element identifying that the subspace is in or represents an access context, a count of sides, a count of surfaces, a measure/indication of brightness, a font, an output focus assignment, an input focus assignment, or an operational state—to name some examples. An operational state may include an operational state of a member of an access context that includes or is represented by a subspace. An operational state may include an operational state of a context resource of an access context. Exemplary resources that may have an operational state include a thread, a computing process, an application, an operating environment, a first hardware resource, a device, a network, a network interface, a network protocol, a network protocol endpoint, a network relay, a communications agent, a user agent, a file system, a source of streamed data, a source of asynchronous messages, a source of responses to a request, circuitry included in accessing/operating an interprocess communication mechanism, or a processor.

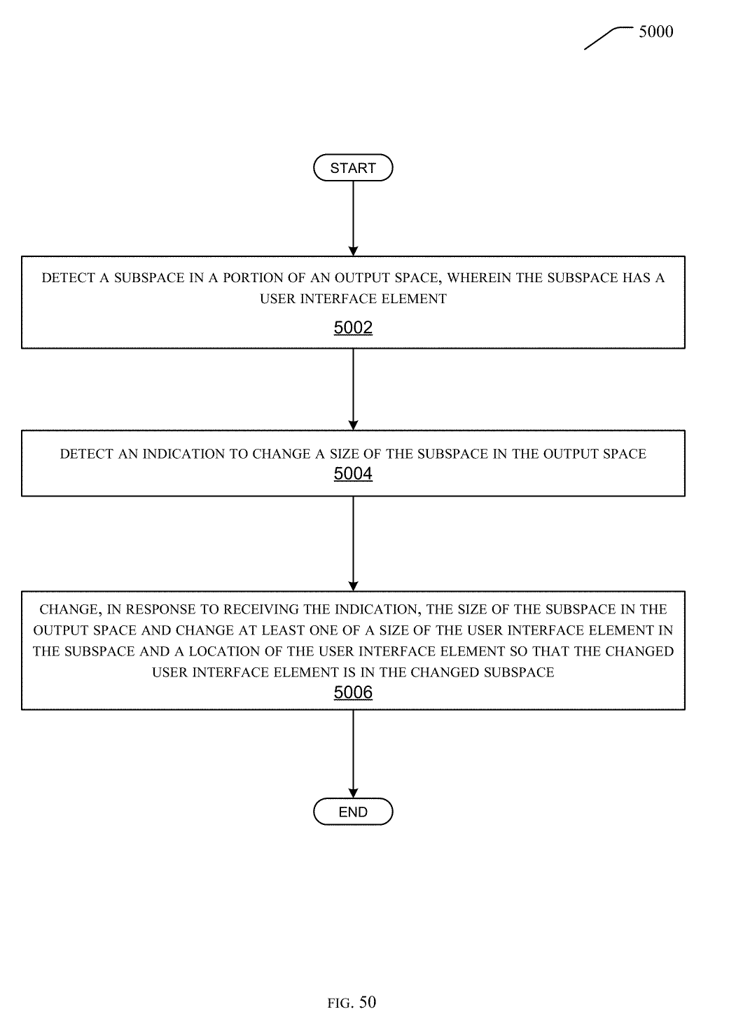

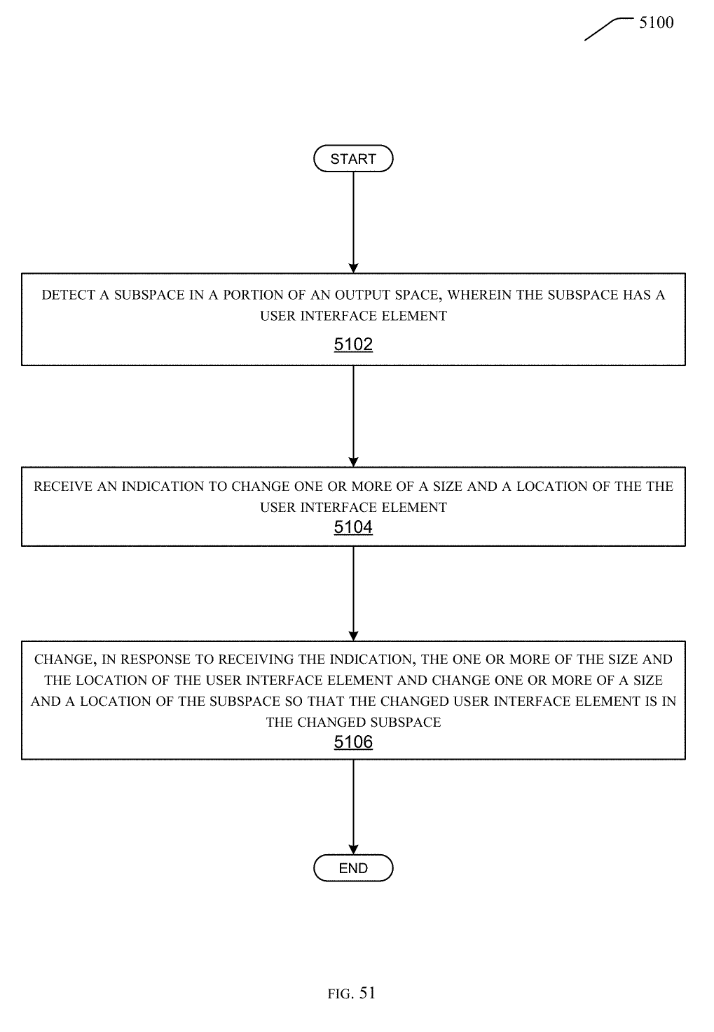

FIG. 50 shows a flow chart 5000 in accordance with an embodiment of a method of the present disclosure. Circuitry may be included in an embodiment or a method may include providing circuitry that is operable for use with a system included in performing a method of flow chart 5000. Such a system may include one or more devices of one or more operating environments. At block 5002, the circuitry may operate in detecting a subspace in a portion of an output space. The subspace may include one or more user interface elements. At block 5004, the circuitry may operate in detecting, receiving, accessing, or identifying an indication to change a size of the subspace in the output space. A size change may be absolute or may be relative to a size of an output space, the subspace, another subspace, or a user interface element in the subspace or not. At block 5006, the circuitry may operate in changing, in response to receiving the indication, the size of the subspace in the output space and in changing one or more of a size of one or more user interface elements in the one or more user interface elements in the subspace and a location of one or more user interface elements in the one or more user interface elements in the subspace of the user interface element so that the changed one or more user interface elements are in the changed subspace.

In an embodiment, a user interface element size change may be proportional to a change in size of a subspace. The user interface element may be in the subspace or not. Alternatively or additionally, a size of a user interface element may be changed based on an input focus assignment, an output focus assignment, an output activity, a user interaction, or a measure or an indication of visibility of the user interface element.

FIG. 51 shows a flow chart 5100 in accordance with an embodiment of a method of the present disclosure. Circuitry may be included in an embodiment or a method may include providing circuitry that is operable for use with a system included in performing the flow chart 5100. Such a system may include one or more devices of one or more operating environments. At block 5102, the circuitry may operate in detecting a subspace in a portion of an output space of one or more operating environments. The subspace has a user interface element. At block 5104, the circuitry may operate in receiving, detecting, determining, or identifying an indication to change one or more of a size and a location of the user interface element. At block 5106, the circuitry may operate in changing, in response to receiving the indication, the one or more of the size and the location of the user interface element and may operate in changing one or more of a size and a location of the subspace. The changing of the subspace may be performed so that the changed user interface element is included the changed subspace.

A state of a user interface element in a subspace or of an operating instance of the user interface element may change in response to a change in size, location, or other attribute of the subspace or the user interface element. A subspace may represent an access context that includes the operating instance as a member or the subspace may be in a context set of an access context that includes the operating instance as a member. The subspace, the user interface element, or the operating instance may be placed in sleep state, a run state, a low power state, a high-power state, a closed state, a locked or unlock state for interaction with a user, assigned an input focus, unassigned an input focus, assigned an output focus, or unassigned an output focus—to name a few examples. The user interface element may be in a user interface of the operating instance. When an operating instance is a member of an access context, a context resource of the access context may be changed based on change in a size, a location, or other attribute of a user interface element of the member, a subspace that includes the user interface element, or another user interface element in the subspace or not in the subspace. The subspace may represent the access context or may be a context resource of the access context. Still further, a user interface model of a member may be based on a size, a location, or a change in size or location of a user interface element of the member, a subspace that includes the user interface element, or another user interface element in the subspace or not in the subspace. For example, a member may have a desktop user interface model (e.g. WINDOWS or MAC OS) when a size of a user interface element of the member meets a specified size threshold, such as exceeding specified size. In an embodiment, the member may, otherwise, have a mobile user interface model such as WINDOWS MODERN or IOS user interface model. A user interface of a member may have a 2-dimensional user interface model based on a size, a location, or a change in size or location. The member may have a 3-dimensional user interface model based on a different size, a location, or a change in size or location. The foregoing resources may, alternatively or additionally, be changed in response to adding a user interface element of an operating instance to a subspace, adding an operating instance to an access context as a member, removing a user interface element of an operating instance from a subspace, or removing an operating instance as a member from an access context.

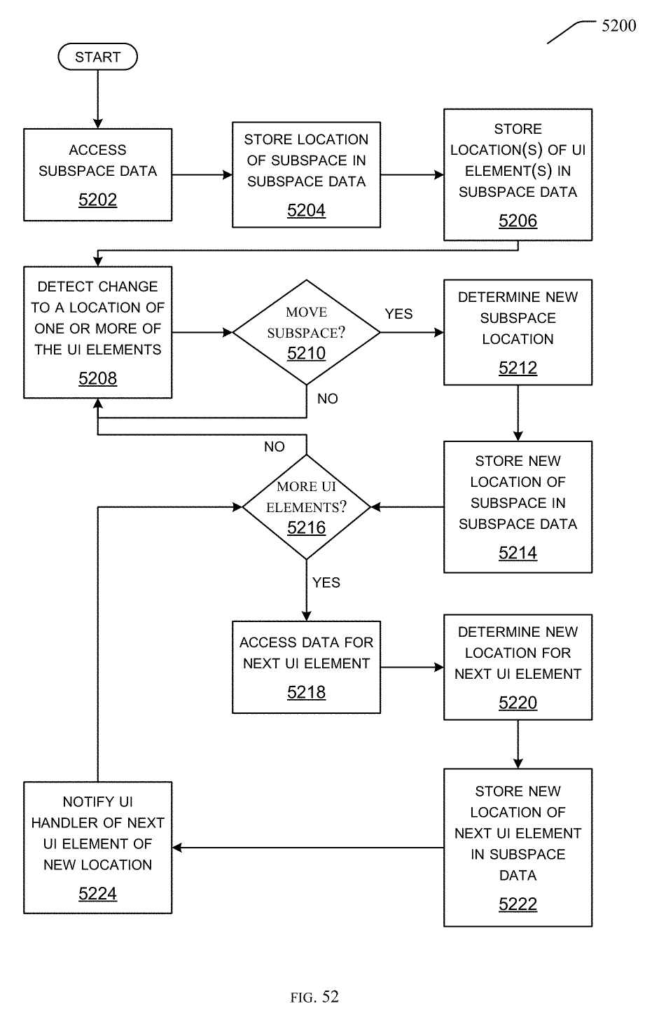

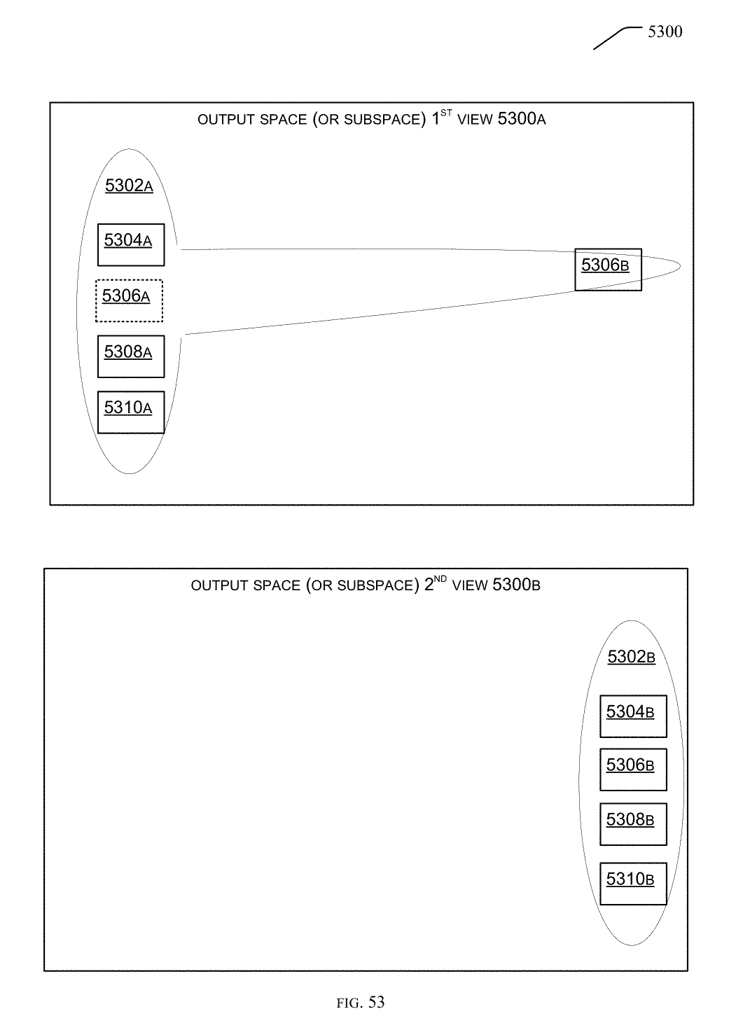

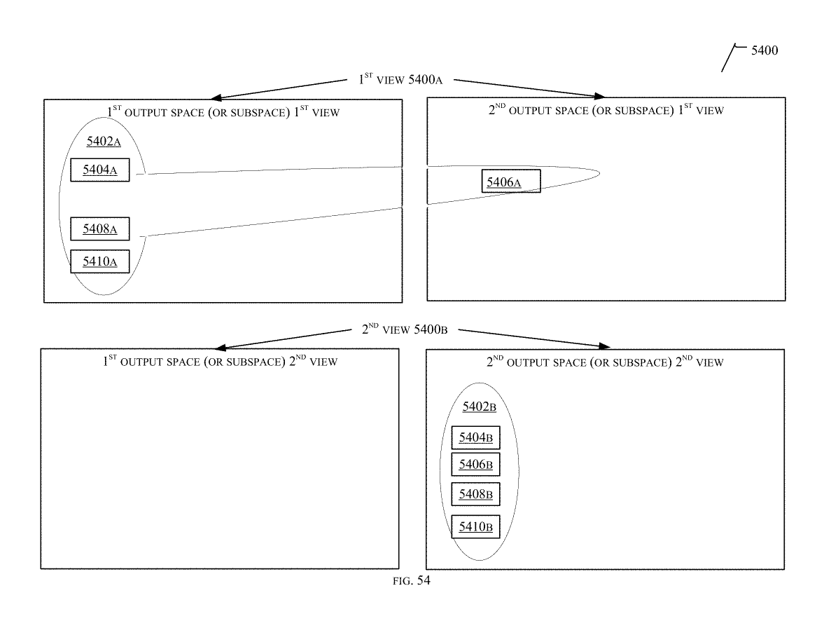

FIG. 52 shows a flow chart 5200 in accordance with an embodiment of a method of the present disclosure. In various embodiments, circuitry may be included in a system or circuitry may be provided that is operable for use with a system included in performing the flow chart 5200. Such a system may include an output device and an output space. At block 5202, the circuitry may operate in accessing subspace data. At block 5204, the circuitry may operate in storing, in the subspace data, a location of a subspace. The stored location may identify a location in the subspace or a location in the output space. At block 5206, the circuitry may operate in storing, in the subspace data, a location, in the subspace or in the output space, of a user interface element in the subspace. The user interface element may be in a user interface of an operating instance of an operable entity or the user interface element may otherwise represent the operating instance. At block 5208, the circuitry may operate in detecting a change to the location of the user interface element. At block 5210, the circuitry may operate in determining, in response to detecting the change, whether to move the subspace. If the subspace is not to be moved, control may return to circuitry of block 5208. If the subspace is to be moved, then at block 5212, the circuitry may operate in determining a new subspace location. At block 5214, the circuitry may operate in replacing, in the subspace data, the stored location of the subspace with the new location. At block 5216, the circuitry may operate in determining that the subspace has another user interface element. If no other user interface elements are detected, control may return to circuitry of block 5208, in an embodiment. If another user interface element is detected, then at block 5218, the circuitry may operate in getting access to data for a next user interface element. At block 5220, the circuitry may operate in determining a new location, in the subspace or in the output space, for the next user interface element. At block 5222, the circuitry may operate in replacing, in the subspace data, a stored location for the other user interface element with the new location. At block 5224, the circuitry may operate in invoking user interface circuitry to present the other user interface element at the new location.

FIG. 53, illustrates a first view 5300a of an output space including a subspace in a first subspace location 5302a at a first time. A second view 5300b of the subspace is also shown illustrating the output space at a second time. At the second time the subspace is in a second subspace location 5302b. At the first time, the subspace in the first subspace location 5302a may include a first-first location 5304a for a first user interface element, a first-second location where a second user interface was location prior to the first time, a second-second location 5306b for the second user interface element at the first time, a first-third location 5308a for a third user interface element, and first-fourth location 5310a for a fourth user interface element. At the first time, the second user interface element is included in a moving operation from the first-second location 5306a of the second user interface element prior to the moving and to the left in the first view 5300a to the second-second location 5306b shown in both views 5300. At the second time, the subspace is in the second subspace location 5302b subsequent to the moving operation. In response to moving the second user interface element from the first-second location 5306a to the second-second location 5306b, as shown at the first time, the subspace is moved from the first subspace location 5302a to the second subspace location 5302b, the first user interface element is moved from the first-first location 5304a to a second-first location 5404b; the third user interface element is moved from the first-third location 5308a to a second-third location 5308b; and the fourth user interface element is moved from the first-fourth location 5310a to the second-fourth location 5310b.

FIG. 54, illustrates views 5400 of a first output space and a second output space. A first view 5400a of the first output space and the second output space at a first time is shown. Additionally, a second view 5400b of the first output space and the second output space at a second time is also shown. In the first view 5400a, a subspace is shown in a first subspace location 5402a that includes part of the first output space and part of the second output space. Prior to the first time, the subspace may be in the first output space with no part of the subspace in the second output space. At the first time, a first user interface element is at a first-first location 5402a in the first output space, a third user interface element is at a first-third location 5408a, a fourth user interface element is at a first-fourth location 5410a in the first output space while a second user interface element is at a first-second location 5404a in the second output space. The first time of the first view 5400a may be during an moving of the second user interface element from the first output space to the second output space. At the second time, the second view 5400b shows the subspace moved to a second subspace location 5402b in the second output space by or in response to the moving of the second user interface element. The second user interface element may be moved by a user or moved automatically (e.g. snapped) into a second-second location 5404b in response to the move of the second user interface element to or through the first-second location 5404a. In response to moving the second user interface element from the first output space to the second output space, the subspace may be automatically moved to the second subspace location 5402b in the second output space as just described. To keep the user interface elements of the subspace in the subspace, the first user interface element may be relocated or re-displayed from the first-first location 5404a to a second-first location 5404b in the second output space 5404b; the third user interface element may be moved from the first-third location 5408a to a second-third location 5408b; and the fourth user interface element may be moved from the first-fourth location 5410a to a second-fourth location 5410b. During a moving of a user interface element of a subspace; a size, a shape, a visibility, a location, or other visual attribute of the subspace may be altered during the moving, in various embodiments. In an embodiment, one or more of visual attributes of a subspace may remain unchanged during a moving, reshaping, resizing, or other modifying of a user interface element of the subspace space. One or more of the one or more unchanged visual attributes may be changed subsequent to or in response to the moving, reshaping, sizing, or other modifying.

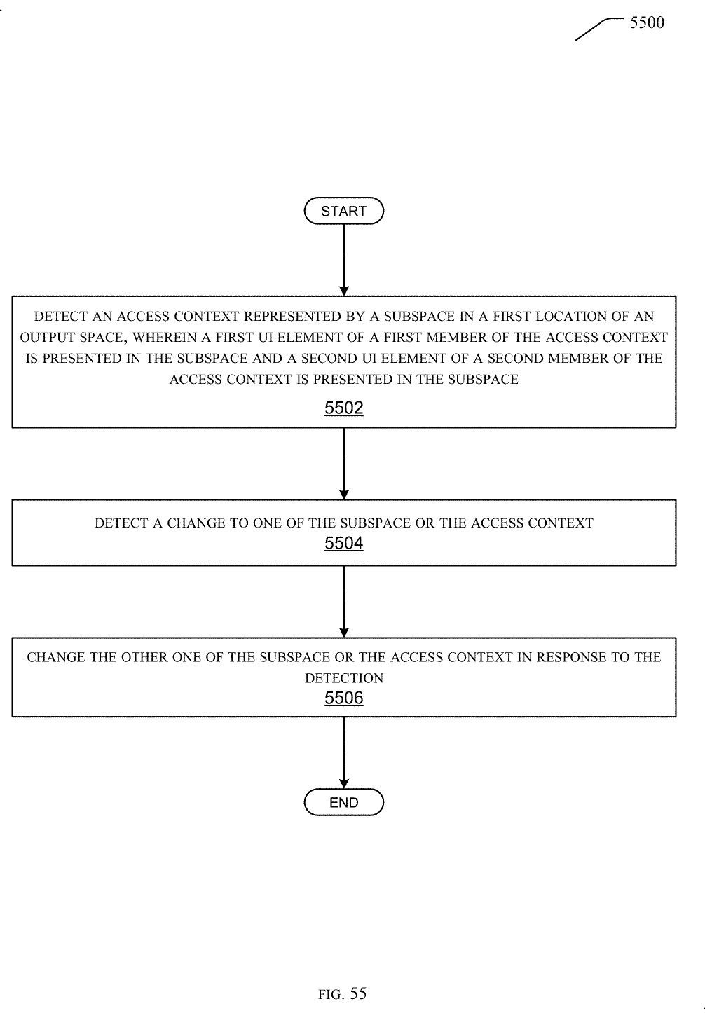

FIG. 55 shows a flow chart 5500 in accordance with an embodiment of a method of the present disclosure. In various embodiments, circuitry may be included in a system or circuitry may be provided that is operable for use with a system included in performing the flow chart 5500. At block 5502, the circuitry may operate in detecting an access context represented by a subspace in a first location of an output space. At block 5504, the circuitry may operate in detecting a change to one of the subspace or the access context. At block 5506, the circuitry may operate in changing the other one of the subspace or the access context in response to the detecting.

In an embodiment, a user interface element representing a member of an access context may be presented in a subspace. The subspace may represent the access context. Circuitry of the subspace, circuitry of a user interface handler for the user interface element, or circuitry of the member may detect a change to the user interface element or may detect a change to the member. In response to detecting the change, the circuitry may send an indication, such as a specified electrical signal, to change the member, the subspace, or the access context when the change detected is to the user interface element or to change the user interface element when the change detected is to the member, the subspace, or the access context. The circuitry of the subspace, the user interface handler, the member, or the access context may operate in sending the signal or in receiving the signal and may operate in performing the change to the user interface element, the member, the subspace, or the access context.

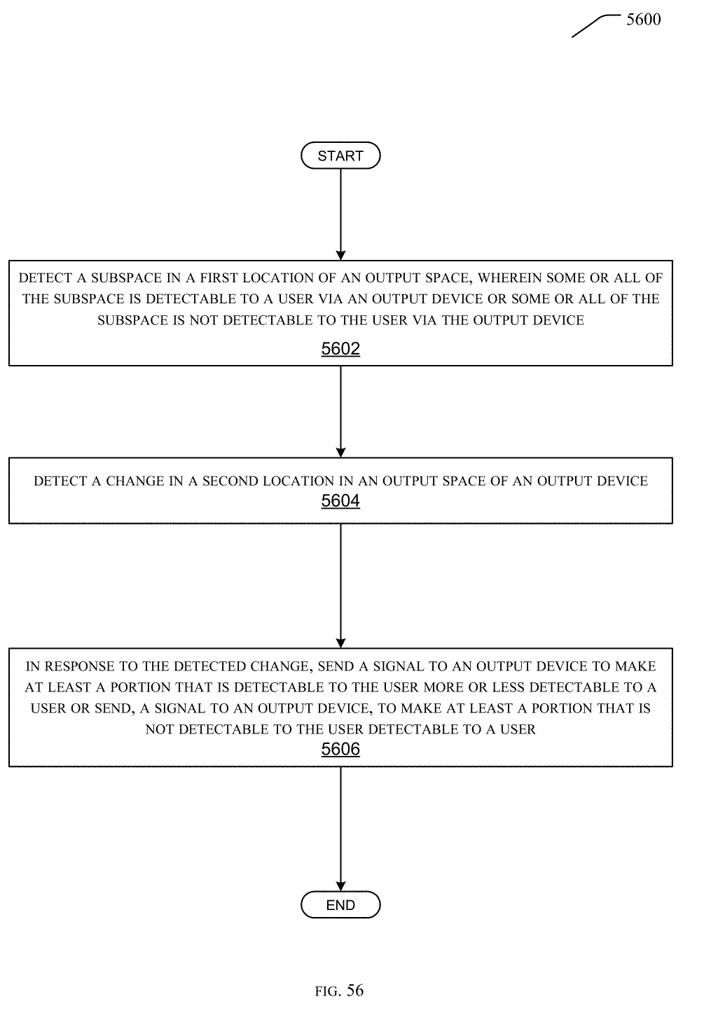

FIG. 56 shows a flow chart 5600 in accordance with an embodiment of a method of the present disclosure. Circuitry may be included in an embodiment or a method may include providing circuitry that is operable for use with a system included in performing a method of flow chart 5600. Such a system may include one or more devices of one or more operating environments. At block 5602, the circuitry may operate in detecting a subspace in a first location of an output space of the one or more output devices. Some or all of the subspace may be detectable to a user via the one or more output devices. Alternatively or additionally, some or all of the subspace may not be detectable to the user via an output device or via any output device. At block 5604, the circuitry may operate in detecting a change in a second location in an output space of the one or more output devices. The change may include a change in a user interface element at the second location. The user interface element may be in a user interface of an operating instance of an operable entity. The user interface element may be in the subspace. In another scenario, the user interface element may not be in the subspace. In an embodiment, the change may include detecting an input via the second location or otherwise corresponding to the second location, such as a touch detected at the second location, detected moving into or out of the second location, or detected within a specified distance of the second location. In an embodiment, a user interface element may move (e.g. a pointer user interface element) into the second location or out of the second location, may move through the second location, may overlay part or all of the second location, or may underlie part or all of the second location. At block 5606, the circuitry may, in response to the change at the second location, operate in sending, for the some or all of the subspace that is not detectable, a signal to an output device to make, at least a portion of the some or all that is not detectable, user detectable. The signal may include or may identify presentation data to present a visible boundary or to present the at least a portion in a color or pattern that visibly differentiates it from the output space. Still further, part or all of a subspace may not be detectable due to its location, size, or orientation in one or more dimensions of the subspace. For example, it may be off screen, overlaid by another user interface element, or may be too small to be detectable to a user. A signal may include data to change a location, size, or orientation of the part or all of the subspace to make it user detectable. Alternatively or additionally, the circuitry may, in response to a change at the second location operate in sending, for some or all of a subspace that is user detectable, a signal to an output device to make, at least a portion of the detectable some or all of the subspace, not user detectable, more user detectable, or less user detectable. A signal may include or may identify presentation data to hide or remove a visible boundary (e.g. make it transparent) or to present at least a detectable portion of a subspace in a color or pattern that does not visibly differentiate it from an including output space, is more visibility differentiated, or is less visibly differentiated. Still further, part or all of a subspace may be detectable due to its location, size, or orientation in one or more dimensions of the output space. For example, a subspace may be in a visible portion of an output space, not overlaid by another user interface element, or may be large enough to be detectable to a user. A signal may include data to change a location, size, or orientation of the some or all of a detectable subspace or part thereof to make it undetectable, less detectable, or more detectable.

In an embodiment, a signal to change a presentation attribute of a subspace or of a part of the subspace may be based on a measure of distance between a location of the subspace or of the part and a location of a user interaction or other change. The location of user interaction or change may include a user interface element for controlling visibility of some or all of the subspace or the part. A color, transparency, visual pattern, location, orientation, size, and the like may be changed in response to a user interaction via the user interface element. In an embodiment, a signal to change a visual attribute of a subspace maybe based on a change in a user interface element not in the subspace or a change in another subspace. The signal may be sent when the user interface element is within a specified distance of a boundary of the subspace or a part of the boundary. In an embodiment, a boundary of a subspace may be unpresented, overlaid by another user interface element, or transparent. A threshold distance may be specified. When a distance between the user interface element, not in the subspace, is less than the threshold, the boundary may be presented, the boundary's transparency may be decreased, the boundary may be widened, the boundary may be presented in a color that differentiates it from at least some part of the output space visibly bounding it, and so forth. Alternatively or additionally, any of the foregoing attributes of a boundary may be presented to increase or decrease visibility as the distance between a user interface element outside the subspace and the subspace decreases or increases respectively (or vice versa). In an embodiment, the second location of flow chart 5600 may be in the subspace. For example, a user interface element in the subspace may change. The visibility of some or all of the subspace interior, output space exterior to the subspace, or a boundary of the subspace may change. A change in size, location, or orientation of a user interface element in a subspace may change the visibility of some or all of the subspace, in an embodiment.

In an embodiment, a signal to change a visual attribute of a subspace maybe based on a change in a user interface element in the subspace or a change in another subspace. A signal may be sent when the user interface element is within a specified distance of a boundary of the subspace. In an embodiment, a boundary of a subspace may be unpresented, overlaid by another user interface element, or transparent. A threshold distance may be specified. When a distance between the user interface element in the subspace is less than the threshold, the boundary may be presented, the boundary's transparency may be decreased, the boundary may be widened, presented in a color that differentiates it from at least some part of the output space visibly bounding it, and so forth. Alternatively or additionally, any of the foregoing attributes of a boundary of a subspace may be changed to increase or decrease visibility as the distance between a user interface element outside the subspace and the subspace decreases or increases respectively or vice versa. An indication of the subspace, may be included in a user interface element in the subspace or in a user interface element not in the subspace.

An attribute of a user interface element may be based on a location of the user interface element in a subspace. An attribute of a user interface element may be based on a location of the user interface element not in a subspace. For example, as a distance between a user interface element and a subspace boundary decreases or meets a specified threshold, a transparency level, size, font, output focus, orientation, or any other user detectable attribute of the user interface element may change.

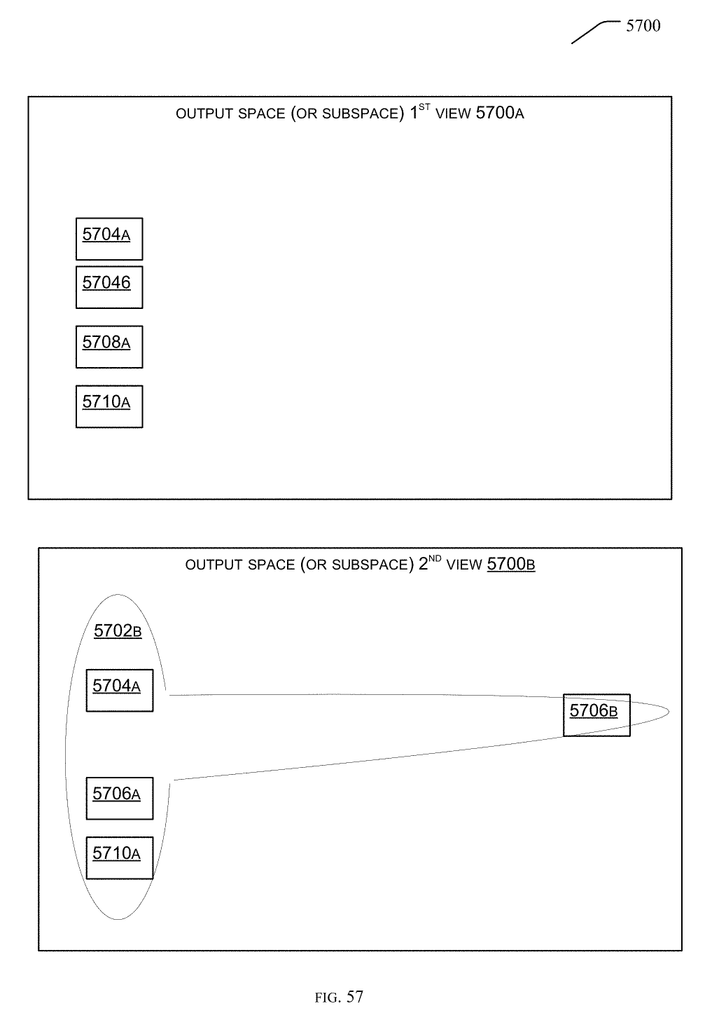

FIG. 57, illustrates an output space 5700 including a subspace (not shown) that is not user detectable in a first view 5700a of the output space. In the first view 5700a, the subspace includes a first-first location 5704a for a first user interface element, a first-second location 5706a for a second user interface element, a first-third location 5708a for a third user interface element, and first-fourth location 5710a for a fourth user interface element. A second view 5700b is also presented where a boundary 5702b of the subspace is visible during a moving of the second user interface element from the first-second location 5704a to a second-second location 5704b. In an embodiment, the subspace boundary is presented to include a moved user interface element or a moving user interface element. The boundary may be made visible, invisible, more visible, or less visible in response to a specified interaction with a user interface element in the subspace, in response to a moving of a user interface element, in response to a change in size of a user interface element in the subspace, or in response to a user detectable change to some other attribute of the user interface or of the subspace.

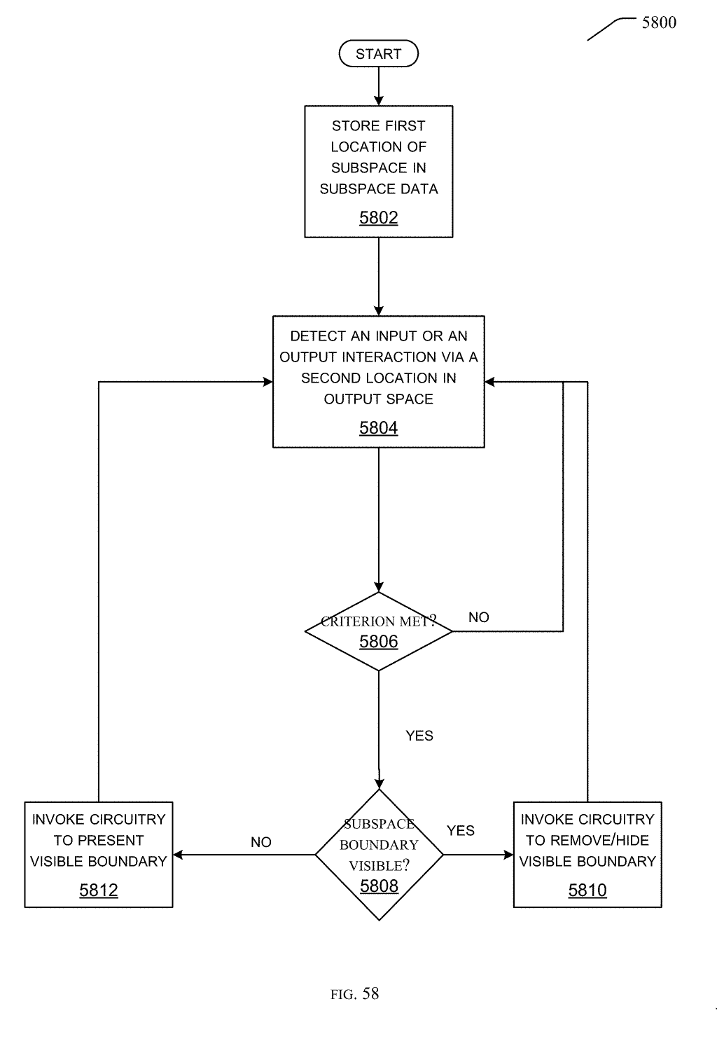

FIG. 58 shows a flow chart 5800 in accordance with an embodiment of a method of the present disclosure. In various embodiments, circuitry may be included in a system or circuitry may be provided that is operable for use with a system included in performing a method of flow chart 5800. At block 5802, the circuitry may operate in storing a first location identifier, of a subspace in an output space, in subspace data in a memory device. At block 5804, the circuitry may operate in detecting an input or an output interaction via a second location in the output space. At block 5806, the circuitry may operate in determining whether a specified criterion is met, in response to detecting the interaction. In an embodiment, the criterion may be based on the first location or the second location. At block 5808, the circuitry may operate in determining whether some or all of a subspace boundary is visible. At block 5810, the circuitry may operate in invoking circuitry to remove, hide or otherwise decrease visibility of some or all of a boundary. Alternatively or additionally at block 5810, the circuitry may operate in invoking circuitry to present or otherwise enhance visibility of a boundary.

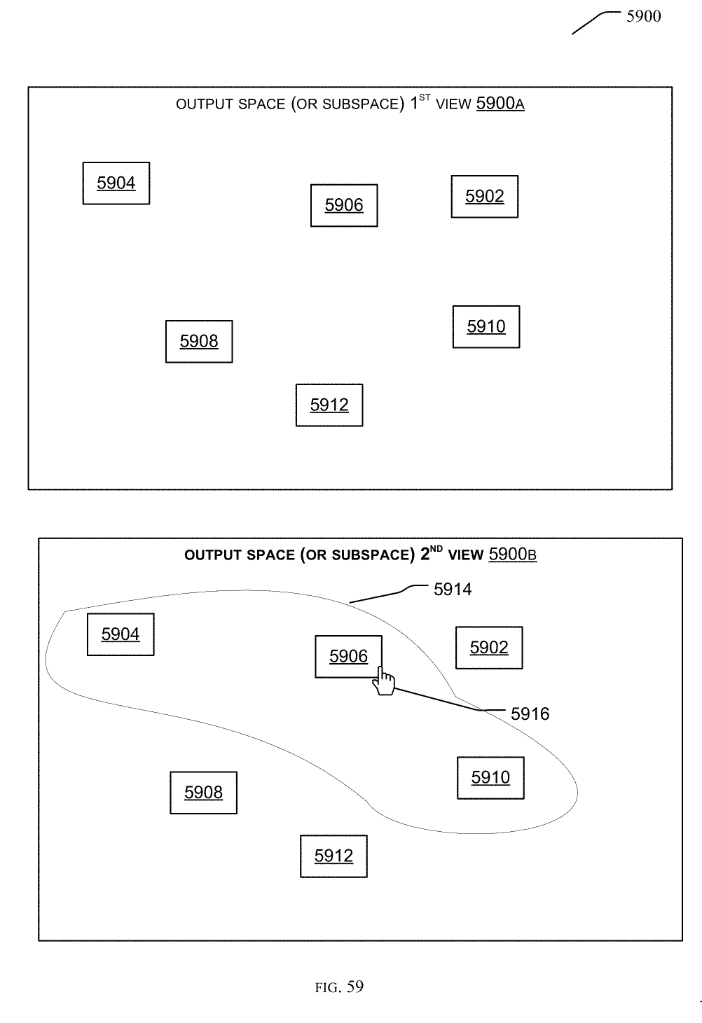

FIG. 59, illustrates an output space 5900 including a subspace (not shown) that is not user detectable in a first view 5900a of the output space. In the first view 5900a, the subspace includes a first location 5902 for a first user interface element, a second location 5904 for a second user interface element, a third location 5906 for a third user interface element, a fourth location 5908 for a fourth user interface element, a fifth location 5910 for a fifth user interface element, and a sixth location 5912 for a sixth user interface element. A second view 5900b is also presented where a boundary 5914 of the subspace is visible during an interaction with the third user interface element in the subspace, as illustrated by a pointer user interface element 5916 over the third location 5906 of the third user interface element. The boundary 5914 shows that the second user interface element, the third user interface element, and the fifth user interface element are in the subspace as their respective second location 5904, third location 5906, and fifth location 5910 are within the subspace boundary 5914. The first location 5902, the fourth location 5908, and the sixth location 5912 are outside the boundary 5914 indicating the respective first user interface element, fourth user interface element, and sixth user interface element are not in the subspace.

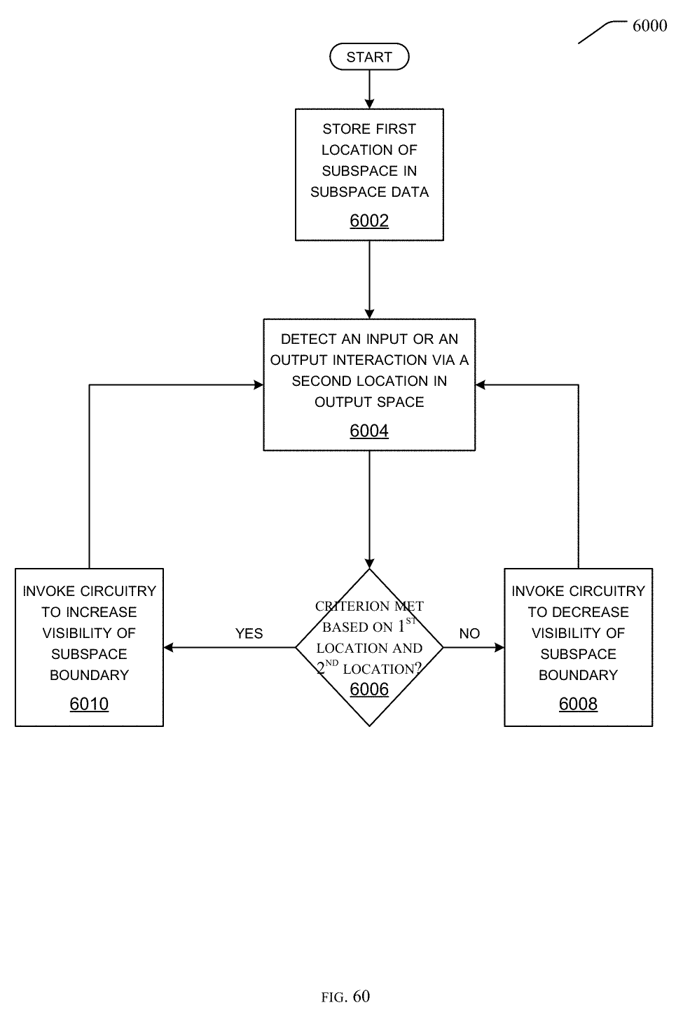

FIG. 60 shows a flow chart 6000 in accordance with an embodiment of a method of the present disclosure. In various embodiments, circuitry may be included in a system or circuitry may be provided that is operable for use with a system included in performing a method of flow chart 6000. Such a system may include one or more devices of one or more operating environments. At block 6002, the circuitry may operate in storing a first location, of a subspace in an output space, in a memory location allocated for subspace data. At block 6004, the circuitry may operate in detecting an input or an output interaction via a second location in the output space. At block 6006, the circuitry may operate in determining whether a specified criterion is met based on the first location and based on the second location. If the determination indicates the criterion is not met, then at block 6008, the circuitry may operate in removing, hiding, or otherwise making some or all of a visible boundary of the subspace less visible. If the determination indicates the criterion is met, then at block 6010, the circuitry may operate in making some of all of a boundary more visible, provided it is not already in a most visible state according to an embodiment.

Circuitry, in an embodiment, may operate in determining a distance between a first location of a subspace and a second location that corresponds to one or more of a user input detected by an input device, an output presented to a user via an output device, or a change in either of a user detected input and an output presented to the user. The circuitry may further operate, based on the determined distance, to send a signal or provide access to data to increase the visibility of some or all of a boundary of the subspace. Visibility may be increased by moving a user interface element that overlays at least a portion of the some or all of the boundary. Alternatively or additionally, a z-level or a location in a depth dimension of an output space may be changed for at least a portion of some or all of a boundary. Alternatively or additionally, visibility may be increased by changing a color, a visual pattern, a width, a shape, a transparency attribute, or a location of at least a portion of some or all of a boundary or of another user interface element that obscures, hides, or otherwise constrains visibility of the at least a portion. In an embodiment, alternatively or additionally (for a separate portion of a boundary), circuitry in or operable with a system may operate, based on the determined distance, to send a signal or provide access to data to decrease the visibility of some or all of a boundary of the subspace. Visibility may be decreased by moving a user interface element so that it that overlays at least a portion of the some or all of the boundary or change a z-level or location in a depth dimension of the output space of at least a portion of the some or all of the boundary so that it is behind some other visible user interface element. Alternatively or additionally, visibility may be decreased by changing a color, a visual pattern, a width, a shape, a transparency attribute, or a location of at least a portion of the some or all of the boundary or of another user interface element to obscure, hide, or otherwise constrain visibility of the at least a portion.

In an embodiment, a first criterion, based on a distance, may be specified for increasing visibility when met. A second criterion, based on a distance, may be specified for decreasing visibility when met.

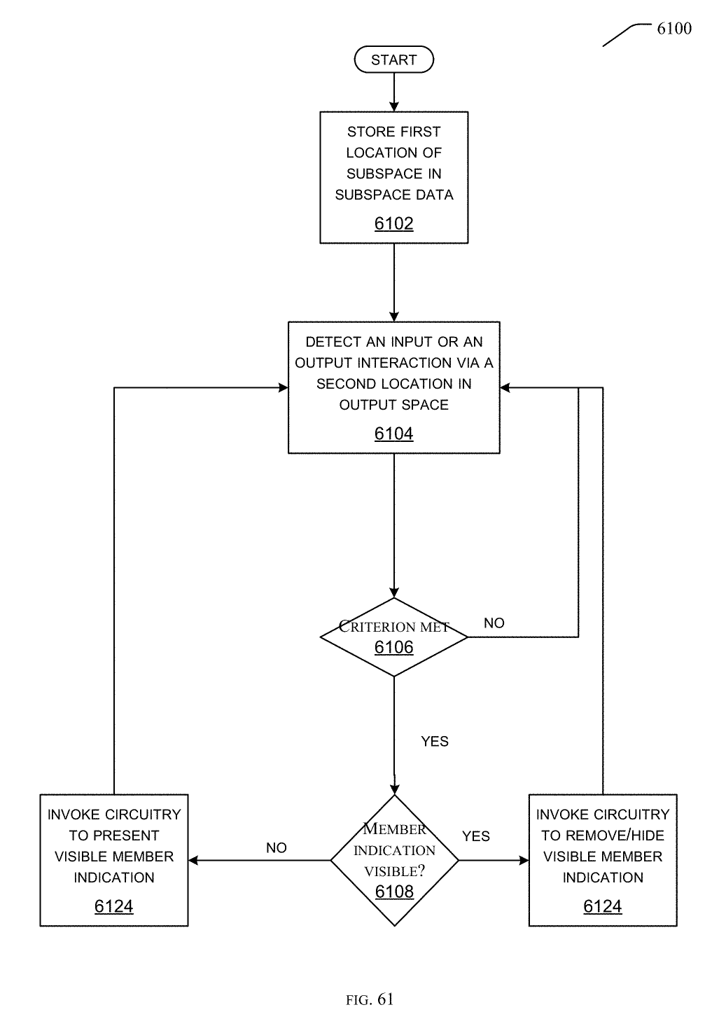

In another embodiment, a criterion may be specified that, when met, changes visibility of an indicator of whether a user interface element is in a subspace. FIG. 61 shows a flow chart 6100 in accordance with an embodiment of a method of the present disclosure. In various embodiments, circuitry may be included in a system or circuitry may be provided that is operable for use with a system included in performing a method of flow chart 6100. Such a system may include one or more devices of one or more operating environments. At block 6102, the circuitry may operate in storing a first location, of a subspace in an output space, in a memory location allocated for subspace data. At block 6104, the circuitry may operate in detecting an input interaction or an output interaction via a second location in the output space. At block 6106, the circuitry may operate in determining whether a specified criterion is met based on the interaction, the first location, or the second location. If the determination indicates the criterion is not met, then control may return to circuitry embodying block 6104. If the determination indicates the criterion is met, then at block 6108, the circuitry may operate in identifying whether the met criterion indicates whether a membership indicator for a user interface element should be made more or less visible to a user. If the criterion identifies that the membership indicator should be invisible or otherwise less visible, then at block 6110 the circuitry may operate in removing, hiding, or otherwise making an indicator that the member is in the subspace less visible. If the criterion identifies that the membership indicator should be visible or otherwise more visible, then at block 6112 the circuitry may operate in moving, presenting, or changing the user interface element or another user interface element to provide a visible indicator that the user interface element is in the subspace or to otherwise make the indicator more visible or more noticeable.

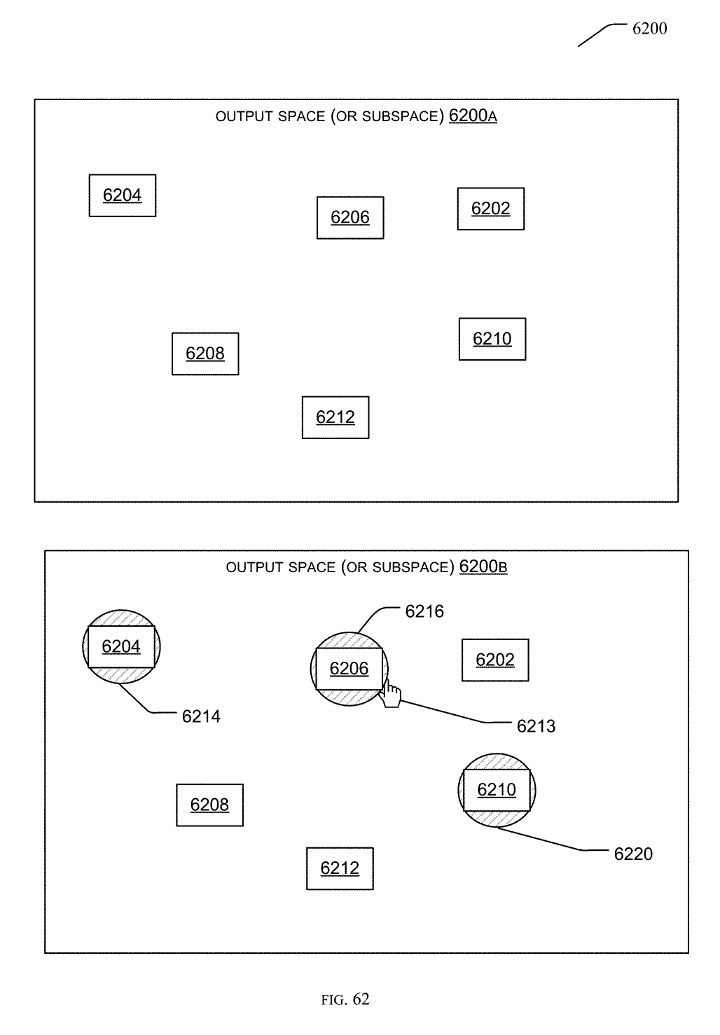

FIG. 62, illustrates views 6200 of an output space that includes a subspace. In a first view 6200a at a first time, the subspace is not user detectable in the output space. In the first view 6200a, the output space includes a first location 6202 for a first user interface element, a second location 6204 for a second user interface element, a third location 6206 for a third user interface element, a fourth location 6208 for a fourth user interface element, a fifth location 6210 for a fifth user interface element, and a sixth location 6212 for a sixth user interface element. A second view 6200b is also presented where a third indicator 6216 is presented underlying the third location 6206 of the third user interface element indicating the third user interface element is a member of the subspace. The third indicator 6216 may be presented in response to an interaction with the third user interface element as illustrated by a pointer user interface element 6213 over, in, or within a specified distance of the third location 6206 of the third user interface element. In an embodiment, a second indicator 6214 may be presented underlying the second location 6204 of the second user interface element and a fifth indicator 6220 underlying the fifth location 5210 of the fifth user interface element may be presented at the same time, in a sequence or other pattern, or during a part of the interaction with the third user interface element. The third indicator 6216, the second indicator 6214, and the fifth indicator 6220 may be associated by time or by some other visually detectable attribute to indicate, respectively, that the third user interface element, the second user interface element, and the fifth user interface element are in the same subspace. No indicators are associated with the first location 6202, the fourth location 6208, and the sixth location 6212 that indicates they are not in the subspace of the second user interface element, third user interface element, and fifth user interface element.

Circuitry, in an embodiment, may operate in detecting an indicator that a user interface element is in a subspace or is not in a subspace. An indicator may be based on, for example, one or more of a user input detected by an input device, an output presented to a user via an output device, or a change in either of the user detected input or the output presented to the user. For example, if the interaction is with a user interface element that is not in a first subspace, circuitry may be invoke to change an indicator for another user interface element that is in the first subspace. The indicator for the other user interface element may be removed, made invisible, hidden, presented with greater transparency, made smaller, or otherwise made less visible. In an embodiment, the indicator of inclusion in the first subspace for the other user interface element may be made more visible in response to the interaction. Alternatively or additionally, an interaction between a user and a user interface element in a subspace may be detected. In response to detecting the interaction, an indicator of inclusion in the subspace for the user interface element may be made visible or otherwise made more visible. In an embodiment, circuitry may operate to make an indicator of inclusion in the subspace invisible or otherwise less visible.

Circuitry, in an embodiment, may operate based on a criterion that is met based on a first location and a second location (e.g. see flow chart 6100). A distance between a location of a user interface element (e.g. a second location) and a location in a subspace (e.g. a first location) may be determined, a rate of change in distance may be determined, a distance from a boundary of the subspace whether inside or outside or overlapping the boundary may be determined, and the like. One or more of the foregoing in the previous sentence may be included in identifying whether an indicator of inclusion in a subspace should be made more or less visible. An indicator of inclusion in a subspace for a user interface element may be an indicator of membership of an operating instance, represented by the user interface, in an access context represented by the subspace. An indicator may be presented or made more visible as a user interface element in a subspace moves toward a boundary of the subspace or may be turned on when a threshold distance between the user interface element and the boundary meets a threshold distance, for example. An indicator that a user interface element is in a subspace may include moving the user interface element to a specified location in one or more dimensions of an output space that includes the subspace. For example, a user interface element in a subspace may be presented in front, behind, to the right of, to the left of, higher than, or lower than a user interface element not in a subspace as specified for an embodiment. A visibility of a user interface element in a subspace may be different than a visibility of a user interface element not in the subspace or not in any subspace. In an embodiment, a first user interface element in a subspace may become more transparent as a distance between the first user interface element and a second user interface element in the subspace increases (or decreases in another scenario). Any suitable, visibly detectable change may be used in addition to or instead of transparency. Inclusion in a subspace (or membership in an access context) may be indicated based on a color, a visual pattern, a size of a user interface element, a visual connection with another user interface element in the subspace or a lack of visual connection with a user interface element not in the same subspace, a location attribute, or a font—to name some examples. An indicator may be obscured or hidden via another user interface element in making it less visible.

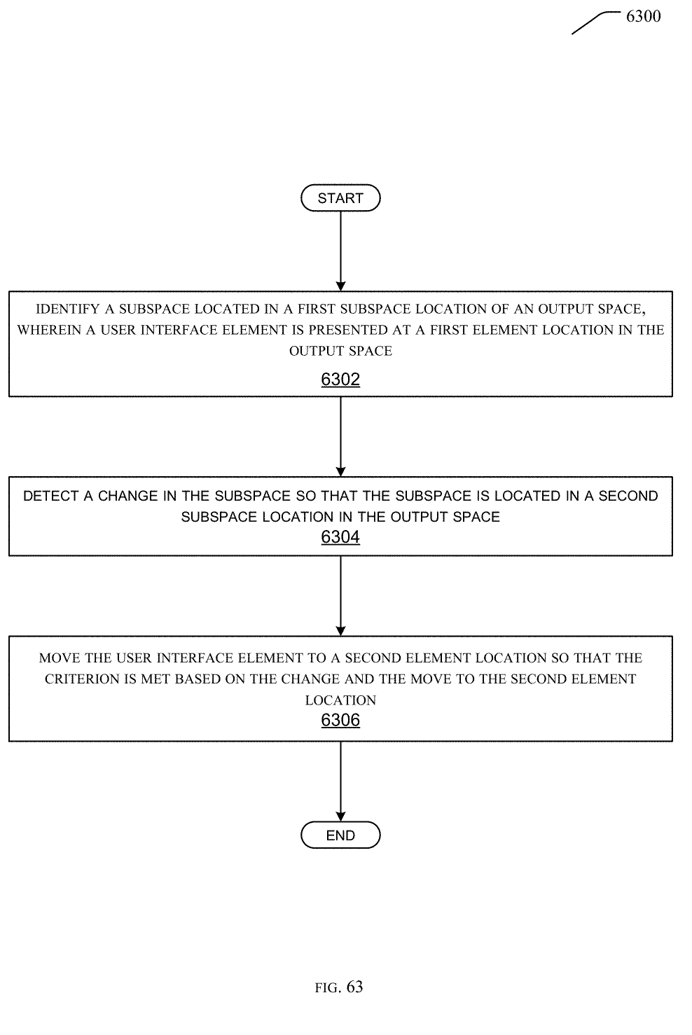

In an embodiment, a location of a subspace or of a user interface element in the subspace may change a location of a user interface element not in the subspace. The user interface element not in the subspace may be in another subspace or not in any subspace. FIG. 63 shows a flow chart 6300 in accordance with an embodiment of a method of the present disclosure. Circuitry may be included in an embodiment or a method may include providing circuitry that is operable for use with a system included in performing a method of flow chart 6300. Such a system may include one or more devices of one or more operating environments. At block 6302, the circuitry may operate in detecting a subspace located at a first subspace location of an output device. A user interface element may be presented at a first element location in the output space. At block 6304, the circuitry may operate in detecting a change in the subspace so the subspace is located at a second subspace location in the output space. At block 6306, the circuitry may operate in moving the user interface element to a second element location in response to detecting the subspace located in or being moved to the second subspace location. In an embodiment, the user interface element presented at the first element location may be in the subspace. Alternatively or additionally, the user interface element may not be in the subspace. The user interface element may represent another subspace.

A first subspace or a first user interface element at a first location in an output space may be located at second location in response to or based on a change to one or more of a location of a second subspace or a second user interface element. a size of the second subspace or the second user interface element, a shape of the second subspace or the second user interface element such as stretching or contracting some or all of the second subspace or the second user interface element, and the like. Subsequent to the change, the first subspace or the first user interface element may no longer be at the first location or may be at both the first location and the second location. In an embodiment, a criterion, based on the first subspace or first user interface element and the second subspace or the second user interface element, may be specified. The criterion may be met prior to a change to the second subspace or the second user interface element. In response to detecting the change, circuitry may operate, in an embodiment, that determines the specified criterion is not met. The first subspace or the first user interface element may be changed so that the criterion is met.

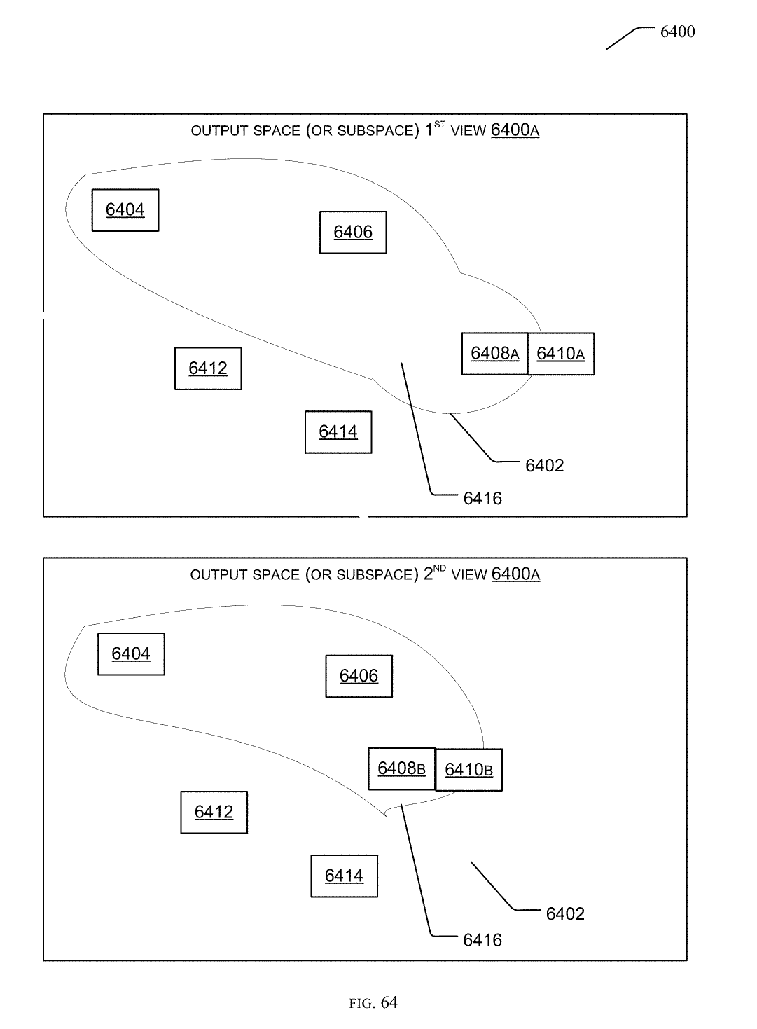

FIG. 64, illustrates views 6400 of an output space. A first view 6400a includes a subspace where a portion of a boundary of the subspace is at a first subspace location 6402. In the first view 6400a, the subspace includes first location 6404 for a first user interface element, a second location 6406 for a second user interface element, and a first-third location 6408a for a third user interface element. A first-fourth location 6410a for a fourth user interface element that is not in the subspace is shown. The fourth user interface element may be bound to the third user interface element. Also illustrated is a fifth location 6412 for a fifth user interface element as well as a sixth location 6414 for a sixth user interface element. A second view 6400b of the output space is also presented in FIG. 64. In the second view 6400b, the boundary is changed to include a second subspace location 6416. In the first view 6400a, the second subspace location is inside the subspace boundary. In the second view 6400b, the second subspace location 6416 is included, while the first subspace location 6402 is no longer in the subspace nor in the boundary. Note the shape and size of the subspace are different in the first view 6400a and the second view 6400b. As a result of the changed boundary in the second view 6400b, the third user interface element may be moved to a second-third location 6408b shown in the second view 6400b from the first-third location 6408a shown in the first view 6400a. The third user interface element may to moved so that the third user interface element remains in the subspace. In an embodiment, the fourth user interface element may be relocated, in order to meet a binding criterion, from the first-fourth location 6410a, shown in the first view 6400a, to a second-fourth location 6410b, shown in the second view 6400b. In an embodiment, the fifth user interface element may remain at the fifth location 6412 and the sixth user interface element may remain at the sixth location 6414. For more on binding of user interface elements or operating instances see U.S. Pat. No. 9,423,954, titled “Graphical User Interface Methods, Systems, and Computer Program Products”, issued on Aug. 23, 2016, by the present inventor.

In an embodiment, a user interface element in subspace may be moved so a criterion is met based on a change in a location of the subspace and the moving of the user interface element. A user interface element in the subspace or not in the subspace may be changed so a criterion is met after a change to a subspace or a user element that was met prior to the change in the subspace or the user interface element.

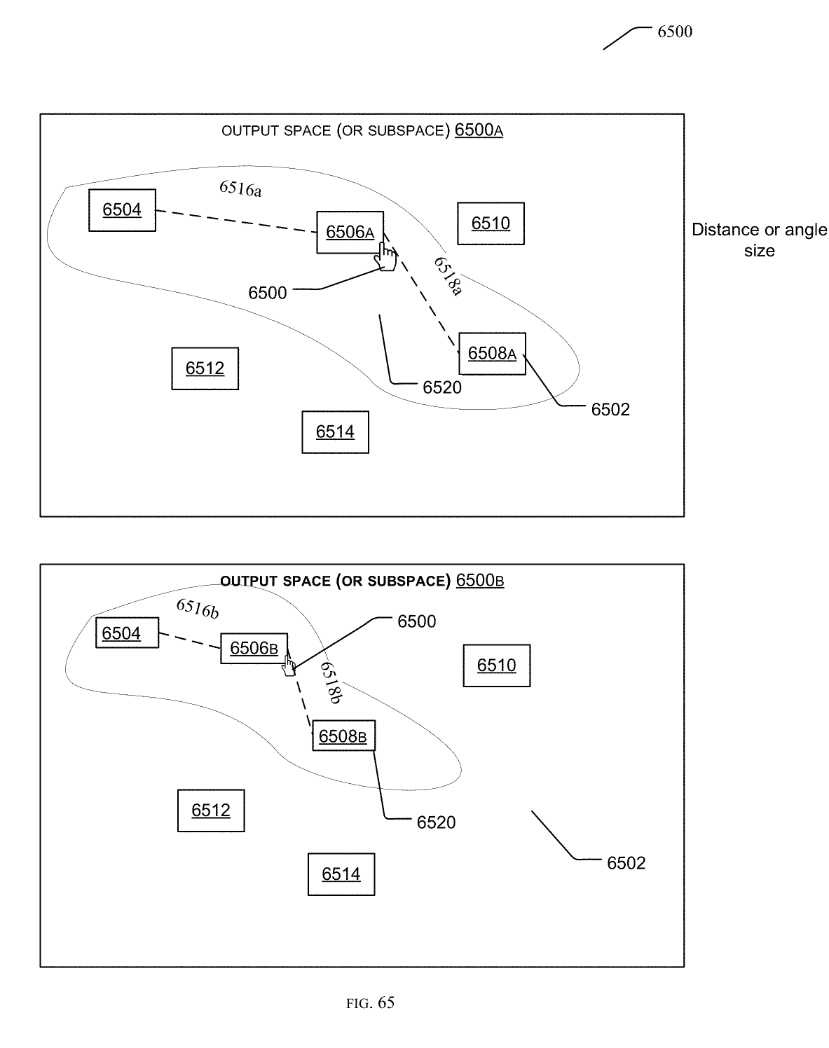

FIG. 65, illustrates views 6500 of an output space. A first view 6500a of the output space includes a subspace where a first portion of the subspace is at a first output space location 6502. In the first view 6500a, the subspace includes a first location 6504 for a first user interface element, a first-second location 6506a for a second user interface element, and a first-third location 6508a for a third user interface element. Note that the first-third location 6508a includes (or alternatively, may be include in) the first output space location 6502. A fourth location 6510 for a fourth user interface element that is not in the subspace is shown. Also illustrated is a fifth location 6512 for a fifth user interface element as well as a sixth location 6514 for a sixth user interface element, each not in the subspace. In an embodiment, the first user interface element, the second user interface element, and the third user interface element may be bound via a rule that specifies a condition that must be met based on a distance between the first user interface element and the second user interface element and a second distance between the second user interface element and the third user interface element. Alternatively or additionally, the condition may specify an angle or vector between the first user interface element and the second user interface element, an angle or a vector between the second user interface element and the third, or an angle or vector between the first user interface element and the third user interface element. For example, a ratio for a first distance with respect to a second distance may be specific (e.g. in a context set of an access context associated with a subspace). In the first view 6500a, a first-first distance 6516a is shown between the first location 6504 and the first-second location 6506a. A first-second distance 6518a is shown between the first-second location 6506a and the first-third location 6508a. A second view 6500b of the output space is also presented in FIG. 65. In the second view 6500b, the subspace is resized. In the second view 6500b, the third user interface element is moved from the first-third location 6508a to a second-third location 6508b located at a second output space location 6520 to keep the third user interface element in the subspace. Note the third user interface element is no longer in a location that includes the first output space location 6502. As a result, one of more of the first user interface element and the second user interface element may be moved so that the criterion based on a distance between the first user interface element and the second user interface element and based on a distance between the second user interface element and the third user interface element is met. In an embodiment, the second user interface element may be moved from the first-second location 6506a, shown in the first view 6500a, to a second-second location 6506b shown in the second view 6500a. The first user interface element may remain in the first location 6504. The first-first distance 6516a may be changed to a second-first distance 6516b and the first-second distance 6518a may be changed to a second-second distance 6518b, so that the criterion is met.

A criterion specified for user interface elements in a subspace may be based on a distance, an angle, a color, a visibility criterion, or any other attribute that may be bound between or among two or more user interface elements in or not in a subspace or that may be bound between or among one or more user interface elements and a boundary or other portion of a subspace.

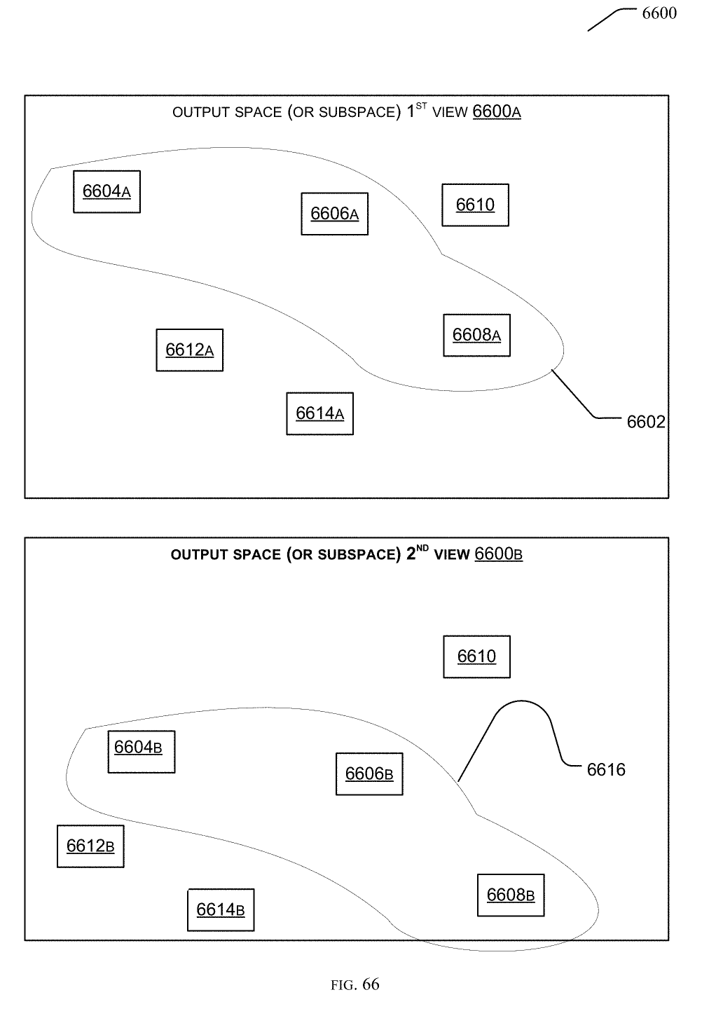

FIG. 66, illustrates views 6600 of an output space. A first view 6600a of the output space includes a subspace identified by a boundary at a first boundary location 6602. In the first view 6600a, the subspace includes a first-first location 6604a for a first user interface element, a first-second location 6606a for a second user interface element, and a first-third location 6608a for a third user interface element. Also illustrated is fourth location 6610 of a fourth user interface element, a first-fifth location 6612a for a fifth user interface element, and a first-sixth location 6614a for a sixth user interface element. The fourth location 6610, the first-fifth location 6612a, and the first-sixth location 6614 and their respective user interface elements are not in the subspace. A second view 6600b of the output space is also presented in FIG. 66. In the second view 6600b, the subspace is shifted to a different portion of the output space included in a boundary at a second boundary location 6616. In the second view 6600b, the first user interface element, the second user interface element, and the third user interface element may be moved to keep them in the subspace or to ensure some other specified criterion is met. The first user interface element may be moved from the first-first location 640a shown in the first view 6400a to a second-first 6604b. The second user interface element is moved to a second-second location 6606b. The third user interface element is moved to a second-third location 6608b. In the second view 6600b, the fifth user interface element may show moved to a second-fifth location 6612b and the sixth user interface element is moved to a second-sixth location 6614b to present them outside the moved subspace identified by the boundary at the second boundary location 6616 or to ensure some other specified criterion between one or both of the fifth user interface element and the sixth user interface element and based on the subspace or one or more user interface elements in the subspace is met. The fourth user interface element is shown in the fourth location, unmoved from the first view 6600a to the second view 6600b. The fifth user interface element or the sixth user interface element may be moved to meet a criterion that is based on whether the subspace overlaps the fifth user interface element or the sixth user interface element, a criterion based on a subspace (not shown) that includes one of both of the fifth user interface element or the sixth user interface element, a criterion based on one or more of the first user interface element, the second user interface element, and the third user interface element and one or both of the fifth user interface element, the sixth user interface element, or a subspace of one or both of the fifth user interface element or the sixth user interface element. Alternatively or additionally, the fifth user interface element or the sixth user interface element may be moved based on a criterion that is based at least one subspace (not shown) that includes one or more of the first user interface element, the second user interface element, and the third user interface element and that also includes one or both of the fifth user interface element and the sixth user interface element.

A moving or other change to a user interface element may be performed automatically in response to determining that a specified criterion is not met. Note that the second view 6600b illustrates that a portion of a subspace may not be in a visible portion of an output space as shown by a portion of the second boundary location 6616 outside the visible output space.

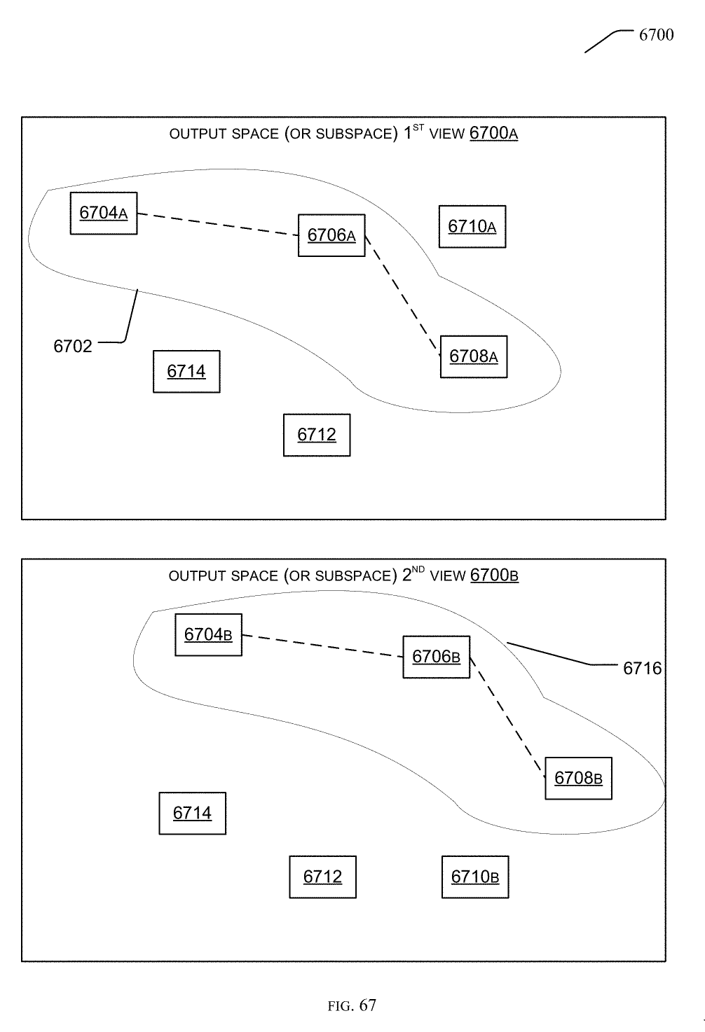

FIG. 67, illustrates views 6700 an output space. A first view 6700a includes a subspace bounded by a boundary at a first boundary location 6702 in the output space. In the first view 6700a, the subspace includes a first-first location 6704a for a first user interface element, a first-second location 6706a for a second user interface element, and a first-third location 6708a for a third user interface element. Also illustrated, not in the subspace, is first-fourth location 6710a of a fourth user interface element, a fifth location 6712 for a fifth user interface element, and a sixth location 6714 for a sixth user interface element. A second view 6700b of the output space is also presented in FIG. 67. In the second view, the subspace is bounded by a boundary at a second boundary location 6716. In the second view 6700b, the first user interface element, the second user interface element, and the third user interface element may be moved to keep them in the subspace or to ensure some other specified criterion is met. The first user interface element is moved to a second-first location 6704b. The second user interface element is moved to a second-second location 6706b. The third user interface element is moved to a second-third location 6708b. In the second view 6700b, the fifth user interface element and the sixth user interface element are each not moved from the fifth location 6712 and the sixth location 6714, respectively, that are each shown in both the first view 6700a and the second view 6700b. The fourth user interface element is shown moved to a second-fourth location 6710b. The fourth user interface element may be moved based on a criterion that is based on whether the subspace overlaps the fourth user interface element, a criterion based on a subspace (not shown) that includes the fourth user interface element, a criterion based on one or more of the first user interface element, the second user interface element, and the third user interface element and the fourth user interface element, or a subspace of the fourth user interface element. Alternatively or additionally, the fourth user interface element may be moved based on a criterion that is based at least one subspace (not shown) that includes one or more of the first user interface element, the second user interface element, and the third user interface element and that also includes the fourth user interface element.

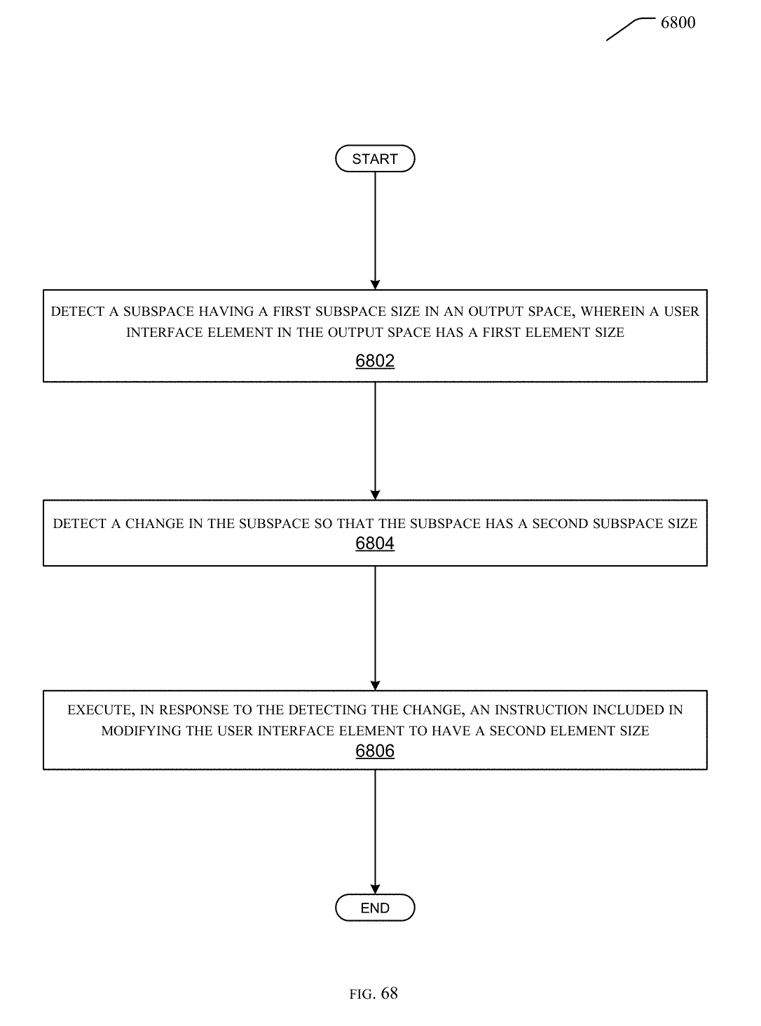

FIG. 68 shows a flow chart 6800 in accordance with an embodiment of a method of the present disclosure. Circuitry may be included in an embodiment or a method may include providing circuitry that is operable for use with a system included in performing a method of flow chart 68. Such a system may include one or more devices of one or more operating environments. At block 6802 in flow chart 6800, the circuitry may operate in detecting a subspace having a first subspace size in an output space. A user interface element in the output space may have a first element size. At block 6804, the circuitry may operate in detecting a change in the subspace size so that the subspace has a second subspace size. At block 6806, the circuitry may operate, in response to detecting the change, in executing an instruction or performing some other operation included in modifying the user interface element to have a second element size. The modified user interface element may be in the subspace or not, in an embodiment.

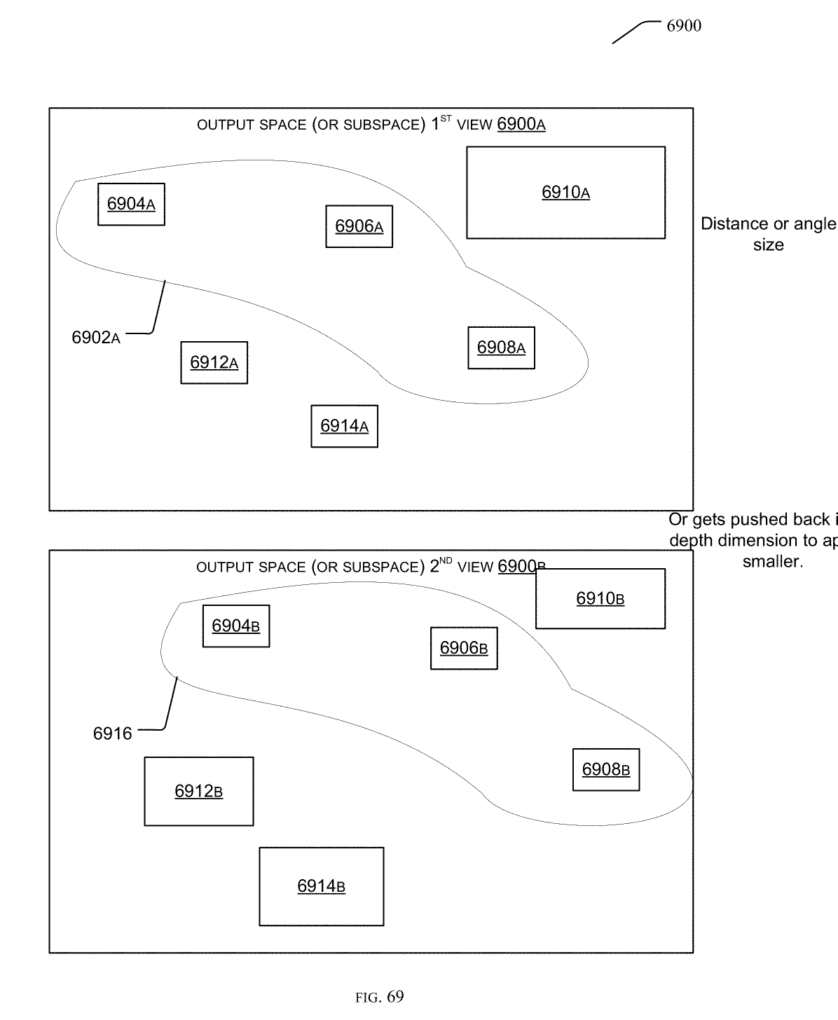

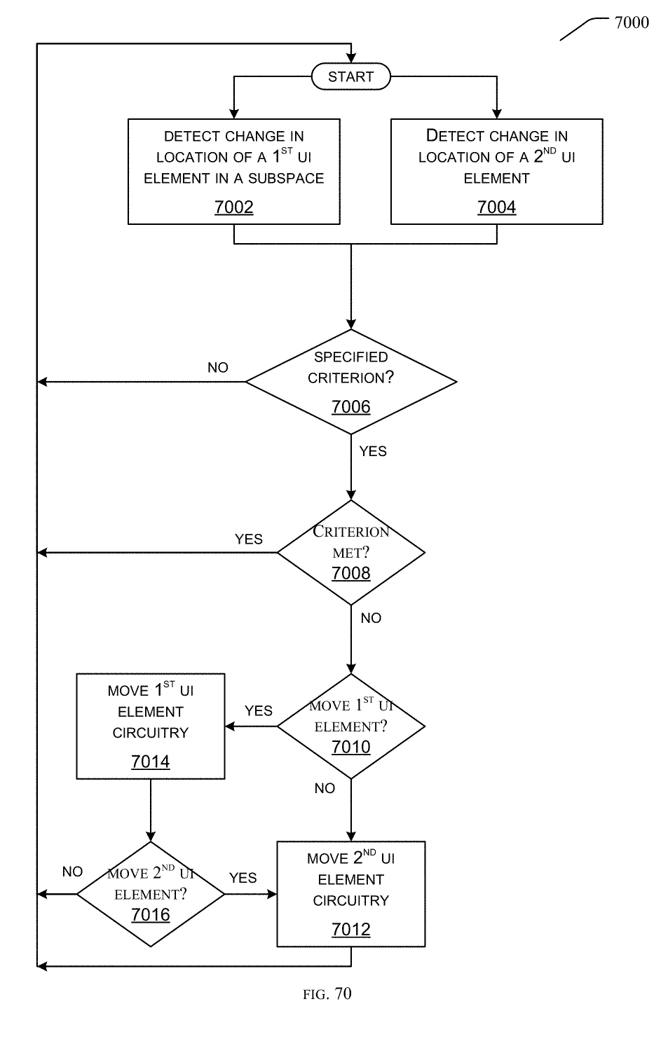

FIG. 69, illustrates view 6900 of an output space. A first view 6900a includes a subspace in a portion of the output space in a first boundary 6902a. In the first view 6900a, the subspace includes a first-first location 6904a for a first user interface element, a first-second location 6906a for a second user interface element, and a first-third location 6908a for a third user interface element. Also illustrated are locations for user interface elements not in the subspace. The first view illustrates a first-fourth location 6910a of a fourth user interface element, a fifth location 6912 for a fifth user interface element, and a sixth location 6914 for a sixth user interface element. A second view 6900b of the output space is also presented in FIG. 69. In the second view 6900b, the subspace in a different portion of the output space in a second boundary 6902b. In the second view 6900b, the first user interface element, the second user interface element, and the third user interface element may be moved to keep them in the subspace or to ensure some other specified criterion is met. They may, alternatively or additionally, be resized (not shown). The first user interface element is shown moved to a second-first location 6904b in the second view 6900b. The second user interface element is moved to a second-second location 6906b. The third user interface element is moved to a second-third location 6908b. In the second view 6900b, the fifth user interface element and the sixth user interface element are each not moved from the first view 6900a, but both are resized as shown by a second-fifth location 6912b and a second-sixth location 6914b, respectively. The fourth user interface element is shown moved and resized as shown by a second-fourth location 6910b of the fourth user interface element in the second view 6900b. The fourth user interface element, the fifth user interface element, or the sixth user interface element may be resized based on a measure of visibility, based on a change in an operational state, based on a size of a portion of the output space in which the one or more user interface elements (i.e. the fourth user interface element, the fifth user interface element, or the sixth user interface element) may be at least partially visible, or based on a distance to the subspace or a user interface element in the subspace from the one or more user interface elements not in the subspace (i.e. the fourth user interface element, the fifth user interface element, or the sixth user interface element).

FIG. 70 shows a flow chart 7000 in accordance with an embodiment of a method of the of the present disclosure. In various embodiments, circuitry may be included in a system or circuitry may be provided that is operable for use with a system included in performing a method of flow chart 7000. Such a system may include one or more devices of one or more operating environments. At block 7002, the circuitry may operate in detecting change in a location of a first user interface element in a subspace in an output space. At block 7004, the circuitry may, alternatively or additionally, operate in detecting change in a location of a second user interface element in the output space. At block 7006, the circuitry may operate in accessing a specified criterion associated with one or both changes. If there is no criterion associated with a detected change, then the circuitry may wait for a next change. At block 7008, the circuitry may operate in determining whether the criterion is met or not met based on one or both changes. If the criterion is met then the circuitry may wait for a change. If the criterion is not met, then at block 7010, the circuitry may operate in determining which of the first user interface element or the second user interface element to move (or change in some other way) so that the criterion is met. If the first user interface element is not to be moved, then at block 7012, the circuitry may operate in moving the second user interface element only. Control may return to wait for a change. If the first user interface element is to be moved, then at block 7014, the circuitry may operate in moving the first user interface element. At block 7016, the circuitry may operate in determining whether the second user interface element is to be moved. If not, control returns to wait for a change. If the second user interface element is to be moved, then control is passed to circuitry that moves the second user interface element as depicted by the “YES” flow from block 7016 to block 7014.

In an embodiment, a criterion based on a z-ordering or relative locations in a depth dimension may be specified that changes the z-ordering or changes the relative locations in response to a change, such as a move, to a subspace or to a user interface element in an output space. The user interface element may be in the subspace in a scenario. In another scenario, the user interface element may not be in the subspace. Alternatively or additionally, a criterion based on a z-ordering or relative locations in a depth dimension may be specified that preserves the z-ordering or preserves the relative locations in response to a change to a subspace or to a user interface element in an output space. The user interface element may be in the subspace in a scenario. In another scenario, the user interface element may not be in the subspace.

In an embodiment, circuitry may be included or may otherwise be operable for use with a system. The circuitry may operate in detecting a subspace in a first location in an output space. The subspace may include multiple user interface elements each representing a respective operating instance. Further, each user interface element may be in a location in a z-ordering. For example, each user interface element may be presented assigned to a respective z-level or coordinate in a depth dimension of the output space or the subspace. The circuitry may also operate in receiving an indication to move the subspace. The indication may identify a move in one or more dimensions of the output space. The circuitry may further operate in moving, in response to receiving the indication, the subspace. Moving may include a moving of the entire subspace, an expanding of some or all of the subspace, a contracting of some or all of the subspace, a reshaping, or a rotation of some or all of the subspace. As a result of the moving, some or all of the subspace is no longer included in the first location. Alternatively or additionally, the some or all of the subspace may be in a second location that includes no part of the subspace prior to the moving. Still further, the circuitry may operate in modifying one or more of the user interface elements in response to the moving to preserve the z-ordering of the user interface elements in the subspace.

Alternatively or additionally, in an embodiment, an ordering in a width dimension or an ordering in a height dimension may be preserved for user interface element in subspace by a modifying operation performed in response to a moving, resizing, reshaping, or other changing of the subspace. In an embodiment, a distance between two or more user interface elements in a depth dimension may be preserved. A distance between two or more user interface elements in a depth dimension may be changed while preserving the ordering. Relative distances between the two or more user interface elements may also be preserved or not as desired for an embodiment.

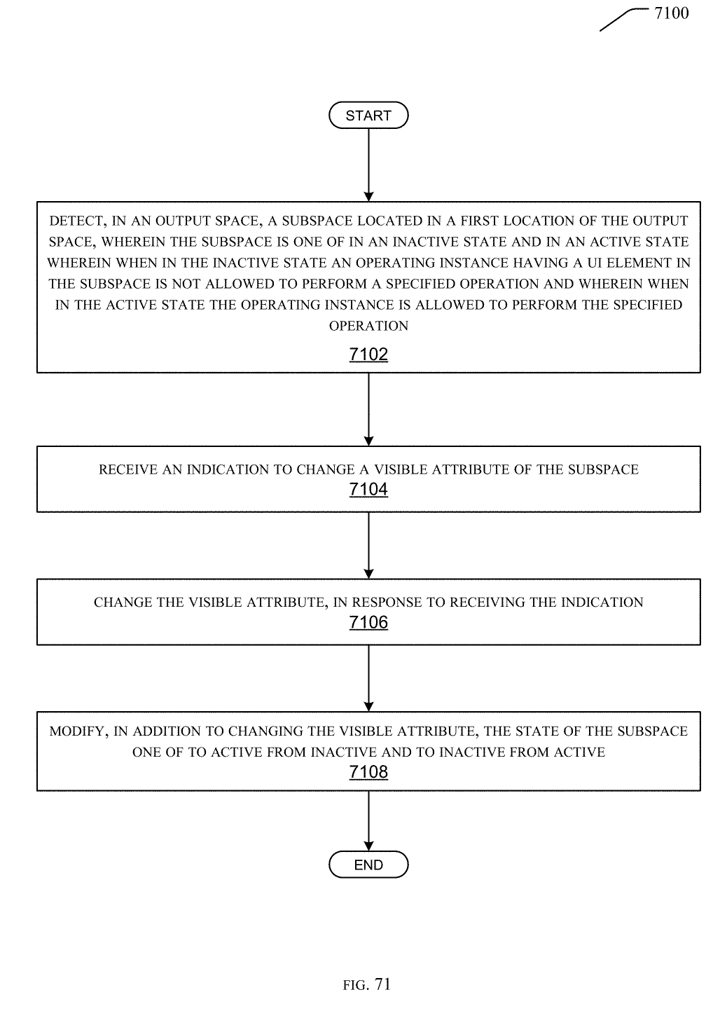

FIG. 71 shows a flow chart 7100 in accordance with an embodiment of a method of the present disclosure. Circuitry may be included in an embodiment or a method may include providing circuitry that is operable for use with a system included in performing a method of flow chart 7100. Such a system may include at least one device of at least one operating environment. At block 7102, the circuitry may operate in detecting in an output space, a subspace located in a location of the output space, wherein the subspace is one of in an inactive state and in an active state wherein when in the inactive state an operating instance having a user interface element in the subspace is not allowed to perform a specified operation and wherein when in the active state the operating instance is allowed to perform the specified operation. At block 7104, the circuitry may operate in receiving an indication to change a visible attribute of the subspace. At block 7106, the circuitry may operate in changing, in response to receiving the indication, the visible attribute. At block 7108, the circuitry may operate in modifying, along with or in addition to changing the visible attribute, the state of the first subspace one or to active from inactive and to inactive from active. As an alternative, modifying may be performed in response to detecting the change to the visible attribute, where the receiving the indication and changing of the visible attribute may not be performed by an embodiment of the alternative method.

In an embodiment, an operation, allowed when a subspace is in an active state and not allowed when the subspace is an inactive state, may include interacting with a user via an input device or an output device. For example, in an active state a user interface element in the subspace may be assigned an input focus for an input device allowing an operating instance of the user interface element to interact with a user via the input device. Alternatively or additionally in the active state, a user interface element may be assigned an output focus for an output device allowing the operating instance to interact with a user via the output device. When in an inactive state, the user interface element may not be assigned the input focus or the output focus. A state for a subspace may be associated with an operation included in exchanging data via a network, for communicating via a first communications agent that represents a user as a communicant, for retrieving data, for storing or changing stored data, and so on. For example, an exchange may be between a user represented by a communications agent having a user interface element in the subspace and a communications agent representing another communicant may be allowed for an operating instance having a user interface element in a subspace that is in an active state for communicating between or among communicants.

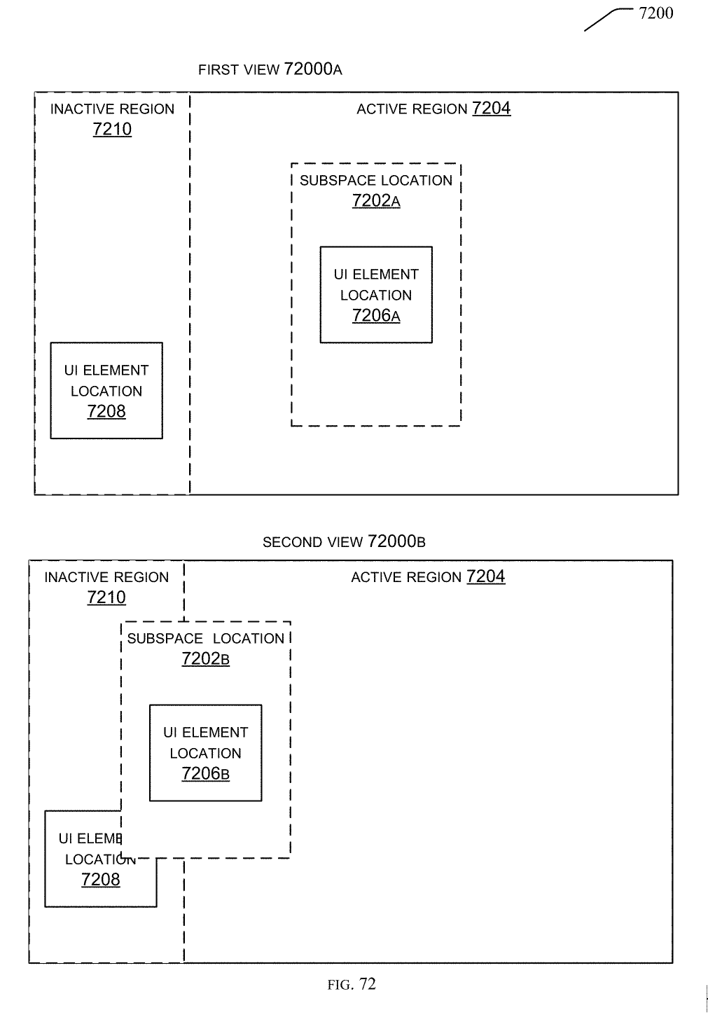

FIG. 72, illustrates views 7200 of an output space A first view 7200a is shown including a subspace at first subspace location 7202a in an active region 7204 shown in both the first view 7200a and the second view 7200b of the output space. In the first view 7200a, a first user interface element is in the active region 7204 when in a first-first location 7206a in the subspace while in the first subspace location 7202a. In both the first view 7200a and the second view 7200b, a second user interface element is presented in a second location 7208 in the inactive region 7210. In an embodiment, an operating instance of the first user interface element may receive processor time while in the first-first location 7206a when the subspace is in the first subspace location 7202a in the active region 7204 as shown in the first view 7200a. The operating instance of the second user interface element while in the second location 7208 in the inactive region 7206 may be halted, placed in a sleep state, or hibernated so that instructions in the operating instance of the second user interface element are not executed by a processor. To deprive the operating instance of the first user interface element processor time, the subspace may be moved completely into or partially into, according to an embodiment, the inactive region 7210 as shown by the second subspace location 7202b as shown in the second view 7200b. The first user interface element may be in a first-second user interface element location 7206b location in the second subspace location 7202b during or as a result of moving the subspace. Access to a processor is provided merely as an example of operation that may be performed or not performed based on a state associated with a subspace. A state of subspace may be in a context set of an access context that includes the subspace as a context resource, is represented by the subspace, or has another relationship with the subspace.

In an embodiment, circuitry may be included or may otherwise be operable for use with a system. The circuitry may operate in identifying a subspace in a first location of an output space of an output device. The subspace may include a first user interface element of a first operating instance and second user interface element of a second operating instance. In an embodiment, the first user interface element and the second user interface element may not have a same parent user interface element or may have a parent user interface element that is not in the subspace. Alternatively or additionally, neither of the first user interface element and the second user interface element is a parent of the other. The circuitry may also operate in assigning an output focus resource in a context set of the subspace. When the output focus resource is assigned a first setting, both the first user interface element and the second user interface element may be assigned output focus for an output device. When the output focus resource is assigned a second setting or when the output focus resource is removed from the context set, both the first user interface element and the second user interface element are not assigned the output focus for an output device. The output device may be a same device for each of the first user interface element and the second user interface element or may be different output devices for each of the first user interface element and the second user interface element.

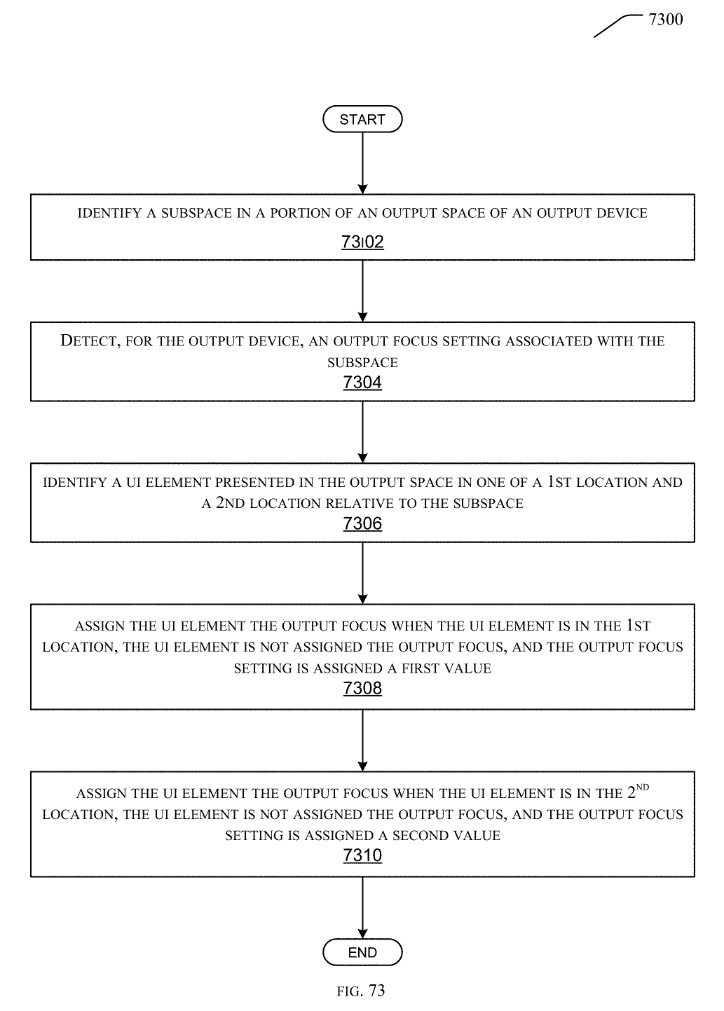

FIG. 73 shows a flow chart 7300 in accordance with an embodiment of a method of the present disclosure. In various embodiments, circuitry may be included in a system or circuitry that is operable for use with a system may otherwise be provided. At block 7302, the circuitry may operate in identifying a subspace in a portion of an output space of an output device. At block 7304, the circuitry may operate detecting, for the output device, an output focus setting associated with the subspace, as described elsewhere herein. Alternatively or additionally, the circuitry may operate in detecting, for an input device, an input focus setting associated with the subspace. At block 7306, the circuitry may operate in identifying a user interface element presented in the output space in one of a first location and a second location relative to the subspace. Block 7308 may be performed, when the user interface element is in the first location, the user interface element is not assigned the output focus, and the output focus setting is assigned a first output focus value. At block 7308, the circuitry operates in assigning the user interface element the output focus. Block 7310 may be performed in addition to or as an alternative to block 7308. According to block 7308, when the user interface element is in the second location, the user interface is not assigned the output focus, and the output focus setting is assigned a second value; the circuitry operates in assigning the user interface element the output focus.

Analogously, in addition to or instead of assigning output focus, when the user interface element is in the first location, the user interface element is not assigned an input focus, and an input focus setting associated with the subspace is assigned a first value; circuitry may be included in an embodiment that operates in assigning the user interface element the input focus. In addition to or as an alternative, when the user interface element is in the second location, the user interface is not assigned the input focus, and the input focus setting is assigned a second value; circuitry may be included in an embodiment to operate in assigning the user interface element the output focus.

In an embodiment, the circuitry may also operate in detecting a change in relative location, with respect to a subspace, of a user interface element from one of a first location and a second location to the other one of the first location and the second location. With respect to the subspace, the change may be in at least one of a horizontal direction and a vertical direction. In an embodiment, the user interface element may not be minimized when the output focus is assigned to the user interface element. The circuitry, may further, operate in modifying, in response to detecting the move, an output focus or an input focus assignment for the user interface element so that when, relative to the subspace, the user interface element is in the first location the user interface element may have the output focus or may have the input focus when the subspace has the output focus or when the subspace has the input focus, may not have the output focus or may not have the input focus when the subspace does not have the output focus or when the subspace does not have the input focus. Further, when the user interface element is in the second location the user interface element may not have the output focus or may not have the input focus when the subspace has the output focus or when the subspace has the input focus, and may have the output focus or may have the input focus when the subspace does not have the output focus or when the subspace does not have the input focus. Other capabilities or attributes, in addition to or instead of input focus or output focus, may be controlled or managed based on a relative location of a user interface element is with respect to a subspace such a audio output focus, communications capabilities, user access, network capabilities, and so on.

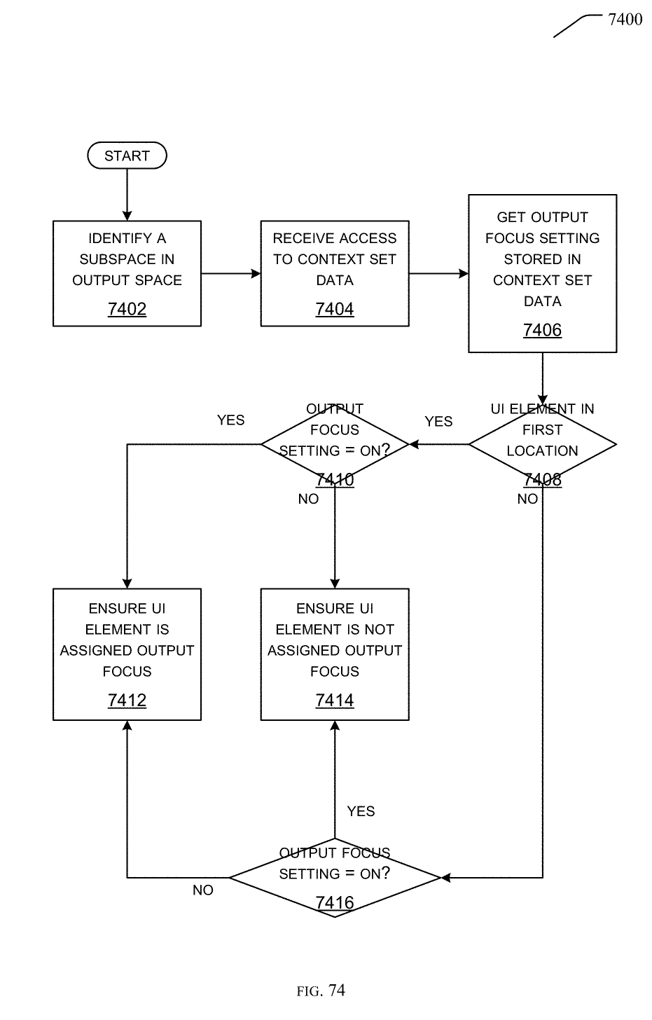

FIG. 74 shows a flow chart 7400 in accordance with an embodiment of a method of the present disclosure. In various embodiments, circuitry may be included in a system or circuitry may be provided that is operable for use with a system included in performing a method of flow chart 7400. At block 7402, the circuitry may operate in identifying a subspace in an output space. At block 7404, the circuitry may operate in receiving access to context set data for the identified subspace. The context set data may be in a context set of an access context associated with the subspace. At block 7406, the circuitry may operate in accessing an output focus setting included in the context set. At block 7408, the circuitry may operate in determining whether a user interface element is in a specified location. At block 7410, the circuitry may operate in checking the output focus setting. At block 7412, the circuitry may operate in assigning output focus for an output device to the user interface element or to an operating instance of the user interface element, if at block 7410 the output focus setting is determined to have a first value and at block 7408 the user interface element is detected in the specified location. At block 7414, the circuitry may operate in removing the output focus assignment from the user interface element or the operating instance when the output focus is assigned to the user interface element or the operating instance, if at block 7410 the output focus setting is determined to have a second value or some other value that is not the first value and at block 7408 the user interface element is detected in the specified location. Also at block 7412, the circuitry may operate in assigning output focus for an output device to the user interface element or to an operating instance of the user interface element, if at block 7416 the output focus setting is identified as the first value and at block 7408 the user interface element is not detected in the specified location. Further at block 7414, the circuitry may operate in removing the output focus assignment from the user interface element or the operating instance when the output focus is assigned to the user interface element or the operating instance, if at block 7416 the output focus setting is determined to have a second value or some other value that is not the first value and at block 7408 the user interface element is not detected in the specified location.

Some or all of a specified location may be in a subspace in an embodiment. Alternatively or additionally, some or all of a specified location may not be in a subspace.

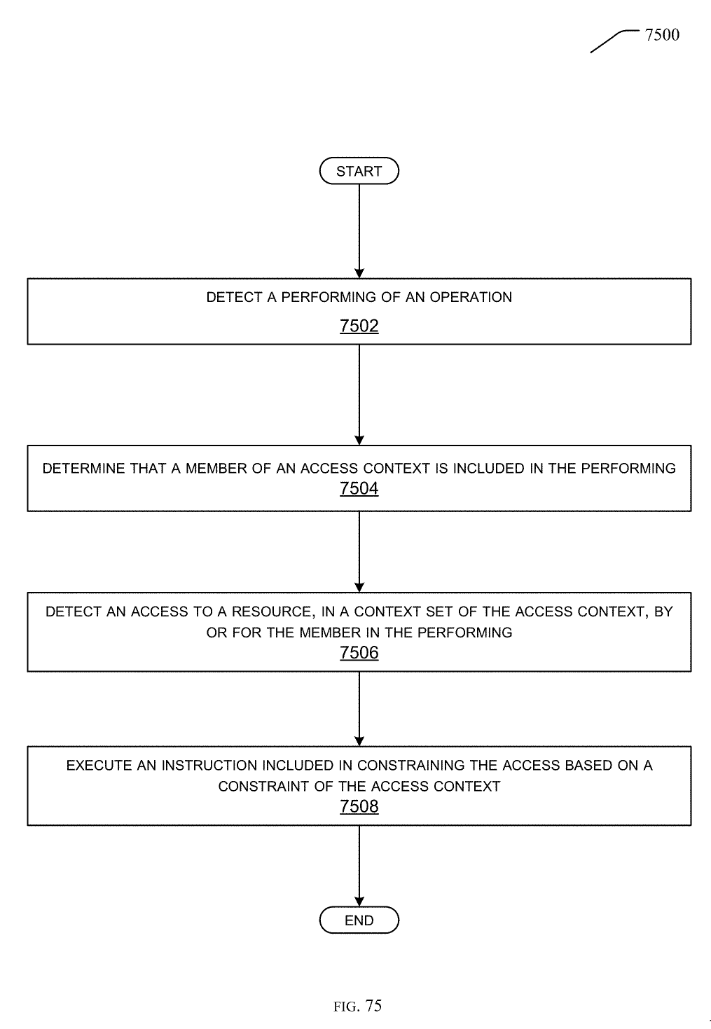

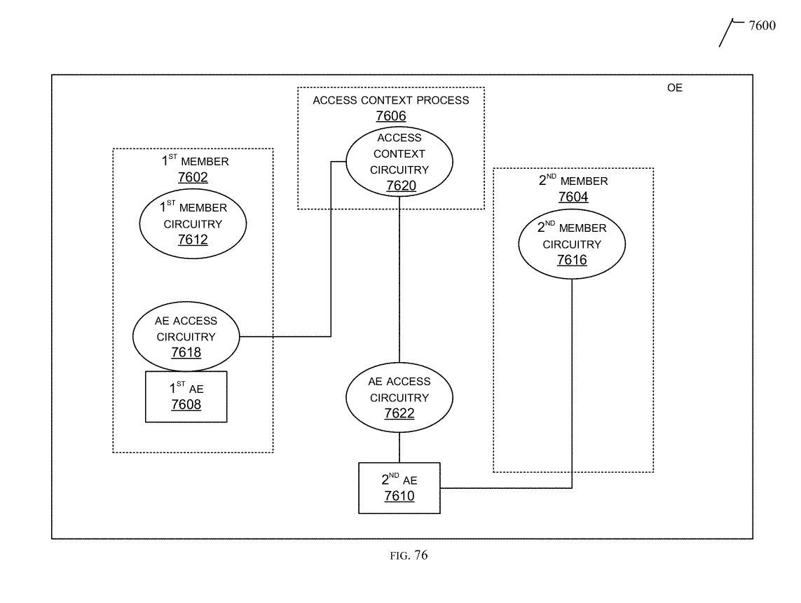

FIG. 75 shows a flow chart 7500 in accordance with an embodiment of a method of the present disclosure. In various embodiments, circuitry may be included in a system or circuitry may be provided that is operable for use with a system included in performing a method of flow chart 7500. Such a system may include a processor and a processor memory accessible to the processor. At block 7502, the circuitry may operate in detecting a performing of an operation. At block 7504, the circuitry may operate in detecting that a member of an access context is included in the performing. At block 7506, circuitry may operate in identifying a resource accessed by the member is a context resource of the access context. That is, an access to the resource by the member in the performing may be detected. At block 7508, the circuitry may operate in executing an instruction included in constraining the accessed based on the context resource in the context set. The access or the resource is changed via a constraint of the access context.

When an operating instance is a member of an access context and accesses a resource, such as an addressable entity, the access is constrained by the access context when the resource is in the context set of the access context. When the accessed resource is not in the access context or the operating instance is not a member of the access context, the access takes places as allowed by the operating environment of the operating instance. Note that a constraint of an access context refers to a difference in accessing the addressable entity when a member than when not a member of the access context. Thus, a constraint may constrict, expand, or change access to a resource or in a mechanism for accessing a resource. Detecting an access to a resource may include enforcing a constraint before or during the access. Alternatively or additionally, a resource or a mechanism for accessing a context resource of an access context may be applied prior to detecting an access.

A resource or a context resource may be an addressable entity. An addressable entity may be any entity specified in source code written in a programming language. An addressable entity may be accessed, by a processor as data or machine code in a processor memory. The machine code may be a translation of the source code. Examples of addressable entities as specified in a programming language include data such as variables and constants and instructions such as subroutines and function.

FIG. 76 shows a system 7600 that may operate in performing one or more methods of the subject matter of the present disclosure, such as a method of flow chart 7500. FIG. 76 shows a system 7600 that includes a first member 7602 of an access context. The first member may operate via virtual circuitry 7612 realized by a processor, such as processor 3710 in FIG. 37, executing code, such as first member code 3720, as described above. Similarly, system 7600 includes a second member 7604 that may be realized via an operation of second member circuitry 7616. Second member circuitry 7616 may be realized, at least in part, by processor 3710 executing code of an operable entity, such as second member code 3720 in FIG. 37. An access context process 7606 is illustrated that may operate as virtual circuitry 7620 realized by processor 3710 executing access context code 3742 in FIG. 37. FIG. 76 also illustrates an addressable entity 7608 of the first member 7602 accessed by or for the first member 7602. For example, addressable entity 7608 may be a variable, a interprocess communication mechanism, a file handle, a buffer for exchanging data via a network, an output space of subspace for interacting with a user via an output device, an event received in response to an input detected via an input device, a function, a method, an instance of class translated from code written in an object oriented programming language, an aspect (i.e. a pointcut, a jointpoint, or advice), machine code of a code library stored in a processor memory and linked to machine code of the first member 7602 via a symbolic reference, an interprocess communications mechanism, data stored in a memory, a memory or a portion of a memory, a database, a network protocol endpoint, a user interface element of the first member 7602, a semaphore, a queue, a data stream, an address of a network service, or a user—to name a few examples in addition to others just identified and those identified elsewhere in the present disclosure. The first addressable entity 7608 may be included in the context set of the access context. Similarly, a second addressable entity 7610, which in a scenario illustrated is not included in the second member 7604, may be accessed as constrained by an access context by or for the second member 7604. The second addressable entity 7610 may be a member of the same access context as the first addressable entity 7608 during an operation of an embodiment. In an embodiment, the first addressable entity and the second addressable entity may be included in a same addressable entity (not shown). Second member circuitry 7616 may be realized by execution of the second member code 3730 by the processor 3710 as described with respect to FIG. 37. Addressable entity access circuitry 7618 may be realized as virtual circuitry, at least in part, based on execution of code generated from or written in a programming language to detect a change, to operate in changing, or to operate in an access of the first addressable entity 7608 during operating of the first member 7602. Addressable entity access circuitry 7618 may be included in the first member 7602. First addressable entity access circuitry 7618 may be included in first member circuitry 7612 in an embodiment. Addressable entity access circuitry 7618 may be realized as virtual circuitry, at least in part, based on execution of code generated from or written in a programming language to detect a change, operate in changing, or to operate in accessing addressable entity 7610 by or for the second member 7604. Addressable entity access circuitry 7622 may operate in an operating instance other than the second member 7604. In an embodiment, addressable entity access circuitry 7622 may be included in access context circuitry 7620. Addressable entity access circuitry 7622 may exchange information or otherwise interoperate with the second member 7604 via an interprocess communication mechanism, via a network, or via a reference such as a processor memory address. Note the first member 7602 and the second member 7604 may operate in a same device or the same operating environment in an embodiment. The first member 7602 and the second member 7604 may operate in different devices or different operating environments in an embodiment.

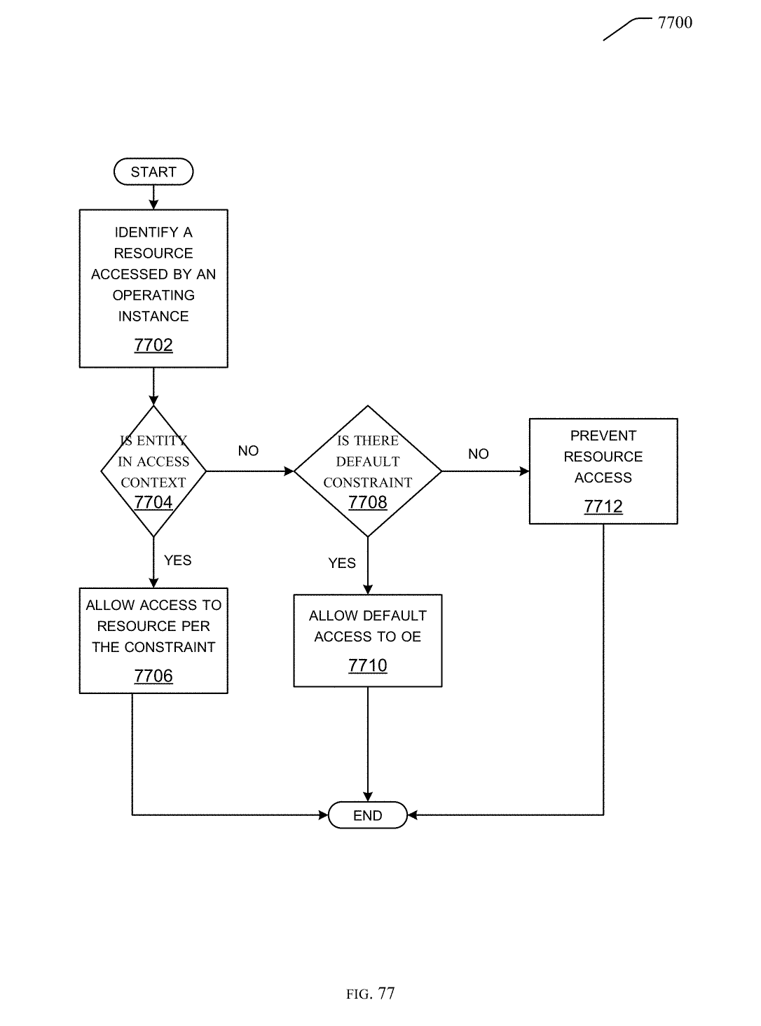

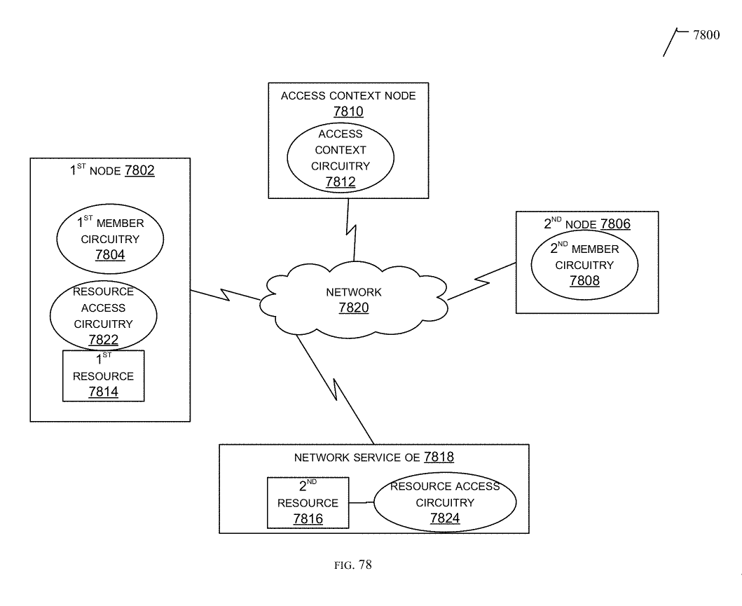

FIG. 77 shows a flow chart 7700 in accordance with an embodiment of a method of the present disclosure. In various embodiments, circuitry may be included in a system or circuitry may be provided that is operable for use with a system included in performing the flow chart 7700. At block 7702, the circuitry may operate in identifying a resource accessed by an operating instance. At block 7704, the circuitry may operate in determining whether the operating instance is a member of an access context. At block 7706, the circuitry may operate in allowing the operating instance to access a resource per a constraint of the access context, when the operating instance is determined to be a member of the access context. At block 7708, the circuitry may operate in determining whether a default constraint is defined, if the operating instance is not in the access context per the determination in block 7704. At block 7710, the circuitry may operate in allowing the operating instance to access a suitable resource per the default constraint, when it is determined, via circuitry corresponding to block 7708, that a default constraint is specified. At block 7712, the circuitry may operate in preventing the operating instance from accessing the resource if there is no specified default.

In an embodiment, a resource may in a context set of an access context in an operating environment. An operating instance that is not a member of the access context may access a different resource. For example, a file system path for template documents may be a first specified path for a member of the access context and may be second specified path specified for the operating environment. Alternatively or additionally, a resource accessible to a member of an access context in an operating environment may not be available to an operating instance, in the operating environment, that is not a member of the access context. For example, a user name or password may be accessible to a member of the access context, but not accessible to an operating instance that is not a member of the access context.

FIG. 78 shows a system 7800 that may operate in performing one or more methods of the subject matter of the present disclosure, such as a method of flow chart 7500. FIG. 78 shows that system 7800 includes a first node 7802 which may be or which may otherwise include a first member of an access context. The first member may operate via first member circuitry 7804. Similarly, system 7800 includes a second node 7806 that may be or that may include a second member realized via an operation of second member circuitry 7808. A node 7810 is illustrated that may be include or may be included in an access context which may operate, at least in part, based on circuitry 7812. In an embodiment, access context node 7810 may be provided by a cloud service provider or may be included in a cloud operating environment. Node 7810 may be a physical device or may be a virtual node realized via one or more physical devices. The first member and the second member may be members of the access context realized, at least in part, via access context circuitry 7812. FIG. 78 also illustrates a first resource 7814 of the first node 7802 accessed by or for the first member realized via the first member circuitry 7804. For example, resource 7814 may be a network interface, an interprocess communications mechanism, data stored in a memory, a memory or a portion of a memory, a database, a machine code library referenced by the first member, a user interface element of the first member, a semaphore, a stack, a list, a table, a queue, a data stream, an address of a network service, or a user—to name a few examples in addition to others just identified and those identified elsewhere in the present disclosure. The first resource 7814 may be included in the context set of the access context via one or more data exchanges via a network 7820 between the first node 7802 and access context circuitry 7812. The first node 7802, in an embodiment, may include agent circuitry (not shown) that exchanges data with access context circuitry via a protocol defined for exchanging access context data. Similarly, a second resource 7816, which in a scenario illustrated, is accessible to the second member from a network service operating environment 7818 via the network 7820. The network service operating environment may be an operating environment of a single node or of multiple nodes, may be an operating environment provided by a cloud service provider, may be an operating environment of an internet of things device (e.g. an appliance, an automobile, a media player, a recording device, etc.), or may be any other suitable operating environment. The second resource 7816 may include an image, a web page, a media stream, or circuitry of a remote procedure call or other type of request or command—to name a few examples. The second resource 7816 may be accessed according to an access context by or for the second member. The second member may be in the same access context as the first member, where the first resource 7814 and the second resource 7816 are in the same context set. Resource access circuitry 7822 may be realized as virtual circuitry, at least in part, based on execution of code generated from or written in a programming language to detect a change, to operate in changing, or to operate in an access of the first resource 7814 by or for the first member 7802. Resource access circuitry 7822 may be included in the first node 7802 or in an operating environment of the first node 7802. Resource access circuitry 7822 may be included in first member circuitry 7804, in an embodiment. Resource access circuitry 7822 may operate to detect a change to, operate in changing, or to operate in accessing resource 7814 by or for the first member circuitry 7804 of first node 7802. Resource access circuitry 7824 may be included in or otherwise accessible to the network service operating environment 7818. Resource access circuitry 7824 may be included in or otherwise accessible to an operating environment of the second node 7806. Resource access circuitry 7824 may be included in the network service operating environment 7818 in an embodiment. Resource access circuitry 7824 may operate to detect a change to, operate in changing, or to operate in accessing the second resource 7816 by or for the second member circuitry 7808 of first second 7806.

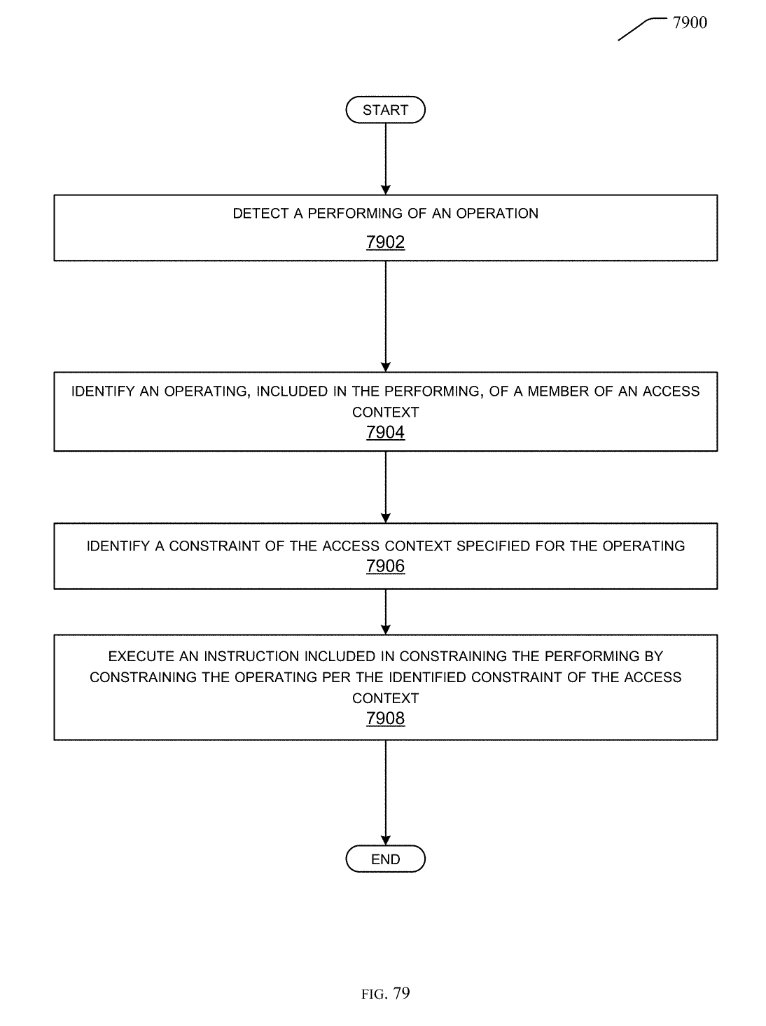

A resource may be hardware or virtual circuitry. A resource may be or may include an operating instance or a portion of an operating instance. FIG. 79 shows a flow chart 7900 in accordance with an embodiment of a method of the present disclosure. In various embodiments, circuitry may be included in a system or circuitry may be provided that is operable for use with a system included in performing a method of flow chart 7900. Such a system may include at least one device of at least one operating environment. At block 7902 in flow chart 7900, the circuitry may operate in detecting a performing of an operation. At block 7904, the circuitry may operate in identifying an operating, included in the performing, of a member or a part of the member of an access context. At block 7906, the circuitry may operate in identifying a constraint of the access context specified for the operating. At block 7908, the circuitry may operate in executing an instruction included in constraining the performing by constraining the operating per the identified constraint of the access context.

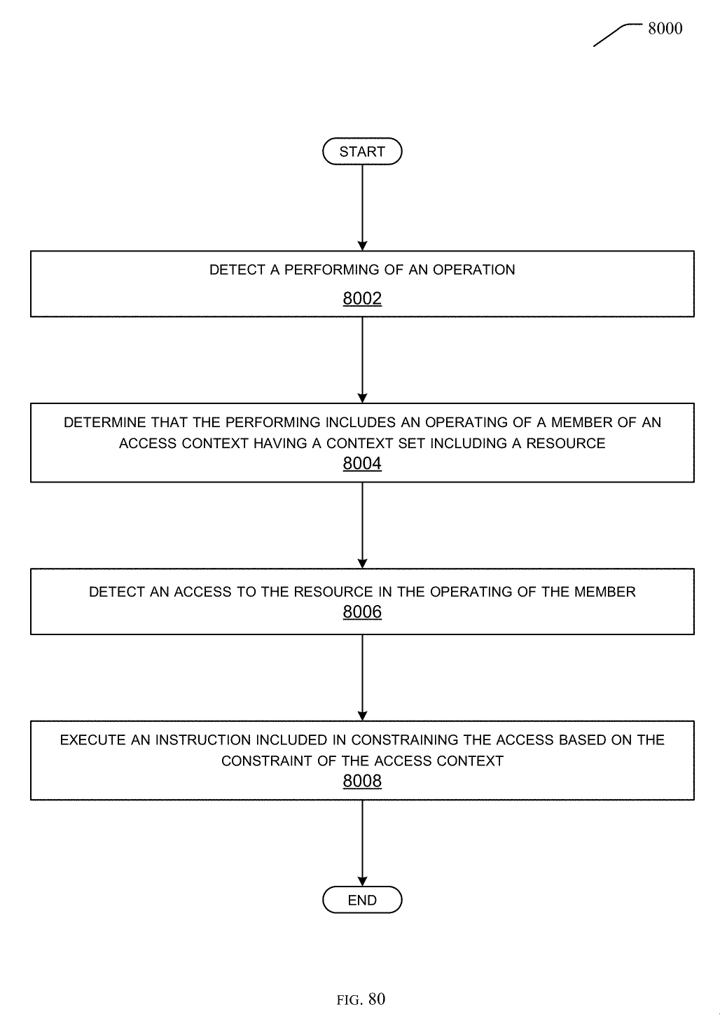

FIG. 80 shows a flow chart 8000 in accordance with an embodiment of a method of the present disclosure. In various embodiments, circuitry may be included in a system or circuitry may be provided that is operable for use with a system included in performing a method of flow chart 8000. Such a system may include at least one device of at least one operating environment. At block 8002, the circuitry may operate in detecting a performing of an operation. At block 8004, the circuitry may operate in determining that the performing includes a member of an access context having a context set including a resource. At block 8006, the circuitry may operate in detecting an access to the resource by or for the member. At block 8008, the circuitry may operate in executing an instruction included in constraining the access based on the constraint of the access context.

In an embodiment, the resource accessed by or for an operating instance of an operable entity may be included in or may include a resource accessed by or for the operating. The operating instance of the operable entity may be a member of an access context. A resource accessed by or for the operating may be includable/excludable in the context set of the access context. The resource may include or may be based on one or more of a processor, a memory, hardware for storing data, hardware for sending a signal, hardware for receiving a signal, a source of energy, a type of energy, an energy exchange medium, an operating system, a file system, a database, an output device, an input device, a peripheral device, a transmit buffer, a receive buffer, an interprocess communication mechanism, source code that specifies an addressable entity, a programming language of source code, a translation of the addressable entity from source code, a data type of an addressable entity, data or circuitry that indicates whether an addressable entity may include an instruction executable by an operating environment of a member, data or circuitry that indicates whether an addressable entity may be excludable from a translation source code, a value stored in a memory location that represents an addressable entity, a network protocol, a network protocol endpoint, a network protocol address, a network protocol address space, a network path, a path node, a hop, a link, a data transmitting node, a data receiving node, a network interface, a quality of service setting or other quality of service resource, another operating environment, a user agent, a communications agent, a network service (WEB, cloud, etc.), a user interaction, a user, a group, a data source, an input focus assignment, an output focus assignment, a source of energy, a type of energy, a measure of energy, an operational state, a source of data, a time, a duration, a geospatial location, an ambient condition, a shared resource, a service provider accessible via a network, hardware, a size, a type of user interface element, a state of a user interface element, a relationship for exchanging data, an administrator, a developer, a security resource, a performance resource, a priority or ranking, a developer, a reseller, a contractual condition, a law, a regulation, a source of a resource, a state of a resource, or metadata for a resource. This list is not exhaustive.

A context set of an access context may include state data to identify a state for one or more members of the access context. For example, a context set may have state data that may be set to indicate a stopped or not operating state, a starting state or initialization state, an interacting state, a non-interaction state, a network exchange state, a state that indicates no data may be exchanged via a network, or a normal operating state. In an embodiment, when a state resource in a context set of an access context identifies a starting state, one or more operating instances of one or more members of the access context may be started. An access context, thus, allows a mechanism to control the state of multiple operable entities via a setting. A context set of an access context may contain multiple state settings for respective multiple members. When a first state of a first member changes, a second state of a second member may be changed by changing a state setting in the context set for the second member. An access context, thus, may provide a mechanism for coordinating states of multiple members.

Instead of or in addition to a context set that includes a modifiable setting as described in the previous paragraph, a context set may include a resource having a fixed or constant data setting. Using the state settings from the previous paragraph as examples, states of an operating instance of an operable entity may be changed by moving the operating instance an access context with a context set that includes a first state setting to another access context with a context set that includes a second state setting. Respective states of the multiple operating instances may be coordinated by moving one or more of the operating instances between or among access contexts.

In an embodiment, an operable entity may be identified for identifying one or more operating instances of the operable entity as members of an access context. An operating instance may be a member of a first access context that is a child of a second access context that may include other members. Changing a setting for a member(s) of a first access context may include moving the first access context to a second access context so that the first access context is a child of the second access context where a context set of the second access context modifies the setting. Note that an operating instance may have multiple settings such as a setting for a network resource or a network operation, a setting for a storage resource, a setting for a processor, a setting for an output device, and so on. A context set may include settings, stored a code or data, for such multiple settings allowing their values to be managed in coordinated fashion via one or more policies of a context set. Alternatively or additionally, one or more settings may be managed in a coordinated fashion via moving one or more members between or among access contexts to change access to the one or more setting as membership changes. Alternatively or additionally, one more setting may be managed for an operating instance by assigning the operating instance as a member to more than one access context that together include the one or more setting in their context sets.

When two or more access contexts have respective context sets with duplicate, overlapping, or contradictory settings, embodiments of the present disclosure may assign priorities to the access contexts in a static manner, based on user interaction, based on an order in which a member is added to the corresponding access contexts, based on respective times of setting or changes to such settings, and so forth. Just as adding or removing a member may be represented by user detectable changes to a subspace that represents an access context, a priority or ranking may be represented via user interface elements of subspaces that are included in or that represent access contexts. For example, a z-ordering of subspaces in an output space may identify priorities of duplicate, overlapping, or contradictory settings in context settings of respective access contexts each represented by a subspace in the z-ordering. Alternatively or additionally, a font resource, a color resource, a transparency resource, a size resource, a shape resource, and the like may indicate a ranking or priority of resources in context sets of respective access contexts represented by subspaces to a user.

An operating instance may be prespecified as a member of an access context, may be prespecified as excluded as a member, may be added or removed via interaction between a user and a user interface, such as a subspace, that represents an access context, or may be added or removed automatically based one or more criterion such as an occurrence of a specified event. A member set of an access context may be fixed or partially fixed.

An access context may be configured to provide a mechanism to prevent instances of operable entities from sharing a resource. Alternatively or additionally, an access context may be configured to provide a mechanism to allow instances of operable entities to share a resource. Examples of resources that an access context may allow sharing or may prevent sharing include processors and processor resources, storage resources, data exchange resources, operational resources, input resources, and the like. A subspace, included in or that represents an access context, may enable access to a shared resource (e.g., data, a network connection, a device, an interprocess communication mechanism) accessible to apps, operating environments, etc. that have user interface elements in the subspace. For example, a subspace may have its own network interface, stack, secondary storage, and the like as constrained via an access context that includes the subspace or is represented by the subspace.

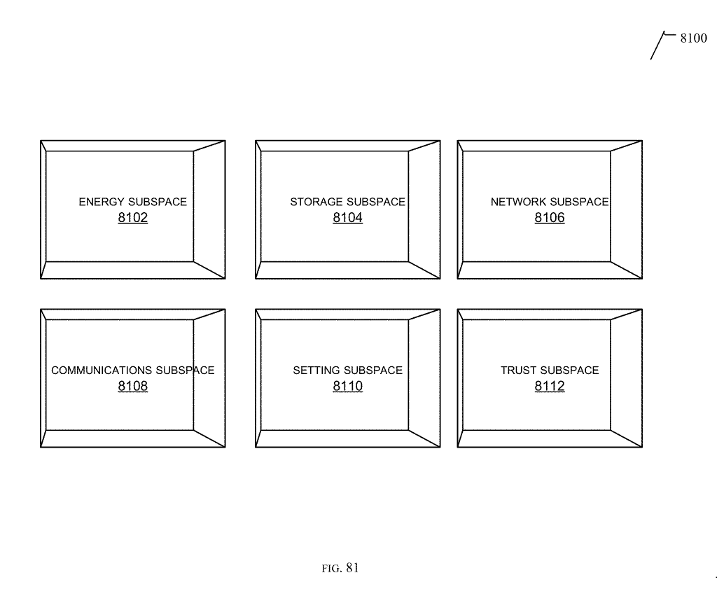

FIG. 81 illustrates subspaces 8100 that represent respective access contexts that each provide a portion of an operating environment or that modify access to a portion of an operating environment. An energy subspace 8102 is shown that may represent an access context that provides, denies, or modifies access to one or more sources or energy. Alternatively or additionally, an energy subspace may represent an access context that provides, prevents, or modifies access to one or more resources utilized in accessing energy to be utilized, monitoring energy utilization, or modifying energy utilization. For example, an energy access context may be provided including a context set for monitoring, managing, or controlling waste heat; a context set for monitoring, managing, or controlling stored energy such as in a battery; a context set for monitoring, managing, or controlling electrical energy from an electricity generator some or all of which may be included in a system or that may be external to a system; or a context set for monitoring, managing, or controlling energy states of one or more members of an access context that includes the context.

FIG. 81 also illustrates a storage subspace 8104 that may represent an access context that may provide access to one or more storage sources or resources utilized in accessing, monitoring, modifying a physical or a virtual storage device, a file system, a data base, a memory address space, or a stored entity. For example, a first storage access context may provide a file system or a portion of a file system accessible to members of the first storage access context. A second storage access context may provide a file system or a portion of a file system accessible to members of the second storage access context. The members of the first access context and the members of the second access context may operate in a same operating environment with access to other operating environment resources not in the first context set of the first access context. For a member of the first access context, access to one or more files may be modified or differentiated, with respect to access for a member of the second context or for an operating instance that is not a member of the first access context or the second access context. In an embodiment, the context set of the first access context may intersect with the context set of the second access context. In an embodiment, the context sets may not intersect (i.e. their intersection is null). In an embodiment, members of the first access context may operate in a first stage of a workflow process and members of the second access context may operate in a second stage. Data accessible via the second access context may be created by or based on one or more members of the first access context. The data may be provided to members of the second access context through a shared portion of a file system or may be provided by an interprocess communication mechanism, a network, or other communicative coupling between one or more members of the first access context or the first access context and the one or more members of the second access context or the second access context.

FIG. 81 also illustrates a network subspace 8106 that may represent an access context that may provide access to one or more network resources or resources utilized in accessing, monitoring, modifying a physical or virtual network, a network protocol, a network interface, a network node, a firewall, a network address space, and the like.

FIG. 81 also illustrates a communications subspace 8108 that may represent an access context that may provide access to one or more communications resources or resources utilized in accessing, monitoring, modifying a communications agent, a communicant, a communications protocol, a communications proxy, a communications service provider, a private key or a public key, an encryption protocol, and the like. For example, a member of a communications access context may be constrained to accessing a network identified in the context set of the access context, constrained to communicating via a first mode of communication (e.g. email), data may be exchanged in a communication when the data meets a specified policy on allowable content, communication may be constrained to communications with communicants identified in a first address book identified in the context set, communication may be based on a time or duration identified in the context set, communication may be based on a geospatial location of one or more of the communicants included in a communication according to the context set or circuitry of the access context or circuitry of the context set, and the like.

FIG. 81 also illustrates a setting subspace 8110 that may represent an access context that may provide access to one or resources utilized in accessing, monitoring, modifying an operational state of a member or managing configuration settings identified in a context set of the access context that are accessed by or for members of the access context as described elsewhere in the present disclosure.

FIG. 81 also illustrates a trust state 8112 that may represent an access context that may provide access to one or resources to members based a measure, level, or indicator of trust assigned to the member via the context set of the access context. A trust level may be assigned based on one or more resources accessed by an operating instance. An operable entity of the operating instance may be associated with an access context for the trust assigned to the operable entity or assigned to a user of an operating instance of the operable entity. An access context may enhance trust and security mechanisms of an operating environment. An access context may allow greater flexibility in managing access to resources based on one or more levels of trust. A trust level, category, or group not supported by an operating environment may be added via an access context. An existing trust level, category, role, or group may be changed operationally via an access context. Trust and security provided by an operating environment may be replaced in whole or in part via one or more access contexts.

An access context have a context set that includes resources utilized for multiple purposes by or for members of the access context. For example, a single access context may be provided all or some of the separate access contexts illustrated in FIG. 81, illustrating the flexibility enabled by access contexts. Access contexts may be created, deleted, or modified dynamically.

Instead of allocating an operating environment, such as a virtual machine or a Linux Container, for various applications or other types of operating instances, some or all of the operating instances may share an operating environment. One or more of the operating instances may be members of one of more access contexts which may each customize the operating environment for respective members. An access context may provide a partial operating environment. An access context may change, modify, or customize an operating environment for an operating instance operating as a member of the access context. Operating environments may be much more flexible, sharable, safer, or energy efficient than current operating environment—to name a few examples. An operating environment may be reusable for different purposes by configuring an operating environment with one or more access contexts and assigning operating instances to one or more of the access contexts based on the operating instances, quality of service agreements, privacy of data being processed, priority of one or more tasks to perform, a user or client being served, and the like. Operating environments may be customized faster than configuring new operating environments and operating environment initialization and tear down may be faster by changing access contexts while allowing an operating environment to remain static or relatively static. Interoperation between operating instances, sharing an operating environment while each operates in a customized environment via assignment to one or more access contexts, may be faster. Interprocess communication mechanisms maybe be utilized to exchange information as opposed to utilizing network resources or virtual network resources utilized by present day cloud computing environments that exchange information between operating instances operating in different virtual operating environments. Interoperation may be safer than exchanging data between or among multiple operating environments. Hardware resources may be utilized more efficiently. For example, fewer virtual operating environments may be needed when operating instances share virtual operating environments customized for one or more operating instances by one or more access contexts. Fewer virtual or physical processors, storage devices, input devices, output devices, network devices, and the like may be needed to perform the same work.

A subspace or an access context may be cloned or copied to create a new subspace that may subsequently differ from the parent subspace or access context. A first member of a first access context and a second member of a second access context may operate in distinct environments, as if each operated in a separate operating environment (e.g. a LINUX containers, a VM, an operating system), when access one or more resources in the respective contexts sets of the first access context and the second access contexts. When accessing resource(s) not in the first access context or the second access context the first member and the second member operate as if both operate in a same operating environment (which may be the operating environment that includes the first access context and the second access context or may be an access context that includes the first access context and the second access context). Each access context can have its own path defaults, templates, default file paths, device drivers, adapters, or other physical or virtual resources; while accessing other resources via a shared portion of the operating environment. For example, an access context may provide a virtual file system rather than allow access to or direct access to a file system of an operating environment modified by the access context. The underlying data storage system of the operating environment may be utilized but hidden or not utilized. Moving members of the access context to another operating environment may require little or no change to code of a member that accesses the virtual file system.

An access context may be cloned or copied. An access context clone may include the same resources in its context set while having cloned or copied instances of operating members. An access context clone may include cloned instances of resources in its context set. In an embodiment, an access context and a clone of the access context may operate independently subsequent to the cloning. In an embodiment, an access context and a clone of the access context may be related so that a change to or operating of one changes the other. For example, one or more resources in a context set of an access context may be synchronized in whole or in part with one or more resources in a context set of a clone of the access context. An access context and a clone of the access context may operate in a same device, in a same operating environment, in different devices, or in different operating environments.

An access context or a combination of access context may create an operating environment which may be a virtual operating environment or not. An operating environment created by configuring one or more access contexts may be highly specialized. Parts of a traditional or present day operating environment may be excluded. For example, an operating environment may be configured so that it includes no or a different type of file system, no or a different type of network interface, no or a different type visual output subsystem, no or a different type user input driver, and the like with respect to the present day operating environments which include operating system supported (E.g. Windows, Linux, Android, iOS, etc.) file systems, network interfaces, visual output subsystems, user input drivers, and the like. Alternatively or additionally, an operating environment may be created that supports a networking protocol not supported by a hosting operating environment. The networking protocol may be a non-standard network protocol. The non-standard protocol may be unique to the access context. Alternatively or additionally, non-standard persistent data storage systems may be included in an operating environment via an access context. An access context may be reusable, providing a customizable building block. From a number of access context building blocks, an assortment of operating environments may be configured. A diverse set of operating environments may provide a safer Internet. Diversity in operating environments may make creation and deployment of malware more difficult and may make use of malware less destructive across the Internet or other networks. Note that an operating environment can be in a context set of an access context which may be accessed for or by member of the access context.

For current user devices and operating systems that support multiple users, each user is currently provided with a separate user interface. In an embodiment, a first access context may allow input from a first user to be received by a member of the first access context and a second access context may allow input from a second user to be received by the second access context, but not vice versa. Both users may share a user interface via separate input or output devices or via one or more shared input or output devices. A third access context may include members that allow input from either user to be received by a member of the third access context. Access context may be utilized to share or separate access to one or more user interfaces. A shared access context may allow access to user only when two or more users are authenticated.

In another embodiment, a first access context may allow input from a first user to be received by a member of the first access context and a second access context may allow input from a second user to be received by the second access context, but not vice versa. User interfaces of members of the first access context and members of the second access context may be represented in a first user interface for the first user and in a second user interface to the second user. The first user interface and the second user interface may differ per user customization. The first user interface and the second user interface may differ based on a difference in an input device or an output device accessible to the first user and the second user, respectively. For example, a two-dimensional tiled user interface may be provided by a handheld device of the first user while three-dimensional hologram (which may be included in an e-space that includes a physical object) may be provided by an operating environment of a projection enabled device interacting with the second user.

An access context may be configured for or based on a specified task or type of task, a specified transaction or type of transaction, a specified exchange of data or type of data exchange, a specified communications agent or mode of communication, a specified interoperation between or among operating instances, a specified user or type of user (e.g. a user assigned a role, a user in a location, etc.). The foregoing examples are not exhaustive.

An access context may be predefined, configured in response to an identifying of an attribute of a user of the access context, or may be modified while the access context is instantiated or operating. Members of an access context may be predefined, may be determined based on a specified criterion, may be assigned by a user, or may be assigned automatically by a device or system.

An access context may be configured so that operating instances exchange information when operating as members of the access context, but otherwise are not configured to exchange information.

An access context may be configured to provide a distributed operating environment for a member operating in an operating environment that is not otherwise included in a distributed system or distributed operating environment.

An access context may be configured that provides a shared mechanism for configuration or monitoring of operating instances that are members where there is no shared mechanism for configuring or monitoring the operating instances, as a group, when not operating as members of the access context. Shared mechanisms for monitoring operating instances and modifying operating instances may be provided by a suitably configured access context.

As described herein, access contexts enable a wide range of operating environments for a wide range of devices from internet of things devices (e.g. thermostats, watches, etc.) to servers to cloud computing environments. Access contexts enable customization of existing operating environments allowing operating instances to operate in a same operating environment that may be customized for respective operating instances according to their membership in one or more access contexts. Access contexts have other benefits that will be or will become apparent, based on the present disclosure, to others according to their area(s) of art in which they are skilled.

In one or more embodiments of the subject matter of the present disclosure, an access context or subspace may be definable or configurable by a user. A user may be a user of an operating instance that may be added as a member to an access context or subspace being defined or configured. A user may be a user of a member that is already a member of the access context or subspace being defined or configured. A user may have authorization to access a resource of the context set of the access context to configure. A user may have authorization to add, remove, or replace a resource in a context set. In an embodiment, an access context may be configurable via a member of the access context, a user interface presented by circuitry of the access context, or via an operating instance that is not a member of the access context. Similarly, a subspace may be configurable via a user interface element in the subspace, a user interface presented by circuitry of the subspace, or via a user interface element that is no in the subspace.

One or more template access contexts may be provided that include code or data for creating and managing an access context, a member(s) of an access context, operations of an access context, or attributes of an access context. Code or data for creating and managing an access context or separate code or data be included in creating and managing a context set of an access context, manage resource(s) of a context set, manage operations of a context set, or manage attributes of a context set. In addition to a generic access context template, templates may be accessed that are pre-configured or partially preconfigured for including or excluding specified types of operating instances, sources of operating instances, users of operating instances, or operating instances of specified operable entities. Pre-defined templates for access contexts that specify, in whole or in part, a security environment, a network environment, a user interaction environment, a data storage environment, a security environment, and the like may be included in an operating or may otherwise be accessible to the operating environment for customizing the operating environment or for creating or customizing another operating environment.

In an embodiment, an access context may be configured for an operating instance, such as an application. Such an access context may be created or configured via circuitry of the operating instance or via an operating environment of the operating instance. An access context for an operating instance may include only the operating instance as a member in an embodiment. In another embodiment, membership may be restricted to operating instances of a same operable entity. Alternatively or additionally, membership may be restricted to operating instances that operate in performing a specified task, a transaction, or a workflow. Alternatively or additionally, membership may be restricted to operating instances that operate for a specified user(s), group, or legal entity. A template access context may be provided by an operating instance, by an operating environment of an operating instance, or provided via remote service provider.

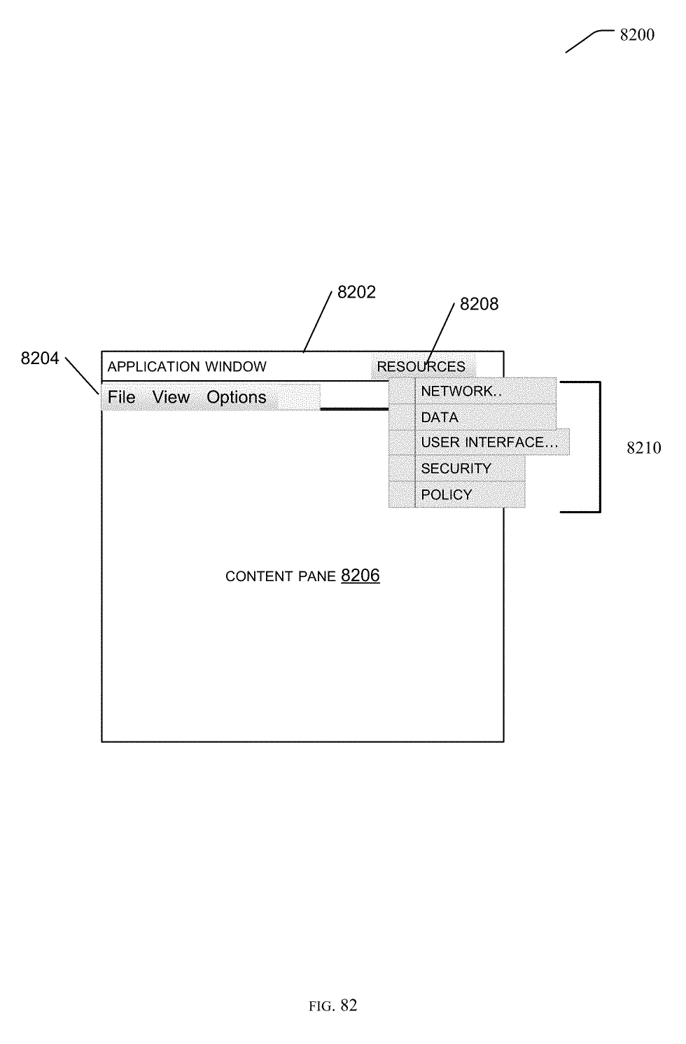

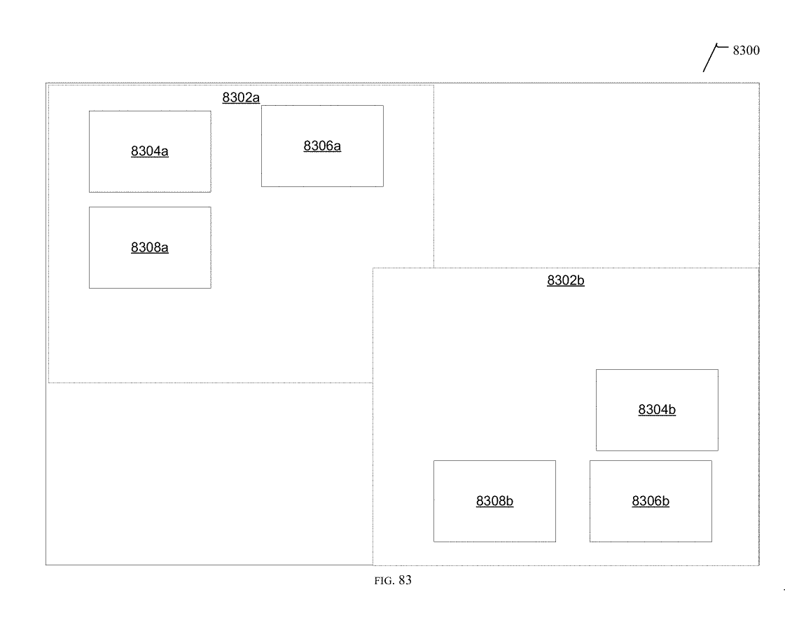

FIG. 82 illustrates a user interface element 8200 of an application or other type of operating instance. The user interface element 8200 illustrates that an embodiment may have a structure similar to traditional desktop user interfaces. Other embodiments may present a user interface element based on a different user interface model. A title bar 8202 is illustrated, as is a menu bar 8204 with submenus labeled “File”, “View”, and “Options” that are familiar to desktop users. A content pane 8206 is shown for displaying application content. FIG. 82 shows user interface elements for configuring or modifying an access context for an operating instance, which may be the operating instance presenting the user interface element 8200. A resources menu 8208 is presented in the title bar user interface element 8202. Submenu elements 8210 identifies user interface elements for accessing controls for adding, selecting, or configuring a network resource such as a network interface, a data resource such as a file path or access to a file or folder, a user interface resource such as a selection of an output device or a user interface model, a security resource for adding or configuring roles or privileges, and a policy resource for selection of predefined policies and code for enforcement or for configuration of a new policy and linking to code corresponding to a new policy.

Code may be written that when executed operates on, monitors, manages, updates, or accesses portions of access contexts of various types that may include different types of members or different types of resources in respective context sets. A context set for an access context may be allowed to include a resource, a type of resource, or a resource that meets a specified criterion included in defining the context set. A context set for an access context may be allowed to include zero, one, or more resources of a same type or that each meet a same criterion included in defining the context set. A context set for an access context may be allowed to include a heterogenous set of resources having different types or resources or resources that meet one or more criteria included in defining the context set.

A resource may be predefined as included in a context set of an access context. For a context set of an access context, a resource may be added, removed, or modified prior to an adding of a member to the access context, by or for a member, or in response to a completing of a member. A constraint may be specified to change a resource in a context set when accessed by or for a member of the context set's access context. A constraint may be specified to remove or initiate a removing of a resource accessed by or for a member of an access context from a context set of the access context. A constraint may be specified to add or initiate an adding of a resource accessed by or for a member of an access context from a context set of the access context.

A resource in a context set of an access context that is accessed by or for a member of the access context may be included in code or data of an operable entity, in code or data of a member, stored in a data storage device, stored in a processor memory of an operating instance, or may be external to memory of any member or other operating instance. A resource in a context set of an access context may be accessible to a first member of the access context from or via a second member of the access context.

Examples of operating instances include computing processes, threads, applications which may include one or more processes or threads and which may operate across one or more devices or operating environments, devices, and operating environments which include stand-alone operating environments, virtual operating environments, and cloud computing environments.

In an embodiment, an operating instance may be added as a member to an access context that includes a resource sharing mechanism allowing members to access resources provided by one or more other members. Examples of resource sharing mechanisms include a shared data storage system, a shared data storage location, a pipe such as a UNIX pipe, a bus whether physical or virtual, a data link, a network, an interrupt, a queue, a stack, a messaging system such as a request-reply system or a notification system, a semaphore, or an interprocess communication mechanism not otherwise identified in the present disclosure.

A resource in a context set may include one or more of a user interface element, an output device, an output space, another access context, a subspace of an output space, an input device, an operating environment (e.g. a virtual operating environment, a cloude computing environment, etc.), a processor, a memory, a network protocol endpoint, circuitry that may operate according to a network protocol, a network interface, a data transmission medium, an operating instance, a member of an access context, a peripheral device, a peer device, a user agent, a communications agent, a network service (WEB site, a cloud, etc.), a network relay (physical or virtual switch, router, etc.), configuration data, a source of energy, a source of data, a source of code, a certification authority, authentication information, authorization information, a role, an owner, an administrator, a user, a measure of energy, a measure of data, a mode of communication, a communicant address, a schema an address space, a measure/indicator of a speed, a rate, an amount, a measure of variability or deviation, a range, a maximum, a minimum, a price, a cost, a measure of heat, a measure of power, metadata for a processor, metadata for a memory, an operational state (e.g., of a context resource or of a member), a location (e.g., of a resource, a user, a member, etc.), a size, an output focus state, an input focus state, a thread state, a computing process state, a user detectable resource, an orientation in a multi-dimensional output space (may be a subspace), a security resource, a functional capability, a time, a duration, an ambient condition, a user, a group, a legal entity, a network protocol, an interprocess communication mechanism, a computing process, an application, a device, and a representation (e.g. a user interface element, a proxy, etc.) or metadata for any of the foregoing.

Members of an access context or user interface elements in a subspace may share a common value for a resource such as a font. Members of an access context or user interface elements in a subspace may each have a resource that is established relative to a resource or setting of the another member or user interface element. For example, as a subspace size changes the relative sizes of the user interface elements in the subspace may change. A shared resource may be accessed by one or a subset of members of an access context at any given time. Two or more subspaces may each have an output focus resource. In one of the subspaces, the output focus may be assigned to one member at a time. In another of the subspaces, more than one member may be assigned output focus at a same time.

As described above, a member of an access context, a context resource accessed by or for a member, or a member of an access context may be changed in response to a change in the access context, a change the context set of the access context, a change in a resource in the context set, or a change in another member of the access context. As also described, an access context, the context set of the access context, or a resource in the context set may be changed in response to a change in a member, a context resource accessed by or for a member, or during operating of a member of the access context. A changing of any of the foregoing may include an interaction between a user and a user interface element of a member, a user interface element of an access context, a user interface element of a context set, or a user interface element of a resource of a context set. Alternatively or additionally, a changing of any of the foregoing may be based on change information not received in or via an interaction. In an embodiment, change information may be received via a network, a physical link, a device, an interprocess communication mechanism, a data exchange interface hardwired in physical circuitry (can be an ePROM, FPGA), a data exchange interface realized in virtual circuitry, or an operand of a machine code instruction that may identify a memory location of change information. Change information may be received via the network in a communication received from a communications agent, in a message received from another communications agent. The other communications agent may be included in or otherwise may represent a network service. The message may be included in one or more of a response to a request, in an asynchronous message received based on a subscription or not, and in a broadcast message.

A user interface element of a member may be presented in a subspace in an output space of an output device. The subspace may be an output representing the access context. The subspace may have a plurality of user interface elements that each represent a member of the access context

A subspace may have a one or more of a size, a shape, a boundary, and a location in an output space that may or may not be determined based on one or more of a size, a shape, a boundary, or a location, or count of any user interface element that represents a resource in the access context of the subspace.

In an embodiment, a change to a user interface element may include a change to one or more of a location in an output space, a location in a subspace of an output space, an attribute of a subspace of the user interface element, an input focus assignment, an output focus assignment, an output space assignment, an output device assignment, an input device assignment, a network access resource, a network quality of service resource, a network protocol, a network, a communicative coupling, content presented via the user interface element, a source of content presented via a user interface element, circuitry included in interacting with a user via a user interface element, a mode of interaction with a user, a user detectable attribute of the user interface element, a resource of power utilized in executing circuitry of the user interface element, a user interacting with the user interface element, the access context, a subspace of the access context, or a member of an access context that includes or is represented by a subspace.

In an embodiment, a first member of an access context may change a resource in a context set of the access context. The resource may be accessed by or for the first member per a constraint of the access context. A resource accessed by a second member may be changed, in response to the change to the resource by first member. The second member and the first member may each be operating instances of a same operable entity or they be operating instances of different operable entities. The change to the resource accessed by or for the second member may be based on a rule of the access context. The resource accessed by or for the first member and the resource accessed by or for the second member may be the same resource or may be different. The resource accessed by or for the first member may include the resource or vice versa.

A change to a resource accessed by or for a member of an access context may be result in or may be represented by a change in a user interface element of one or more members of the access context. The user interface element may be presented in a subspace in an output space. A change to a resource may result in or may be represented by a change for a user interface element to one or more of a location of the user interface element in the output space, a location in the output pace of the subspace, an attribute of the subspace, an input focus assignment, an output focus assignment, an output space assignment, an output device assignment, an input device assignment, a network access resource, a network quality of service resource, a network protocol, a network, a communicative coupling, content presented via another user interface element, a source of content presented, circuitry included in interacting with a user via the user interface element, a mode of interaction with a user, a user detectable attribute of the user interface element, or a member.

As described elsewhere herein, an access context may have a criterion that is evaluated for determining whether an operating instance may be added as a member to the access context, removed as a member of the access context, or modified. For example, a criterion may identify one or more of a maximum number of members includable an access context, a minimum number of members that must be in an access context, a count (e.g. a range) of members that define a state of an access context, an ordering of members in an access context indicating an order of adding or an order of removing members, a type of resource includable in or excludable from an access context, a time that a resource may be includable, or a duration that a resource may be in, includable, or excludable. A specified criterion may be prespecified or static. A criterion may be modifiable.

A constraint or a criterion of an access context may be based on, may include, or may be included in one or more of a user interface element, an output device, an output space, another access context, a subspace of an output space, an input device, an operating environment (e.g. a virtual operating environment, a cloud computing environment, etc.), a processor, a memory, a network protocol endpoint, circuitry that operates according to a network protocol, a network interface, a data transmission medium, a thread, a computing process, an application, a device, a peripheral device, a peer device, a user agent, a communications agent, a network service (WEB site, a cloud, etc.), a network relay (physical or virtual switch, router, etc.), configuration data, a source of energy, a source of data, a source of code, a certification authority, authentication information, authorization information, a role, an owner, an administrator, a user, a measure of energy, a measure of data, a mode of communication, a communicant address, a schema, an address space, a speed, a rate, an amount, a deviation, a range, a maximum, a minimum, a price, a cost, heat, power, metadata for a processor, metadata for a memory, an operational state, a location, a size, an output focus state, an input focus state, a thread state, a computing process state, a user detectable resource, an orientation in a multi-dimensional output space (may be a subspace), a security resource, a functional capability, a time, a duration, an ambient condition, a user, a group, a legal entity, an interprocess communication mechanism, or metadata for any of the foregoing.

In an embodiment, a constraint may identify one or more of a change/modification that may be allowable or not allowable to a resource in a context set. A change to an access context may include a change to one or more of a criterion, a constraint, the context set of the access context, a resource in the context set, or a member. Resources of an access context that may be changed or monitored for a change include a count of resources in the context set of the access context, a count of members in the access context, a maximum number of resources allowed in the context set, a minimum number of resources that must be in the access context, a maximum number of members allowed, a minimum number of members required, a state of the access context, a user interface element representing the access context, a subspace of the access context, a user interacting with the access context, a relationship to another access context, a security resource of the access context, an input focus resource, an output focus resource, a network resource, or other metadata for the access context.

In an embodiment, an operating instance that is a member of an access context may be assigned to another access context, based on a resource accessed by the member or based on a state of a work flow or transaction that is performed in whole or in part by the operating instance. For example, in an embodiment a first operating instance may be automatically assigned as a member to an access context that allows the member output focus for an output device. When access to output focus changes, the member may be automatically unassigned or reassigned. An operating instance may be automatically assigned membership so that the operating instance maintains an output focus assignment. Automatic membership change may prevent an operating instance from having output focus for a specified output device. Automatic membership change may prevent an operating instance from being denied access focus for one or more output devices. Access to other resources may be also be controlled via automatic membership assignment to access contexts based on a change to a resource, an access context, or to an operating instance. Subspace assignments may be made similarly. For example, a user notification user interface element may be presented always in a front most subspace or a subspace meeting a specified criterion (e.g. the subspace closest to a bottom left corner.

A user interface element may be copied from one subspace to another or moved (e.g. cut and pasted). Copying a user interface element may cause other user interface elements to also be copied or may cause some user interface elements to be copied. Removing a user interface element from a subspace may cause other user interface element in the subspace to be removed. When a subspace represents an access context, copying or moving a user interface element from a first subspace representing a first access context to a second subspace of a second access context may respectively copy or move a member that corresponds to the user interface element copied or moved from the first access context to the second access context.

Change information, as used herein, may refer to a change to one or more of an operating environment, a communicative coupling, an energy source, a user interface element, an addressable entity, or security data accessed by or for a member of an access context. The change information may identify; for the member, the resource, or a user interface element representing the member or the resource; a change to one or more of a location in an output space, a location in a subspace of an output space, an attribute of a subspace, an input focus assignment, an output focus assignment, an output space assignment, an output device assignment, an input device assignment, a network access resource, a network quality of service resource, a communicative coupling, a source of energy, a type of energy, a measure of energy, content presented via an output device, a source of content presented via an output device, circuitry included in interacting with a user, a mode of interaction with a user, a user detectable resource, a resource of power utilized, a user, an interaction, the access context, a subspace, a processor, a memory, hardware for storing data, hardware for sending a signal, hardware for receiving a signal, a measure of energy, an energy exchange medium, an operating system, a file system, a database, an output device, an input device, a peripheral device, a transmit buffer, a receive buffer, an interprocess communication mechanism, an addressable entity, source code that specifies an addressable entity, a programming language of source code, a translation of an addressable entity from source code, a data type of an addressable entity, whether an addressable entity includes an executable instruction, whether an addressable entity may be excludable from a translation source code, a value stored in a memory location that represents an addressable entity, a network protocol, a network protocol endpoint, a network protocol address, a network protocol address space, a network path, a path node, a hop, a link, a data transmitting node, a data receiving, node, a network interface, an operating environment, a user agent, a communications agent, a network service (WEB, cloud, etc.), a group, a data source, an operational state, a source of data, a time, a duration, a geospatial location, an ambient condition, a shared resource, a service provider accessible via a network, hardware, a size, a type of user interface element, a state of a user interface element, a relationship for exchanging data, an administrator, a developer, a security resource, a performance resource, a priority or ranking, a reseller, a contractual condition, a law, a regulation, a source of a resource, a state of a resource; a member, a size, a transparency level, a font size, a color, a location in the subspace, a shape, whether a user interface element may be included in a subspace, a data exchange, a time, a date, a duration, security data, user data, geospatial location data, location data for a user interface element in a subspace, an output space, an output device, an input device, another subspace, output focus data, input focus data, energy, energy data, owner data, administrative data, support data, error data, a user detectable attribute of a subspace, a user interface model, a user interface mode, a permission or authorization, a user agent, a communications agent, a remote service provider accessible via a network, a communicant address, interaction data, attention data, ambient data, processor memory data, secondary storage data, processor data, shape data, creating a clone/copy, adding a user interface element to a subspace, removing a user interface element from a subspace, other hardware data, color data, shape data, creating a clone/copy, adding a user interface element to a subspace, removing a user interface element from a subspace, a criterion for determining whether a user interface element may be included in a subspace, or a resource of or metadata for any of the foregoing.

Change information, for a resource, may identify a change to one or more of a security principal for authenticating an accessing of a resource by or for an operating instance, a device, an operating environment, a user, a location, and the like. Alternatively or additionally, change information may identify a security role, a type of access allowed or not allowed, a criterion for allowing access, or a criterion for not allowing access—to identify some examples. One or more of the criterion may be based on a time, a date, a day, a duration, a count of may access, a type of access, second security data for the resource, security data for another resource, a location in a memory, a geospatial location, a user, a group, a legal entity, a device, an application, a process, a thread, a processor, a memory, an energy source, a location in an output space, a location in a subspace of an output space, an attribute of a subspace of the access context, an input focus assignment, an output focus assignment, an output space assignment, an output device assignment, an input device assignment, a network access resource, a network quality of service resource, an addressable entity, a communicative coupling, a source of energy, content presented via the first user interface element, a source of content presented via the first user interface element, circuitry included in interacting with a user via the first user interface element, a mode of interaction with a user, a user detectable attribute of a user interface element, a resource of power utilized in executing circuitry of the resource, a resource of power utilized in accessing the resource, a user interaction, the access context, a subspace of the access context, hardware for storing data, hardware for sending a signal, hardware for receiving a signal, a type of energy, a resource of energy, an energy exchange medium, an operating system, a file system, a database, an output device, an input device, a peripheral device, transmit buffers, a receive buffer, an interprocess communication mechanism, source code that specifies an addressable entity, a programming language of source code, a translation of an addressable entity from source code, a data type of an addressable entity, whether an addressable entity may include an instruction executable by circuitry of the one or more operating environments, whether an addressable entity may be excludable from a translation the source code, a value stored in a memory location that represents an addressable entity, a network protocol, a network protocol endpoint, a network protocol address, a network protocol address space, a network path, a path node, a hop, a link, a data transmitting node, a data receiving, node, a network interface, a quality of service resource, another operating environment, a user agent, a communications agent, a network service (WEB, cloud, etc.), a type of energy, a measure of energy, an operational state, an ambient condition, a shared resource, a service provider accessible via a network, hardware in or otherwise accessible, a size, a type of user interface element, a state of a user interface element, a relationship for exchanging data, an administrator, a developer, a performance resource, a priority or ranking, a developer, a reseller, a contractual condition, a law, a regulation, a source of the resource, a state of the resource; a computing process, an application, hardware, an operating environment, a device, or metadata for any of the foregoing.

Change information may be received via a user interaction with a user interface element that represents a resource, a subspace, a member, or an access context. The representation may be direct or indirect.

In an embodiment, a change to a resource may be made via or otherwise represented via a change to a user interface element that represents the resource or a member where the resource is access by or for the member. In an embodiment, the operation may be performed to change the access context. In an embodiment, an operation may be performed based on change information, to change each resource in a context set.

In an embodiment, an output space may have at least three dimensions. An output space may be or may include an e-space. An e-space may include a user detectable physical object (not presented via the output device and not included in the output device). A subspace may be located in an e-space based on a physical object. The subspace may include no portion of the physical object. There may be no visual overlap detectable to a user interacting with one or more of the subspace and the physical object. Alternatively or additionally, a visual overlap may be detectable to a user interacting with one or more of the subspace and the physical object.

A physical object may be a resource accessed by or for a member of an access context. A representation of the physical object may be included in a context set of the access context. In an embodiment, a user interface element may represent the physical object in an output space. The user interface element may be presented by a member in which the representation or the physical object is accessed by or for the member. In an embodiment, the user interface element may identify, for the physical object, one or more of a previous user, an authorized user, a monetary value, a cost of performing a task that may include access to or interoperation with the physical object, a role of a user interacting with one or more of the user interface element or the physical object, a maintenance operation to perform, a content rating, an indicator of whether the physical object may be identified in a specified set of objects for a task (a recipe, a construction task, a shopping list, . . . ), a temperature, a chemical, a biological element, a next location, an archive location, a home location, a defect, an error, a duration of operation, a duration in a location, a manufacturer, a seller, a previous owner, whether the physical object may be purchased (bought, borrowed, leased, rented, given as a gift, . . . ), a companion object, a substitute object, another version, an alternative (and a source of the alternative), a reminder of a task (scheduled) that may include or may be based on the physical object.

In an embodiment, a resource, type of a resource, or arrangement of resources in a context set may identify an access context, a type of access context, or an access context template.

As described, a subspace may be included in an access context as a resource in a context set of the access context. Alternatively or additionally, a subspace may be associated with an access context via some other mechanism such a pointer, a symbolic reference, a data structure, or a database record. A subspace may be provided as a visual representation of an access context with user interface elements presented in the subspace provided as visual representations of respective members of the access context. A user may interact with an access context or its members via the presented visual representations. In an embodiment, a change to a user interface element of a subspace may represent a change to the access context. A change to a user interface element of a member, may represent a change to the member. A change in an access context may be based on a change in data or circuitry of the access context. A change in an access context may be based on a change in one or more members of the access context. A change in a member may be based on a change in the access context.

A change in a member of an access context may include one or more of an addition of an operating instance to the member set of the access context, a removal of a member from the member set, or a change in a current member.

Changing an access context, a member set of an access context, a member of a member set, a context set, or a resource in a context set may include or may be made in response to an interaction between a user and a user interface element of one or more of the access context, the member of the member set, the context set, another resource in the context set. Such a changing may include receiving change information that identifies the change. Change information may be received via one or more of a network, a physical link, a peripheral device, a remote device, a user agent, a network service provider, an interprocess communication mechanism, a data exchange interface hardwired in physical circuitry (can be an ePROM, FPGA), or a data exchange interface realized in virtual—to name some examples. Change information may be received via the network in a communication received from a communications agent, in a message received from a network service.

In an embodiment, an operation may be performed to change a first member based on a change to a second member. An operation may be performed to change a first resource in a context set based on a change to a second resource in the context set. An operation may be performed to change a member based on a change to a resource in a context set. An operation may be performed to change a resource in a context set based on a change to a member.

Change information for a change to an access context, a context set, a resource in a context set, a member set, a member in a member set, or a user interface element that represents or is included in any of the foregoing may identify a change to a memory location for storing one or more of state data, time data, duration data, security data, user data, geospatial location data, subspace location data, user interface element location data, a rule of the subspace, an output space, an output device, an input device, another subspace, output focus data, input focus data, a source of data, a destination for data, a network, a network protocol, a network protocol endpoint, a network path, a path node, a hop, a link, an operating environment, a source of energy, energy data, owner data, administrative data, support data, error data, a user detectable attribute of the subspace, a user interface model, a user interface mode, a permission or authorization, a user agent, a communications agent, a remote service provider accessible via a network, a communicant address, interaction data, attention data, ambient data, processor memory data, secondary storage data, processor data, a size, transparency data, font data, color data, shape data, creating a clone/copy, adding a user interface element to a subspace, removing a user interface element from a subspace, a criterion for determining whether a user interface element may be included in a subspace, data exchanged with circuitry operating in embodying another subspace, other hardware data, or metadata for any of the foregoing.

Each member of an access context may be changed in response to a change in the access context, the context set of the access context, a resource in the context set, or another member of the access context.

In an embodiment, change may be represented by a change in a user interface element. A change to a user interface element may include a change to one or more of a size, a transparency level, an input focus assignment, an output focus assignment, a font size, a color, a location in a subspace, a shape, user detectable content, a state, a creation of a clone/copy, whether the user interface element may be included in the subspace, a data exchange, a time, a day, a duration, security data, user data, geospatial location data, location data for a user interface element in a subspace, an output space, an output device, an input device, another subspace, output focus data, input focus data, a source of data, a destination for data, a network, a network protocol, a network protocol endpoint, a network path, a path node, a hop, a link, an operating environment, a source of energy, energy data, owner data, administrative data, support data, error data, a user detectable attribute of the subspace, a user interface model, a user interface mode, a permission or authorization, a user agent, a communications agent, a remote service provider accessible via a network, a communicant address, interaction data, attention data, ambient data, processor memory data, secondary storage data, processor data, shape data, adding a user interface element to a subspace, removing a user interface element from a subspace, hardware data, or metadata for any of the foregoing.

A change to a subspace may include one or more of an addition or a removal of a user interface element of one or more of members of an access context that includes the subspace in a context set or where the subspace is associated with the access context in another manner.

In response detecting a change in a subspace representing an access context, an operation may be performed to modify each user interface element representing a member of the access context. In an embodiment, each user interface element in the subspace may represent a respective member. A change to a subspace may correspond to a change in an access context. A change in an access context may include a change to a context set of the access context or a change to a resource in the context set. Examples of resources, in addition to examples identified elsewhere herein, may include or may be included in one or more of a an appliance, an item of furniture, a user interface element, an output device, an output space, a subspace of an output space, an input device, an operating environment (e.g. a virtual operating environment, a cloud computing environment, etc.), a processor, a memory, a thread, a computing process, an application, a device, a communicative coupling, a network protocol endpoint, a network interface, a peripheral device, a peer device, a user agent, a communications agent, a network service (WEB site, a cloud, etc.), a network relay (physical or virtual switch, router, etc.), configuration data, a source of energy, a source of data, a source of code, a certification authority (authorization, authentication), authentication information, authorization information, a role, an owner, an administrator, a user, a measure of energy, a measure of data, a mode of communication, a communicant address, a schema, a quality of service resource (an speed, rate, amount, variability, range, deviation, a max, a min, a price, heat, power, processor resource, a measure or resource of memory), a location in an output space, a location in a subspace of an output space, an attribute of a subspace that may include the user interface element, an input focus assignment, an output focus assignment, an output space assignment, an output device assignment, an input device assignment, a network access resource, a network quality of service resource, a network protocol, a network, content presented via a user interface element, a source of content presented via a user interface element, circuitry included in interacting with a user via a user interface element, an mode of interaction with a user, a user detectable attribute of a user interface element, a resource of power utilized in executing circuitry of a user interface element, or a user interacting with a user interface element.

A user interface elements in a subspace may be associated, bound, or related via, for example, a data record or via executable instructions in a memory, to identify the user interface elements in the subspace. When the subspace represents an access context, a data record or executable instructions of the access context may determine how one or more of the user interface elements in the subspace or members of the access context change in response to a change in a resource in a context set of an access context.

In an embodiment, user interface elements in a subspace may be associated, bound, or combined to create compound user interface elements presented by multiple operating instances represented in a subspace or multiple members of an access context when the subspace is in a context set of the access context or represents the access context. Simpler user interface elements may be combined to build compound user interface elements. For example, in an e-space a mix of displayed user interface elements and physical objects may be combined. Virtual books may be presented on a real surface (e.g. of a desk, table, shelf. Etc.). When a user interface element representing the bottom book of the stack is moved in the e-space, the other user interface elements representing other books in the stack may move in a specified way. They may move as they would in the real world or in a way not probable in the real world. In an embodiment, if a sensor detects a movement of the real surface, one or more of the virtual objects (e.g. books) may be moved or changed in response.

Multiple user interface elements of multiple operating instances operating in one or more devices of one or more operating environment may be combined to construct objects that may be manipulated as a set or a single element. Systems and processes may associate unrelated user interface elements and may then manipulate those user interface elements as a group. An access context of such a subspace may provide resources enabling members to exchange information or operate according to a configuration of the access context. For example, on a display, a writing application and a drawing application may be associated such that when one is opened and displayed, the other is also opened and displayed. Furthermore, when one is moved, the other may move in a manner specified by a rule, policy, or identified operation.

Some or all of a boundary in an output space of subspace may be made detectable to a user via one or more of an audio output device or a haptic output device. An output may be presented via one or more of the audio device and the haptic device to indicate to the user the presence/existence of the some or all of the boundary. Some or all of a boundary of subspace may be detectable during a moving, copying, or other operation being performed on the subspace or a user interface element in the set. The subspaces may be prevented from overlapping or otherwise occupying a same portion of an output space.

Subspaces in an output space may have one or more fixed-sized dimensions, may be stacked in one or more dimensions, and may have a regular arrangement in an output space. Subspaces in an output space may be arranged irregularly in the output space. Subspaces may at least partially overlap in one or more dimensions. A subspace may have a curved shape or may have an irregular shape. Subspace shapes are not limited to the shapes described or illustrated in the present disclosure.

A user interface element may be in more than one subspace, such that movement of the subspace may warp, stretch, etc. Moving a user interface element towards a boundary of a subspace, resize, or reshape the boundary. In response, other user interface elements in the subspace may be moved, resized, or reshaped accordingly. Moving a user interface element outside the bounds of the subspace may remove the user interface element from the subspace. Moving a user interface element outside a boundary of a subspace that represents an access context may remove an operating instance of the user interface element as a member of the access context.

In 3-D virtual reality displays (e.g., headgear, glasses), a physical object in an output space may be associated with a subspace that provides one or more user interface elements for interacting with (e.g., controlling) the physical object or that presents data about the physical object. A first output space may be partially shared with a second output space via associating user interface elements to a shared subspace.

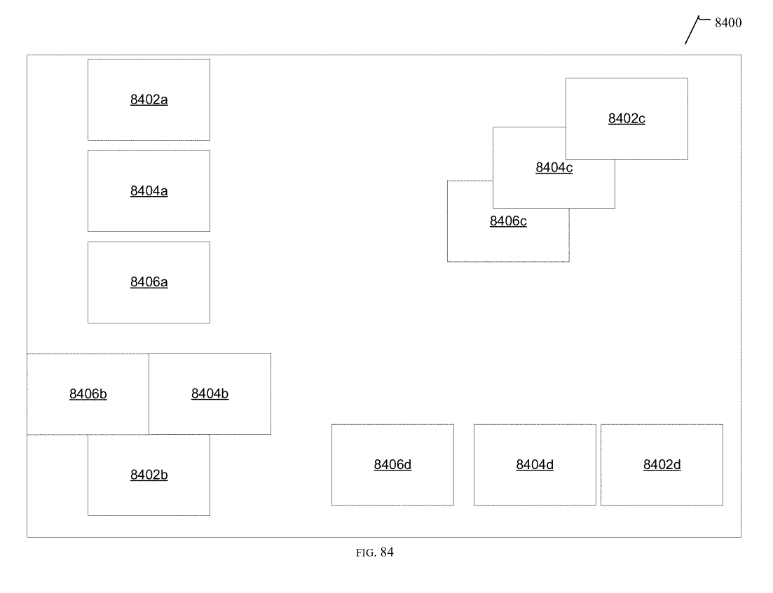

Referring to FIG. 83, an output space 8300 may include a first subspace location 8302a for a subspace. The subspace may include a first user interface element, a second user interface element, and a third user interface element. The subspace may be located in the first subspace location 8302a, which in FIG. 83 is in an upper left portion of the output space 8300. When in the first subspace location 8302a, the first user interface element may be in a first-first location 8304a, the second user interface element may be in a first-second location 8306a, and the third user interface element may be in a first-third location 8308a in the subspace or in the output space 8300. In an embodiment, the user interface elements may form an angle opening down and to the right. The subspace may also be copied or moved to a second subspace location 8302b, which in FIG. 83 is in a lower right region of the output space 8300. When the copied or moved subspace is in the second subspace location 8302b, the copied or moved first user interface element may be in a second-first location 8304b, the copied or moved second user interface element may be in a second-second location 8306b, and the copied or moved third user interface element may be in a second-third location 8308b. As shown, the copied or moved user interface element may form an angle that opens up and to the left when the subspace is in the second subspace location 8302b. In an embodiment, as the subspace 8302 is moved or copied to other locations, the copied or moved user interface elements may take other positions based on the location of the subspace. For example, when the subspace copied or moved to or near the middle of the output space 8300, the copied or moved user interface elements may be placed in a line. In some embodiments, the number of user interface elements may determine the placement for each user interface element for a location of a subspace in an output space 8300. The arrangements of user interface element described with respect to FIG. 83 are exemplary. Other arrangements, some of which are described in the present disclosure, are all within the scope of the present invention

Referring to FIG. 84, an output space 8400 may include a first user interface element of a first member of an access context, a second user interface element of a second member of the access context, and a third user interface element of a third member of the access context. A context set of the access context may include a first setting for a location of the first user interface element, a second setting for a location of the second user interface element, and a third setting for a location of the third user interface element. The context set of access context may include data or circuitry that defines rule that associates the first setting, the second setting, and the third setting. The rule may be based on a location in the output space of one or more of the first user interface element, the second user interface element, and the third user interface element. Alternatively or additionally, the rule may be based on a location of a subspace in the output space 8400 that includes the first user interface element, the second user interface element, and the third user interface element. A boundary of a subspace may be hidden or not presented. In an aspect, when a location of subspace that includes the user interface elements is towards the top and left of the output space 8400 or when one or more of the user interface elements is presented (e.g. for a first time or moved) into a region towards the top-left of the output space 8400, the user interface elements of members of the access context may be presented in a first arrangement. The first arrangement in FIG. 84 may be characterized as presenting the user interface elements in a vertical alignment with the first user interface element in a first-first location 8402a, the second user interface element in a first-second location 8404a, and the third user interface element in a first-third location 8406a. In another aspect, when a location of a subspace that includes the user interface elements is towards the bottom and left of the output space 8400 or when one or more of the user interface elements is presented (e.g. for a first time or moved) into a region towards the bottom-left of the output space 8400, the user interface elements of members of the access context may be presented in a second arrangement. The second arrangement in FIG. 84 may be characterized as presenting the user interface elements centered rows in the subspace or region. The first user interface element in a second-first location 8402b, the second user interface element in a second-second location 8404b, and the third user interface element in a second-third location 8406b. Note that presenting a set of user interface elements in differing arrangement may have an operational benefit for a user. Depending on the user interface elements and the interactions that a user may be engaged in, different arrangements may display data in an order, size, orientation, etc. that is more readable, more efficient, or otherwise more desirable to a user at a given time. Patterns of user interaction may be changed via rearranging user interface elements helping a user's attention or alertness as well as reducing repetitive motion. The identified benefits are not intended to be exhaustive. A benefit may be specified to a user, a set of user interface elements, a task associated with an interaction, or an ambient condition. In yet another aspect, when a location of subspace that includes the user interface elements is towards the top and left of the output space 8400 or when one or more of the user interface elements is presented (e.g. for a first time or moved) into a region towards the top-left of the output space 8400, the user interface elements of members of the access context may be presented in a third arrangement. The third arrangement in FIG. 84 may be characterized as presenting the user interface elements stacked in a vector from the top-right of the output space 8400 towards the center of the output space 8400. The first user interface element in a third-first location 8402c, the second user interface element in a third-second location 8404c, and the third user interface element in a third-third location 8406c. Such an arrangement may be useful for parking the user interface elements while the user interacts with another user interface element(s). In still another aspect, when a location of subspace that includes the user interface elements is towards the bottom and left of the output space 8400 or when one or more of the user interface elements is presented (e.g. for a first time or moved) into a region towards the bottom-left of the output space 8400, the user interface elements of members of the access context may be presented in a fourth arrangement. The fourth arrangement in FIG. 84 may be characterized as presenting the user interface elements aligned horizontally, but not necessarily spaced evenly, in a bottom-left region of the space 8400. The first user interface element in a fourth-first location 8402c, the second user interface element in a fourth-second location 8404c, and the third user interface element in a fourth-third location 8406c. The arrangements in FIG. 84 are meant to be illustrative of many possible arrangements that may suit various purposes and have various benefits.

In an embodiment, an arrangement of locations of user interface elements in a subspace may be based on one or more operating instances of the user interface elements, a task performed by one or more of the operating instances, a duration that of an arrangements (e.g. arrangement changes may be timed), a count of inputs from a user (e.g. arrangement may be changed 1000 touches for a device with only a touch input device), a detected or determine indicator of user attention, a state of one or more of the operating instances or corresponding user interface elements, or an ambient condition—to name some examples.

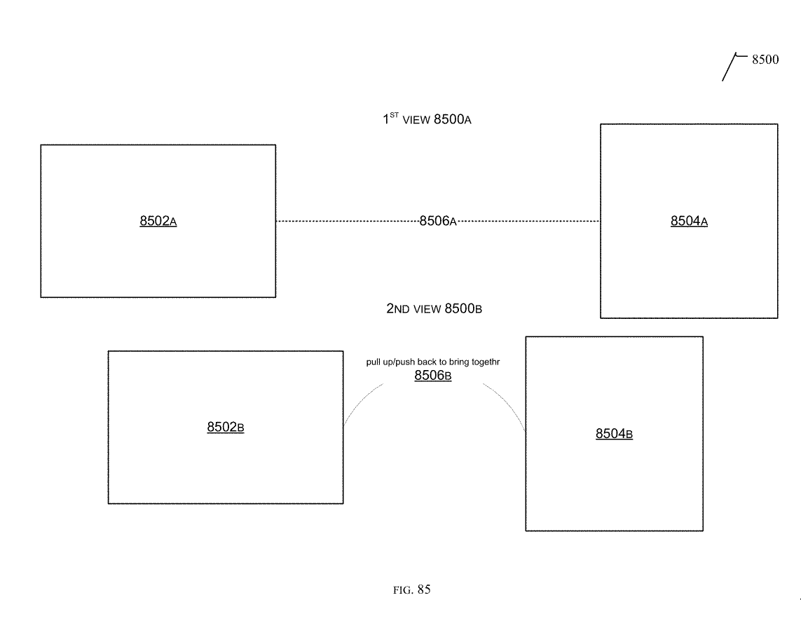

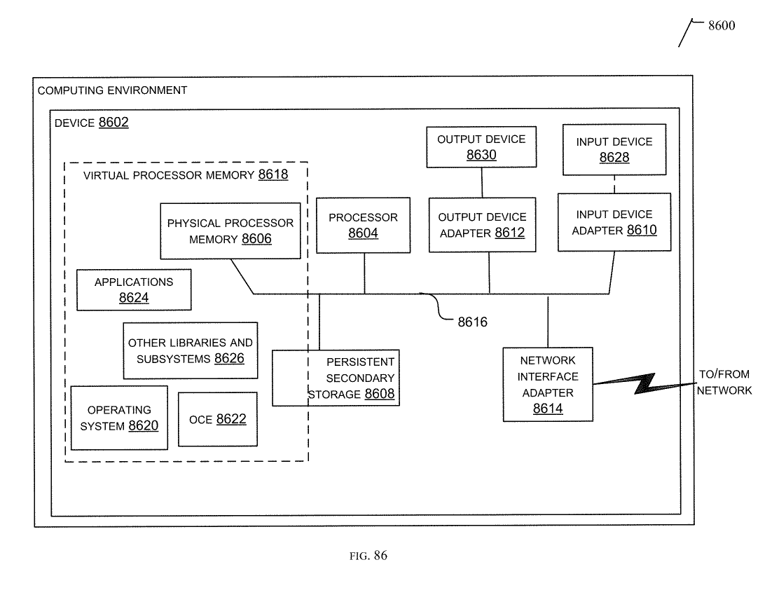

Referring to FIG. 85, views 8500 of relative locations of two user interface elements (one or both may include a subspace) are presented. A first view 8500a shows a first-first location 8502a for a first user interface element and a first-second location 8504a for a second user interface element. The first view 8500a also illustrates an indicator that takes the form of a straight line 8506a in the first view 8500a. A location indicator may identify a relationship between or among user interface elements. A second view 8500b shows a second-first location 8502a for the first user interface element and a second-second location 8504a for the second user interface element. The second view 8500b illustrates the indicator as a curved line 8506b. Note that with respect to the straight-line indicator 8506a, the curved indicator 8506b may be curved in a height dimension of an output space or may be curved in a depth dimension of the output space. A rule may be specified that associates a measure of curve with a distance between locations of the first user interface element and the second user interface element Alternatively or additionally, a user may interact with a visual representation of an indicator or may interact with an output space via a gesture to designate an indicator or to change an indicator of a relationship between or among locations of user interface elements bound or related by the location indicator. FIG. 85 illustrates one example of a location indicator or location control and is not intended to be exhaustive.

In another embodiment, an indicator or control such as the straight line 8506a may remain in a fixed shape while moved in response to user interaction to move the locations of the user interface elements simultaneously in a height dimension, a depth dimension, or a width dimension. A user may interact with a line or other control off-center to move a location of one user interface element more than a location of another or to move user interface element in different directions (e.g. a rotation, an expansion, a contraction, etc.). User interface element locations may be rotated in one or more dimensions of an output space via an interaction with an indicator or via a gesture that identifies a type of indicator. An indicator or control may be hidden, visible, partially visible, at least partially transparent, and may have other attributes that when changed cause circuitry to be invoked that changes the associated user interface elements in addition or instead of changing locations of the associated user interface elements.

Moving a subspace, changing a size of a subspace, or changing some other attribute of the subspace may change an input focus assignment, an output focus assignment, a z-ordering, a transparency level any other user detectable attribute of a user interface element in the subspace. For example, a subspace may be specified such that when a user interface element is in the subspace, the user interface element has output focus, and, when the user interface element is not in the subspace, the user interface element does not have output focus.

An access context or a subspace may be defined such that a first operating instance of an operable entity and a second operating instance of an operable entity are communicatively coupled when the first operating instance and the second operating instances are members of the access context, which may or may not be represented by a subspace in which each of the first operating instance and the second operating instance has a respective user interface element.

In an embodiment, a first user interface element in a subspace or of a first member of an access context may operate in a first operating environment. A second user interface element in the subspace or of a second member of the access context may operate in a second operating environment. The first operating environment may operate at least partially in a cloud operating environment that may interoperate via a network with a device that may include or may interoperate with an output device having an output space in which the first user interface element may be presented. The second operating environment may operate at least partially in the device to present the second user interface element in the output space.

An output space (e.g. subspace) may be bound to a physical object such as a wall, an automobile, a person, a floor, furniture, a building, a room, an appliance, or a road—to name a few examples. For example, a physical package may have an associated user interface element that represents a shipping label. The shipping label may be bound to a side of the package (e.g. the side facing a user, facing a scanner, or in a position readable by another non-human reading system). The location of the shipping label may change based on a location or orientation of the package with respect to a user. Different labels may be presented for different users. If no user is looking at the package, no label may be displayed or projected on to a side of the package. The shipping label is merely exemplary, other data about a physical about may be processed similarly.

In an embodiment, a subspace or any user interface element may be identified by its location in any of its containing output spaces. Recall that a subspace is itself an output space included at least partially in another output space. A location may be identified in an absolute manner, such as via a coordinate in a coordinate space of the containing output space. Alternatively or additionally, a location may be identified in a relative manner, such as one or more distances from another location in one or more respective dimensions, via vector in a coordinate space of a containing output space, via a relative location in an ordering, such as a z-ordering, y-ordering, or x-ordering. For example, a location of user interface element may be identified as being two locations in front of another user interface element in a z-ordering and one location to the left of the same or another user interface element in a width dimension.

A depth dimension, in an embodiment, may be identified via an axis in a coordinate space that may include at least two dimensions. A coordinate space with three dimensions may be mapped to a two-dimensional output space, as is common in current display devices where a depth location may be simulated by overlaying a user interface element over some or all of another user interface element to indicate it is in front of the other user interface element in the depth dimension. The ordering may be accessed via circuitry as an ordered list or each user interface element may be given a coordinate in a depth dimension that is simulated when presented in the two-dimensional output space. In general, an n-dimensional space may be simulated in a m-dimensional space where n is greater than m. Circuitry may be included or provided to interoperate with a system to map or translate one coordinate system to another. A coordinate space may identify a location in an output space that is not visible, such as a cached output space or may identify a location in a visible output space of an output device. As described elsewhere herein, an output space of an output device may be included in (e.g. may be a subspace of) an e-space creating an augmented reality output space (or subspace). An augmented reality output space may include one or more physical objects which may be associated with user interface elements presented in the augmented reality output space.

A first subspace and a second subspace may be presented in an output space so that their intersection in the output space is empty. If the first subspace represents a first access context and the second subspace represents a second access context, an intersection of the first access context and the second access context may be empty when the intersection of the first subspace and the second subspace is empty. A moving of one or both of the subspace may create a non-empty intersection of the two subspaces (and their respective access contexts when they represent access contexts) during the moving or as an end result of the moving. In an embodiment, intersecting subspaces or intersecting access contexts may not be allowed. A subspace may be moved or a subspace may be removed to allow another subspace to move to or through a portion of their output space while avoiding intersecting of the subspaces (and their respective access contexts if the subspaces represented respective access contexts). The removal may be temporary lasting during the moving or lasting until the moved subspace is moved to allow the removed subspace to return to its location. Alternatively of additionally, both subspaces may be moved in a coordinated fashion to prevent a non-empty intersection of the subspaces in the output space (and their respective access contexts if the subspaces represented respective access contexts).

A first subspace, in an embodiment, may include no portion of an output space included in a second subspace prior to a moving. A portion of the output space may be included in each of the first subspace and a second subspace during or subsequent to the moving. One or more of the first subspace and the second subspace may include the other one prior to, during, or subsequent to the moving. In an embodiment, a first subspace may be, with respect to a user when interacting with the subspace, between the user and a second subspace. The first subspace, with respect to a user, may be between the user and the second subspace prior to the moving, during the moving, or subsequent to the moving. The first subspace, with respect to a user may be behind the second subspace prior to the moving, during the moving, or subsequent to the moving. Subsequent to the moving, some or all of the first subspace may be between the user and the second subspace. Subsequent to the moving, some or all of the first subspace may be behind the second subspace from the perspective of a user.

In an embodiment, a first subspace may include a first portion of the output space included in a second subspace prior to a moving. No portion of the output space may be included in each of the first subspace and the second subspace subsequent to the moving. A second portion of the output space may be included in each of the first subspace and the second subspace subsequent to the moving. One or more of the first subspace and the second subspace may include the other one of the one or more of the first subspace and the second subspace. A portion of the first subspace may be, with respect to a user when interacting with the subspace, between the user and the second subspace prior to the moving. Subsequent to the moving, some or all of the second subspace may be between the user and the first subspace. Subsequent to the moving, a portion of the first subspace may be between the user and the second subspace. A portion of the second subspace may be, with respect to a user when interacting with the subspace, between the user and the first subspace prior to the moving. Subsequent to the moving, some or all of the first subspace may be between the user and the second subspace. In an embodiment, a first user interface element may be presented inside a first subspace or in a bounding surface of the first subspace prior to and subsequent to a moving.

A first subspace and a second subspace may be included in a first z-ordering in an output space. One or more user interface elements in the first subspace may be included in the first z-ordering. In an embodiment, one or more user interface elements in the first subspace may be in a second z-ordering. The first z-ordering may include user interface elements that are child user interface elements of the output space. User interface elements in the second subspace may be included in the first z-ordering. User interface elements in the second subspace may be included in the second z-ordering along with user interface elements of the first subspace. User interface elements in the second subspace may be included in the third z-ordering.

In an embodiment, locations in an output space may be identified by respective coordinates in a first coordinate space. Locations in a first subspace in the output space may be identifiable via a second coordinate space that may be unchanged after a moving. The second coordinate space may be an instance of a second coordinate system and the first coordinate space may be an instance of a first coordinate system. In another embodiment, the first coordinate space and the second coordinate space may be instances of a same coordinate system.

A moving may include a rotation of a first subspace in an output space. In an embodiment, locations in the first subspace may be identified via a respective first portion of coordinates of the first coordinate space prior to the moving. The locations in the first subspace may be identified via a respective second portion of coordinates of the first coordinate space prior to the moving.

In an embodiment, a subspace may have fewer dimensions than an output space that includes some or all of the subspace. Alternatively or additionally, a subspace included at least partially in an output space may have more dimensions than the output space.

A user interface element in a subspace may have an identifiable location in one or more dimensions of the subspace. A location of a user interface element in an output space, where the user interface element is in a subspace at least partially in the output space, may be identifiable via an identifier in a coordinate space of the output space. A location of a user interface element in an output space, where the user interface element is in a subspace at least partially in the output space, may be identifiable via an identifier in a coordinate space of the output space along with an identifier in a coordinate space of the subspace.

In an embodiment, in response to moving a subspace, a first user interface element and a second user interface element may each be located in respective same locations in the subspace before, during, or after the moving of the subspace. The respective same locations may be identified based on a coordinate space of the subspace that does change in response to the moving. The respective same locations may be identified based on a coordinate system that changes size in response to the moving. The move may include a change in size of the subspace. The coordinate system may change size in response to a change in size of the subspace.

In an embodiment, in response to moving a subspace, a first user interface element and a second user interface element may change locations with respect to each other in the subspace before, during, or after the moving of the subspace. In response to moving a subspace, a first user interface element may have a same location with respect to the subspace before, during, or in response to the moving while a second user interface element may have a different location with respect to the subspace at least one of before, during, or in response to the moving.

In an embodiment, a first user interface element and a second user interface element in a subspace do not overlap in the subspace in one or more dimension prior to the moving. The first user interface element and the second user interface element may overlap at least partially in the subspace during or as a result of the moving. In an embodiment, a first user interface element and a second user interface element in a subspace may overlap in the subspace in one or more dimension prior to a moving. The first user interface element and the second user interface element may not overlap or a size of an overlap region in one or more dimensions may change during or as a result of the moving.

In an embodiment, a first user interface element and a second user interface element in a subspace do not intersect in the subspace in one or more dimension prior to a moving. The first user interface element and the second user interface element may intersect at least partially in the subspace during or as a result of the moving. In an embodiment, a first user interface element and a second user interface element in a subspace may intersect in the subspace in one or more dimension prior to a moving. The first user interface element and the second user interface element may not intersect or a size of an intersection region in one or more dimensions may change during or as a result of the moving.

In an embodiment, a first subspace in an output space may be, with respect to a user when interacting with the subspace, closer in a depth dimension of the subspace to the user than a second subspace prior to a moving of the first subspace. In an embodiment, subsequent to the moving, some or all of the second subspace may be closer in the depth dimension to the user than the first subspace. A first subspace in an output space may be, with respect to a user when interacting with the subspace, between the user and a second subspace prior to a moving of the first subspace. That is the first subspace may overlay the second subspace from the perspective of the user. The perceived overlay may include a partial intersection of the first subspace and the second subspace. In an embodiment, subsequent to the moving, some or all of the second subspace may be between the user and the first subspace. That is the second subspace may overlay the first subspace from the perspective of the user. The perceived overlay may include a partial intersection of the first subspace and the second subspace.

In an embodiment, a first subspace in an output space may be, with respect to a user when interacting with the subspace, further away in a depth dimension of the subspace to the user than a second subspace prior to a moving of the first subspace. In an embodiment, subsequent to the moving, some or all of the second subspace may be further away in the depth dimension to the user than the first subspace. A first subspace in an output space may be, with respect to a user when interacting with the subspace, behind the second subspace prior to a moving of the first subspace. That is the second subspace may overlay the first subspace from the perspective of the user. The perceived overlay may include a partial intersection of the first subspace and the second subspace. In an embodiment, subsequent to the moving, some or all of the first subspace may be between the user and the second subspace. That is the first subspace may overlay the second subspace from the perspective of the user. The perceived overlay may include a partial intersection of the first subspace and the second subspace.

A subspace may include user interface elements of operating instances of different devices or different operating environment. User interface elements presented by multiple output devices may be presented in a same output space such as an e-space that may include one or more physical objects. User interfaces of multiple device or operating environment may be at least partially merged or shared via a same output space of via multiple output spaces where at least part of a presentation in each output space is synchronized.

In various embodiments, a context set may include one or more computing process resources. Examples of computing process resources include a processor, a processor memory, a scheduler, a process state, a process queue, a processor register, stack memory space, heap memory space, a memory data segment, a memory code segment, an instruction cache, a data cache, and processor memory schema. Alternatively or additionally, a context set may include one or more storage resources. Examples of storage resources include a file, a folder, a database, a data structure, a variable, a constant, a virtual memory, a physical memory, a memory address space, a persistent memory, a volatile memory, a storage device driver, a storage device hardware adapter, circuitry and hardware for access remote storage such a cloud-based data store, a cloud-based data store, a removable data storage device, a flash drive, a hard-drive, a tape, a tape drive, an optical data storage device, a thermal data storage device, a magnetic data storage device, an electronic data storage device, a file handler, a primary key for a record in a plurality of records, a secondary, key, or metadata for any of the foregoing. Alternatively or additionally, a context set may include one or more interaction resources. Examples of interaction resources include an output device, an input device, an output adapter, an input adapter, an output space, a coordinate system, a coordinate space of a coordinate system, a user interface element, a graphics code library, a GPU, a user interface model, or metadata for any of the foregoing. Alternatively or additionally, a context set may include one or more resources from other categories of resources such a data exchange resource, an input resource, an output resource, a network resource, a time resource, a personal communications resource, an energy resource, an error or exception resource, a configuration resource, a monitoring resource, a security resource, or metadata for the foregoing resources.

In an embodiment, context set of an access context may include an operating environment resource of a virtual operating environment, a cloud computing environment, or task operating environment.

A user interface element may be pre-specified to be assigned to a subspace. Alternatively or additionally, user interface element may be included in a subspace based on a user interaction engaged in for some other purpose. A user interface element may be added to a subspace in response to a starting or initiating of an operating instance or a portion of an operating instance, such as a function or specified step in a process. A user interface element may be included in a subspace based on a user, a role, a date, a location, a legal entity (a company), or a power state—to name some examples.

A location attribute of a subspace may serve as an anchor, may define a boundary, may define a constraining region, may identify an orientation in an output space, may control/constrain depth/width/height of a user interface element(s) in the subspace.

As described above, an output space (e.g. subspace) or an access context may be copied, cut, or pasted to another output space or access context, respectively. For example, a subspace may be copied or moved from one virtual desktop to another or from the output space of a first output device to an output space of a second output device. A subspace may be moved or copied from first output space to a second output space that may have a different number of dimensions (e.g. two-dimension to three-dimensional or vice versa), that may have different sizes (e.g. tablet to wide-screen TV), from a first user interface model to a second user interface model (e.g. Windows 10 to Android).

An output space (e.g. subspace) or an access context can be closed, hibernated, slept/paused and states the user interface elements or their operating instances may be changed in response. A user interface element or an operating instance may be closed, hibernated, or paused, running, initializing, and the like.

An output space (e.g. subspace) or an access context may respectively have a parent output space (e.g. subspace) or access context, a child output space (e.g. subspace) or access context, or a peer output space (e.g. subspace) or access context.

Operable entities may be located in a folder that corresponds to an access context. Operating instances may be configured based on context set data stored in the folder, in a parent folder, or stored as metadata for the folder or for an operable entity in the folder. A folder may be created or identified for including one or more operable entities. Operating instances of the one or more operating entities may be pre-configured to be members of a specified access context or group of access contexts. Alternatively or additionally, a user interface element of each operating instance of the one or more operable entities in the folder may be pre-configured to be includes in a specified subspace or group of subspaces. Virtual file systems may each reference or include a same file or folder creating an intersection. Such an intersection may pre-specify an intersection between subspaces or access contexts for operating instances of operable entities in the intersection of two or more files or virtual files or of two or more folders or virtual folders. Any storage container may be utilized rather than or as an equivalent of a folder, such as a database table, an XML document, a named list or hierarchy, and the like.

Resources that may be included in a context set, in addition to or instead of resources identified elsewhere in the present disclosure, include data, a system, an apparatus, hardware (e.g. mechanical, electrical, etc.), or a user accessed via an interaction by or for an operating instance. A resource accessed by or for an operating instance may, at least in part, be a physical entity or may at least in part be a virtual entity realized by one or more physical entities. A physical entity may be alive or not. In an automobile, an operating gasoline engine may, as an operating instance, access gas, as a resource, from a gas tank. The gas tank may also a resource for the operating gasoline engine. In a computing environment, physical processor memory, virtual processor memory, a persistent storage device, network hardware, a processor, a computing process, virtual circuitry operated when a processor accesses and executes code stored in a processor memory, and the like are each an example of a resource when accessed by or for an operating instance. For example, a signal propagated by a communications medium may be a resource accessed by or for an operating instance. Data stored on a hard drive may be a resource. Neither the signal nor the data is an operating instance. Exemplary resources with respect to various operating instances include a cache memory, a system bus, a switching fabric, an input device, an output device, a network protocol, an interrupt, a semaphore, a pipe, a queue, a stack, a data segment, a memory address space, a file system, a network address space, a URI, an image capture device, an audio output device, a user, a database, a persistent data store, a semaphore, a pipe, a socket, a processor, a memory manager, a scheduler, a process, a thread, an executable maintained in a library, a data store, a data storage medium, a file, a directory, a file system, user data, authorization data, authentication data, a stack, a heap, a queue, an interprocess communication mechanism (e.g. a stream, a pipe, an interrupt, etc.), a synchronization mechanism (e.g. a lock, a semaphore, an ordered list, etc.), an input device, a networking device, a device driver, a network protocol, a link or reference, a linker, a loader, a compiler, an interpreter, a sensor, an address space, an addressable space, an invocation mechanism, a memory mapper, a security model or a security manager, a GPS client or server, a web server, a browser, a container (such as a LINUX container), a virtual machine, a framework (such as a MESOS framework or an OMEGA framework), a scheduler, a timer, a clock, a code segment, a data segment, boot logic, shutdown logic, a cache, a buffer, a processor register, a log, a tracing mechanism, a registry, a network adapter, a line card, a kernel, a security ring, a policy, a policy manager, encryption hardware or software, a routing/forwarding/relaying mechanism, a data base, a user communications agent (e.g. Email, instant messaging, voice, etc.), a distributed file system, a distributed memory mechanism, a shared memory mechanism, a broadcast mechanism, a display, graphics hardware, a signal, a pipe, a stream, a socket, a physical memory, a virtual memory, a virtual file system, a command line interface, and loadable logic code or data (e.g. a dynamic link library), or metadata for any of the foregoing. Examples of metadata include a state, a condition, an amount, a duration, a time, a date, a rate, an average, a measure of dispersion, a maximum, a minimum, a temperature, a velocity, an acceleration, a weight, a mass, a count, an order, or an ordering—to name a few examples.

One or more operating instances in a computing environments may operate for process management, thread management, memory management, input/output device management, virtual machines, kernels, storage management, security management, network management, user interface management, data storage, data exchange via a network, presenting output, detecting input, operatively coupling to a peripheral device or a peer device, providing power, generating heat, dissipating heat, and the like. Each may operate as a member of zero, one, or more access contexts.

The various embodiments described herein along with the equivalents or analogs may be realized in various operating environments. An “operating environment” (operating environment), as used herein, is an arrangement of physical entities and/or virtual entities that include or that may be configured to include an embodiment of the subject matter of the present disclosure. An operating environment may, as indicated, include one or more virtual entities represented or otherwise realized in one or more physical entities. For example, physical electronic circuitry is a physical entity that includes one or more electronic circuits designed and built to perform an operation, task, or instruction. An example of a virtual entity, is “virtual circuitry” or logic that is realized in one or more physical electronic circuits, such as the physical circuitry included in a memory device, in a wired or wireless network adapter, or in special purpose or general purpose instruction execution circuitry as described in more detail below. All embodiments of the subject matter of the present disclosure include one or more physical entities that access or utilize one or more physical resources. Embodiments of the subject matter of the present disclosure that provide, transmit, or receive electrical power include electronic circuitry which may include circuitry that is not programmable or may include circuitry that is programmable but that does not embody a Turing machine. Some embodiments may include programmable circuitry that embodies a Turing machine for realizing virtual circuitry. Virtual circuitry may be represented in a memory device or in a data transmission medium, for example as code. Virtual circuitry may be emulated or realized by physical circuitry. For example, virtual circuitry may be specified in data accessible to physical circuitry that emulates the virtual circuitry by processing the data. Such data may be stored or otherwise represented, for example, in a memory device or in a data transmission medium coupled to the physical circuitry to allow the physical circuitry access to a data representation of the virtual circuitry to emulate the operation of the virtual circuitry. A computing process is an example of a virtual resource that represents virtual circuitry that in operation may be emulated or realized by programmable physical circuitry per a data representation of the virtual circuitry.

Virtual circuitry may be represented by data that is a translation of source code written in a programming language. An operating environment may include software accessible to a processor as machine code that operates virtual circuitry. An operating environment may include or may be provided by one or more devices that include one or more processors to execute instruction(s) to operate virtual circuitry. An operating environment that includes a processor is referred to herein as a “computing environment”. In an aspect, a computing environment may include an operating system, such as WINDOWS, LINUX, OSX, OS360, and the like. In an aspect, an operating environment, which may be or may include a computing environment, may include one or more operating systems.

FIG. 86 illustrates an exemplary system that may be included in or may include an operating environment for one or more embodiments of the subject of the present disclosure. Of course, the system may be implemented in any suitable arrangement of hardware. An arrangement of hardware may be included in one or more devices. FIG. 86 illustrates an operating environment as a computing environment 8600 that may be programmed, adapted, modified, or otherwise configured per the subject matter of the present disclosure. FIG. 86 illustrates a device 8602 included in computing environment 8600. FIG. 86 illustrates that computing environment 8600 includes a processor 8604.

FIG. 86 also illustrates that computing environment 8600 includes a physical processor memory 8606 including storage locations identified by addresses in a physical memory address space of processor 8604; a persistent secondary data store 8608, such as one or more hard drives or flash storage media; an input device adapter 8610, such as a key or keypad hardware, a touch adapter, a keyboard adapter, or a mouse adapter; an output device adapter 8612 such as a display adapter or an audio adapter to present information to a user; a network interface, illustrated by a network interface adapter 8614, to exchange data via a network such as a LAN or WAN; and a mechanism that operatively couples elements 8604-8614, illustrated as a data transfer medium 8616. Elements 8604-8614 may be operatively coupled by various means. Data transfer medium 8616 may comprise any type network or a bus architecture. A bus architecture may include a memory bus, a peripheral bus, a local bus, a mesh fabric, a switching fabric, or one or more direct connections.

Processor 8604 may access instructions and data via one or more memory address spaces in addition to the physical memory address space. A memory address space includes addresses identifying locations in a “processor memory”. The addresses in a memory address space of a processor are included in defining a processor memory of the processor. Processor 8604 may have more than one processor memory. Thus, processor 8604 may have more than one memory address space. Processor oe0004 may access a location in a processor memory by processing an address identifying the location. The processed address may be identified by an operand of an instruction or may be identified by a register or other portion of physical processor memory 8606.

An address space including addresses that identify locations in a virtual processor memory is referred to as a “virtual memory address space”; its addresses are referred to as “virtual memory addresses”; and its processor memory is referred to as a “virtual processor memory” or “virtual memory”. The term, processor memory, may refer to physical processor memory, such as physical processor memory 8606 or may refer to virtual processor memory, such as virtual physical processor memory 8606, depending on the context in which the term is used.

FIG. 86 illustrates a virtual processor memory 8618 spanning at least part of physical processor memory 8606 and may span at least part of persistent secondary storage 8608. Virtual memory addresses in a memory address space may be mapped to physical memory addresses identifying locations in physical processor memory 8606. Both physical processor memory 8606 and virtual processor memory 8618 are processor memories, as defined above.

Physical processor memory 8606 may include various types of memory technologies. Exemplary memory technologies include static random access memory (SRAM), Burst SRAM or Synchburst SRAM (BSRAM), Dynamic random access memory (DRAM), Fast Page Mode DRAM (FPM DRAM), Enhanced DRAM (EDRAM), Extended Datan output RAM (EDO RAM), Extended Datan output DRAM (EDO DRAM), Burst Extended Datan output DRAM (BEDO DRAM), Enhanced DRAM (EDRAM), synchronous DRAM (SDRAM), JEDEC SRAM, PC SDRAM, Double Data rate SDRAM (DDR SDRAM), Enhanced SDRAM (ESDRAM), Synclink DRAM (SLDRAM), Ferroelectric RAM (FRAM), RAMBUS DRAM (RDRAM) Direct DRAM (DRDRAM), or XDRTM DRAM. Physical processor memory 8606 may include volatile memory as illustrated in the previous sentence or may include non-volatile memory such as non-volatile flash RAM (NVRAM) or ROM.

Persistent secondary storage 8608 may include one or more flash memory storage devices, one or more hard disk drives, one or more magnetic disk drives, or one or more optical disk drives. Persistent secondary storage 8608 may include a removable data storage medium. The drives and their associated computer readable media provide volatile or nonvolatile storage for representations of computer-executable instructions, data structures, software components, and other data. The computer readable instructions may be loaded into a processor memory as instructions executable by a processor.

Computing environment 8600 may include virtual circuitry specified in software components stored in persistent secondary storage 8608, in remote storage accessible via a network, or in a processor memory. FIG. 86 illustrates computing environment 8600 including virtual circuitry in an operating system 8620, in one or more applications 8622, and in other software components or data components illustrated by other libraries and subsystems 8624. In an aspect, some or all virtual circuitry specified for realizing the software components may be stored in locations accessible to physical processor memory 8606 in a shared memory address space shared by more than one thread or process of computing environment 8600. The circuitry and data for performing operation(s) in software components accessed via the shared memory address space may be stored in a shared processor memory defined by the shared memory address space. In another aspect, first circuitry for a first software component may be represented in one or more memory locations accessed by processor 8604 in a first address space and second circuitry for a second software component may be represented in one or more memory locations accessed by processor 8604 in a second address space. The first circuitry may be represented in memory as first machine code in a first processor memory defined by the first address space and the second circuitry may be represented as second machine code in a second processor memory defined by the second address space.

Computing environment 8600 may receive user-provided information via one or more input devices illustrated by an input device 8628. Input device 8628 may provide input information to other components in computing environment 8600 via an input device adapter 8610 which may be included in computing environment 8600. An input device adapter 8610 may be included for one or more of a keyboard, a touch screen, a microphone, a joystick, a television receiver, a video camera, a still camera, a scanner, a fax, a phone, a modem, a network interface adapter, or a pointing device, to name a few exemplary input devices. An input device 8626 included in computing environment 8600 may be included in device 8602 as FIG. 86 illustrates or may be external (not shown) to device 8602. Computing environment 8600 may include one or more internal or external input devices. External input devices may be connected to device 8602 via corresponding data interfaces such as a serial port, a parallel port, or a universal serial bus (USB) port. An input device adapter 8610 may receive input and provide a representation to a data transfer medium 8616 to be received by a processor 8604, physical processor memory 8606, or other components included in computing environment 8600.

An output device 8628 in FIG. 86 exemplifies one or more output devices that may be included in or that may be external to and operatively coupled to device 8602. For example, output device 8628 is illustrated connected to data transfer medium 8616 via an output device adapter 8612. An output device 8628 may be a display device. Exemplary display devices include liquid crystal displays (LCDs), light emitting diode (LED) displays, virtual reality displays, augmented reality displays (e.g. headgear, glasses, etc.), and projectors of two-dimensional or three-dimensional projections). An output device 8628 may present output of computing environment 8600 to one or more users. In some architectures, an input device may also include an output device. Examples include a phone, a joystick, or a touch screen. In addition to various types of display devices, exemplary output devices include printers, speakers, tactile output devices such as motion-producing devices, and other output devices producing sensory information detectable by a user. Sensory information detected by a user is referred in the present disclosure to as “sensory input” with respect to the user.

A device included in or otherwise providing an operating environment may operate in a networked environment interoperating with one or more other devices via one or more network interface components. FIG. 86 illustrates network interface adapter 8614 as a network interface component included in computing environment 8600 to communicatively couple device 8602 to a network. A network interface component may a network interface hardware (NIH) component and optionally a network interface software (NIS) component. Exemplary network interface components include network interface controllers, network interface cards, network interface adapters, and line cards. A node may include one or more network interface components to interoperate with a wired network or a wireless network. Exemplary wireless networks include a BLUETOOTH network, a wireless 802.11 network, or a wireless telephony network (e.g., CDMA, AMPS, TDMA, CDMA, GSM, GPRS UMTS, or PCS network). Exemplary network interface components for wired networks include Ethernet adapters, Token-ring adapters, FDDI adapters, asynchronous transfer mode (ATM) adapters, and modems of various types. Exemplary wired or wireless networks include various types of LANs, WANs, mesh networks, or personal area networks (PANs). Exemplary networks also include intranets and internets such as the Internet.

Exemplary devices included in or otherwise providing suitable operating environments that may be adapted, programmed, or otherwise modified according to the subject matter include a workstation, a desktop computer, a laptop or notebook computer, a server, a handheld computer, a smartphone, a mobile telephone or other portable telecommunication hardware, a media playing hardware, a gaming system, a tablet computer, a portable electronic device, a handheld electronic device, a multiprocessor device, a distributed system, a consumer electronic device, a router, a switch, a bridge, a network server, any other type or form of computing, telecommunications, network, a media device, a transportation vehicle, a building, an appliance, a human wearable entity, a lighting device, a networking device, a manufacturing device, a test device, a sensor, a musical instrument, a printing device, a vision device, a netbook, a cloud book, a mainframe, a supercomputer, a wearable computer, a minicomputer, an air conditioner, a clock, an answering machine, a blender, a blow dryer, a security system, a calculator, a camera, a can opener, a cd player, a fan, a washer, a dryer, coffee grinder, coffee maker, an oven, a copier, a crock pot, a curling iron, a dishwasher, a doorbell, a lawn edger, an electric blanket, a power tool, a cordless power tool, a musical instrument, a pencil sharpener, an electric razor, an electric toothbrush, an espresso maker, a smoke detector, a carbon monoxide detector, a flashlight, a television, a food processor, a source of electrical energy, a source of non-electrical energy, a freezer, a furnace, a heat pump, a garage door opener, a garbage disposal, a GPS device, an audio recording device, an audio playing device, a humidifier, an iron, a light, lawn equipment, a leaf blower, a microwave oven, a mixer, a printer, a radio, a cook-top, a refrigerator, a scanner, a toaster, a trash compactor, a vacuum cleaner, a vaporizer, a VCR, a video camera, a video game machine, a watch, a water heater, a DVD player, a game console, a robot, a sump pump, a watch, a heart monitor or other body monitors, smart eyewear, an insulin pump, and a pacemaker, It will be understood by those skilled in the art based on the present disclosure that the foregoing list is not exhaustive. Those skilled in the art will understand that the components illustrated in FIG. 86 are exemplary and may vary by operating environment. An operating environment may be or may include a virtual operating environment including software components operating in a host operating environment.

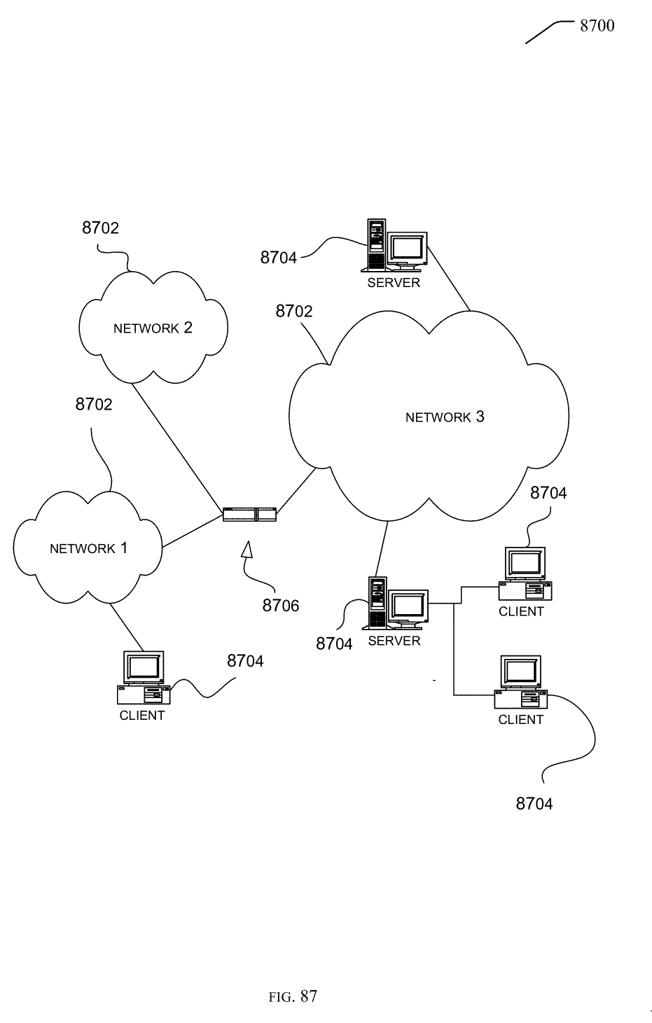

FIG. 87 illustrates a network architecture 8700, in accordance with one or more possible embodiments. As an option, the system of FIG. 86 may be implemented in the context of any of the devices of the network architecture 8700 in FIG. 87. As shown, at least one network 8702 is provided. In the context of the present network architecture 8700, the network 8702 may take any form including, but not limited to a telecommunications network, a local area network (LAN), a wireless network, a wide area network (WAN) such as the Internet, peer-to-peer network, cable network, etc. While only one network is shown, two or more similar or different networks 8702 may be provided.

Coupled to the network 8702 is a plurality of devices. For example, a server node 8704 (e.g. of a web service or a cloud-based service) and an end user node 8704, also referred to as a client node, and a relay/routing node 8706 may be coupled to the network 8702 for purposes of exchanging data. An end user node 8704 may include a desktop computer, lap-top computer, or any other type of resource accessor including network interface hardware such as a wired or wireless adapter.

Other exemplary devices that may be coupled to the network 8702 include a personal digital assistant (PDA) resource accessor, a mobile phone device, a television, a media capture device, a media playing device, a home appliance (e.g. a thermostat, a refrigerator, a stove, an oven, a light which may include an LED, a power outlet, a power storage device, a power generating device), circuitry included in a construction material (e.g. a sheet rock panel, a wall or ceiling support, etc.), a fan, a filter, a pump, a cooling device, a heating device, a self-propelled vehicle, or an automotive vehicle—among others.

Use of the terms “a” and “an” and “the” and similar referents in the context of describing the subject matter (particularly in the context of the following claims) are to be construed to cover both the singular and the plural, unless otherwise indicated herein or clearly contradicted by context.

The use of all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the subject matter as claimed.

The use of “including”, “comprising”, “having”, and variations thereof are meant to encompass the items listed thereafter and equivalents thereof as well as additional items and equivalents thereof.

The term “or” in the context of describing the subject matter (particularly in the context of the following claims) is to be construed to be, as used herein, inclusive. That is, the term “or” is equivalent to “and/or” unless otherwise indicated herein or clearly contradicted by context.

Terms used to describe interoperation or coupling between or among parts are intended to include both direct and indirect interoperation or coupling, unless otherwise indicated. Exemplary terms used in describing interoperation or coupling include “mounted,” “connected,” “attached,” “coupled”, “communicatively coupled,” “operatively coupled,” “invoked”, “called”, “provided to”, “received from”, “identified to”, “interoperated” and similar terms and their variants.

As used herein, any reference to an entity “in” an association or relationship is equivalent to describing the entity as “included in or identified by” the association or relationship, unless explicitly indicated otherwise.

In various implementations of the subject matter of the present disclosure, circuitry for “sending” an entity is referenced. As used herein “sending” may refer to providing via a network or making accessible via a shared data area, a stack, a queue, a pointer to a memory location, an interprocess communication mechanism, and the like. Similarly, in various implementations of the subject matter of the present disclosure, circuitry for “receiving” an entity as use herein may include receiving or otherwise accessing via a network, gaining access via a network or making accessible via a shared data area, stack, a queue, a pointer to a memory location, an interprocess communication mechanism, and the like. Circuitry for “exchanging” may include circuitry for sending or for receiving. In various implementations of the subject matter of the present disclosure, circuitry for “identifying” as use herein may include, without being exhaustive, circuitry for accessing, sending, receiving, exchanging, detecting, creating, modifying, translating, or transforming. In various implementations of the subject matter of the present disclosure, circuitry for “detecting” as use herein may include, without being exhaustive, circuitry for accessing, sending, receiving, exchanging, identifying, creating, modifying, translating, or transforming.

As used herein a “processor” may be an instruction execution machine, apparatus, or device. A processor may include one or more electrical, optical, or mechanical parts that when executed operate in interpreting and executing data that specifies virtual circuitry (i.e. circuitry), typically generated from code written in a programming language. Exemplary processors include one or more microprocessors, digital signal processors (DSPs), graphics processing units (GPUs), application-specific integrated circuits (ASICs), optical or photonic processors, or field programmable gate arrays (FPGAs). A processor in an operating environment may be a virtual processor emulated by one or more physical processors. A processor may be included in an integrated circuit (IC), sometimes called a chip or microchip. An IC is a semiconductor wafer on which thousands or millions of resistors, capacitors, and transistors are fabricated. An IC can function as an amplifier, oscillator, timer, counter, computer memory, or processor. A IC may be categorized as linear (analog) or digital, depending on its intended application.

A “virtual operating environment” (VOE) operates in another operating environment, referred to as a “host operating environment” with respect to the virtual operating environment. With respect to computing environments, Linux and Windows virtual machines are examples of virtual operating environments. The term “virtual machine” (VM) as used herein may refer to an implementation that emulates a physical machine (e.g., a computer). A VM that includes an emulation of a processor is a virtual operating environment provided by a host operating environment where the host operating environment includes a processor realized in hardware. VMs provide hardware virtualization. Another category of virtual operating environment is referred to, herein, as a “process virtual environment” (PVE). A PVE includes a single computing process. A JAVA VM is an example of a process virtual environment. PVEs are typically tied to programming languages. Still another exemplary type of virtual operating environment is a “container operating environment” (COE). As used herein, a container operating environment may be a partition of a host operating environment that isolates an executing of circuitry, such as in a computer program, from other partitions. For example, a single physical server may be partitioned into multiple small partitions that each execute circuitry for respective web servers. To circuitry, such as circuitry implementing a web server, operating in a partition (COE); the partition appears to be an operating environment. Container operating environments are referred to in other contexts outside the present disclosure as virtual environments (VE), virtual private servers (VPS), guests, zones, containers (e.g. Linux containers), etc. At least one of a resource utilized by a resource accessor (e.g. task circuitry) and a resource provider that allows the resource accessor to access the resource (e.g. a task operating environment or task host circuitry) may be included in a virtual operating environment.

An operating instance in an operating environment may access one or more resources of the operating environment or accessible via the operating environment. As illustrated by the description of access contexts above, access to one or more of the resources may be changed or access to one or more resources may be changed when an operating instance is a member of an access context. The one or more resources changed or for which access may be changed are context resources of the access context. The set of context resources is referred to herein as a context set of the access context. A subspace may be a type of access context. A member of an access context is an operating instance that operates at least partially in the access context. An access context, as described, may have a “context set” that includes context resources of the access context. The access context, as described, may also have a member set that includes operating instances that operate at least partially in the access context and are members of the access context. An access context specifies a relationship between a context resource in a context set of the access context and an operating instance that is a member of a “member set” of the access context. A “member set” may include or zero or more operating instances of zero of more operable entities at any time. In an embodiment, a member set may by dynamic changing over time. A member set may be pre-specified and may also be static (i.e. unchangeable). In an embodiment, a members of a member set may be specified by one or more operable entities. An operating instance of a specified operable entity may be a member of an access context when the member set is defined based on one or more identified operable entities. An additional criterion may be specified for an access context so that only operating instances of a specified operable entity that meet the specified criterion may be members of the member set. An operating instance may be included in more than one member set of more than one respective access context. An operable entity may have an operating instance in a first members set of a first access context and a second operating instance in a second member set of a second access context.

A context set may identify one or more context resources. A resource may be accessed by or for an operating instance operating in the context of an operating environment. A context resource may be, alternatively or additionally, accessed by or for the operating instance when operating at least partially in the access context. In an embodiment, an access context may allow access to a context resource that is otherwise not accessible as a resource in an operating environment. Alternatively or additionally, an access context may allow access to a context resource rather than a resource accessible in the operating environment. Still further, an access context may constrain or change access to a resource accessible without the change or with a different constraint when accessed in the operating environment. An access context may alter a resource or may alter access to resource (i.e. the resource is a context resource) for a member of the access context.

In an embodiment, an access context may alter no resources not included in the context set nor alter access to any resources not included in the context set of the access context. An access context changes some or all of an operating environment of an operating instance member depending on the resources in the context set. When an access context modifies a portion of resources or modifies access to a portion of resources accessible otherwise in an operating environment for an operating instance member, a “partial operating environment” for the member is realized via the access context.

An access context may modify a resource, substitute a resource, or modify access to a resource by replacing a default setting of an operating environment of the operating instance and of the access context, replacing a default setting of an operable entity for an operating instance that is a member of the access context, altering or replacing a resource accessed by, accessed for, or included in an operating instance of an operable entity, specifying a security constraint for a resource access, specifying a resource to access when an operating environment provides multiple suitable resources (e.g. an access context may include a subset of processors in its context resources set of a set of processors accessible an operating environment to an operating instance of an operable entity), change a constant setting accessible via an operating environment to a variable setting settable via one or more mechanisms, constrain a number of times a resource may be accessed by an member or by the member set of an access context, constrain a time or duration of access to a resource, modify a source of resource such a default file system or a averment path, specify minimum number of accesses or resources accessed for a member or for a member set, change default application for processing an access resource, or change or constrain access to one or more network nodes or other network resources. Other types of changes, substitutions, and constraints are described elsewhere in the present disclosure. In an embodiment, an operating instance of an operable entity may have access to resource only when the operating instance is a member of a subspace has a context set that includes the resources. Some operable entities may have operating instances that perform an operation only in the context of one or more access contexts or types of access contexts. Note that one or more a device, a process, an operating environment, another access context, or a thread whether in an environment of an operating instance or in an another accessible environment may be context resources in an access context. Access contexts may be configured to specify and manage access to resources in cloud computing systems and other types of distributed or network based systems such as client-server systems.

An access context may affect access by a member to resources accessed by or for exchanging data via a network, accessed by or for storing or retrieving data from a memory device, accessed in executing executable instructions, accessed in an interaction with a user, and the like. Examples of resources accessed in exchanging data via a network include a network interface, a network, or protocol endpoint. other network entity whether physical or virtual. A context set may identify an access context or a type of access context. An access context may be assigned an identifier such as a name, a number, an image, a character string, or an identifier from any identifier space selected for an embodiment by a developer, user, administrator, or other authority. Identifiers are resources in and of themselves and may be context resources for an access context. Other resources that may be included in a context set of an access context include hard drives, file systems, files, CCEs, operating environments, security roles, processors, and identifiers of each of the foregoing. It will be understood that this listing is not exhaustive.

As used herein, the term “addressable entity” may refer to any entity specified in source code written in a programming language. An addressable entity specified in source code may be translated into one or more other representations such as a different programming language, object code, virtual circuitry, or circuitry. An addressable entity may be translated to object code stored in an application file or code library in a data store such as a file system. The addressable entity may be translated from the object code to machine code stored in a processor memory of a processor. The addressable entity may be processed or realized as virtual circuitry by a processor accessing the machine code via the processor memory and realizing the addressable entity as virtual circuitry by processing the machine code. An addressable entity may include an instruction carried out by the processor or may include data processed as one or more operands of one or more machine code instructions carried out by the processor. An addressable entity may include circuitry. An addressable entity may include a circuit or may be specified in machine code, object code, byte code, or source code—to name some examples. Object code includes a set of instructions or data elements that either are prepared to link prior to loading or are loaded into an operating environment. When in an operating environment, object code may include references resolved by a linker or may include one or more unresolved references. The context in which this term is used will make clear the state of the object code when it is relevant. An addressable entity may include one or more addressable entities. As used herein, the terms “application”, “service”, “subsystem”, and “library” include one or more addressable entities accessible to a processor via a data storage medium or may be realized in one or more hardware parts. An addressable entity may be defined, referenced, or otherwise identified by source code specifiable in a programming language. An addressable entity is addressable by a processor when translated from the source code and loaded into a processor memory of the processor in an operating environment. Examples of addressable entities include variables, constants, functions, subroutines, procedures, modules, methods, classes, objects, code blocks, and labeled instructions. A “code block” includes one or more instructions in a given scope specified in a programming language. An addressable entity may include a value. Addressable entities may be written in or translated to a number of different programming languages or representation languages. An addressable entity may be specified in or translated into source code, object code, machine code, byte code, or any intermediate language for processing by an interpreter, compiler, linker, loader, or analogous tool. Some addressable entities include instructions executed by a processor.

A “programming language” is defined for expressing data or operations (in one or more addressable entities) in source code written by a programmer or generated automatically from an identified design pattern or from a design language, which may be a visual language specified via a drawing. The source code may be translated into instructions or into data that are valid for processing by an operating environment to emulate a virtual circuit or virtual circuitry. For example, a compiler, linker, or loader may be included in translating source code into machine code that is valid for a type of processor in an operating environment. A programming language is defined or otherwise specified by an explicit or implicit schema that identifies one or more rules that specify whether source code is valid in terms of its form (e.g. syntax) or its content (e.g. vocabulary such as valid tokens, words, or symbols). A programming language defines the semantics or meaning of source code written in the programming language with respect to an operating environment in which a translation of the source code is executed. Source code written in a programming language may be translated into a “representation language”. As used herein, a “representation language” is defined or otherwise specified by an explicit or implicit schema that identifies at least one of a syntax and a vocabulary for a scheduled translation of source code that maintains the functional semantics expressed in the source code. Note that some programming languages may serve as representation languages. Exemplary types of programming languages for writing or otherwise expressing source code include array languages, object-oriented languages, aspect-oriented languages, assembler languages, command line interface languages, functional languages, list-based languages, procedural languages, reflective languages, scripting languages, and stack-based languages. Exemplary programming languages include C, C#, C++, FORTRAN, COBOL, LISP, FP, JAVA®, APL, PL/I, ADA, Smalltalk, Prolog, BASIC, ALGOL, ECMAScript, BASH, and various assembler languages. Exemplary types of representation languages include object code languages, byte code languages, machine code languages, programming languages, and various other translations of source code.

A “user interface element” (UI element), as used herein may refer to a user-detectable output of an output device of an operating environment. A user interface element may be a visual output in a graphical user interface (GUI) presented via a display device. Exemplary user interface element elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application user interface may include one or more of the user interface elements listed. Those skilled in the art will understand that this list is not exhaustive. The terms “visual representation”, “visual output”, and user interface element, as outputs of a display device, are used interchangeably herein. Other types of user interface elements include audio outputs referred to as “audio interface elements”, tactile outputs referred to as “tactile interface elements”, and the like.

A user interface element may be stored or otherwise represented in an output space. The term “output space”, as used herein, may refer to memory or other medium allocated or otherwise provided to store or otherwise represent output information. Output information may include audio, visual, tactile, or other sensory data for presentation via an output device. For example, a memory buffer to store an image or text string for presenting to a user may be an output space. An output space may be physically or logically contiguous or non-contiguous. An output space may have a virtual as well as a physical representation. An output space may include a storage location in a processor memory, in a secondary storage, in a memory of an output adapter device, or in a storage medium of an output device. A screen of a display, for example, may, in operation, include an output space. In various embodiments, a display may be included in a mobile device (e.g., phone, tablet, mobile entertainment device, etc.), a fixed display device (e.g., within a vehicle, computer monitor, a non-portable television, etc.), or any other display element, screen, or projection device which may present a visual output to a user.

A “subspace”, as described herein, is an output space that may be included, in whole or in part, in a portion of another output space. A subspace may include one or more of user interface elements that are included respectively in user interfaces of one or more respective operating instances. An operating instance may be an operating of one or more operable entities. Examples of operable entities include applications, operating systems, operating environments, devices, hibernated computing processes, hibernating threads, dynamic and static link libraries accessible as object code from a data store or accessible as machine code in a processor memory, a network adapter, a disk drive, and so on. An operable entity includes a physical entity of a virtual entity. A subspace, thus, identifies a set of user interface elements and a corresponding set of operating instances. An operating instance of an operable entity may include a process that operates in an operating environment, a thread of a process in an operating environment that supports threaded processes, an instance of an application which may include one or more processes operating in one or more operating environments of one or more devices, an operating device, an operating instance of an operating system such as WINDOWS or LINUX, an identified portion of an operating environment such as a LINUX container, or a task assigned to an operating environment or device in a cloud computing environment such as BORG, OMEGA, KUBERNETES, and the like.

A subspace may include or otherwise access structured data or circuitry for monitoring or modifying a user interface element set in the subspace. A subspace may be a resource accessed by or for circuitry of a user interface handler of an operating instance to interact with a user via a user interface element of the operating instance that is presented in the subspace. A subspace may include or provide access to one or more other resources included in modifying or monitoring user interface elements, of operating instances, that are in the subspace. A resource may be embodied as data, code, or circuitry that is accessed by or for monitoring or modifying a user interface element in the subspace. The resource may be accessed directly or indirectly by circuitry of the subspace or circuitry of the operating instance of the user interface element, such as circuitry of a user interface handler. An embodiment, may include data, code, or circuitry that operates in monitoring, creating, removing, modifying, or otherwise processing the subspace or other attribute of the subspace accessible by or for monitoring or modifying a user interface element in the subspace. Data or circuitry of a subspace may specify a configurable attribute of a user interface element in the subspace or of the operating instance of the user interface element. Data or circuitry of a subspace may specify a policy, a schema, or circuitry accessible for monitoring or modifying a user interface element in the subspace.

An order of visual outputs in a dimension is herein referred to as an order in that dimension. For example, an order with respect to a Z-axis is referred to as a “Z-order”. The term “Z-value” as used herein may refer to a location in a Z-order. A Z-order specifies the front-to-back or back-to-front ordering of visual outputs in an output space with respect to a Z-axis. In one aspect, a visual output with a higher Z-value than another visual output may be defined to be on top of or closer to the front than the other visual output. In another aspect, a visual output with a lower Z-value than another visual output may be defined to be on top of or closer to the front than the other visual output. For ease of description the present disclosure defines a higher Z-value to be on top of or closer to the front than a lower Z-value.

A “user interface handler” (UI handler), as the term is used herein, may refer to one or more addressable entities that include circuitry (virtual or physical) to send information to present an output via an output device, such as a display. A user interface handler, additionally or alternatively, may also include circuitry to process input information that corresponds to a user interface element. The input information may be received by the user interface handler in response to a user input detected via an input device of an operating environment. Information that is transformed, translated, or otherwise processed by circuitry in presenting a user interface element by an output device is referred to herein as “output information” with respect to the circuitry. Output information may include or may otherwise identify data that is valid according to one or more schemas (defined below). Exemplary schemas for output information are defined data such as raw pixel data, JPEG for image data, video formats such as MP4, markup language data such as defined by a schema for a hypertext markup language (HTML) and other XML-based markup, a bit map, or instructions (such as those defined by various script languages, byte code, or machine code)—to name some examples. For example, a web page received by a browser may include HTML, ECMAScript, or byte code processed by circuitry in a user interface handler to present one or more user interface elements.

An “interaction”, as the term is used herein, may refer to any activity including a user and an object where the object is a source of sensory data detected by the user or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input of the portable electronic device exemplifies the device, as an input target, receiving input from the user. Note that the user in providing input is receiving sensory information from the portable electronic. An interaction may include an input from the user that is detected or otherwise sensed by the device. An interaction may include sensory information that is received by a user included in the interaction that is presented by an output device included in the interaction.

As used herein, the term “network protocol” may refer to a set of rules, conventions, or schemas that govern how nodes exchange information over a network. The set may define, for example, a convention or a data structure. Those skilled in the art will understand upon reading the descriptions herein that the subject matter disclosed herein is not restricted to the network protocols described or their corresponding OSI layers or other architectures (such as a software defined network (SDN) architecture). The term “network path” as used herein may refer to a sequence of nodes in a network that are communicatively coupled to transmit data in one or more data units of a network protocol between a pair of nodes in the network. The terms “network node” and “node” herein both refer to a device having a network interface hardware capable of operatively coupling the device to a network. Further, the terms “device” and “node” in the context of providing or otherwise being included in an operating environment refer respectively, unless clearly indicated otherwise, to one or more devices and nodes.

As used herein, the term “user communication” may refer to data exchanged via a network along with an identifier that identifies a user, group, or legal entity as a sender of the data. Alternatively or additionally, a receiver of the data. The identifier is included in a data unit of a network protocol or in a message of an application protocol transported by a network protocol. The application protocol is referred to herein as a “user communications protocol”. The sender is referred to herein as a “contactor”. The receiver is referred to herein as a “contactee”. The terms “contactor” and “contactee” identify roles of “communicants” in a user communication. The contactor and the contactee is each a “communicant” in the user communication. An identifier that identifies a communicant in a user communication is referred herein as a “communicant identifier”. The terms “communicant identifier” and “communicant address” are used interchangeably herein. A communicant identifier that identifies a communicant in a user communication exchanged via a user communications protocol is said to be in an identifier space or an address space of the user communications protocol. The data in a user communication may include text data, audio data, image data, or instruction data. A user communications protocol defines one or more rules, conventions, or vocabularies for constructing, transmitting, receiving or otherwise processing a data unit of or a message transported by the user communications protocol. Exemplary user communications protocols include a simple mail transfer protocol (SMTP), a post office protocol (POP), an instant message (IM) protocol, a short message service (SMS) protocol, a multimedia message service (MMS) protocol, a Voice over IP (VOIP) protocol, internet mail access protocol (IMAP), and hypertext transfer protocol (HTTP). Any network protocol that specifies a data unit or transports a message addressed with a communicant identifier is or may operate as a user communications protocol. In a user communication, data may be exchanged via one or more user communications protocols. Exemplary communicant identifiers include email addresses, phone numbers, multi-media communicant identifiers such as SKYPE® IDs, instant messaging identifiers, MMS identifiers, and SMS identifiers. Those skilled in the art will see from the preceding descriptions that a URL may serve as a communicant identifier.

The term “user communications agent” may refer to circuitry which may be included in an application that may operate in an operating environment to receive, on behalf of a contactee, a communicant message addressed to the contactee by a communicant identifier in the user communication. The user communications agent interacts with the contactee communicant in presenting or otherwise delivering the communicant message. Alternative or additionally, a user communications agent operates in an operating environment to send, on behalf of a contactor, a communicant message in a user communication addressed to a contactee by a communicant identifier in the user communication. A user communications agent may operate on behalf of a communicant in the role of a contactor or a contactee as described above is said, herein, to “represent” the communicant. A user in the role of a communicant interacts with a user communications agent to receive data addressed to the user in a user communication. Alternatively or additionally, a user in the role of a communicant interacts with a user communications agent to send data addressed to another communicant in a user communication.

A “communicant message” may refer to data spoken, written, or acted by a contactor for a contactee. The data is received by a user communications agent representing the contactor and is further received or to be received in a communication by a user communications agent to present via an output device to the contactee identified in the communication by a communicant identifier. Examples of communicant messages include text written by a contactee in an email or an instant message and a spoken message by a contactee included in an audio communication by a VoIP client. To be clear attachments, data unit headers, message headers, communication session control data, or connection data for setup and management of a communication are not communicant messages as defined herein.

The term “communicant alias” as used herein may refer to an identifier of a communicant in a communication where the communicant alias is not a communicant identifier in an address space of a communication protocol via which the communication is exchanged.

The term “attachment” as used herein may refer to data, that is not a communicant message, exchanged in a communication from a sending user communications agent or communications service to a recipient user communications agent or communications service. An attachment may be, for example, a copy of a file stored or otherwise represented in a file system or in another data store in an operating environment that includes a user communications agent included in exchanging the attachment in a communication. A resource sent as an attachment is data that is typically not presented “inline” in a communicant message. Email attachments are perhaps the most widely known attachments included in communications. An email attachment may be a file or other data entity sent in a portion of an email separate from a communicant message portion. As defined, other communicant messages may be sent in other types of communications along with one or more attachments.

A “user communications request”, as the term is used herein, may refer to a request sent by a user communications agent via a user communications protocol. A “user communications response”, as the term is used herein, may refer to any response corresponding to a user communications request. A user communications response may be transmitted via the same user communications protocol as its corresponding user communications request, a different user communications protocol, a web protocol, or via any other suitable network protocol. A “user communications service”, as the term is used herein, may refer to a recipient of a user communications request that is included in performing the request. Performing the request may include sending a service request based on the user communications request to a service application included in performing the request. A user communications service or a service application included in performing a user communications request may generate a user communications response to the request. “Service application”, as the term is used herein, may refer to any application that provides access to a resource. “Resource”, as the term is used herein, may refer to a data entity, a hardware part, an addressable entity, or service. A service request is a request to a service application to get, create, modify, delete, move, or invoke a resource. A response to a service request is referred to as a service response. Data in a service response is a resource. A communications request is a type of service request.

A “web protocol”, as the term is used herein, may refer to any version of a hypertext transfer protocol (HTTP) or any version of a HTTP secure (HTTPS) protocol. A “web request”, as the term is used herein, may refer to a request initiated by a user agent. A “web service”, as the term is used herein, may refer to a recipient of a web request. A web service generates a response to the request. A “web response”, as the term is used herein, may refer to any response that corresponds to a web request. A web response may be transmitted via the same web protocol as its corresponding web request, a different web protocol, via a user communications protocol, or via any other suitable network protocol. A web request is a type of service request.

A “service provider”, as the term is used herein, may refer to any entity that owns, maintains, or otherwise provides a service application such as a web service, user communications service, or other network accessible application. The term “service site” is used interchangeably with services and facilities that host a web service or other application of a service provider. For example, a service provider system may include a server farm, a content delivery network, a database, a firewall, etc.

The terms “user agent” and “service application” refer to roles played by one or more addressable entity, hardware parts, or devices operating in an operating environment, or systems in a data exchange. A “user agent” initiates or sends a command, such as a HTTP request. A “service application” accepts a command identified in a request in order to process the command. Processing a command includes performing or otherwise providing for performing an operation based on the command. The performing of the command may be successful or unsuccessful. As defined and described herein a server node may send information in a response, such as an HTTP response, to a user agent in response to receiving a command from the user agent in a request. A service application may also send a message via an asynchronous protocol or a portion of protocol that allows an asynchronous exchange via a network. Examples of applications that may include or may otherwise interoperate with a user agent include web browsers, HTML editors, spiders (web-traversing robots), or other end user tools. Note also that a protocol service, such an HTTP protocol service, is a user agent as the term is defined herein. While the present disclosure focuses the use of HTTP by user agents and server nodes and in some cases user agent clients (defined below), those skilled in the art will understand based on the descriptions and drawings provided herein that the methods described herein may be adapted to utilize other network protocols or other application s protocols instead of or in addition to HTTP and circuitry in a systems described herein and their variants may be modified to operate in performing the adapted methods.

The term “schema”, as used herein refers one or more rules that define or otherwise identify a type of resource. The one or more rules may be applied to determine whether a resource is a valid resource of the type defined by the schema. Schemas may be defined in various languages, grammars, or formal notations. For example, an XML schema is a type of XML document. The XML schema identifies documents of that conform to the one or more rules of the XML schema. For instance, a schema for HTML defines or otherwise identifies whether a given document is a valid HTML document. A rule may be expressed in terms of constraints on the structure (i.e. The format) and content (i.e. The vocabulary) of resources of the type defined by the schema. Exemplary languages for specifying schemas include the World Wide Web Consortium (W3C) XML Schema language, Data Type Definitions (DTDs), RELAX NG, Schematron, the Namespace Routing Language (NRL), MIME types, and the like. XML schema languages define transformations to apply to a class of resources. XML schemas may be thought of as transformations. These transformations take a resource as input and produce a validation report, which includes at least a return code reporting whether the resource (e.g. a document) is valid and an optional Post Schema Validation Infoset (PSVI), updating the original resource's infoset (e.g. The information obtained from the XML document by the parser) with additional information (default values, data types, etc.). A general-purpose transformation language is thus a schema language. Thus, languages for building programming language compilers are schema languages and a programming language specifies a schema. A grammar includes a set of rules for transforming strings. As such, a grammar specifies a schema. Grammars include context-free grammars, regular grammars, recursive grammars, and the like. For context-free grammars, Backus Normal Form (BNF) is a schema language. With respect to data and a schema for validating the data, a “data element” as the terms is used herein refers at least a portion of the data that is identifiable by a parser processing the data according to the schema. A document or resource conforming to a schema is said to be “valid”, and the process of checking that conformance is called validation. Markup elements are data elements according to a schema for a markup language.

The term “criterion” as used herein may refer to any information accessible to circuitry in an operating environment for determining, identifying, or selecting one option over another via the execution of the circuitry. A criterion may be information stored in a location in a memory or may be a detectable event. A criterion may identify a measure or may be included in determining a measure such a measure of performance.

It will be appreciated that an embodiment may also be implemented on platforms and operating environments other than those mentioned. Of course, the various embodiments set forth herein may be implemented utilizing hardware, software, or any desired combination thereof. For that matter, any type of circuitry may be utilized which is capable of implementing the various features and functions set forth herein. It will be understood that various details may be combined, removed, or otherwise changed without departing from the scope of the claimed subject matter. It should be strongly noted that such illustrative information is set forth for illustrative purposes and should not be construed as limiting in any manner. Any of the aspects identified by the illustrative information may be optionally incorporated with or without the exclusion of any other of the aspects. The description herein of any sequence of actions is not intended to imply that the specific order described for performing that sequence must be followed.

Suitable operating environments for the various methods described in the present disclosure may include or may be provided by a network node. Suitable operating environments include host operating environments and virtual operating environments. Suitable operating environments may include more than one node such as an operating environment of a cloud computing system. Some or all of the code, hardware, or other resources included in performing any one or more of the methods described in the present disclosure may be adapted to operate in a number of operating environments. In an aspect, circuitry of such code may operate as a stand-alone application or may be included in or otherwise integrated with another application or software system.

For each method, circuitry to perform the method may be arranged in various optional arrangements of addressable entities. Circuitry in an implementation of each of method of the present disclosure may be a translation of or otherwise may be specifiable in source code written in a programming language. Each method of the present disclosure may be embodied in one or more of various suitable arrangements in an operating environment or distributed between or among multiple operating environments. It will be understood that other arrangements of circuitry for performing each method of the present disclosure may be implemented with the circuitry distributed among addressable entities that are included in or accessible to one or more computing processes or operating environments.

Those skilled in the art will understand based on the present disclosure that the methods described herein and illustrated in the drawings may be embodied utilizing algorithms that may each be specified in more detail in source code written in any of various programming languages per the desires of one or more programmers. The source code may be translated or otherwise transformed to circuitry, such as machine code, that is executable by a processor. Those skilled in the art will further understand that modern operating environments, programming languages, and software development tools allow a programmer numerous options in writing the source code that specifies in more detail an algorithm that implements a method. For example, a programmer may have a choice with respect to specifying an order for carrying out the operations specified in the method. In another example, a programmer may present a user interface element in any number of ways that are known to those skilled in the art. Details of the source code typically will depend on an operating environment which may include an operating system and user interface software library. Compilers, loaders, and linkers may rewrite the instructions specified in the source code. As such, with respect to an algorithm that implements a method, the number of possible algorithms increases or at least remains as large as the level of specificity increases. Specificity generally increases from software analysis languages to design languages to programming languages to object code languages to machine code languages. Note the term “language” in this paragraph includes visual modeling (e.g. a flow charts, class diagrams, user interface drawings, etc.). It would be impractical to identify all such algorithms specified at the level of analysis languages or at the level of design languages, but such specifications will be apparent to the population of those skilled in the art. Further, at least at some of all such specifications will be apparent or derivable based on the present disclosure to each member of the population. As such, the present disclosure is enabling and all such specifications of the methods/algorithms that may be written by those skilled in the art based on the descriptions herein or based on the drawings in an analysis language, a design language, a high-level programming language, or an assembler language are within the scope of the subject matter of the present disclosure. Further, all specifications generated by a tool from any of the user written specifications are also within the scope of subject matter of the present disclosure.

It will also be apparent to those skilled in the art the algorithms taught based on the descriptions herein, the drawings, and the pseudo-code are exemplary and that an architecture, design, or implementation for any of the methods described herein may be selected based on various requirements that may vary for an embodiment including or otherwise invoking the circuitry. Requirements may vary based on one or more resources in an operating environment, performance needs/desires of a user or customer, resources of a display device, resources of a graphics service if included in an operating environment, one or more user interface elements processed by the circuitry or otherwise affecting the processing of the circuitry, a programming language, an analysis language, a design language, a test tool, a field support requirement, an economic cost of developing and supporting the implemented circuitry, and the desires of one or more developers of the architecture, design, or source code that includes or accesses the implemented circuitry. It will be clear to those skilled in the art that in the present disclosure it would impractical to attempt to identify all possible operating environments, programming languages, development, and test tools much less identify all possible algorithms for implementing the various methods whether the algorithms are expressed in pseudo-code, flow charts, object oriented analysis diagrams, object oriented design diagrams, resource data flow diagrams, entity-relationship diagrams, resource structures, classes, objects, functions, subroutines, and the like.

The methods described herein may be embodied, at least in part, in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of an addressable entity in one or more forms including an electronic, magnetic, optical, and electromagnetic form, such that the instruction execution machine, system, apparatus, or device may read (or fetch) the instructions from the non-transitory or transitory computer readable medium and execute the instructions for carrying out the described methods. By way of example, and not limitation, computer readable media may comprise computer storage media and resource exchange media. Computer storage media includes volatile and nonvolatile, removable and non-removable media implemented in any method or technology for storage of information such as computer readable instructions, resource structures, addressable entities or other resources. Computer storage media includes, but is not limited to, Random Access Memory (RAM), Read Only Memory (ROM), Electrically Erasable Programmable Read Only Memory (EEPROM), flash memory or other memory technology; portable computer diskette; Compact Disk Read Only Memory (CDROM), compact disc-rewritable (CDRW), digital versatile disks (DVD) or other optical disk storage; magnetic cassettes, magnetic tape, magnetic disk storage or other magnetic storage devices; or any other medium which can be used to store the desired information and which can accessed by a device. Resource exchange media typically embodies computer readable instructions, resource structures, addressable entities, or other resources in a modulated resource signal such as a carrier wave or other transport mechanism and includes any information delivery media. The term “modulated resource signal” means a signal that has one or more of its characteristics set or changed in such a manner as to encode information in the signal. By way of example, and not limitation, resource exchange media includes wired media such as a wired network or direct-wired connection, and wireless media such as acoustic, RF, infrared and other wireless media. Combinations of any of the above should also be included within the scope of computer readable media.

I claim:

1. A method comprising:
detecting, in an output space having at least one dimension, a first location of a subspace, wherein a first user interface element of a first operating instance of an operable entity is presented, based on the first location, in the subspace location and a user interface element of a second operating instance of an operable entity is presented, based on the first location, in the subspace;
receiving an indication to change the subspace; and
changing the subspace to have a second location in the output space, wherein the first user interface element and the second user interface element are each presented, based on the second location, in the changed subspace.
